(19) United States
(12) Patent Application Publication
(10) Pub. No.: US 2016/0335854 A1
(43) Pub. Date: Nov. 17, 2016

(54) GAMING MACHINE

(71) Applicants: Universal Entertainment Corporation, Tokyo (JP); Aruze Gaming (Hong Kong) Limited, Kowloon (HK)

(72) Inventors: Kenta KITAMURA, Tokyo (JP); Tatsuya TERANISHI, Tokyo (JP); Kazunori OTSUKA, Tokyo (JP); Akira OSAWA, Tokyo (JP); Hiroatsu IKE, Tokyo (JP); Yoshitomo SASAKI, Tokyo (JP)

(21) Appl. No.: 15/153,823

(22) Filed: May 13, 2016

(30) Foreign Application Priority Data
May 15, 2015 (JP) 2015-100459

(51) Int. Cl. G07F 17/34; G07F 17/32

(52) U.S. Cl. CPC G07F 17/34; G07F 17/3244; G07F 17/3267

(57) ABSTRACT

An object is to provide a gaming machine capable of facilitating the enhancement of the player's interest in a repeat random determination. The controller 220 executes the following steps of (1a) to (1d): (1a) selecting one slot 202 through random determination; (1b) when a multiplier upgrade slot 202a (repeat random determination slot) is selected in the step (1a), executing the step (1a) again; (1c) increasing a wheel multiplier (roulette multiplier) when the multiplier upgrade slot 202a is selected in the step (1a), and increasing the wheel multiplier each time the multiplier upgrade slot 202a is selected; and (1d) when a payout slot is selected in the step (1a), a payout is determined in accordance with the wheel multiplier.

### CROSS REFERENCE TO RELATED APPLICATION

The present application claims priority from Japanese Patent Application No. 2015-100459, which was filed on May 15, 2015, the disclosure of which is herein incorporated by reference in its entirety.

### FIELD OF THE INVENTION

The present invention relates to a gaming machine.

### BACKGROUND OF THE INVENTION

There has been known a gaming machine configured to make a random determination, for example as described in Patent Literature 1 (Japanese Unexamined Patent Publication No. 240451/2013 (Tokukai 2013-240451)). Further, there is a gaming machine configured to make a repeat random determination when a predetermined condition is satisfied as a result of a random determination (see, for example, claim 4 of Patent Literature 1.)

### BRIEF SUMMARY OF THE INVENTION

Most of gaming machines configured to make a repeat random determination merely provide effects for the repeat random determination. Such a repeat random determination prolongs the playing time of a game. Therefore, it has been considered that merely providing effects for the repeat random determination is not necessarily good for players.

In view of the above, an object of the present invention is to provide a gaming machine capable of facilitating the enhancement of the player's interest in a repeat random determination.

According to a first aspect of the invention, a gaming machine includes: a roulette including a plurality of slots including a repeat random determination slot and a payout slot; a storage device storing a roulette multiplier which is a numerical value indicating a multiplying factor; and a controller configured to execute the following steps of (1a) to (1d):

(1a) selecting one slot out of the plurality of slots through random determination;
(1b) when the repeat random determination slot is selected in the step (1a), executing the step (1a) again;
(1c) when the repeat random determination slot is selected in the step (1a), increasing the roulette multiplier, and when the step (1a) is executed repeatedly and the repeat random determination slot is selected repeatedly, increasing the roulette multiplier each time the repeat random determination slot is selected; and
(1d) when the payout slot is selected in the step (1a), determining a payout accordance with the roulette multiplier.

In the above arrangement, when the repeat random determination slot is selected in the random determination in the step (1a) (hereinafter “roulette random determination”), the roulette random determination is performed again in the step (1b) (repeat random determination is performed). The controller makes control as follows: the more repeatedly the repeat random determination slot is selected in the random determination, the larger the roulette multiplier becomes in the step (1c), and the larger the payout (benefit awarded to a player) becomes. Thus, the gaming machine not only gives the player an opportunity of repeat random determination, but also a possibility of increasing the payout (benefit awarded to the player). As a result, the gaming machine facilitates the enhancement of the player's interest in the repeat random determination.

According to a second aspect of the invention, the gaming machine may be arranged so that: the storage device stores a slot payout which is a value associated with the payout slot; and in the step (1d), when the payout slot is selected in the step (1a), a product of the slot payout associated with the selected payout slot and the roulette multiplier is determined as the payout.

In the above arrangement, the following game effect is provided: when the payout slot is selected in the roulette random determination, the product of the slot payout associated with the selected payout slot and the roulette multiplier is determined as the payout. As compared with the case where such a game effect is not provided, the game effect regarding how to determine the payout is diversified.

According to a third aspect of the invention, the gaming machine may be arranged so that: the controller sets an initial value of the roulette multiplier to 1; and in the step (1c), when the step (1a) is executed repeatedly and the repeat random determination slot is selected repeatedly, the roulette multiplier is incremented by a predetermined increment value each time the repeat random determination slot is selected repeatedly.

In the above arrangement, the following game effect is provided: each time the repeat random determination slot is selected repeatedly, the roulette multiplier, the initial value of which is 1, is incremented by a predetermined increment value (for example, 1, 2, 3, 4, 5, and so on). As compared with the case where such a game effect is not provided, the game effect regarding the way to increase the roulette multiplier is diversified.

According to a fourth aspect of the invention, the gaming machine may be arranged so that: the controller sets an initial value of the roulette multiplier to 1; and in the step (1c), when the step (1a) is executed repeatedly and the repeat random determination slot is selected repeatedly, the roulette multiplier is multiplied by a predetermined multiplying value each time the repeat random determination slot is selected repeatedly.

In the above arrangement, the following game effect is provided: each time the repeat random determination slot is selected repeatedly, the roulette multiplier, the initial value of which is 1, is multiplied by the predetermined multiplying value and increased in geometric progression (for example, 1, 2, 4, 8, 16, and so on). As compared with the case where such a game effect is not provided, the game effect regarding the way to increase the roulette multiplier is diversified.

According to a fifth aspect of the invention, the gaming machine may be arranged to further include: a reel including a plurality of symbols and provided separately from the roulette; and a display window configured to display one or more symbols out of the plurality of symbols, and arranged so that the controller is configured to execute the following steps of (5a) and (5b):

(5a) selecting one or more symbols to be displayed in the display window out of the plurality of symbols through random determination; and
(5b) when a predetermined trigger condition is satisfied in the step (5a), starting the step (1a).

In the above arrangement, the random determination in the step (5a) (hereinafter “symbol random determination”) is performed. Further, the step (5b) provides the following game effect: a result of the symbol random determination may cause satisfaction of the condition for starting the roulette random determination (trigger condition). As compared with the case where such a game effect is not provided, the game effect regarding the start of the roulette random determination is diversified.

According to a sixth aspect of the invention, the gaming machine may be arranged so that: the plurality of symbols include a plurality of specific symbols; the storage device stores a roulette random determination play number which is a numerical value indicating the number of plays of the roulette random determination; and the controller is configured to execute the following steps of (6a) to (6c):

(6a) when the trigger condition is satisfied, determining the roulette random determination play number in accordance with the number of the specific symbols displayed in the display window;
(6b) when the payout slot is selected in the step (1a), decreasing the roulette random determination play number by 1; and
(6c) when the roulette random determination play number after decreasing in the step (6b) is 1 or larger, starting the step (1a).

In the above arrangement, the steps (6a) to (6c) are executed. There is provided the following game effect: the roulette random determination play number is determined in accordance with the number of the specific symbols displayed in the display window when the trigger condition is satisfied; and the roulette random determination is repeated until the roulette random determination play number becomes less than 1. As compared with the case where such a game effect is not provided, the game effect regarding the number of plays of the roulette random determination is diversified.

According to a seventh aspect of the invention, the gaming machine may be arranged so that when the step (1d) is executed multiple times, the controller executes a process of updating a value of the payout to a sum of amounts of the payout determined multiple times.

In the above arrangement, the following game effect is provided: when the step (1d) is executed multiple times, the value of the payout is updated to the sum of the amounts of the payout determined multiple times. As compared with the case where such a game effect is not provided, the game effect regarding how to determine the payout is diversified.

According to an eighth aspect of the invention, the gaming machine may be arranged to further include: a reel including a plurality of symbols and provided separately from the roulette; and a display window configured to display one or more symbols out of the plurality of symbols, and arranged so that the plurality of symbols include a plurality of second specific symbols; and the controller is configured to execute the following steps of (8a) and (8b):

(8a) after the step (1d), selecting one or more symbols to be displayed in the display window out of the plurality of symbols through random determination; and
(8b) determining a product of the payout and the number of the second specific symbols selected in the step (8a) as a second payout.

In the above arrangement, the random determination in the step (8a) (symbol random determination) is performed. In the step (8b) the product of the payout and the number of the second specific symbols selected to be displayed in the display window in the symbol random determination is determined as the second payout. As compared with the case where such a game effect is not provided, the game effect regarding the payout is diversified.

According to a ninth aspect of the invention, the gaming machine may be arranged so that: the roulette includes a mechanical wheel which is rotatable about a rotation axis; the storage device stores a scenario which is a data sheet in which a rotational direction and a rotational speed of the wheel are defined in chronological order; and the controller executes a process of controlling rotational operation of the wheel in accordance with description in the scenario.

In the above arrangement, the rotational operation of the wheel is controlled by the controller in accordance with the scenario which is the data sheet in which the rotational direction and the rotational speed of the wheel are defined in chronological order. Therefore, as compared with the case where such a scenario is not used, control and adjustment of the rotational operation of the wheel are easier. For example, suppose the case where the descriptions of the rotational direction and the rotational speed of the wheel are combined in a complicated manner. In this case, by describing the complex combination in the data sheet (by editing the datasheet), the control and adjustment of the rotational operation of the wheel is facilitated.

The scenario is a data sheet in which the rotational direction and the rotational speed of the wheel are defined in chronological order. This makes it easier for a developer and the like of the gaming machine to check the flow of the rotational operation of the wheel. This facilitates the adjustment of the rotational operation of the wheel. As a result, the period of time required for this adjustment is shortened. This consequently shortens the development cycle of the gaming machine, and hence, the productivity and development efficiency of the gaming machine is improved.

Because the flow of the rotational operation of the wheel is thus easily checked, a bug in the data sheet is easily found. This consequently shortens the development cycle of the gaming machine.

Because a bug in the data sheet is easily found, determination regarding the causes for an error in the rotational operation of the wheel is easier. Specifically, for example, determination whether the error in the rotational operation of the wheel results from a bug in the datasheet or a defect in its peripheral hardware is easier.

The above arrangement facilitates the enhancement of the player's interest in the repeat random determination.

### BRIEF DESCRIPTION OF THE DRAWINGS

Other and further objects, features and advantages of the invention will appear more fully from the following description taken in connection with the accompanying drawings in which:

FIG. 1 illustrates the outline of a game executed by a gaming machine.

FIG. 2 is a diagram showing a function flow of the gaming machine.

FIG. 3 shows the overall structure of the gaming machine.

FIG. 4 is a block diagram illustrating the internal structure of the gaming machine.

FIG. 5A shows the relationship between bet buttons and bet amounts.

FIG. 5B shows symbol arrays on reels.

FIG. 5C shows the relationship between the symbols and weights.

FIG. 5D illustrates paylines.

FIG. 5E shows payouts of line wins.

FIG. 6A illustrates a wheel.

FIG. 6B shows slot arrangement of the wheel and weights.

FIG. 6C shows parameters of a scenario for the wheel.

FIG. 6D shows descriptions in the scenario.

FIG. 6E shows settings for progressive payout.

FIG. 6F shows weights in progressive payout obtainment random determination.

FIG. 6G shows weights in progressive payout level random determination.

FIG. 6H illustrates the outline of the game.

FIG. 7A is a flowchart of a main control process.

FIG. 7B is a flowchart of a bet/start check process.

FIG. 7C is a flowchart of a progressive jackpot-related process.

FIG. 7D is a flowchart of a feature game process.

FIG. 7E is an explanatory diagram for an accumulation amount for the progressive payout.

FIG. 7F is a flowchart of a wheel random determination.

FIG. 7G is an explanatory diagram for a fixed payout of the progressive payout.

FIG. 7H illustrates examples of won amounts of the progressive payout.

FIG. 8 illustrates an upper image display panel, a display window, and a liquid crystal display device.

FIG. 9A illustrates the upper image display panel.

FIG. 9B illustrates the upper image display panel.

FIG. 10A illustrates the liquid crystal display device.

FIG. 10B illustrates the liquid crystal display device.

FIG. 10C illustrates the liquid crystal display device.

FIG. 10D illustrates the liquid crystal display device.

FIG. 10E illustrates the liquid crystal display device.

FIG. 10F illustrates the liquid crystal display device.

FIG. 10G illustrates the liquid crystal display device.

FIG. 11A illustrates a flow of screen display.

FIG. 11B illustrates the flow of screen display.

FIG. 11C illustrates the flow of screen display.

FIG. 11D illustrates the flow of screen display.

FIG. 11E illustrates the flow of screen display.

FIG. 11F illustrates the flow of screen display.

FIG. 12A illustrates a display on the upper image display panel.

FIG. 12B illustrates the display on the upper image display panel.

FIG. 13A illustrates the relationship between the bet buttons and bet amounts of the second embodiment.

FIG. 13B illustrates symbol arrays on reels of the second embodiment.

FIG. 13C illustrates the relationship between symbols and weights in a base game of the second embodiment.

FIG. 13D illustrates the relationship between symbols and weights in a free game of the second embodiment.

FIG. 13E shows payout amounts of line wins of the second embodiment.

FIG. 13F shows payout amounts of scattered wins of the second embodiment.

FIG. 14A illustrates a wheel of the second embodiment.

FIG. 14B illustrates slot arrangement of the wheel and weights of the second embodiment.

FIG. 14C shows settings for progressive payout of the second embodiment.

FIG. 14D shows weights in progressive payout obtainment random determination in the second embodiment.

FIG. 14E shows weights in level random determination of the progressive payout of the second embodiment.

FIG. 14F is a flowchart showing the outline of the game of the second embodiment.

FIG. 15A is a flowchart of a feature game process of the second embodiment.

FIG. 15B is a flowchart of a wheel game process of the second embodiment.

FIG. 15C is a flowchart of a free game process of the second embodiment.

FIG. 15D is a flowchart of a wheel random determination of the second embodiment.

FIG. 16A illustrates the upper image display panel of the second embodiment.

FIG. 16B illustrates the upper image display panel of the second embodiment.

FIG. 16C illustrates the upper image display panel of the second embodiment.

FIG. 17A illustrates the liquid crystal display device of the second embodiment.

FIG. 17B illustrates the liquid crystal display device of the second embodiment.

FIG. 17C illustrates the liquid crystal display device of the second embodiment.

FIG. 17D illustrates the liquid crystal display device of the second embodiment.

FIG. 18A illustrates a flow of screen display in the second embodiment.

FIG. 18B illustrates the flow of screen display in the second embodiment.

FIG. 18C illustrates the flow of screen display in the second embodiment.

FIG. 18D illustrates the flow of screen display in the second embodiment.

FIG. 18E illustrates the flow of screen display in the second embodiment.

FIG. 18F illustrates the flow of screen display in the second embodiment.

FIG. 18G illustrates the flow of screen display in the second embodiment.

FIG. 18H illustrates the flow of screen display in the second embodiment.

FIG. 18I illustrates the flow of screen display of the second embodiment.

FIG. 18J illustrates the flow of screen display in the second embodiment.

FIG. 18K illustrates the flow of screen display in the second embodiment.

FIG. 18L illustrates the flow of screen display in the second embodiment.

FIG. 19A illustrates the upper image display panel, the display window, and the liquid crystal display device.

FIG. 19B illustrates the upper image display panel, the display window, and the liquid crystal display device.

FIG. 19C illustrates the upper image display panel, the display window, and the liquid crystal display device.

FIG. 20A illustrates the liquid crystal display device.

FIG. 20B illustrates the liquid crystal display device and the like.

FIG. 20C illustrates the liquid crystal display device and the like.

FIG. 20D illustrates the liquid crystal display device and the like.

FIG. 20E illustrates the liquid crystal display device and the like.

FIG. 20F illustrates the liquid crystal display device and the like.

FIG. 20G illustrates the liquid crystal display device and the like.

FIG. 20H illustrates the liquid crystal display device and the like.

FIG. 20I illustrates the liquid crystal display device and the like.

FIG. 21A is a table showing the period of time during which increment display is performed.

FIG. 21B shows threshold values for the level of effects.

FIG. 22A illustrates a flow of an effect provided at the time of winning.

FIG. 22B illustrates the relationship between symbols and the effect levels.

FIG. 22C illustrates a flow of an effect provided at the time of winning.

FIG. 22D illustrates a flow of an effect provided at the time of winning.

FIG. 22E illustrates a flow of an effect provided at the time of winning.

FIG. 22F illustrates a flow of an effect provided at the time of winning.

FIG. 23A illustrates a flow of an effect for the reels at the time of winning.

FIG. 23B illustrates the flow of the effect for the reels at the time of winning.

FIG. 23C illustrates the flow of the effect for the reels at the time of winning.

FIG. 24A is an explanatory diagram for a line win signboard.

FIG. 24B is a table regarding the line win signboard.

FIG. 24C is an explanatory diagram for the line win signboard.

FIG. 24D is an explanatory diagram for the line win signboard.

FIG. 25A illustrates a flow of an effect of the line win signboard.

FIG. 25B illustrates a flow of an effect of the line win signboard.

FIG. 25C illustrates a flow of an effect of the line win signboard.

FIG. 25D illustrates a flow of an effect of the line win signboard.

FIG. 26A illustrates the progress of the game and a flow of screen display.

FIG. 26B illustrates the progress of the game and the flow of screen display.

FIG. 26C illustrates the progress of the game and the flow of screen display.

FIG. 26D illustrates the progress of the game and the flow of screen display.

FIG. 26E illustrates the progress of the game and the flow of screen display.

FIG. 26F illustrates the progress of the game and the flow of screen display.

FIG. 26G illustrates the progress of the game and the flow of screen display.

FIG. 26H illustrates the progress of the game and the flow of screen display.

FIG. 26I illustrates the progress of the game and the flow of screen display.

FIG. 27A shows texts displayed on the liquid crystal display device.

FIG. 27B shows texts displayed on the liquid crystal display device.

FIG. 28A is an explanatory diagram for a HELP screen.

FIG. 28B is an explanatory diagram for the HELP screen.

FIG. 28C is an explanatory diagram for the HELP screen.

FIG. 28D is an explanatory diagram for the HELP screen.

FIG. 28E is an explanatory diagram for the HELP screen.

FIG. 29A is an explanatory diagram for touch icons.

FIG. 29B is an explanatory diagram for the touch icons.

FIG. 29C is an explanatory diagram for the touch icons.

FIG. 29D is an explanatory diagram for the touch icons.

FIG. 29E is an explanatory diagram for the touch icons.

FIG. 29F is an explanatory diagram for the touch icons.

FIG. 29G is an explanatory diagram for the touch icons.

FIG. 29H is an explanatory diagram for the touch icons.

FIG. 30 illustrates an example of the button configuration on the control panel.

FIG. 31A illustrates an example of the button configuration of the control panel and numbers given to the buttons.

FIG. 31B is a table illustrating the functions of the buttons.

FIG. 31C shows the meaning of words used in tables of FIG. 31D to FIG. 31U.

FIG. 31D is a table showing the state of the buttons and the like.

FIG. 31E is a table showing the state of the buttons and the like.

FIG. 31F is a table showing the state of the buttons and the like.

FIG. 31G is a table showing the state of the buttons and the like.

FIG. 31H is a table showing the state of the buttons and the like.

FIG. 31I is a table showing the state of the buttons and the like.

FIG. 31J is a table showing the state of the buttons and the like.

FIG. 31K is a table showing the state of the buttons and the like.

FIG. 31L is a table showing the state of the buttons and the like.

FIG. 31M is a table showing the state of the buttons and the like.

FIG. 31N is a table showing the state of the buttons and the like.

FIG. 31O is a table showing the state of the buttons and the like.

FIG. 31P is a table showing the state of the buttons and the like.

FIG. 31Q is a table showing the state of the buttons and the like.

FIG. 31R is a table showing the state of the buttons and the like.

FIG. 31S is a table showing the state of the buttons and the like.

FIG. 31T is a table showing the state of the buttons and the like.

FIG. 31U is a table showing the state of the buttons and the like.

FIG. 32A illustrates a payout message and the like.

FIG. 32B illustrates the payout message.

FIG. 32C illustrates the payout message.

FIG. 32D illustrates the payout message.

FIG. 32E illustrates the payout message.

FIG. 32F illustrates the payout message.

### DESCRIPTION OF THE PREFERRED EMBODIMENTS

### First Embodiment

The following will describe a gaming machine of the first embodiment of the present invention with reference to the drawings.

(Outline)

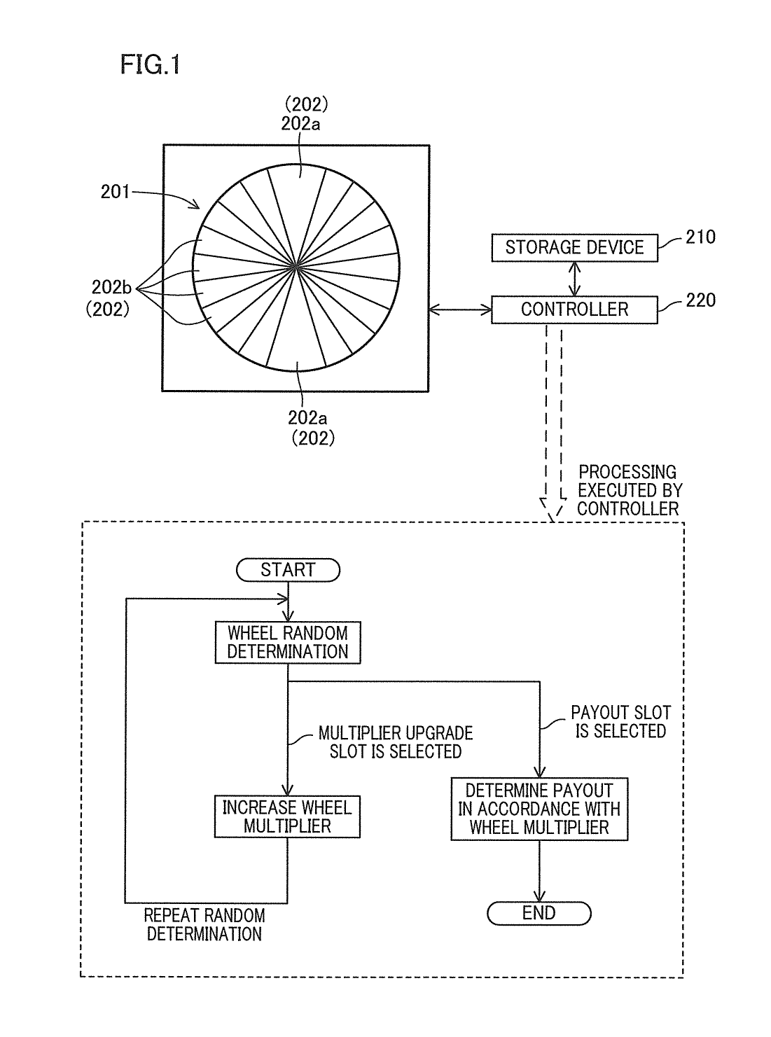

As shown in FIG. 1, the gaming machine includes: a wheel 201 (roulette); a storage device 210; and a controller 220. The wheel 201 has a plurality of slots 202. The slots 202 include: multiplier upgrade slots 202a (repeat random determination slot) and payout slots 202b. In FIG. 1, reference numerals are given to only some of the slots 202, and only some of the multiplier upgrade slots 202a. The storage device 210 stores a wheel multiplier (roulette multiplier) which is a numerical value indicating a multiplying factor. The controller 220 is configured to execute the following steps of (A1a) to (A1d):

(A1a) selecting one slot 202 out of the plurality of slots 202 through random determination (“wheel random determination” in the figure);
(A1b) when the multiplier upgrade slot is selected in the step (A1a), executing the step (A1a) again (“repeat random determination” in the figure);
(A1c) when the multiplier upgrade slot is selected in the step (A1a), increasing the wheel multiplier, and when the step (A1a) is executed repeatedly and the multiplier upgrade slot is selected repeatedly, increasing the wheel multiplier each time the multiplier upgrade slot is selected; and
(A1d) when the payout slot 202b is selected in the step (A1a), a payout is determined in accordance with the wheel multiplier.

In the gaming machine, when the multiplier upgrade slot is selected in the random determination in the step (A1a) (“wheel random determination”), the wheel random determination is performed again in the step (A1b) (repeat random determination is performed). The controller makes control as follows: the more repeatedly the multiplier upgrade slot is selected in the repeat random determination, the larger the wheel multiplier becomes in the step (1c), and the larger the payout (benefit awarded to a player) becomes. Thus, the gaming machine not only gives the player an opportunity of repeat random determination, but also a possibility of increasing the payout (benefit awarded to the player). As a result, the gaming machine facilitates the enhancement of the player's interest in the repeat random determination.

(Function Flow)

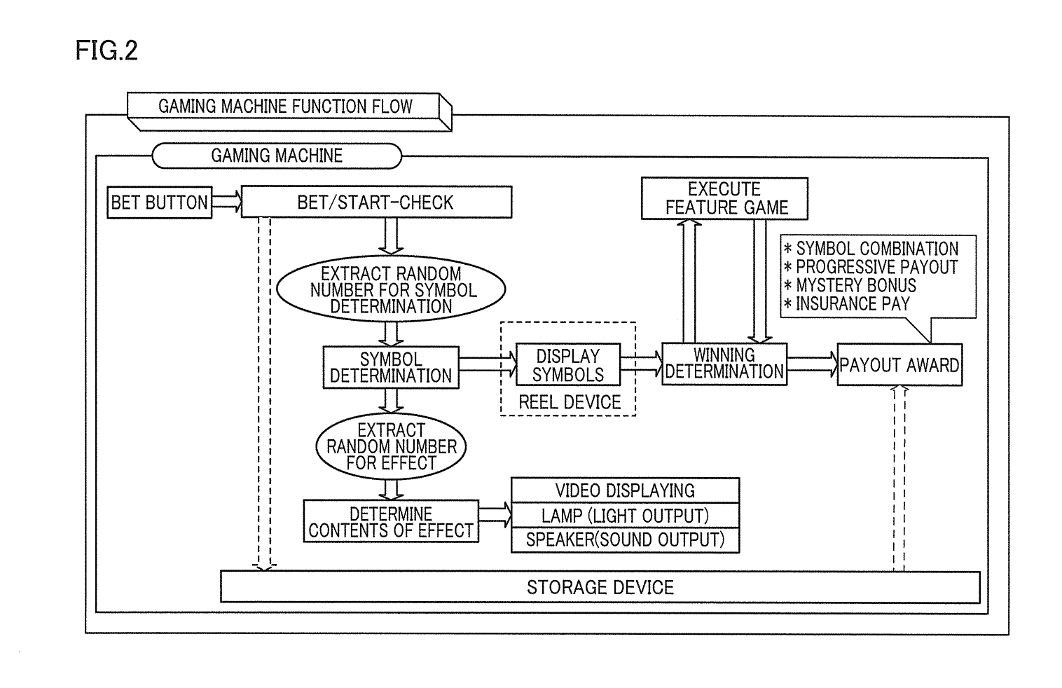

The basic functions of the gaming machine of the embodiment of the present invention will be described with reference to FIG. 2. FIG. 2 is a diagram showing a functional flow of the gaming machine of the embodiment of the present invention.

<Bet/Start-Check>

First, the gaming machine checks whether or not a bet button has been pressed (pressed down, or operated) by a player.

<Symbol Determination>

Next, the gaming machine extracts a random number for symbol determination, to determine symbols to be rearranged (displayed for the player) on reels at the time of stopping the scroll of the reels.

The term “rearrangement” indicates that the symbols are rearranged after the arrangement of the symbols is dismissed. The term “arrangement” indicates a state in which the symbols are visually recognizable by an external player. More specifically, “rearrangement” is a state in which, after the symbols on the reels are variably displayed as the reels rotate, the variable display of the symbols stops as the rotation of the reels stops, and the symbols stop in the display window.

<Symbol Display>

Thereafter, the gaming machine performs a control (reel control) of starting the rotation of each reel and stopping the rotation of each reel so that the determined symbols are displayed in the display window.

<Winning Determination>

Subsequently, as the rotation of each reel is stopped, the gaming machine determines whether each combination of the symbols displayed in the display window is a combination related to winning. Feature game will be described later.

<Awarding Payout>

When any of the combinations of the symbols displayed for the player matches the combination related to winning, the gaming machine offers, to the player, a payout (benefit) according to the combination. For example, when a certain winning combination of the symbols is displayed, the gaming machine awards a payout associated with the combination to the player.

Further, the gaming machine offers a progressive payout to the player when a predetermined condition is satisfied (details thereof will be described later).

When a combination of the symbols related to a free game trigger is displayed, the gaming machine may start a free game.

In addition to the above, the gaming machine may have other benefits such as a mystery bonus and insurance. If the mystery bonus is awarded as a result of a winning in a random determination for the mystery bonus, a predetermined number of coins are paid out. When the spin button is pressed, the gaming machine extracts a random number for the mystery bonus and randomly determines whether a mystery bonus trigger is established.

The insurance is a function for saving the player when the free game is not executed for a long period of time. In this embodiment, whether the insurance is activated or not is freely determined by an administrator of the gaming machine. When the insurance is activated, a predetermined insurance activation amount must be paid. When the insurance is activated, the gaming machine starts to count the number of plays of the game. When the counted number of plays reaches a predetermined number without a large amount of payout due to the free game or the like, the gaming machine pays out coins, the amount of which has been set for the insurance.

<Determination of Effect>

The gaming machine produces an effect by displaying video on a display, outputting light from a lamp, and outputting sound from a speaker. The gaming machine extracts an effect-use random number and determines the contents of an effect based on randomly determined symbols or the like.

(Overall Structure of Slot Machine)

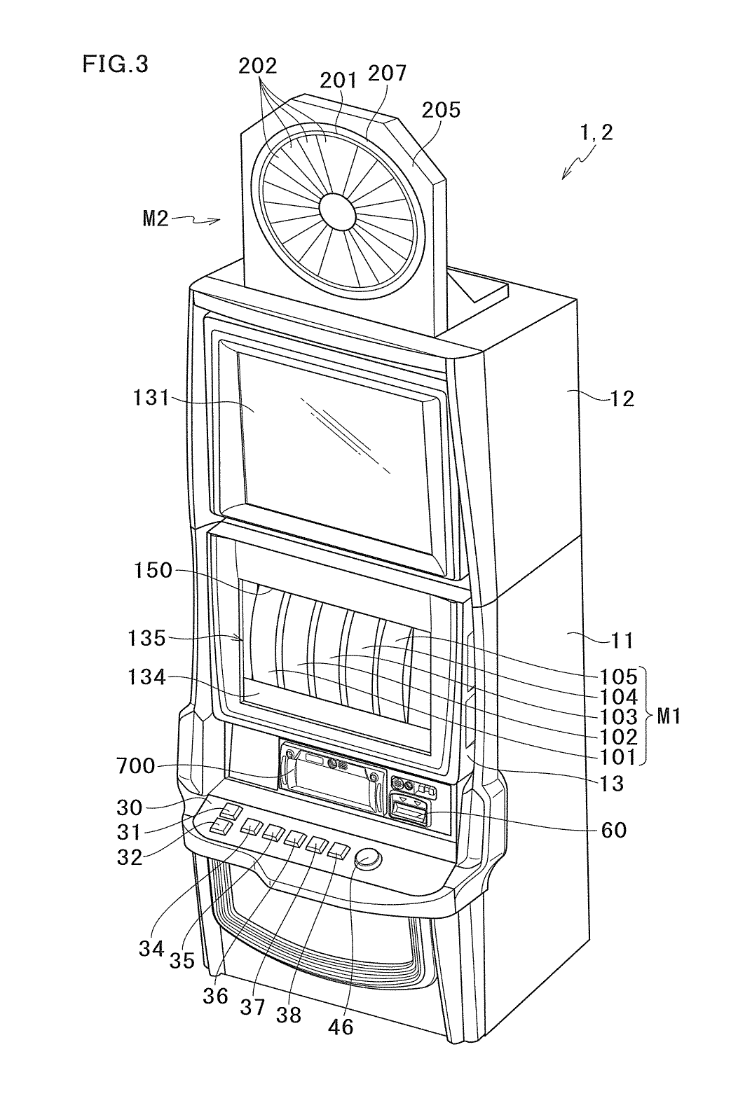

Now, referring to FIG. 3, the overall structure of the gaming machine 1 will be described. FIG. 3 shows the overall structure of the gaming machine 1.

In the gaming machine 1, gaming values are used. A gaming value is electronic valuable information such as electronic money. It is to be noted that the gaming value may be game media such as a coin, a medal, a bill, a token, and a ticket. The ticket may be, for example, a ticket with a barcode in which data such as a credit amount is encoded. Alternatively, the gaming value may be a game point not including valuable information.

The gaming machine 1 includes a cabinet 11, a top box 12 provided above the cabinet 11, and a main door 13 provided on the front face of the cabinet 11.

The main door 13 is provided with a reel device M1 including five reels 101, 102, 103, 104, and 105 (reels 101 to 105). The reel device M1 is configured to rotate the reels 101 to 105 to rearrange symbols 501 on the display window 150. The reels 101 to 105 are specifically, the first reel 101, the second reel 102, the third reel 103, the fourth reel 104, and the fifth reel 105 from the left end when the gaming machine 1 is viewed from the front of the gaming machine 1. In the following description, the left side when the gaming machine 1 is viewed from the front of the gaming machine 1 is simply referred to as the left side, and the right side when viewed in this way is simply referred to as the right side.

On the outer circumferential surface of each of the reels 101 to 105, 22 symbols are depicted. These 22 symbols 501 are arranged along the rotational direction of the reels 101 to 105 to form a symbol column (strip arrangement) (details thereof will be described later).

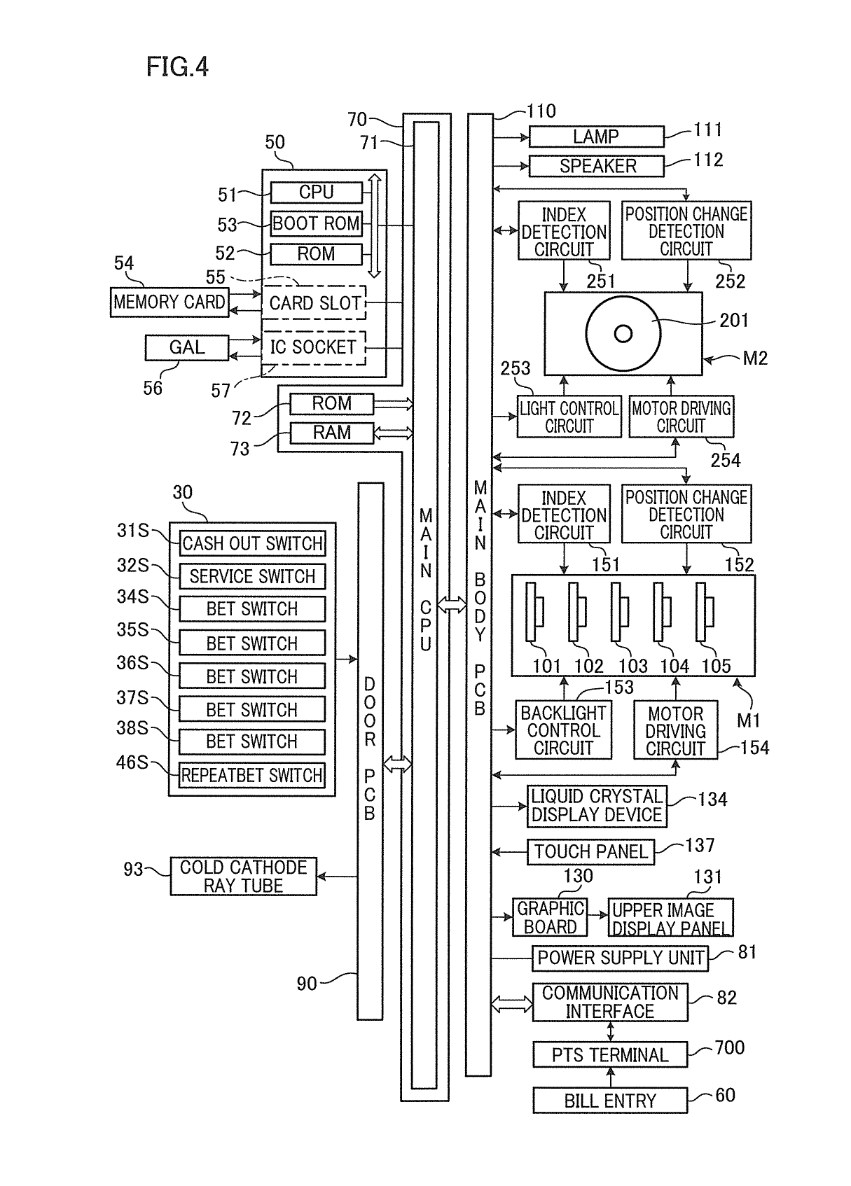

A reel cover 135 is provided in front of the reel device M1. On the front surface of the reel cover 135, a liquid crystal display device 134 by which a game status is reported to the player and a transparent panel are provided. This liquid crystal display device 134 is provided with a touch panel 137 (see FIG. 4). The reel cover 135 has the display window 150 at its central portion. The display window 150 has three areas: an upper stage, a middle stage, and a lower stage. In each of the three areas, corresponding one of the symbols 501 of each of the reels 101 to 105 is displayed. To put it differently, 15 symbols 501 forming a 5 by 3 matrix are visibly displayed in the display window 150. In a modification, the number of the symbols 501 displayed in the display window 150 may be different from 15. For example, the number of the columns of the symbols 501 displayed in the display window 150 may be 3 or 4 (the number of the reels may be 3 or 4). For example, the number of rows of the symbols 501 displayed in the display window 150 may be 4. In this case, the display window 150 may be provided with four areas: an upper stage, an upper middle stage, a lower middle stage, and a lower stage.

A backlight device (not illustrated) is provided on the inner circumferential side of each of the reels 101 to 105 (radially inside from the outer circumferential surface of each of the reels 101 to 105). The backlight devices are arranged so that illuminating light is emitted from the inner circumferential side of the reels 101 to 105 toward the outer circumferential surface side of the reels 101 to 105, and the illumination light passing through the outer circumferential surfaces of the reels 101 to 105 is viewable from the outside of the display window 150. The backlight device is configured to be able to change the amount of illumination light in multiple levels. The degree of freedom in the effects using illumination light is therefore high. Furthermore, each backlight device is able to emit light in multiple colors, and to illuminate the symbols individually with the illumination light.

In the present embodiment, the gaming machine 1 includes the reel device M1 with mechanical reels. In a modification, the gaming machine 1 may adopt video reels that display simulated reels, or adopt a combination of the video reels and the mechanical reels.

An upper image display panel 131 (2nd screen) is provided on the front surface of the top box 12. The upper image display panel 131 is a liquid crystal panel and structures a display. The upper image display panel 131 displays images related to effects and images showing introduction of game contents and explanation of game rules (details thereof will be described later).

The liquid crystal display device 134 displays, for example, touch buttons by which an input from the player is received, and a meter indicating the status of a game (details thereof will be described later).

Below the reel device M1, there are provided: a control panel 30 on which buttons are provided; a PTS device 700; and a bill entry 60.

The bill entry 60 validates bills and receives genuine bills into the cabinet 11. The bill entry 60 is electrically connected with the PTS device 700. When receiving a genuine bill, the bill entry 60 transmits an input signal corresponding to the amount of the bill to the PTS device 700. The input signal includes information on credit data or the like related to the received bill.

The PTS device 700 is a unit in which an LCD (liquid crystal display), a human body detection camera, a microphone, and the like are integrated. The human body detection camera makes it possible to detect the presence of a player by the camera function. The microphone is used for the player's participation in a game by voice and the authentication of a player by voice recognition. Further, the PTS device 700 has a card insertion slot to which an IC card can be inserted. This allows the player to insert an IC card into the card insertion slot and use credits stored in the IC card in the gaming machine 1.

(Control Panel 30)

In a left area of the control panel 30, a cash out button 31 and a service button 32 are provided. In a central area of the control panel 30, five bet buttons 34, 35, 36, 37, and 38 (bet buttons 34 to 38) are provided. In a right area of the control panel 30, a “repeat bet button 46” is provided.

The service button 32 is a button for calling an attendant. The cash out button 31 is an operation button to be used for cashing out credits stored in the gaming machine 1.

When any one of the bet buttons (the bet buttons 34 to 38 and the repeat bet button 46) is operated (is pressed down), the bet amount to be bet in a game is determined, and rotation (spin, scrolling) of the reels 101 to 105 is started. The repeat bet button 46 is used to start a play of the game with the bet amount the same as that in the last play of the game. The repeat bet button 46 is also used to start the rotation (spin) of the wheel 201 (will be described later).

A wheel device M2 is provided at a position higher than (on a top surface of) the top box 12. The wheel device M2 is configured to rotate the wheel 201, and then stops the wheel 201 so that a slot 202 selected in a wheel random determination (will be described later) is stopped at a predetermined position. The wheel device M2 includes: the wheel 201; a frame 205 supporting the wheel 201; and a lighting device 207 provided around the wheel 201.

The frame 205 is fixed onto the top surface of the top box 12. The lighting device 207 is located radially outside the outer circumference of the wheel 201. The lighting device 207 is arranged along the outer circumference of the wheel 201, and is constituted by, for example, a plurality of LEDs (light emitting diodes) which are not illustrated.

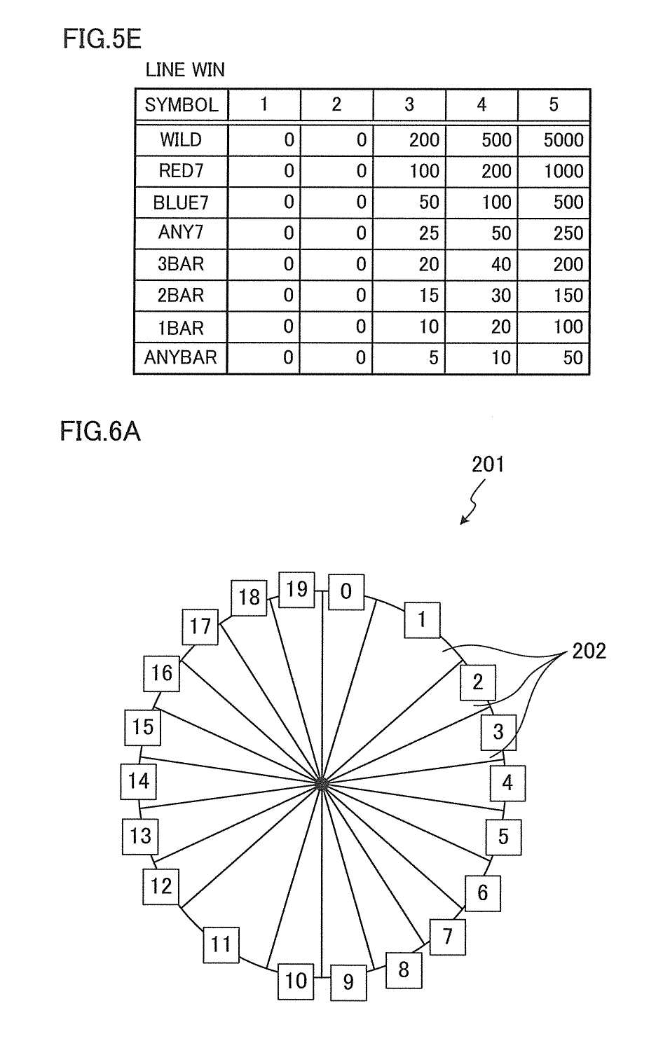

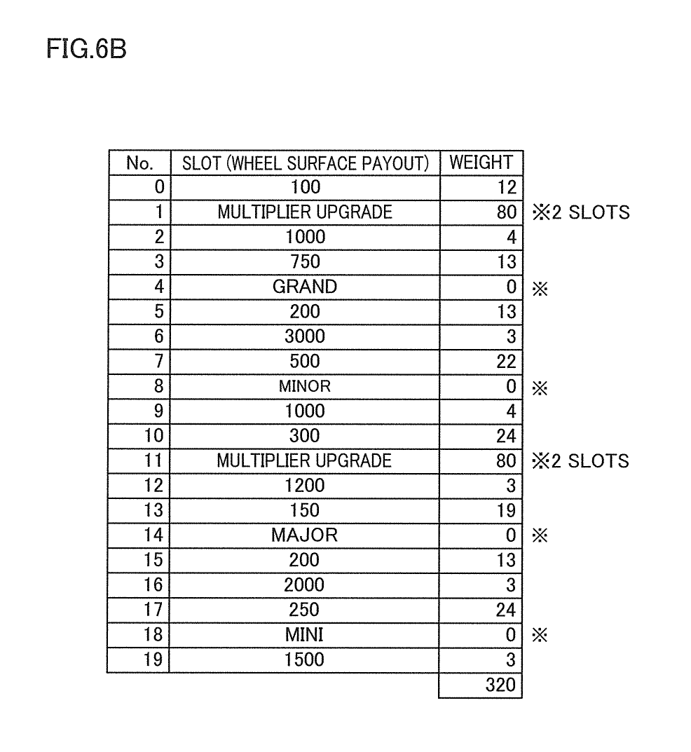

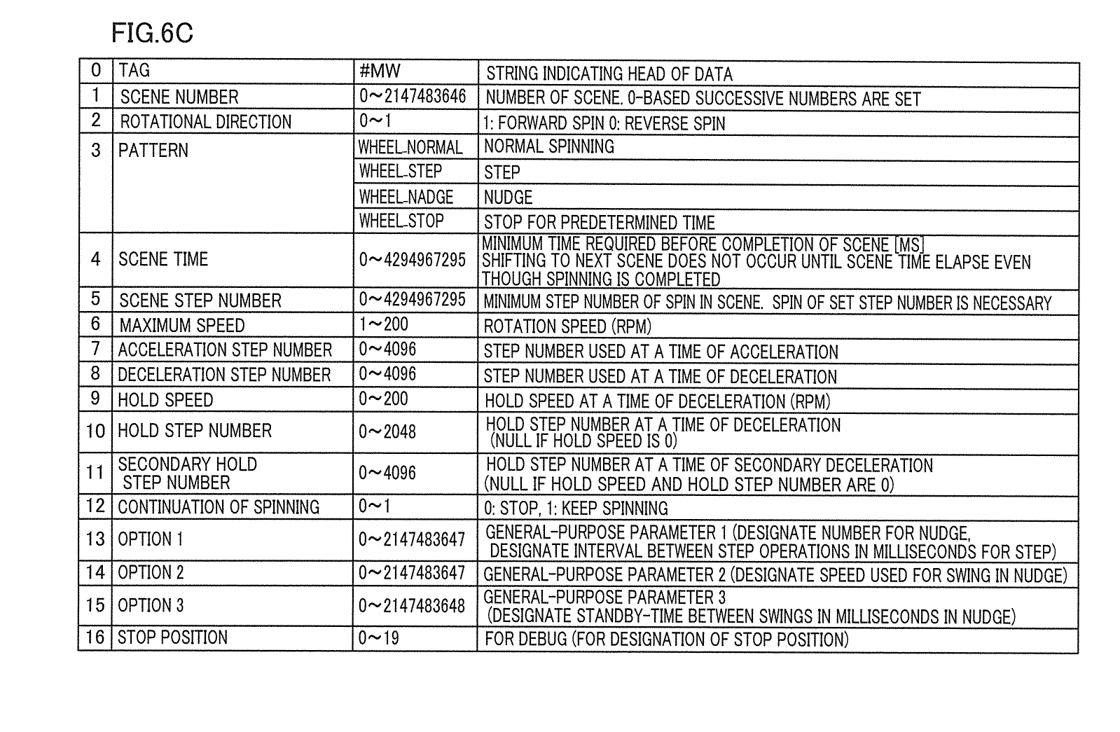

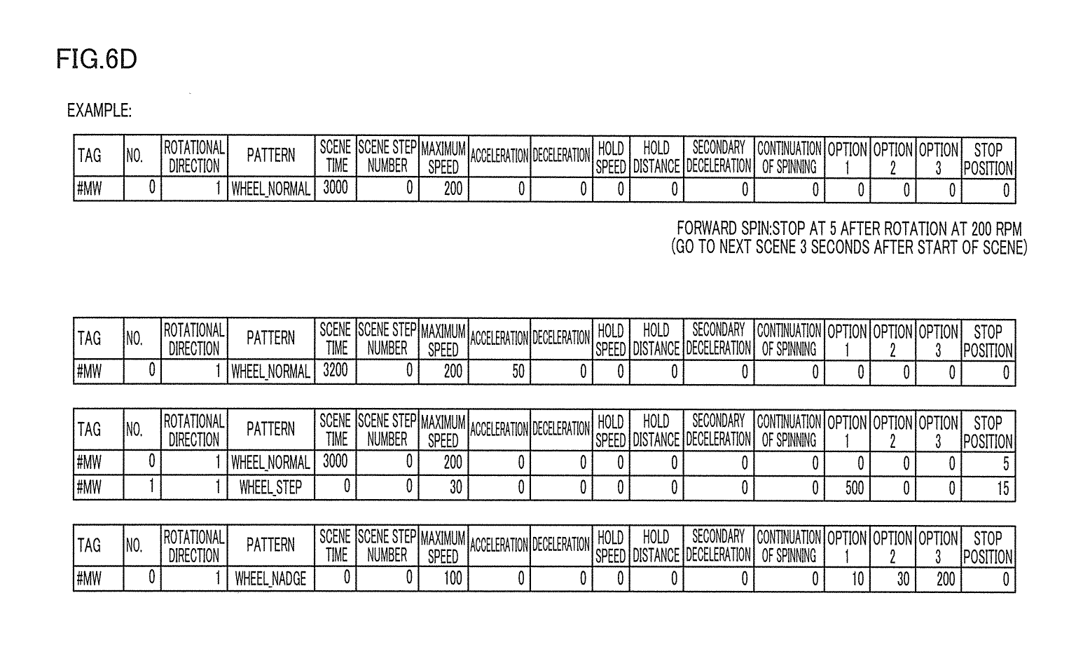

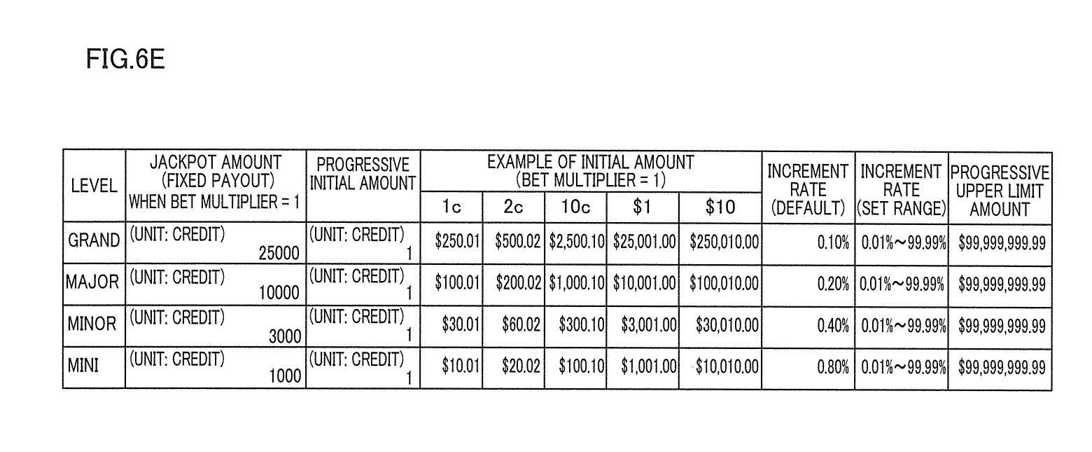

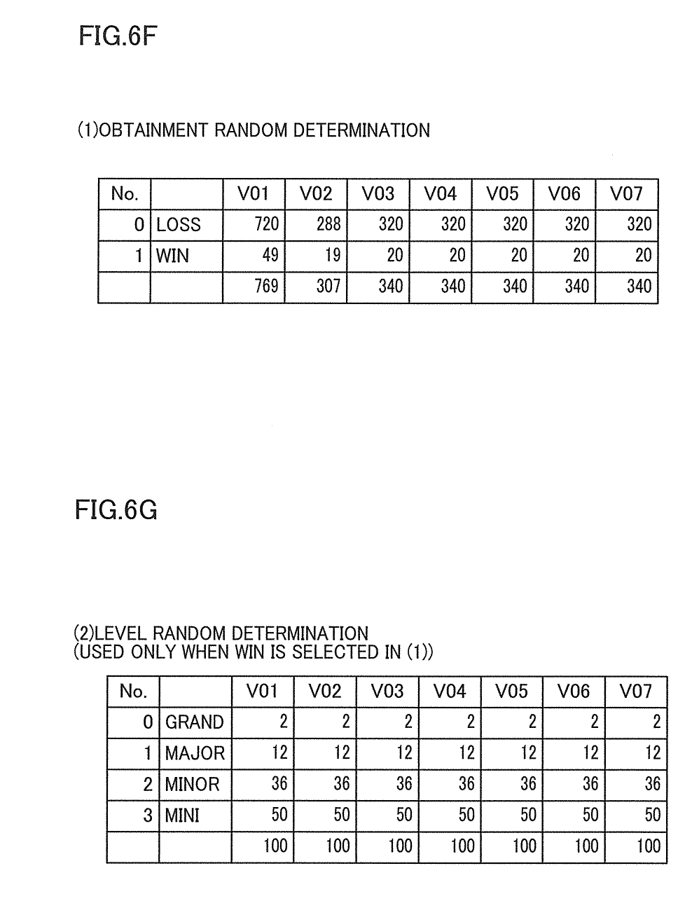

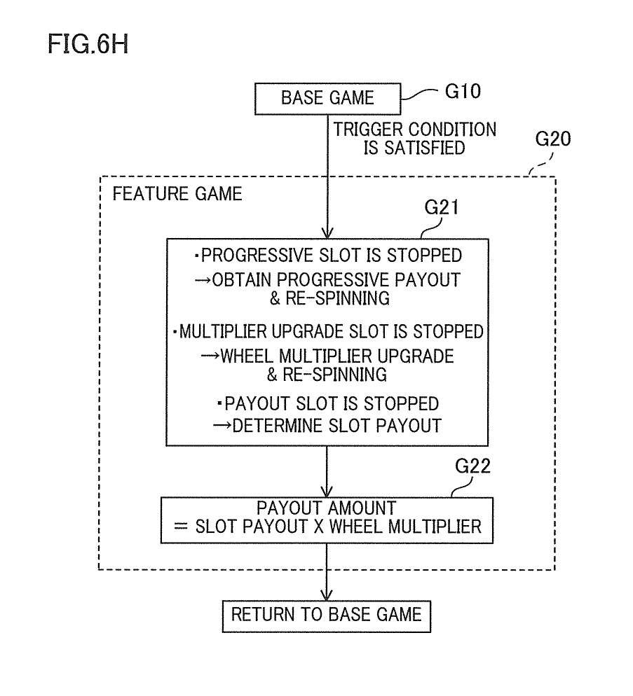

The wheel 201 is a mechanical wheel. To be more specific, the wheel 201 is a disc-like member, and is rotatable about a rotation axis fixed to the frame 205. The wheel 201 is rotated by a motor (not illustrated). There are a plurality of slots 202 on a surface of the wheel 201. The slots 202 structure a slot arrangement (wheel surface arrangement) (details thereof will be described later). In FIG. 3, only some of the slots 202 are given reference numerals. The same shall apply to FIG. 6A and the like.

In the present embodiment, the gaming machine 1 includes the wheel device M2 with the mechanical wheel. However, in a modification, the gaming machine 1 may include a video wheel displaying a simulated wheel.

The gaming machine 1 has plural types of game settings to correspond to rules (regulations) which are different between countries and/or regions, and AUDIT is arranged so that one of these settings is selectable. To be more specific, there are five major game settings which are SC (Setting Combination) 1 to SC5. In each of SC1 to SC5, there are seven minor settings V01 to V07. To put it differently, there are 35 types of game settings in the present embodiment, and the AUDIT is arranged so that one of these 35 types is selectable.

(Circuit Configuration in Gaming Machine)

The following describes a circuit configuration of the gaming machine 1, with reference to FIG. 4. FIG. 4 is a block diagram illustrating the internal structure of the gaming machine 1.

A gaming board 50 is provided with: a CPU (central processing unit) 51, a ROM (read only memory) 52, and a boot ROM 53, which are mutually connected by an internal bus. The gaming board 50 is further provided with: a card slot 55 corresponding to a memory card 54; and an IC (integrated circuit) socket 57 corresponding to a GAL (generic array logic) 56.

The memory card 54 includes a nonvolatile memory, and stores a game program. The game program includes a program related to game progression and an effect program for producing effects by images and sounds.

The card slot 55 is configured so that the memory card 54 can be inserted thereinto and removed therefrom, and is connected to a motherboard 70 by an IDE (integrated development environment) bus. The type and contents of the game to be played on the gaming machine 1 can be changed by removing the memory card 54 from the card slot 55, writing another game program into the memory card 54, and inserting the memory card 54 into the card slot 55. Further, the type and contents of the game to be played on the gaming machine 1 can be changed by rewriting the program written into the memory card 54 as another program.

The GAL 56 is a type of PLD (programmable logic device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI (peripheral component interconnect) bus.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a preliminary authentication program, a program (boot code) to be used by the CPU 51 for activating the pre-authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU (central processing unit) 71, a ROM 72, a RAM (random access memory) 73, and a communication interface 82. The ROM 72 and the RAM 73 correspond to a storage device 210 (see FIG. 1).

The ROM 72 includes a memory device such as a flash memory, and stores a program such as BIOS (basic input/output system) to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The controller 220 (see FIG. 1) in the present invention includes the main CPU 71, the ROM 72, the RAM 73, and the memory card 54 storing the game program. The controller 220 is configured to control the gaming machine 1 by causing the main CPU 71 to execute the game program. The controller 220 does not have to be configured as above. For example, the controller 220 may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations in execution of these programs. For example, the RAM73 includes an area that stores the number of plays, a bet amount, an awarded credit amount, a payout value, and the like. The RAM 73 further includes an area that stores symbols (code numbers) randomly determined and a slot (code number) randomly determined. The RAM 73 stores various data tables (which will be described later and may be simply referred to as tables). The RAM 73 further stores a scenario used to control the operation of the wheel 201.

The communication interface 82 is for communicating with the PTS device 700 or a not-shown external controller. The PTS device 700, upon reception of an input signal from the bill entry 60 (BILL ENTRY), transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

The motherboard 70 is connected with a later-described door PCB (printed circuit board) 90 and a main body PCB 110 by respective USBs (universal serial bus). The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a cash out switch 31S, a service switch 32S, bet switches 34S, 35S, 36S, 37S, and 38S, and a repeat bet switch 46S, correspondingly to the above-mentioned buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The main body PCB 110 is connected with a lamp 111, a speaker 112, a graphic board 130, the liquid crystal display device 134, and the touch panel 137. Further, the main body PCB 110 is connected to an index detection circuit 151, a position change detection circuit 152 (reel position change detection circuit), a backlight control circuit 153, and a motor driving circuit 154 (reel motor driving circuit). The index detection circuit 151, the position change detection circuit 152, the backlight control circuit 153, and the motor driving circuit 154 are connected to the reel device M1.

The lamp 111 turns on based on a control signal outputted from the main CPU 71. The speaker 112 outputs sounds such as BGM (back ground music), based on a control signal outputted from the main CPU 71.

The graphic board 130 controls image display executed by the upper image display panel 131 based on a control signal outputted from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 136 displays an image based on a control signal output from the main CPU 71. The touch panel 137 detects a position on the liquid crystal display device 136 touched by a finger or the like of the player, and outputs a signal corresponding to the detected position to the main CPU 71.

The index detection circuit 151 detects the positions of the rotating reels 101 to 105 and is able to detect the step out of the reels 101 to 105.

The position change detection circuit 152 detects a change in the stop positions of the reels 101 to 105 after the rotation of the reels 101 to 105 is stopped. For example, the position change detection circuit 152 detects whether the stop positions of the reels 101 to 105 have been changed to achieve a winning combination of symbols 501 by an external action such as cheating, though the actual stop positions do not achieve the winning combination of symbols 501. The position change detection circuit 152 is configured to be able to detect a change in the stop positions of the reels 101 to 105 by, for example, detecting unillustrated fins attached at predetermined intervals to an inner part of each of the reels 101 to 105 (i.e., a part located radially inside relative to the outer circumferential surface of each reel).

The backlight control circuit 153 is connected to the backlight devices to individually supply driving power thereto. Upon receiving an instruction from the main CPU 71, the backlight control circuit 153 changes the amount of light emitted in multiple levels. The five backlight devices provided on the inner circumferential surfaces of the reels 101 to 105 are able to individually illuminate 15 symbols 501 having stopped on the display window 150 (see FIG. 3) by means of the backlight control circuit 153.

The motor driving circuit 154 is connected to a stepping motor configured to rotate the reels 101 to 105. Further, the motor driving circuit 154 includes an FPGA (field programmable gate array) and a driver. The FPGA is an electronic circuit such as a programmable LSI (large scale integration), and functions as a control circuit of the stepping motor. The driver functions as an amplifying circuit for pulses to be input to the stepping motor.

The method of magnetic excitation of the stepping motor is not particularly limited; 1-2 phase excitation or 2 phase excitation may be employed. Further, a DC motor may be adopted in place of the stepping motor. In cases of adopting a DC motor, the main body PCB 110 is connected to a deviation counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the deviation counter.

The main body PCB 110 is connected to an index detection circuit 251, a position change detection circuit 252 (wheel position change detection circuit), a light control circuit 253, and a motor driving circuit 254 (wheel motor driving circuit). The index detection circuit 251, the position change detection circuit 252, the light control circuit 253, and the motor driving circuit 254 are connected to the wheel device M2.

The index detection circuit 251 is configured to detect the position of the rotating wheel 201, and is further capable of detecting stepping out of the wheel 201.

The position change detection circuit 252 is configured to detect a change in the stop position of the wheel 201 after the rotation of the wheel 201 is stopped. For example, the position change detection circuit 252 detects whether the stop position of the wheel 201 has been changed by an external action such as cheating so that a slot 202 related to winning is selected, though the slot 202 related to winning is not practically selected through random determination.

The light control circuit 253 is connected to lights constituting the lighting device 207 to individually supply driving power to the lights. Upon receiving an instruction from the main CPU 71, the light control circuit 253 changes the amount of light emitted in multiple levels.

The motor driving circuit 254 is connected to a stepping motor configured to rotate the wheel 201. Further, the motor driving circuit 254 includes an FPGA and a driver. The FPGA and the driver are similar to those included in the motor driving circuit 154. Similarly to the stepping motor for rotating the reels 101 to 105, the method of magnetic excitation of the stepping motor for rotating the wheel 201 is not particularly limited. A DC motor may be used in place of the stepper motor.

(Outline of Game)

FIG. 6H illustrates the outline of the flow of the game executed by the gaming machine 1. The game is implemented by hardware which is included in the gaming machine 1 and executes programs which will be described later. The game includes a base game (G10) (also referred to as a basic game) and a feature game (G20).

(Outline of Base Game)

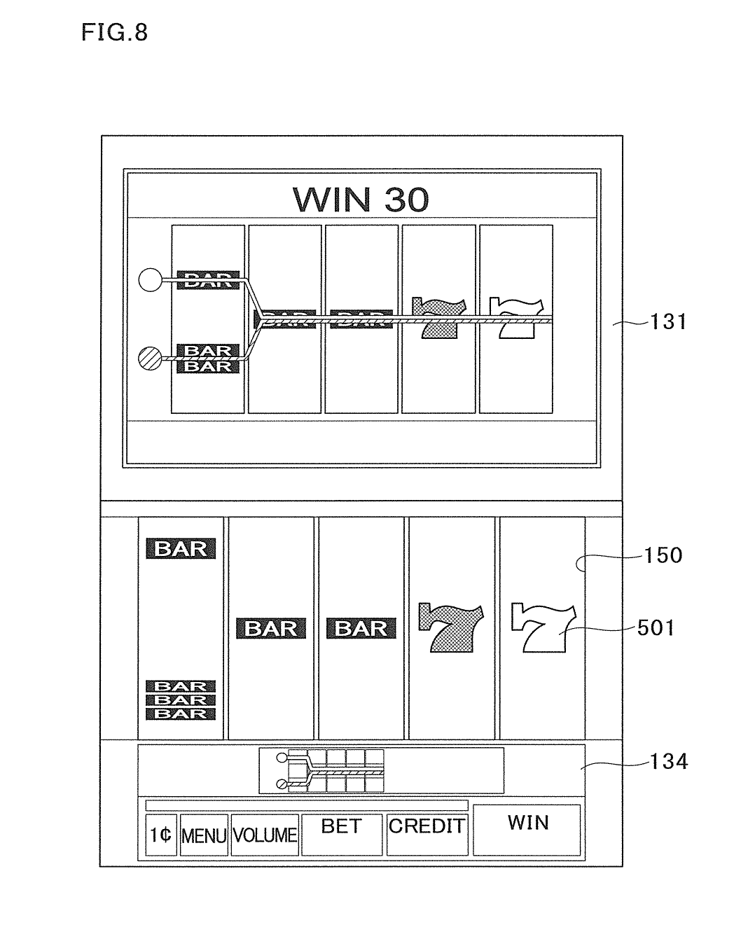

The base game is executed on the reel device M1 shown in FIG. 3. A game result of the base game is obtained based on a combination of the symbols 501 (see FIG. 8, the same shall apply hereinafter for the symbols 501) displayed in the display window 150 when the reels 101 to 105 are stopped.

<Bet Amount>

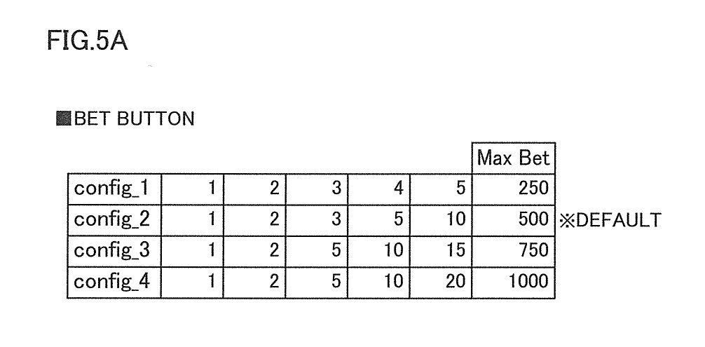

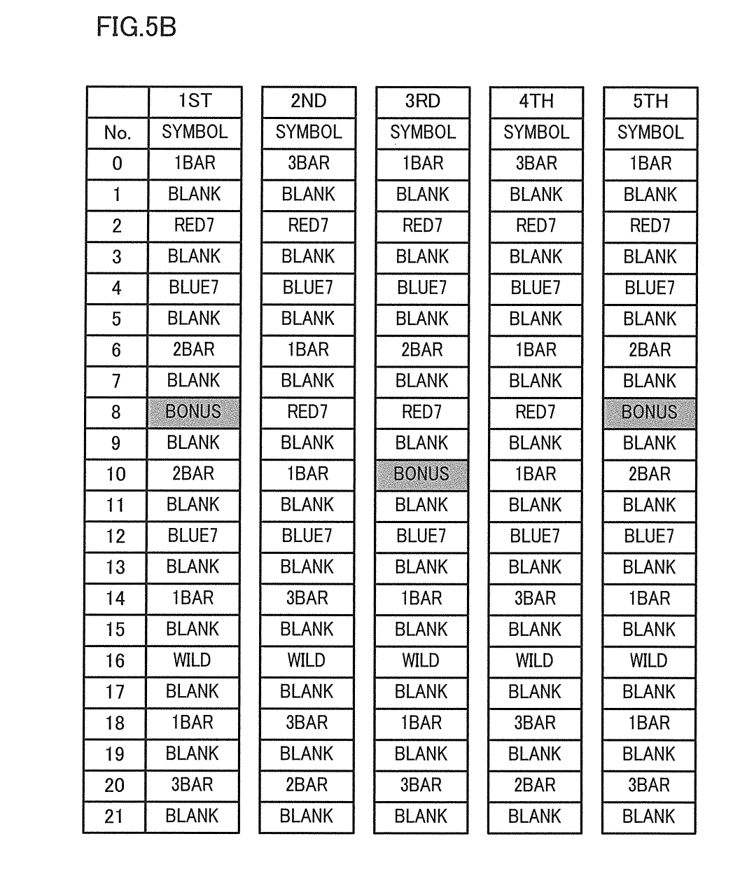

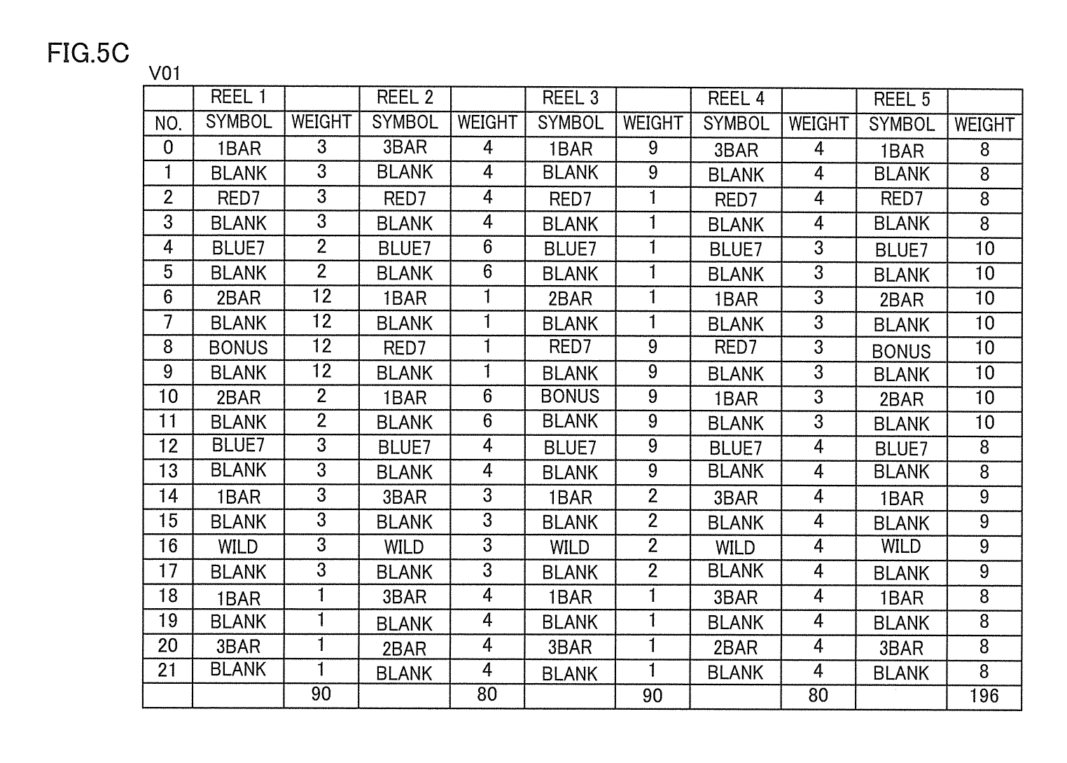

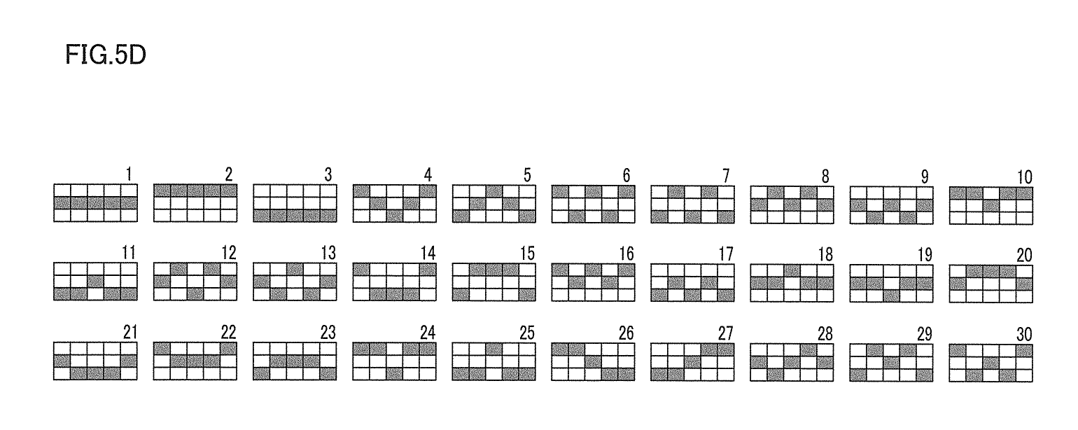

FIG. 5A illustrates the relationship (relative relationship) between the bet buttons 34 to 38 and bet amounts. For example, in Configuration 2 (config 2), relative bet amounts of 1, 2, 3, 5, and 10 are respectively assigned to the bet buttons 34, 35, 36, 37, and 38. In the present embodiment, the minimum bet amount is 50. Specifically, the bet amount in response to the operation of the bet button 34 for the minimum bet amount is 50. Thus, in Configuration 2, the bet amounts in response to the operations of the bet buttons 34, 35, 36, 37, and 38 are respectively 50, 100, 150, 250, and 500. In this configuration, the maximum bet amount (Max Bet) is 500. <Symbol Column>

FIG. 5B shows symbol columns. To each of the first reel 101 (1ST in FIG. 5B), the second reel 102 (2ND), the third reel 103 (3RD), the fourth reel 104 (4TH), the fifth reel 105 (5TH), a symbol column is assigned. Each symbol column is constituted by 22 symbols 501 corresponding to code numbers “0” to “21”. The types (designs) of the symbols 501 are “WILD”, “RED7”, “BLUE7”, “3BAR”, “2BAR”, “1BAR”, “BONUS”, and “BLANK”. The BONUS symbol corresponds to a specific symbol and a second specific symbol in the present invention. The BONUS symbol only exists in the first reel 101, the third reel 103, and the fifth reel 105. The symbol name of “BONUS” may be “WHEEL”. The BONUS symbol projects radially outward from an outer circumferential surface (cylindrical part) of each reel main body portion. The other types of symbols which are not the BONUS symbols are included in each of the reels 101 to 105. The first reel 101 and the fifth reel 105 have the same symbol arrangement. The second reel 102 and the fourth reel 104 have the same symbol arrangement. Note that the type of the symbols and the order in each symbol arrangement may be changed. The designations of the symbols 501 representing the types of the symbols 501 may be changed depending on the designs of the symbols 501, for example.

The symbols 501 to be displayed in the display window 150 are randomly determined based on a reel weight table shown in FIG. 5C. This will be described later.

<Winning Type>

There are two winning types in the base game: line wins achieved on paylines; and scattered wins achieved by scattered symbols. Note that achieving winning may be expressed as “a win is made” (or “a win occurs”).

The line win is achieved when the combination of symbols displayed on a payline (see FIG. 5D) matches any of combinations of symbols defined in a payout table (see FIG. 5E). FIG. 5D illustrates paylines. The paylines are used for winning determination of the symbols rearranged in the display window 150. Thirty paylines (30 lines) are set. In this game, all the 30 paylines are activated irrespective of the bet amount (i.e., the lines are fixed). In a modification, the paylines may be individually activated in response to the player's selection. In the present embodiment, total 15 symbols 501 (in a 3 by 5 matrix) are displayed in the display window 150, and therefore the paylines corresponding to this display manner are set. In a modification, 14 or less, or 16 or more symbols 501 may be displayed in the display window 150 (in a 3 by 3 matrix or in a 4 by 5 matrix, for example). In this case, paylines (not illustrated) corresponding to such a display manner are set.

Whether the line win is achieved is determined in accordance with “LEFT TO RIGHT”. In the determination in accordance with “LEFT TO RIGHT”, a payout is determined based on the types and number of symbols successively arranged on each payline, starting from the leftmost first reel 101 (see FIG. 3) to the rightmost fifth reel 105 (see FIG. 3). The relationship between the types and number of arranged symbols and payout amounts are defined in the payout table shown in FIG. 5E. For example, when three “RED7” are arranged, the payout amount is 100. Basically, the line win is achieved when a plurality of symbols of the same kind are arranged on the payline. However, the line win is achieved also when symbols of different kinds for which winning determination is made in a “Mixed” manner are arranged on the payline. Winning determination for “RED7” and “BLUE7” symbols is made in the “Mixed” manner. Winning determination for “1BAR”, “2BAR”, and “3BAR” symbols is made in the “Mixed” manner. Further, the WILD symbol can be used as a substitute for any type of the symbol, except the BONUS symbol.

The scattered win is achieved when the number of specified symbols rearranged in the display window 150 satisfies a predetermined condition, irrespective of the paylines. Hereinafter, “symbols are rearranged in the display window 150” may be expressed as “symbols are stopped” or “symbols appear”. To be more specific, the scattered win (winning which satisfies a later-described trigger condition) is achieved when 3 BONUS symbols are stopped. In the present embodiment, no payout is awarded for the scattered win.

(Outline of Feature Game)

As shown in FIG. 6H, when the trigger condition is satisfied during the base game (G10) (when “Feature In” occurs), the feature game (G20) is awarded. The trigger condition for the feature game is satisfied when 3 BONUS symbols (specific symbols) are stopped (displayed in the display window 150). The feature game is executed on the wheel device M2 shown in FIG. 3. A game result in the feature game is obtained in accordance with a slot 202 selected in the wheel random determination (will be described later) (G21 in FIG. 6H). Specifically, in the feature game, the wheel 201 is rotated and then stopped. The game result is obtained based on the type of the slot 202 located at a wheel predetermined position (e.g. an upper end portion of the wheel 201) when the wheel 201 is stopped. Note that “a slot 202 is selected in the wheel random determination” may be simply expressed as “a slot 202 is selected” or “a slot 202 is stopped”. In the wheel random determination, one of the slots 202 is selected through random determination on the basis of the tables respectively shown in FIG. 6B, FIG. 6F, and FIG. 6G (details thereof will be described later).

<Explanation of Terms of Feature Game>

The “feature game” has the same meaning as a “bonus game”. The feature game is a game the gaming state of which is more advantageous for the player than that of the base game. For example, in the feature game, a game that provides a player with a chance of winning more gaming values than the base game; a game that provides a player with a higher chance of winning gaming values than the base game; or a game that consumes fewer amounts of gaming values than the base game is provided alone or in combination.

<Slot Arrangement>

As shown in FIG. 6A, the wheel 201 has the plurality of slots 202. The slots 202 structure a slot arrangement. As shown in FIG. 6B, the slot arrangement is constituted by 20 slots 202 respectively corresponding to code numbers “0” to “19”. There are plural types of slots 202: payout slots (payout slots 202b in FIG. 1); progressive slots; and multiplier upgrade slots (repeat random determination slot) (multiplier upgrade slots 202a in FIG. 1). The number of the payout slots (CREDIT) is 14. The payout slots are of plural types: “100”, “150”, “200”, “250”, “300”, “500”, “750”, “1000”, “1500”, “2000”, and “3000”, for example. There are two slots of “200”. The numerical value indicating each of the types of the payout slots is equivalent to a value of a slot payout (will be described later). The number of the progressive slots is 4. The types of the progressive slots are: “GRAND”, “MINOR”, “MAJOR”, and “MINI”. There are in total two multiplier upgrade slots (MULTIPLIER UP) (“Multiplier Upgrade” in the figure) respectively associated with code numbers “1” and “11”. As shown in FIG. 6A, the width of each multiplier upgrade slot (the width of each multiplier upgrade slot in the radial direction of the wheel 201) is twice as large as the width of each of the other slots (equivalent to the width of the two payout slots). Note that the types of the slots, the order of the arrangement, and the widths of the slots may be changed.

<Payout Slot>

As shown in FIG. 6H, when any of the payout slots is selected in the wheel random determination, a slot payout the value of which corresponds to the selected payout slot is paid out, and the feature game ends.

<Multiplier Upgrade Slot>

When any of the multiplier upgrade slots is selected in the wheel random determination (when a multiplier upgrade slot is stopped), “wheel multiplier” (initial value: 1) is increased. Specifically, the “wheel multiplier” is incremented by 1. When the multiplier upgrade slot is stopped, the wheel random determination is performed again (repeat wheel random determination is performed). Specifically, the wheel 201 spin again (“re-spinning”). If the multiplier upgrade slot is selected again and again, each time the multiplier upgrade slot is selected, the wheel multiplier is increased from 1 to 2, 3, 4, 5, 6, 7, and so on. When any of the payout slots is selected after that, the amount obtained by multiplying the slot payout corresponding to the selected payout slot by the current wheel multiplier (G22 in FIG. 6H). Note that the wheel multiplier is a multiplying factor by which the slot payout is multiplied. The below-described progressive payout is not multiplied by the wheel multiplier.

<Progressive Slot>

When any of the progressive slots is selected in the wheel random determination, a progressive payout is paid out, and the repeat wheel random determination is performed. However, the wheel multiplier is not increased. The details of the progressive payout will be described later.

(Basic Structure of Screen Display)

Basic structure of screen display on each of the upper image display panel 131 and the liquid crystal display device 134 shown in FIG. 3 is as follows. Hereinafter, the screen display on the upper image display panel 131 and the screen display on the liquid crystal display device 134 each may be simply referred to as “screen display”.

The display on the upper image display panel 131 (see FIG. 3) is different depending on the game type. Specifically, the display for the base game is different from the display for the feature game.

<2nd Screen for Normal Situation>

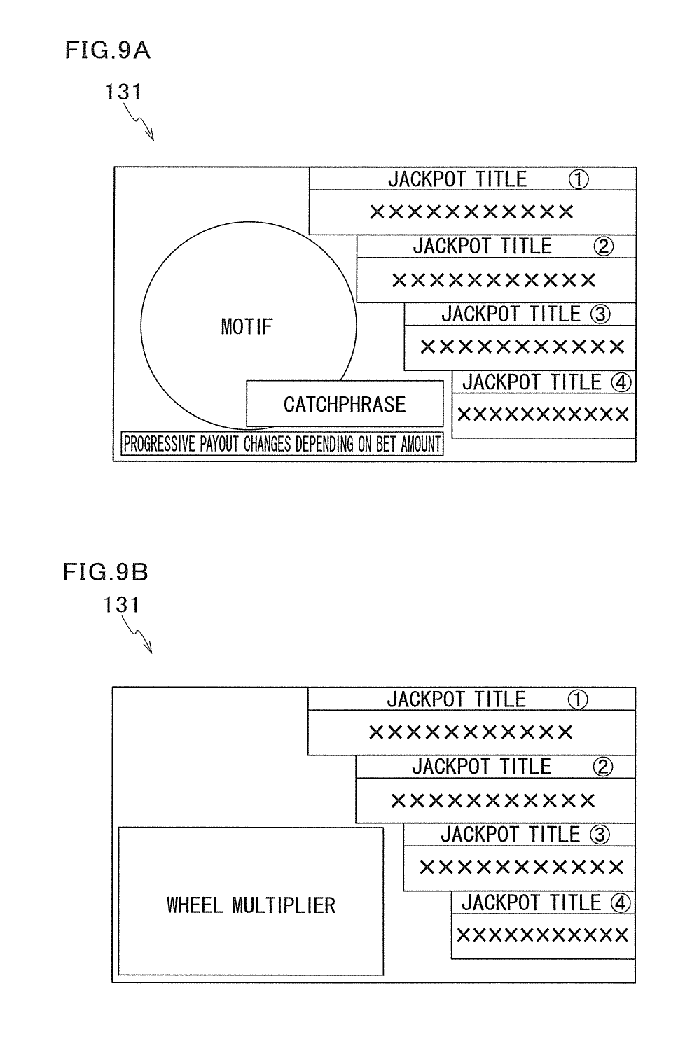

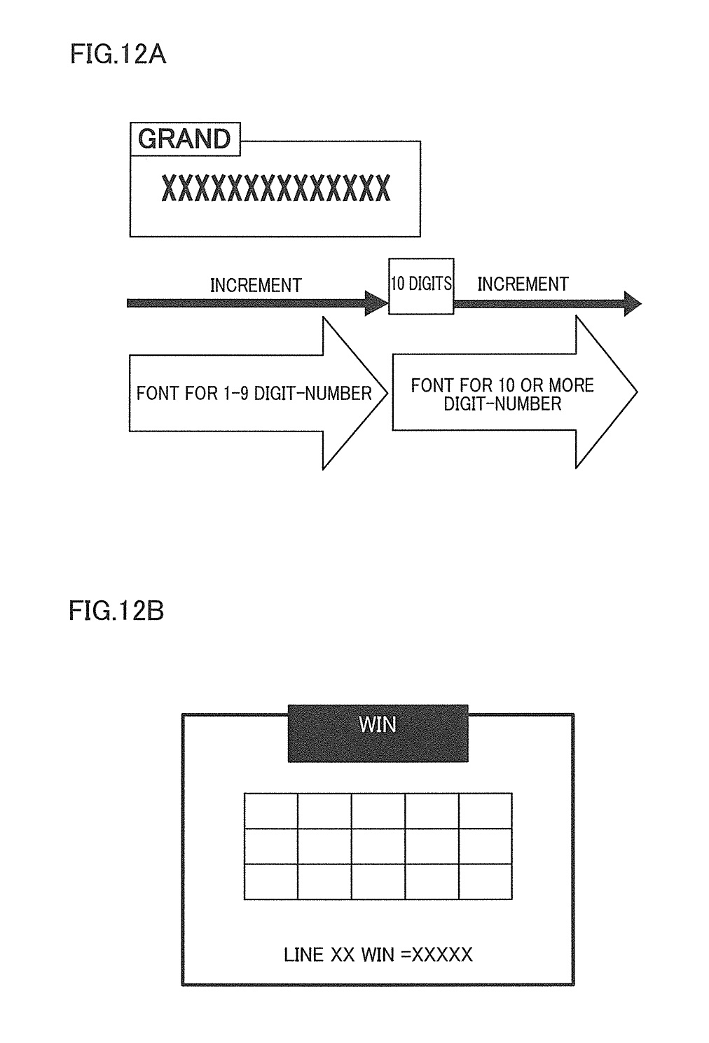

FIG. 9A shows the display on the upper image display panel 131 while the base game is executed (during the base game). During the base game, the upper image display panel 131 displays, in a right area of the screen, titles (jackpot titles in the figure) and payout amounts of the four types of the progressive payout. The displayed titles are “GRAND JACKPOT”, “MAJOR JACKPOT”, “MINOR JACKPOT”, and “MINI JACKPOT”, in this order from the top. As for each payout amount, maximum 11-digit numerical value is displayed with a 3-letter currency code. As shown in FIG. 12A, the font for 10 or more-digit numerical values representing the payout amount is different from the font for 1 to 9-digit numerical values representing the payout amount. At this time, the upper image display panel 131 displays, in a left area of the screen, a motif (e.g., an image), as shown in FIG. 9A. Further, the upper image display panel 131 displays, in a lower area of the screen, a catchphrase (for example, “Multiplier keeps on increasing!”). In addition, the upper image display panel 131 displays, in the lower area of the screen (below the catchphrase), a text indicating that the progressive payout differs depending on the bet amount. For example, “ACTIVE DISPLAY based on bet multiplier.” is displayed. The positions of the constituents of the display screen on the upper image display panel 131 may be changed (the same shall apply to the liquid crystal display device 134).

<2nd Screen for Feature>

FIG. 9B shows the display on the upper image display panel 131 while the feature game is executed (during the feature game). During the feature game, the upper image display panel 131 displays, in the same manner as in the base game, the titles and payout amounts of the 4 types of the progressive payout. During the feature game, the upper image display panel 131 displays, in a lower left area on the screen, a wheel multiplier (WHEEL MULTIPLIER).

<Display on 3rd Screen>

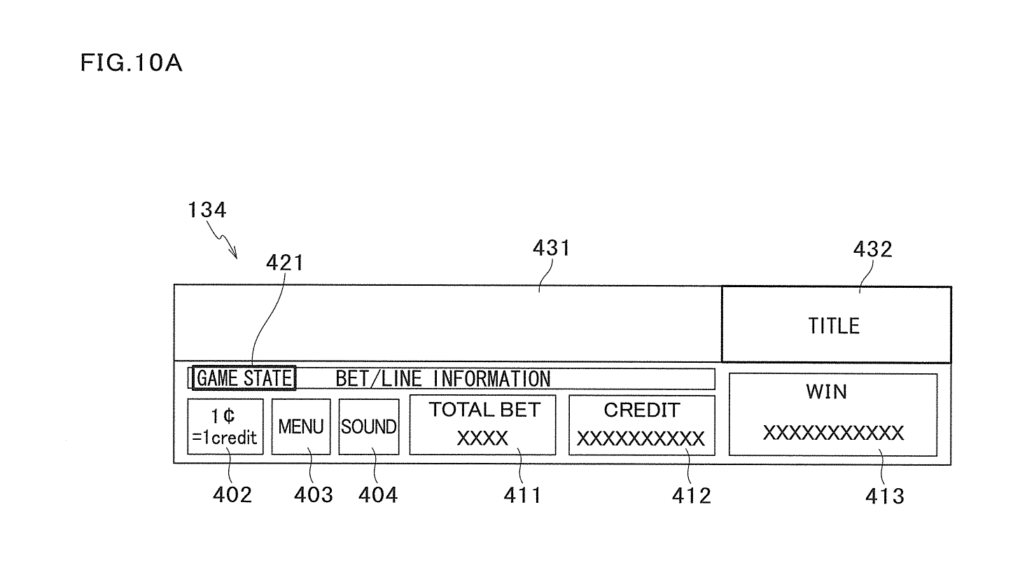

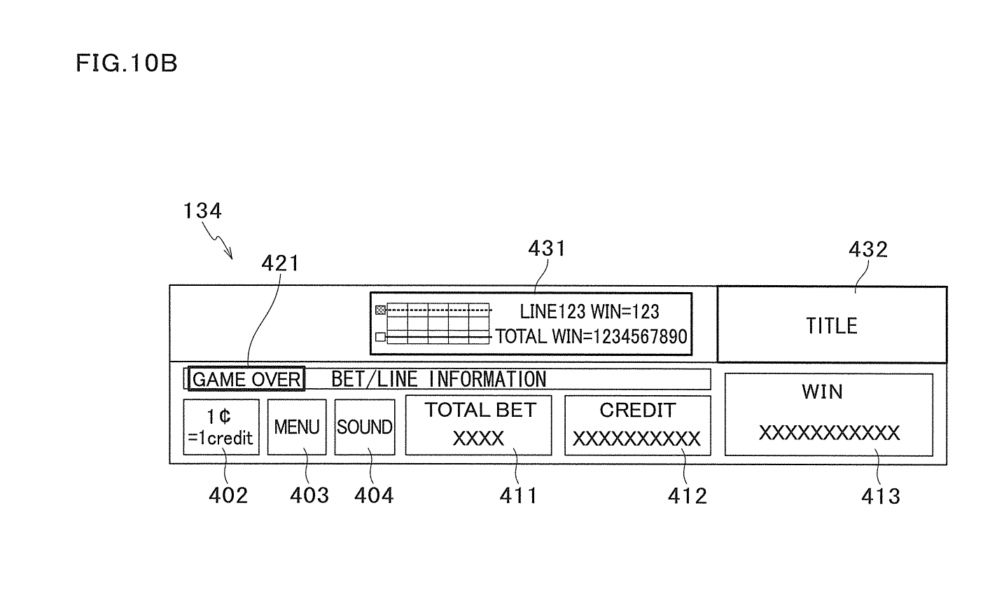

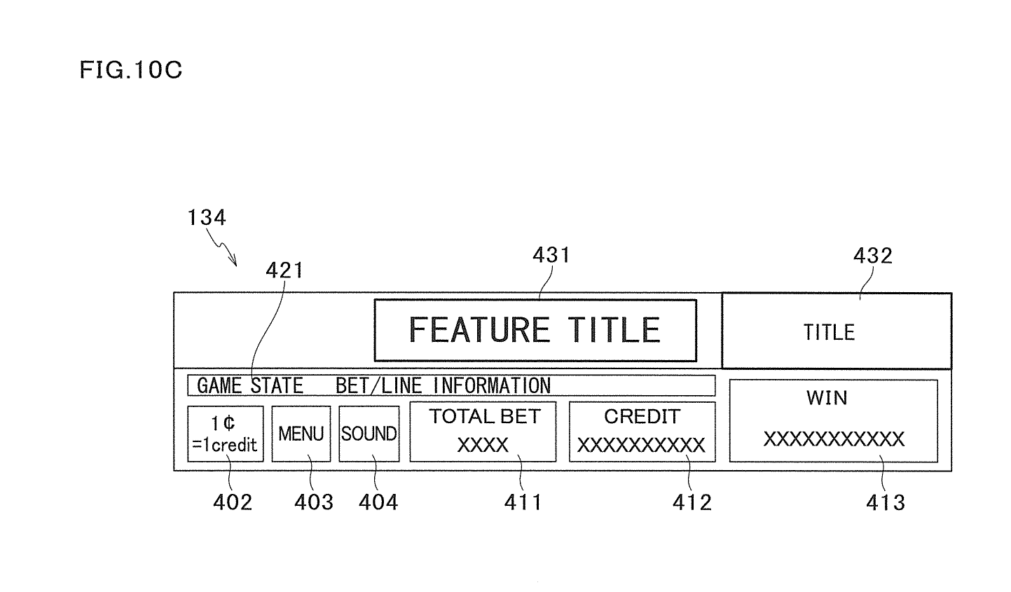

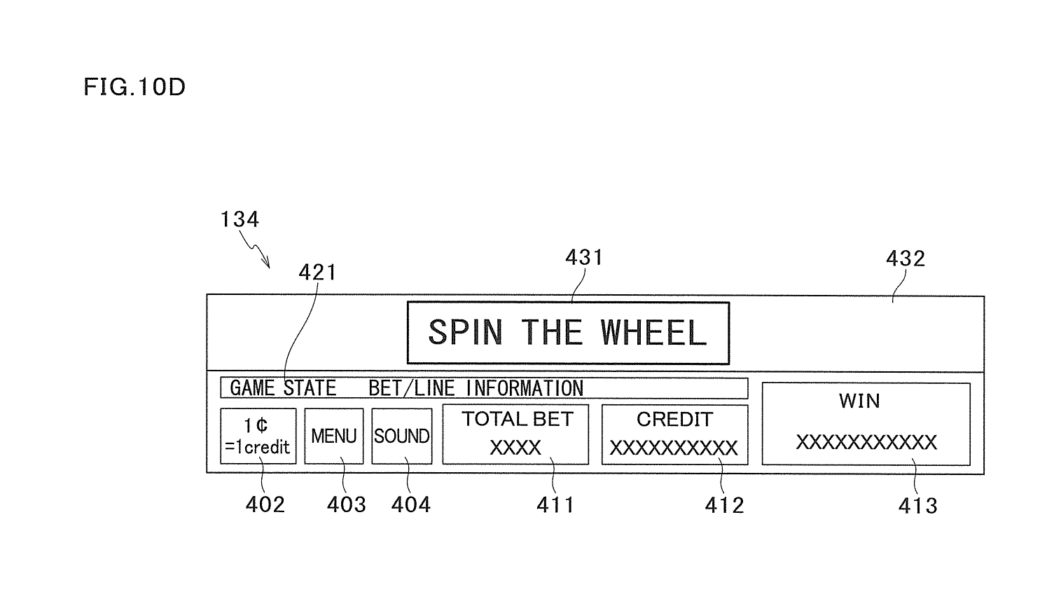

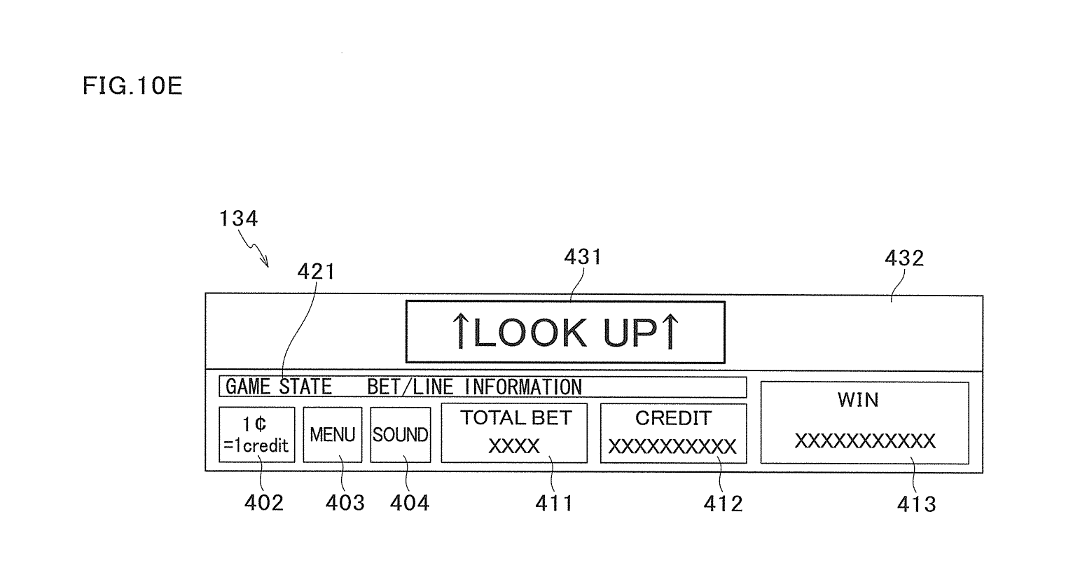

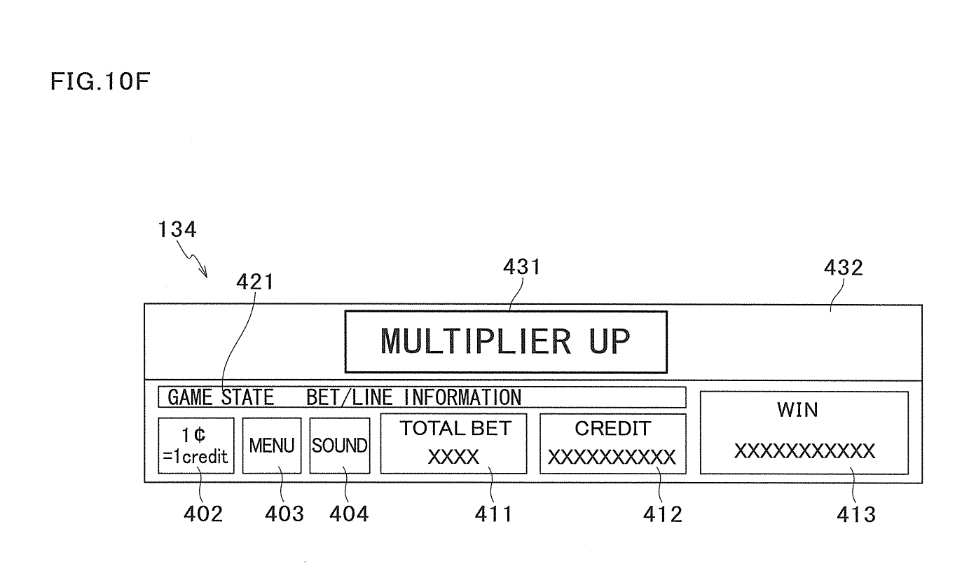

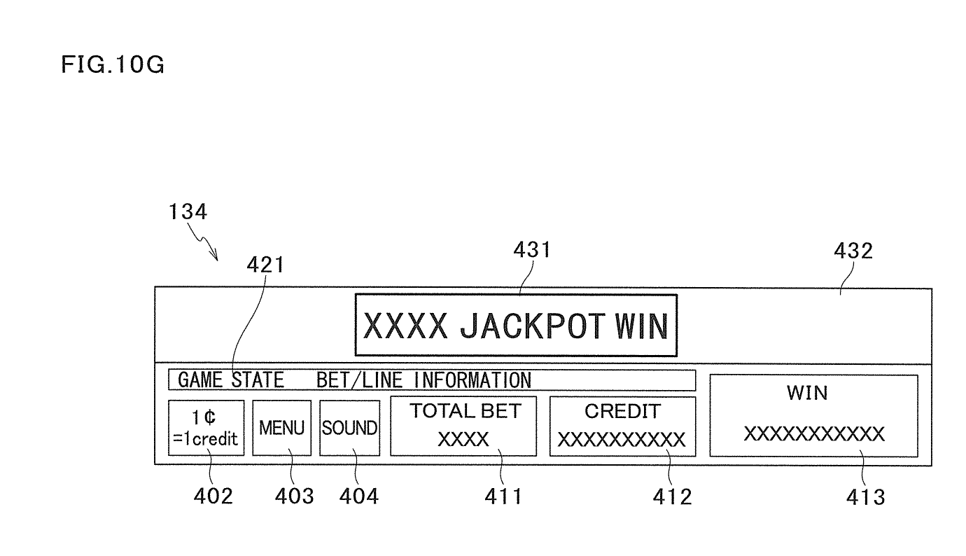

FIG. 10A shows the display on the liquid crystal display device 134 and the like. In a lower left area of the liquid crystal display device 134, there are displayed: a denomination button 402; a menu button 403; and a sound volume switch button 404, in this order from the left to right. In a lower middle area of the liquid crystal display device 134, there are displayed a bet meter 411 and a credit meter 412, in this order from left to right. In a lower right area of the liquid crystal display device 134, a win meter 413 is displayed. In a middle left area of the liquid crystal display device 134, a game state indicator 421 is displayed. In an upper middle area of the liquid crystal display device 134, there is an upper middle display region 431. In an upper right area of the liquid crystal display device 134, there is an upper right display region 432.

The denomination button 402 displays the current denomination set in the AUDIT. A menu screen is displayed when the menu button 403 is touched. The sound volume switch button 404 switches the game sound volume in, for example three stages. Each time the button is touched, the game sound volume is switched from small to middle to large to small to middle, and so on.

The bet meter 411 displays a bet amount. The bet amount is re-calculated in each play of the game. The credit meter 412 indicates the total credit amount at the time. The total credit amount is initially zero, and increases or decreases in accordance with an input of a gaming value, betting, and a game result. The win meter 413 indicates the total credit amount of the prizes won.

The game state indicator 421 indicates the current status of the game. For example, as shown in FIG. 10B, “GAME OVER” is displayed. For example, “GOOD LUCK” is displayed immediately after the start of spinning.

The upper middle display region 431 displays, a variety of contents depending on the gaming status. For example, there is displayed a line win signboard shown in FIG. 10B, the text of “LOOK UP” as shown in FIG. 10E, or the like (details thereof will be described later). Further, as shown in FIG. 10E, in some gaming status, the upper middle display region 431 displays nothing.

The upper right display region 432 displays a variety of contents depending on the gaming status. For example, as shown in FIG. 10A, a title (such as the title of the game) is displayed. Further, as shown in FIG. 10D, in some gaming status, the upper right display region 432 displays nothing.

(Contents of Program)

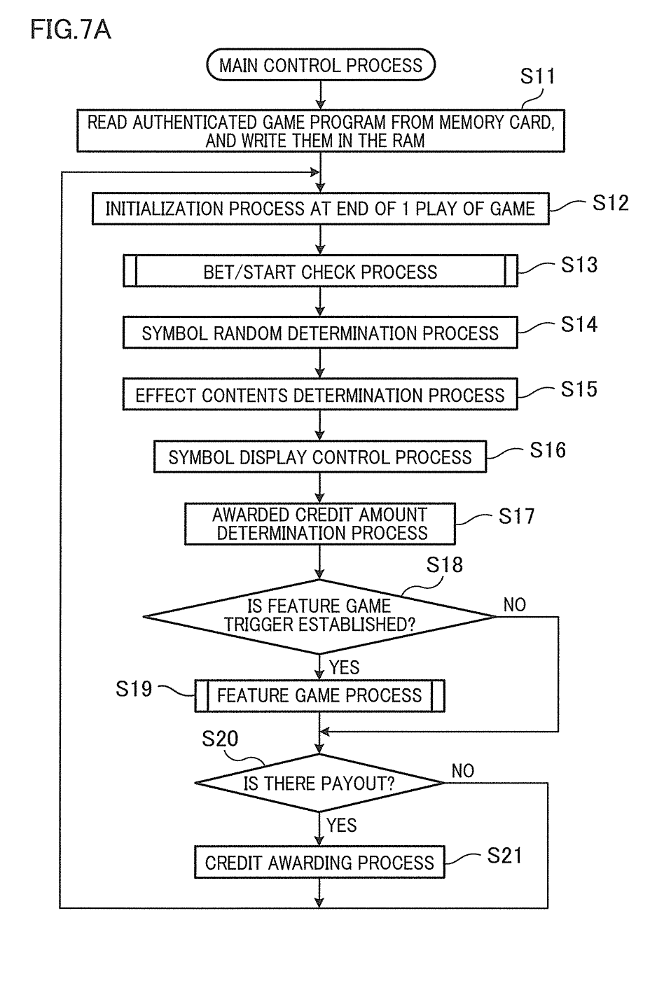

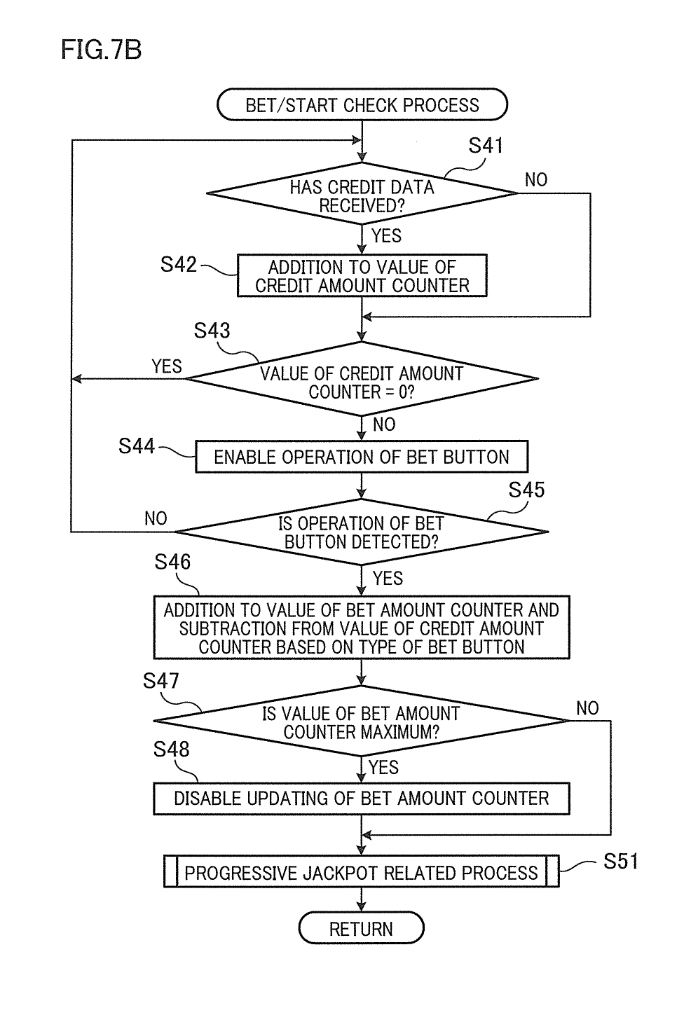

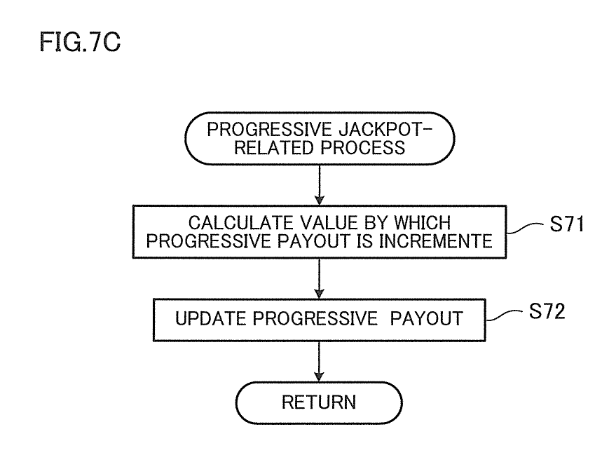

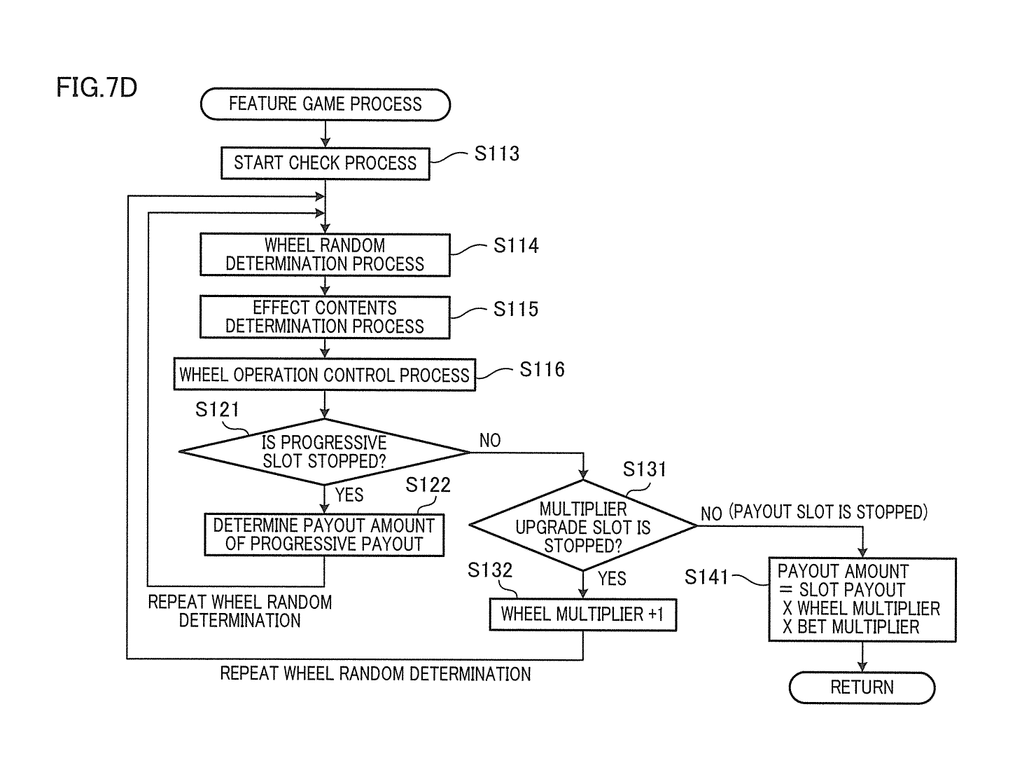

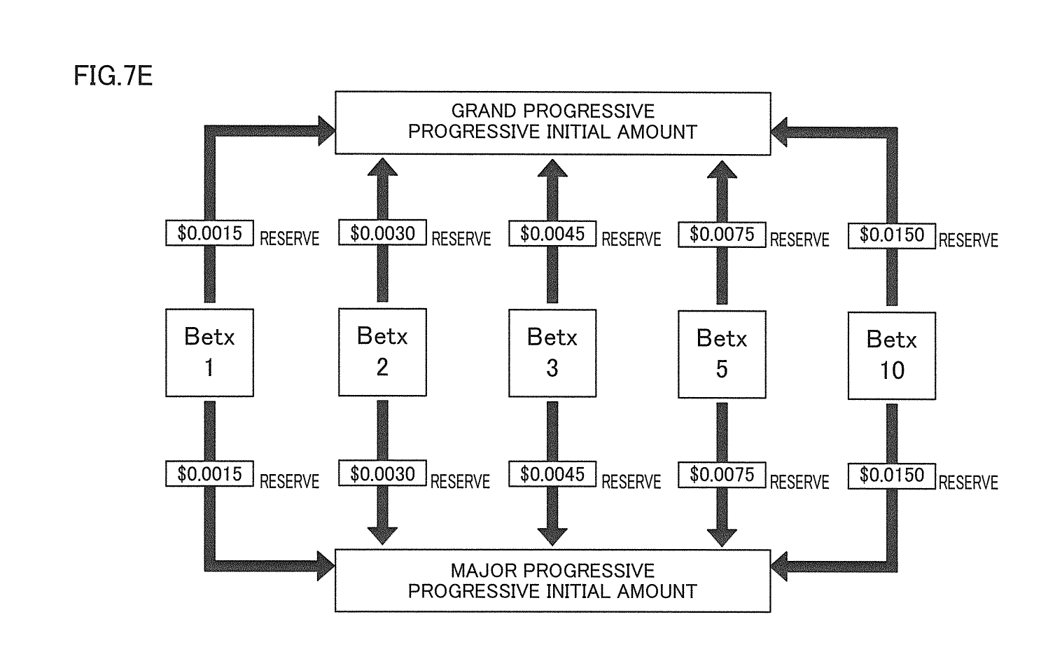

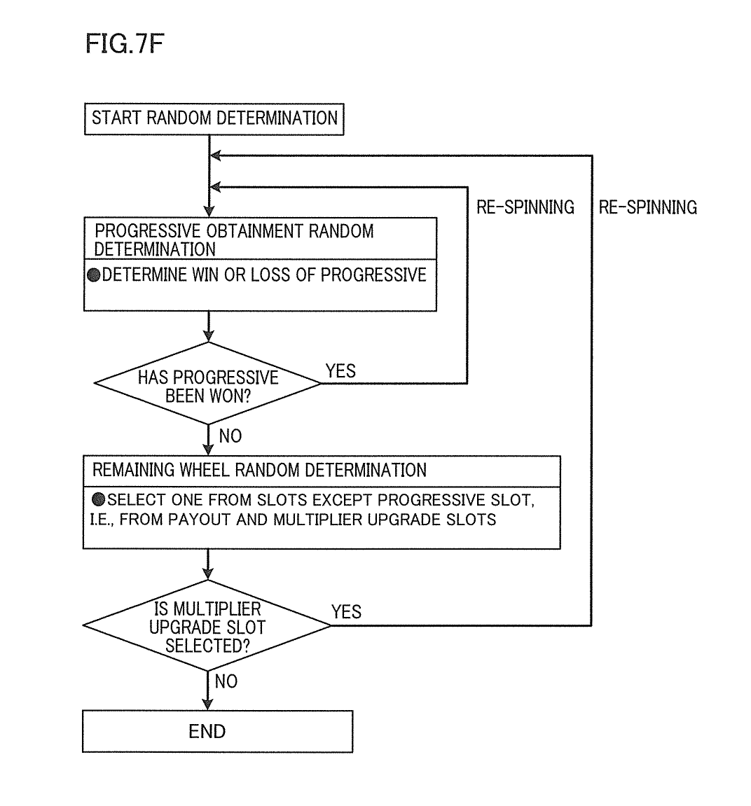

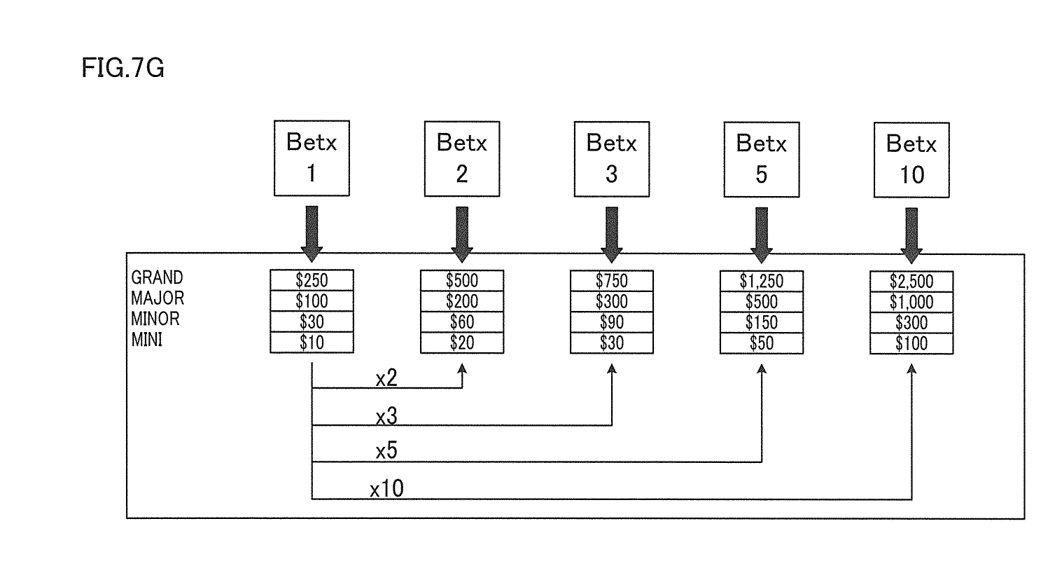

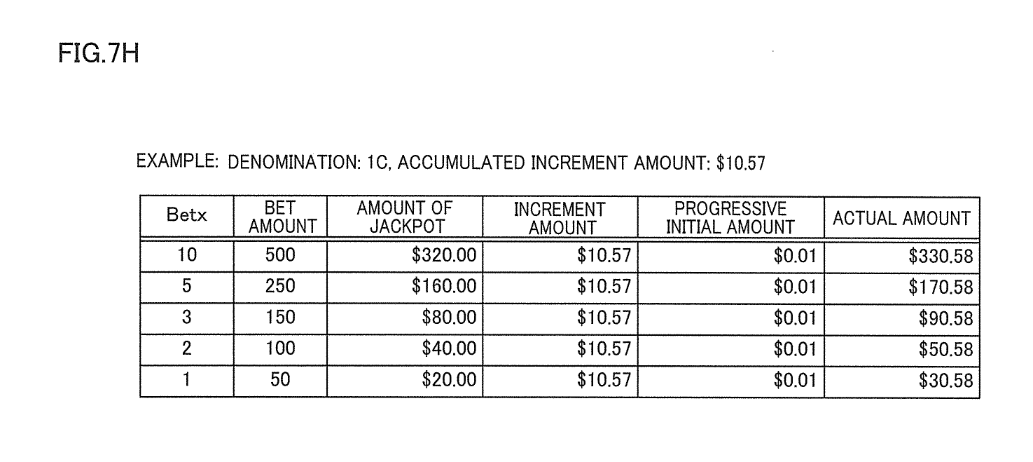

Now, the program to be executed by the gaming machine 1 and the like are described mainly with reference to FIG. 7A to FIG. 7D. In the following description, the reels 101 to 105 and the wheel 201 are described mainly with reference to FIG. 3. The circuitry components such as the main CPU 71 are described mainly with reference to FIG. 4. The steps of each flow are described with reference to FIG. 7A to FIG. 7D.

(Main Control Process)

Referring to FIG. 7A, a main control process will be described.

First, when the gaming machine 1 is powered on, the main CPU 71 (see FIG. 4) reads the authenticated game program from the memory card 54 through the gaming board 50, and writes the program into the RAM 73 (Step S11).

Next, the main CPU 71 executes an initializing process at the end of each play of the game (Step S12). This process clears data in a working area of the RAM 73, which becomes unnecessary at the end of each play of game, e.g., a bet amount, symbols 501 randomly determined, and the like.

The main CPU 71 executes a bet/start check process which will be described later with reference to FIG. 7B (Step S13). In this process, an input check or the like is executed for the bet switches 34S to 38S (see FIG. 4) and for the repeat bet switch 46S (see FIG. 4).

Subsequently, the main CPU 71 executes the symbol random determination process (Step S14). In this process, executed is a symbol random determination for determining to-be-stopped symbols on the basis of a random number for symbol determination. The to-be-stopped symbols are determined based on the reel weight table shown in FIG. 5C. In the reel weight table, weights are respectively set for the 22 symbols 501 of each of the reels 101 to 105. Each weight indicates the probability of the rearrangement of the corresponding symbol 501 in the middle stage of the display window 150 (see FIG. 4). To be more specific, the probability of the rearrangement of a symbol 501 in the middle stage of the display window 150 is a value calculated by dividing the weight associated with the symbol 501 by the total of the weights of all the symbols 501 of the reel to which the concerned symbol 501 pertains. For example, the “1BAR” corresponding to the code number 0 of the first reel 101 (REEL 1) is rearranged in the middle stage of the display window 150 with a probability of 3/90. Further, the “3BAR” corresponding to the code number 0 of the second reel 102 (REEL 2) is rearranged in the middle stage of the display window 150 with a probability of 4/80. Note that FIG. 5C shows the reel weight table of the minor setting V01. There are reel weight tables (not illustrated) respectively corresponding to the other minor settings V02 to V06. The same can be applied to the weights defined in the other tables. The probability that an to-be-determined object (e.g., symbol) is selected is obtained by dividing the weight associated with the to-be-determined object by the total of the weights of all the to-be-determined objects.

Next, the main CPU 71 executes an effect contents determination process (Step S15). For example, the main CPU 71 extracts an effect-use random number and randomly determines any of a plurality of predetermined contents of effect.

Next, the main CPU 71 executes a symbol display control process (Step S16). In this process, scrolling of the reels 101 to 105 is started, and the to-be-stopped symbols, which are determined in the symbol random determination process of Step S14, are stopped in predetermined positions (e.g., in the middle stage of the display window 150). That is, 15 symbols including the to-be-stopped symbols are displayed in the display window 150. In this symbol display control process, the effect determined in the effect contents determination process in Step S15 is executed.

<Screen Display for Normal Situation>

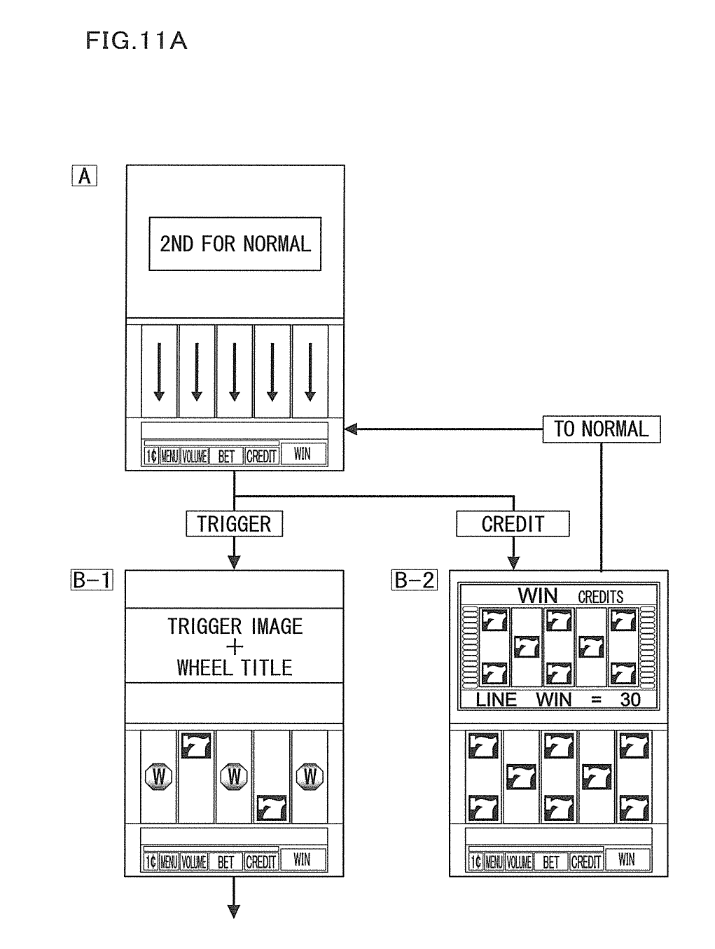

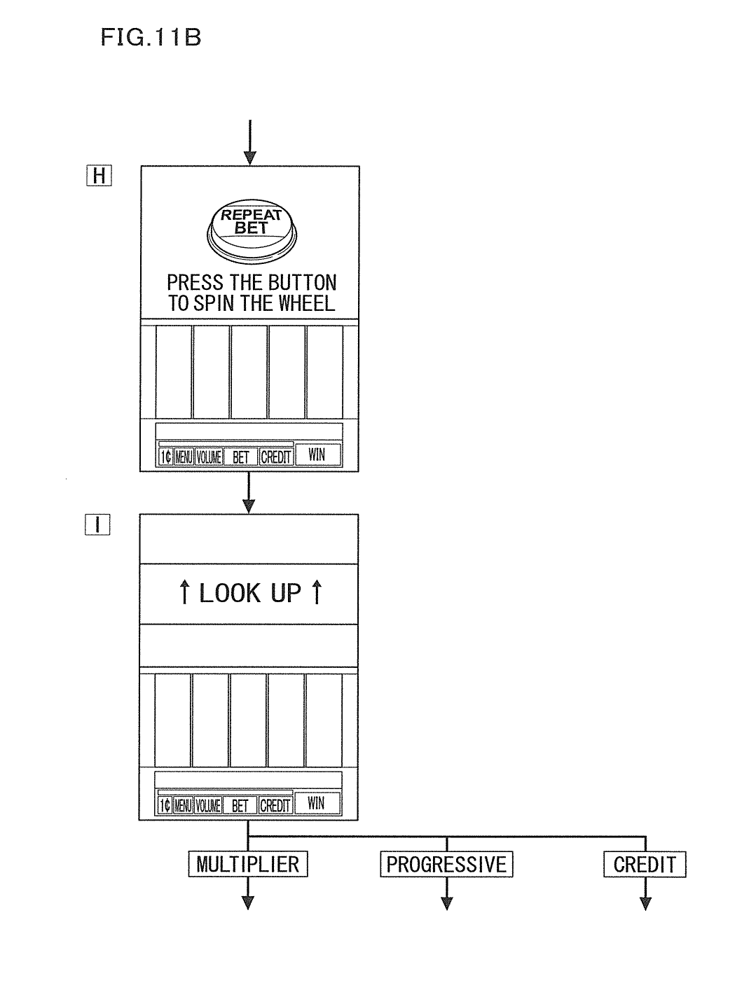

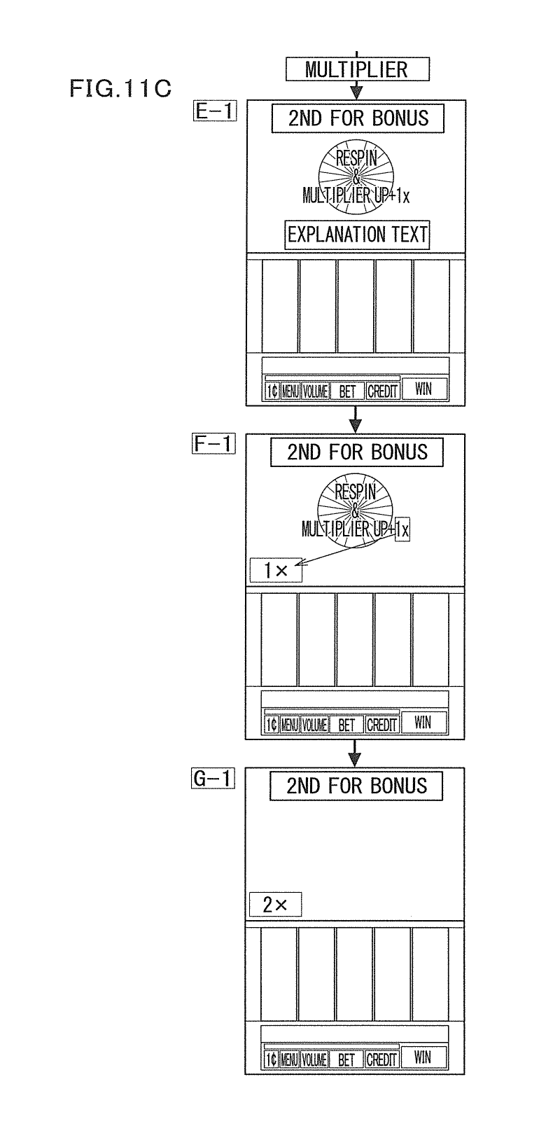

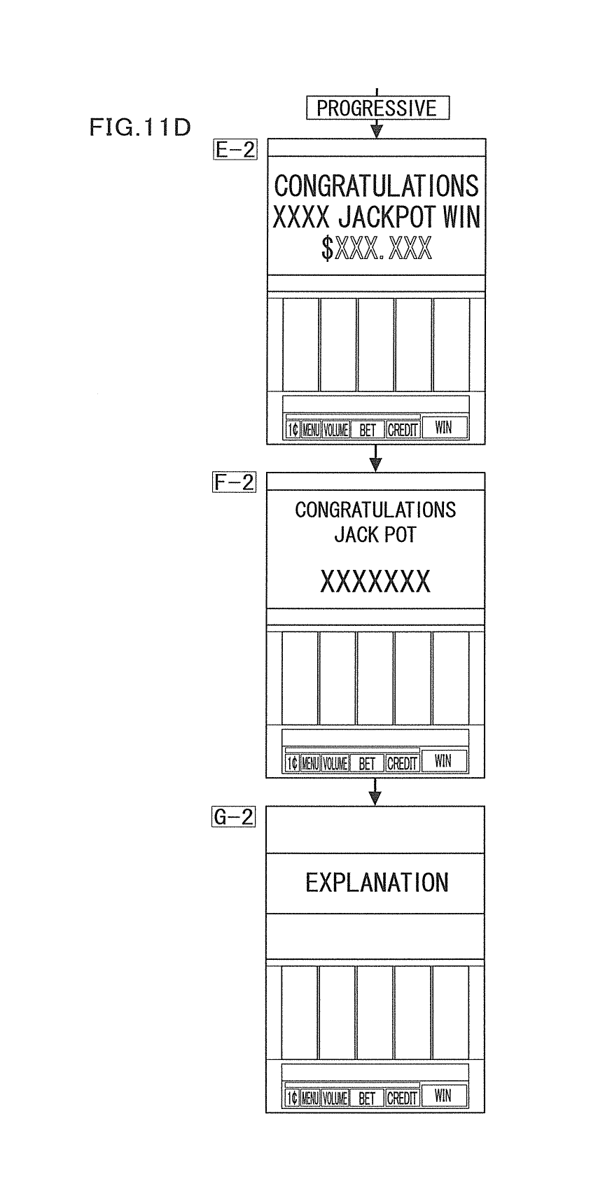

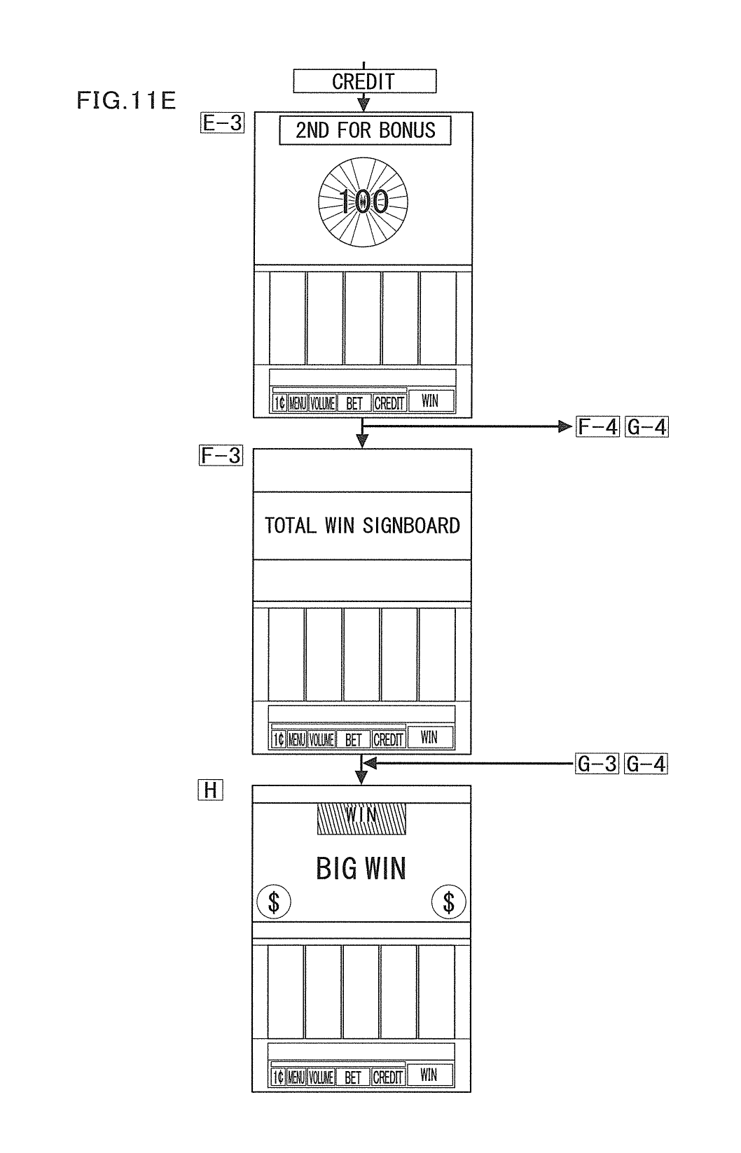

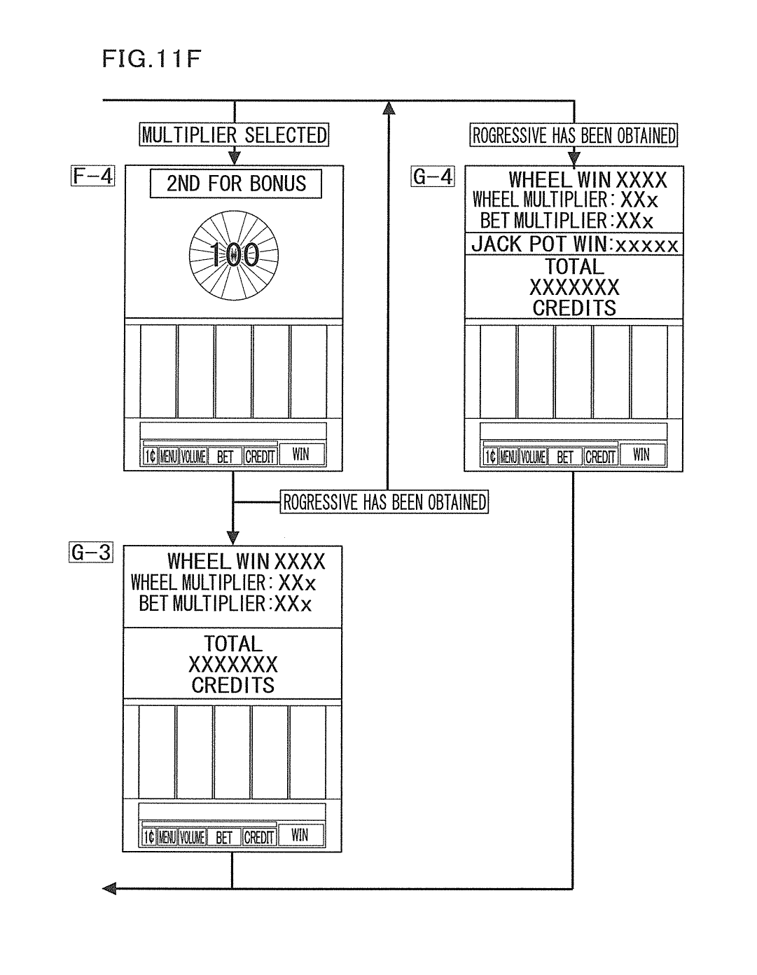

“A” in FIG. 11A shows the screen display in the normal situation in the base game (the trigger condition is not satisfied and a win does not occur). At this time, the upper image display panel 131 (see FIG. 3, the same will apply hereafter) displays a screen for the normal situation in the base game (2nd screen for normal situation) (see FIG. 9A). Immediately after the start of spinning of the reels 101 to 105, the game state indicator 421 (see FIG. 10A) of the liquid crystal display device 134 displays the text of “GOOD LUCK!”.

Subsequently, as shown in FIG. 7A, the main CPU 71 executes an awarded credit amount determination process (Step S17). In this process, the payout table (see FIG. 5E) is referred to, and the awarded credit amount is determined based on a combination of the symbols 501 displayed on each payline, and the credit amount thus determined is stored in the awarded credit amount storage area in the RAM 73 (see FIG. 4). Such a process executed by the main CPU 71 for storing a value in a predetermined storage area in the RAM 73 or changing the stored value is common among various processes which will be described later (with respect to the payout amount, bet amount, credit amount, number of times, and the like).

<Screen Display when Win Occurs>

B-2 in FIG. 11A shows the screen display at the time when a win occurs in the base game. At this time, the upper image display panel 131 displays: the 2nd screen for normal situation as a background; and the win signboard. The upper image display panel 131 displays the win signboard, the type of which is different depending on the size of the win (depending on the payout amount). To be more specific, there are the following win classes: “normal win”; “big win”; and “great win”. Wins, the payout amount awarded by each of which is less than 5 times the bet amount, are classified in the “normal win”. Wins, the payout amount awarded by each of which is not less than 5 times and less than 25 times the bet amount, are classified in the “big win”. Wins, the payout amount awarded by each of which is not less than 25 times the bet amount, are classified in the “great win”. The threshold values between the win classes may be changed.

FIG. 12B shows an example of the win signboard for the normal win. On the win signboard for the normal win, there are provided: the win meter; an indication of the line(s) on (each of) which the winning is achieved (as for the actual display of the line, see the upper image display panel 131 in FIG. 8); and a line win display (“LINE WIN display”), in this order from the top. The win meter indicates the payout amount awarded by the win (obtained credit amount). The line win display includes: the number of lines on each of which a winning is achieved (“LINE XX”); and the payout amount awarded by the line win(s) (“WIN=XXXXX”). The above “X” represents a numerical value. The number of letters “X” (e.g., 5 for “XXXXX”) represents the maximum number of digits (the same shall apply hereafter unless otherwise specified). When a big win occurs, the upper image display panel 131 displays a big win signboard (see “H” in FIG. 11E and a right portion of the figure). When a great win occurs, the upper image display panel 131 displays a great win signboard (see a right portion of the figure). The upper image display panel 131 displays each win signboard for a predetermined period of time. Then, the win signboard is cleared, and the 2nd screen for normal situation is displayed.

Further, when a win occurs in the base game, the liquid crystal display device 134 displays contents corresponding to the payout amount. For example, in the upper middle display region 431 of the liquid crystal display device 134, there is displayed a line win signboard shown in FIG. 10B (a line win effect is provided). The contents of the line win signboard are similar to those of the win signboard displayed on the upper image display panel 131.

Subsequently, as shown in FIG. 7A, the main CPU 71 determines whether a feature game trigger condition has been satisfied (Step S18). The trigger condition is satisfied when 3 BONUS symbols (specific symbols) are rearranged in the display window 150. When the main CPU 71 determines that the trigger condition has been satisfied (S18: YES), the main CPU 71 executes a feature game process which will be described later with reference to FIG. 7D (Step S19).

<Screen Display when Trigger Occurs>

B-1 in FIG. 11A shows the screen display at the time when the feature game trigger condition is satisfied (when a trigger occurs). The upper image display panel 131 displays a trigger image and a feature title (“wheel title” in FIG. 11A). These are displayed at the same time when the last reel (the reel which is stopped last among the reels 101 to 105) stops. While the upper image display panel 131 displays the feature title, the upper middle display region 431 of the liquid crystal display device 134 also displays the feature title, as shown in FIG. 10C (for the same display time).

Then, the screen display on the upper image display panel 131 is changed to a “bonus screen”, as shown in C in FIG. 11B. The bonus screen includes: an image of a button; and a text of “PRESS THE BUTTON TO SPIN THE WHEEL” for encouraging the player to press the button. At the same time when the screen display on the upper image display panel 131 is changed to the bonus screen, the main CPU 71 darkens the reels 101 to 105. While the upper image display panel 131 displays the bonus screen, the upper middle display region 431 of the liquid crystal display device 134 displays the text of “SPIN THE WHEEL”, as shown in FIG. 10D (for the same display time). When the repeat wheel random determination is performed as described below, the wheel 201 spins without operation of the button by the player. For this reason, in the case where the repeat wheel random determination is performed, the upper image display panel 131 does not display the bonus screen, and the upper middle display region 431 of the liquid crystal display device 134 does not display the text of “SPIN THE WHEEL”.

Then, after Step S19 or when the main CPU 71 determines that the trigger condition has not been satisfied in Step S18 (S18: NO), the main CPU 71 determines if there is a payout (Step S20), as shown in FIG. 7A. That is to say, whether any payout has been awarded in Step S17 or Step S19 is determined. When it is determined that there is a payout (S20: YES), the main CPU 71 executes a credit award process (Step S21). Specifically, the main CPU 71 adds the value stored in the awarded credit amount storage area to the value stored in the credit amount storage area provided in the RAM 73. Alternatively, based on an input to the cash out switch 31S (see FIG. 4), the main CPU 71 may control the PTS device 700 and write the credit data indicating the value stored in the awarded credit amount storage area into the IC card inserted into the card insertion slot. After this process or when it is determined that there is no payout in Step S20 (S20: NO), the processing returns to Step S12.

(Bet/Start-Check Process)

Now, the bet/start-check process is described, mainly with reference to FIG. 7B.

To begin with, the main CPU 71 determines whether credit data is received from the PTS device 700 (Step S41). The credit data is sent from the PTS device 700 to the main CPU 71, for example, when the IC card is inserted into the card insertion slot and when the bill entry 60 receives a genuine bill.

When the main CPU 71 determines that the credit data is received (S41: YES), the main CPU 71 adds the value of the received credit data to the value in the credit amount counter (Step S42). To be more specific, the main CPU 71 adds the amount indicated by the received credit data to the value stored in the credit amount storage area in the RAM 73.

After Step S42 or when determining that the credit data has not been received in S41 (S41: NO), the main CPU 71 determines whether or not the value stored in the credit amount storage area is 0 (zero) (Step S43). When the main CPU 71 determines that the value stored in the credit amount storage area is not 0 (zero) (S43: NO), the main CPU 71 permits operation acceptance of the bet buttons (the bet buttons 34 to 38 and the repeat bet button 46) (Step S44).

Then, the main CPU 71 determines whether an operation of the bet button is detected (Step S45). To be more specific, the main CPU 71 determines whether any of the bet buttons is pressed by the player through the corresponding one of the switches (the bet switches 34S to 38S and the repeat bet switch 46S). When the operation of any of the bet buttons is detected (S45: YES), the main CPU 71 performs addition for the bet amount, and subtraction for the credit amount (Step S46), on the basis of the type of the operated bet button. The above-mentioned bet amount is the value stored in the bet amount storage area provided in the RAM 73 (stored in a bet amount counter). The above-mentioned “credit amount” is the value stored in the credit amount storage area provided in the RAM 73. When it is determined that the operation of any of the bet buttons is detected (S45: YES), the main CPU 71 executes a progressive jackpot-related process which will be described later with reference to FIG. 7C (Step S51). Note that a progressive jackpot may be abbreviated as a “progressive”. Then the main CPU 71 terminates the bet/start check process.

(Progressive Jackpot-Related Process)

Now, the progressive jackpot-related process will be described with reference to FIG. 7C. In this process, a part of the bet amount bet in each play of the base game is added to the payout amount of each of the four types (4 levels) of the progressive jackpot, and thus the part of the bet amount is cumulatively accumulated (the payout amount of each type is incremented). As shown in FIG. 6E, the four types of the progressive jackpot are: “GRAND”, “MAJOR”, “MINOR”, and “MINI”. To begin with, the main CPU 71 calculates the values by which the payout amounts of the four types of progressive jackpot are respectively incremented (Step S71) (the details of each value will be described later).

Subsequently, the main CPU 71 accumulatively adds the values for the increment calculated in Step S71 to the payout amounts of the four types of progressive jackpot, respectively, and updates the payout amounts (Step S72). The payout amounts of the four types of progressive jackpot are stored in a progressive payout storage area provided in the RAM 73. After the above step, the progressive jackpot-related process is terminated.

(Feature Game Process)

Now, referring to FIG. 7D, the feature game process will be described. FIG. 7D is a flowchart of the feature game process.

To begin with, when the feature game process is executed, the main CPU 71 executes a start-check process (Step S113). In the start-check process, the main CPU 71 determines whether the operation of the repeat bet button 46 (see FIG. 3) is detected, on the basis of an input signal from the repeat bet switch 46S (see FIG. 4). The main CPU 71 proceeds the processing to the next step when the above operation is detected.

Subsequently, the main CPU 71 executes a wheel random determination process (Step S114). In the wheel random determination process, a random determination for selecting one slot 202 from the plurality of slots 202 (wheel random determination) is made. That is, a to-be-stopped slot is determined. The to-be-stopped slot is the slot 202 which is to be located at the wheel predetermined position (e.g. the upper end portion of the wheel 201). As shown in FIG. 7F, the wheel random determination is performed in two stages: a progressive obtainment random determination; and a remaining wheel random determination.

In the progressive obtainment random determination, it is determined whether any of the progressive slots is selected or not (the progressive payout is won or not). The progressive obtainment random determination is performed in two stages: an obtainment random determination; and a level random determination. In the obtainment random determination, win or loss is randomly determined on the basis of an obtainment random determination table shown in FIG. 6F. In the obtainment random determination table, weights for the win and weights for the loss are set. For example, in the minor setting V01, the probability of the win is obtained by dividing the weight for the win (49) by the total of the weights for the loss and the win (769). The level random determination is performed when the win is selected in the obtainment random determination. In the level random determination, the level of the progressive payout is selected on the basis of a level random determination table shown in FIG. 6G. Specifically, one of “GRAND”, “MAJOR”, “MINOR”, and “MINI” is selected. For example, in the minor setting V01, “GRAND” is selected with a probability of 2/100.

In the remaining wheel random determination shown in FIG. 7F, one slot is selected from a group constituted by the payout slots and the multiplier upgrade slots. The remaining wheel random determination is performed on the basis of a wheel random determination table shown in FIG. 6B. In the wheel random determination table, the weight is set for each slot. For example, the probability that any of the multiplier upgrade slots is selected is 30/320. Whether any of the progressive slots is selected is determined in the above-described progressive obtainment random determination (see FIG. 7F), and therefore the weight for each progressive slot is set to 0 (zero) in the wheel random determination table (see FIG. 6B).

Then, the main CPU 71 determines contents of the effect in an effect contents determination process (Step S115), as shown in FIG. 7D. Then, the main CPU 71 executes a wheel operation control process (Step S116). In the wheel operation control process, spin of the wheel 201 is started, and the to-be-stopped slot determined in the wheel random determination (Step S114) is stopped at the wheel predetermined position (for example, the upper end portion of the wheel 201).

<Control of Rotational Operation of Wheel 201>

In the wheel operation control process, the main CPU 71 controls the rotational operation of the wheel 201 in accordance with descriptions in a scenario (see FIG. 6D). The scenario is a data sheet in which the rotational direction and the rotational speed of the wheel 201 are defined in chronological order. The scenario may include information other than the rotational direction and the rotational speed of the wheel 201. The scenario includes information of the rotational patterns of the wheel 201. Specifically, as shown in FIG. 6C, 17 parameters “0” to “16” are used in the scenario. In FIG. 6D, only a data piece of the scene Nos. 0 and 1 is shown, but there are a plurality of data pieces arranged in chronological order.

<Screen Display During Spin of Wheel>

While the wheel 201 spins, the upper image display panel 131 displays the text of “LOOK UP” for 3 seconds as shown in D of FIG. 11B, and does not display a background. Upward arrows are respectively provided to the left and right of the text of “LOOK UP” (the same shall apply hereafter for the text of “LOOK UP”). The upper image display panel 131 displays the background (2nd screen for feature) at the same time when the text of “LOOK UP” is cleared from the upper image display panel 131. While the upper image display panel 131 displays the text of “LOOK UP”, the upper middle display region 431 of the liquid crystal display device 134 displays the text of “LOOK UP”, as shown in FIG. 10E (for the same display time).

<When Progressive Slot is Stopped>

Thereafter, the main CPU 71 determines whether any of the progressive slots is selected in the wheel random determination (Step S121), as shown in FIG. 7D. To be more specific, the main CPU 71 determines whether the win is selected in the progressive obtainment random determination (see FIG. 7F). Specifically, the main CPU 71 determines whether any of the progressive slots is stopped at the wheel predetermined position. When any of the progressive slots is selected in the wheel random determination (S121: YES), the main CPU 71 pays out the amount of the progressive payout corresponding to the level selected in the level random determination (see FIG. 7F) (Step S122). The amount of the progressive payout to be paid out (progressive winning amount) is the sum of a jackpot amount (fixed payout) (JACKPOT amount) and an increment amount.

The jackpot amount (fixed payout) is, as shown in FIG. 7G, is determined based on the value set for each progressive payout level (see FIG. 6E), taking into consideration the bet multiplying factor (bet multiplier) and a set denomination. For example, as shown in FIG. 6E, the fixed payout for “GRAND” under the condition of the bet multiplier of 1 is set to 25000 credits. If the denomination is 1 credit to 1 cent, the fixed payout for “GRAND” under the condition of the bet multiplier of 1 is 250 dollars. Then, as shown in FIG. 7G, the product of the fixed payout for “GRAND” under the condition of the bet multiplier of 1 and the bet multiplier (bet x) is the jackpot amount (fixed payout).

The increment amount is the sum of a progressive initial amount and an accumulation amount accumulated by reserving a part of a bet amount in each play of the game (accumulation amount). The accumulation amount is the amount accumulated for each level in the progressive jackpot-related process shown in FIG. 7C, by reserving a part of a bet amount each time the game is played. The amount to be accumulated in each play is determined based on the bet amount, taking into consideration the increment rate and the set denomination. To be more specific, in the progressive jackpot-related process, the main CPU 71 calculates the product of the bet amount and the increment rate (see FIG. 6E), and the thus obtained product is processed with the denomination. For example, in the example shown in FIG. 7E, reference is made to the case where: the bet amount is 30 credits (Bet×1); the increment rate is 0.5%; and the denomination is 1 credit to 1 cent. In this case, the amount to be accumulated for each level is 0.0015 dollars (=1.5 cent). In FIG. 7E, only the accumulation for each of the levels “GRAND” and “MAJOR” are illustrated. However, the accumulation for each of the levels “MAJOR” and “MINI” is performed in the same manner. Note that, the increment rate may be the same among the different progressive payout levels, as shown in FIG. 7E. Alternatively, the increment rate for the respective progressive payout levels may be different from each other as shown in FIG. 6E. If the progressive slot associated with one of the above levels is selected once, and the progressive payout amount corresponding to the selected level is paid out, the accumulation amount for the level is reset to 0 (zero). That is, the increment amount is reset to the progressive initial amount. For this reason, if the progressive slot associated with that level is selected for the second time or more, an amount corresponding to the initial value of the that level (see “exemplary initial amount” in FIG. 6E) is paid out.

The progressive initial amount is set to the amount corresponding to 1 credit (e.g., 1 cent). The reason why the progressive initial amount is set is as follows: if a progressive payout is won without increment (the accumulation amount is zero), the progressive winning amount is internally (for the sake of the program processing) calculated as 0 (zero). This should be avoided. For example, in the above-described case where: the jackpot amount (fixed payout) is 250 dollars; the accumulation amount is 0 (zero); and the progressive initial amount is 1 cent (0.01 dollars), the progressive winning amount to be paid out is 250.01 dollars (see “example of initial amount” in FIG. 6E). For example, if the progressive payout at a certain level is won twice or more in the wheel random determination, the accumulation amount for the second time or more is 0 (zero), and therefore the progressive winning amount for the second time or more is merely the sum of the jackpot amount (fixed payout) and the progressive initial amount. FIG. 7H shows the relationship between various bet amounts and the winning amounts of the progressive payout (“actual amount” in this figure) under the condition that: the denomination is 1 credit to 1 cent; the increment amount is 10.57 dollars.

<Screen Display when Progressive Slot is Stopped>

The screen display at the time when a the progressive slot is selected in the wheel random determination and the progressive slot is stopped at the wheel predetermined position (at the time of “progressive stop”) is performed as follows. At this time, the upper image display panel 131 displays, for example, an indication that the progressive payout is won, as shown in E-2 of FIG. 11D. To be more specific, the upper image display panel 131 displays the title of the level of the won progressive payout, such as “GRAND” and “MAJOR”. Further, the upper image display panel 131 displays the amount of the progressive payout obtained by the player (to be paid out to the player). At this time, the upper middle display region 431 of the liquid crystal display device 134 also displays the title of the won progressive payout, as shown in FIG. 10G. However, the liquid crystal display device 134 does not display the amount of the progressive payout. Note that “XXXX” in FIG. 10G does not represent a numerical value, but represents a title such as “GRAND” and “MAJOR”.

Subsequently, as shown in F-2 in FIG. 11D, the upper image display panel 131 displays a congratulation signboard. When the amount of the progressive payout is converted into credits, the upper image display panel 131 changes the display in currency to the display in credits. At this time, the upper image display panel 131 provides the display in credits in an incremental manner (such that a number appears digit by digit) for a short time (e.g., several seconds). At this time, the liquid crystal display device 134 displays the title of the won progressive payout, and does not display the credits of the progressive payout.

Subsequently (if the incremental display is performed in F-2, after the incremental display), as shown in G-2 in FIG. 11D, the upper image display panel 131 displays an explanation text indicating that “random determination is performed again”. At this time, the liquid crystal display device 134 displays the title of the won progressive payout.

<Repeat Wheel Random Determination>

Subsequently, the main CPU 71 executes a repeat wheel random determination process (the processing returns to S114 from Step 122), as shown in FIG. 7D. The wheel random determination performed again after the wheel random determination is referred to as a “repeat wheel random determination”. In the repeat wheel random determination, the random determination same as the wheel random determination is performed. In this process, the screen display is returned to the display shown in D in FIG. 11B.

<When Multiplier Upgrade Slot is Stopped>

As shown in FIG. 7D, when none of the progressive slots is selected in the wheel random determination (in the Step S114) (S121: NO), the main CPU 71 determines whether any of the multiplier upgrade slots is selected in the wheel random determination (Step S131). Specifically, the main CPU 71 determines whether any of the multiplier upgrade slots is stopped at the wheel predetermined position. When any of the multiplier upgrade slots is selected in the wheel random determination (S131: YES), the wheel multiplier is incremented by a predetermined increment value (Step S132). The wheel multiplier is a value stored in the RAM 73. The value (initial value) of the wheel multiplier at the start of the feature game is 1. The predetermined increment value is 1. In a modification, the predetermined increment value may be a value which is not 1. In a modification, the initial value of the wheel multiplier may be a value which is not 1.

<Screen Display when Multiplier Upgrade Slot is Stopped>

The screen display at the time when a multiplier upgrade slot is selected in the wheel random determination and the multiplier upgrade slot is stopped at the wheel predetermined position is performed as follows. At this time, as shown in E-1 in FIG. 11C, the upper image display panel 131 displays: an image of the surface of the wheel (image of the wheel 201) and an explanation text positioned below (or to the lower right of) the image. At this time, the upper image display panel 131 displays the 2nd screen for feature (“2nd for BONUS” in this figure) as a background. At this time, the upper image display panel 131 indicates: re-spinning of the wheel 201; and an increase of the wheel multiplier by 1. Specifically, the upper image display panel 131 displays the text of “RESPIN & MULTIPLIER UP+1×”. While the upper image display panel 131 displays the above text, the upper middle display region 431 of the liquid crystal display device 134 displays the text of “MULTIPLIER UP”, as shown in FIG. 10F.

Then, as shown in F-1 in FIG. 11C, the upper image display panel 131 displays an animation showing that the numerical indication “+1×” representing the increment in the wheel multiplier (which is, for example, displayed at a central portion of the screen) is put into a multiplier counter at a lower left portion of the screen. At this time, the upper middle display region 431 of the liquid crystal display device 134 displays the text of “MULTIPLIER UP” (see FIG. 10F).

Then, as shown in G-1 in FIG. 11C, the upper image display panel 131 displays the thus increased wheel multiplier (the value of after addition) in the multiplier counter at the lower left portion of the screen. At this time, the upper middle display region 431 of the liquid crystal display device 134 displays the text of “MULTIPLIER UP” (see FIG. 10F).

Subsequently, the main CPU 71 performs the repeat wheel random determination (the processing returns to S114 from Step 132), as shown in FIG. 7D. At this time, the screen display is returned to the display shown in D in FIG. 11B.

<When Payout Slot is Stopped>

When any of the payout slots is selected in the wheel random determination (Step S114 shown in FIG. 7D) (S121: NO, S131: NO), the main CPU 71 determines the awarded credit amount (payout amount) to be paid out in the feature game (Step S141). The payout amount thus determined is stored in an awarded credit amount storage area. The payout amount is the product of: the amount of the slot payout (the value corresponding to the selected payout slot); the wheel multiplier; and the bet multiplier. The bet multiplier is a multiplying factor determined depending on the bet amount bet in the base game. Subsequently, the main CPU 71 terminates the feature game process.

<Screen Display when Payout Slot is Stopped>

The screen display at the time when a payout slot is selected in the wheel random determination and the payout slot is stopped at the wheel predetermined position is performed as follows. At this time, the upper image display panel 131 displays an image of the surface of the wheel, as shown in E-3 in FIG. 11E. At this time, the upper image display panel 131 displays a value of the slot payout (100 in E-3 in FIG. 11E).

<Screen Display when Payout Slot is Stopped: No Multiplier Upgrade, No Progressive>

The following describes the screen display in the following situation: none of the progressive slots and the multiplier upgrade slots has been selected; and a multiplier upgrade slot is selected in the wheel random determination and the payout slot is stopped at the wheel predetermined position. In this situation, the upper image display panel 131 displays a total win signboard as shown in F-3 in FIG. 11E (the details thereof will be described with reference to G-3 in FIG. 11F).

Subsequently, as shown in H in FIG. 11E, the upper image display panel 131 displays an increment-purpose signboard. The above figure illustrates a back increment-purpose big win signboard, which is displayed when a big win occurs. The back increment-purpose big win signboard includes: a win meter; the text of “BIG WIN”; and a motif (e.g. dollar bags), which are provided in this order from the top. The win meter indicates a payout amount provided by the win (obtained credits or amount) in the incremental manner (such that a number appears digit by digit). When the win is a great win, a back increment-purpose great signboard is displayed. On the back increment-purpose great signboard, gorgeous effects are provided as compared with those of the back increment-purpose big win signboard, for example, and the text of “GREAT” is displayed.

At this time, the liquid crystal display device 134 displays the type of the win (e.g., “BIG WIN”, or “GREAT”). Then, the screen display returns to a normal screen (see A in FIG. 11A). The main CPU 71 turns on the darkened reels 101 to 105 (turns on the lights for the reels 101 to 105).

<Screen Display when Payout Slot is Stopped: With Multiplier Upgrade, No Progressive>

The following describes the screen display in the following situation: after a multiplier upgrade slot is selected at least once without selection of any of the progressive slots, a payout slot is selected in the wheel random determination and the payout slot is stopped at the wheel predetermined position. In this situation, the upper image display panel 131 displays an image of the surface of the wheel as shown in F-4 in FIG. 11F, and then displays the total win signboard as shown in G-3 in FIG. 11F.

On the total win signboard, there is displayed the details of the calculation in Step S141 (see FIG. 7D). To be more specific, the slot payout, the wheel multiplier, the bet multiplier, and the payout amount are displayed on the total win signboard. Further specifically, on the total win signboard, there are displayed: “WHEEL WIN: XXXX” indicating the value of the slot payout; “WHEEL MULTIPLIER: XXx” indicating the wheel multiplier (the lower case “x” represents a multiplication sign); “BET MULTIPLIER: XXx” indicating the bet multiplier; and “TOTAL XXXXXXX CREDITS” indicating the payout amount, in this order from the top. The upper image display panel 131 does not display all the lines of the above contents (all the texts and numbers) concurrently. The upper image display panel 131 starts the display from the uppermost line sequentially, and displays the payout amount at the end.

Subsequently, as shown in H in FIG. 11E, the upper image display panel 131 displays the increment-purpose signboard. Then, the screen display returns to the normal screen (see A in FIG. 11A). The main CPU 71 turns on the darkened reels 101 to 105 (turns on the lights for the reels 101 to 105).

<Screen Display when Payout Slot is Stopped: With Multiplier Upgrade, with Progressive>

The following describes the screen display in the following situation: after a progressive slot is selected at least once and a multiplier upgrade slot is selected at least once, a payout slot is selected in the wheel random determination and the payout slot is stopped at the wheel predetermined position. In this situation, the upper image display panel 131 displays a progressive total win signboard as shown in G-4 in FIG. 11F. Differently from the above-described total win signboard, the progressive total win signboard includes the display of the payout amount provided by the progressive payout. Specifically, “JACKPOT WIN: XXXXXXXXXXX” is included. Further specifically, on the progressive total win signboard, there are displayed: “WHEEL WIN: XXXX” indicating the value of the slot payout; “WHEEL MULTIPLIER: XXx” indicating the wheel multiplier; “BET MULTIPLIER: XXx” indicating the bet multiplier; “JACKPOT WIN: XXXXXXXXXXX” indicating the progressive payout; and “TOTAL XXXXXXX CREDITS” indicating the total payout amount, in this order from the top. The above total payout amount is the sum of the payout amount provided by the progressive payout and the payout amount calculated in Step S141 (FIG. 7D).

Subsequently, as shown in H in FIG. 11E, the upper image display panel 131 displays the increment-purpose signboard. Then, the screen display returns to the normal screen (see A in FIG. 11A). The main CPU 71 turns on the darkened reels 101 to 105 (turns on the lights for the reels 101 to 105).

The main CPU 71 keeps a log (record) of the payout in each play of the game. The log is a table, for example, in the form of a csv file. The log includes, for example, the following items (A) to (H): (A) number of plays of the game; (B) bet amount; (C) payout amount won in the normal game (credit amount); (when no payout is won, the amount is 0 (zero).) (D) the total payout amount (credit amount) for the payout(s) won only in the feature game; (If no feature game occurs, nothing is recorded.) (E) a payout amount of the “GRAND” progressive payout (grand credit amount) obtained when the “GRAND” progressive payout is won. (If the “GRAND” progressive payout is won twice or more, the above amount is the total amount (the same shall apply hereafter). If the “GRAND” progressive payout is not won, nothing is recorded (the same shall apply hereafter).) (F) a major credit amount obtained when the “MAJOR” progressive payout is won; (F) a minor credit amount obtained when the “MINOR” progressive payout is won; and (F) a mini credit amount obtained when the “MINI” progressive payout is won.

(Functions and Effects)

The functions and effects of the gaming machine 1 of the present embodiment are as follows. In the present embodiment, the RAM 73 (corresponding to the storage device 210 in FIG. 1) stores the slot payout, values of which respectively associated with the payout slots. In the step (A1d), when the payout slot is selected in the step (A1a) (wheel random determination), the product of the slot payout associated with the selected payout slot and the wheel multiplier (roulette multiplier) is determined as the payout (Step S141 in FIG. 7D).

In this arrangement, the following game effect is provided: when any of the payout slots is selected in the wheel random determination, the product of the slot payout associated with the selected payout slot and the wheel multiplier is determined as the payout. As compared with the case where such a game effect is not provided, the game effect regarding how to determine the payout is diversified.

In the present embodiment, the main CPU 71 (corresponding to the controller 220 in FIG. 1) sets the initial value of the wheel multiplier to 1. When, in the step (A1c), the step of (A1a) (wheel random determination) is repeatedly performed and the multiplier upgrade slot (repeat random determination slot) is repeatedly selected, the following process is performed. In this case, each time the multiplier upgrade slot is selected repeatedly, the wheel multiplier is incremented by the predetermined increment value (see Step S132 in FIG. 7D).

In the above arrangement, the following game effect is provided: each time the multiplier upgrade slot is selected repeatedly, the wheel multiplier, the initial value of which is 1, is incremented by the predetermined increment value (for example, 1, 2, 3, 4, 5, and so on). As compared with the case where such a game effect is not provided, the game effect regarding the way to increase the wheel multiplier is diversified.

In the above arrangement in which each time the multiplier upgrade slot is selected repeatedly, the wheel multiplier is incremented by 1 (for example, 1, 2, 3, 4, 5, and so on), it is easier for the player to understand how the wheel multiplier increases.

In the present embodiment, the gaming machine 1 includes the reels 101 to 105 and the display window 150. The reels 101 to 105 include a plurality of symbols 501 and are provided separately from the wheel 201 (see FIG. 3). The display window 150 is configured to display one or more symbols 501 out of the plurality of symbols 501. The main CPU 71 is configured to execute the following steps of (A5a) and (A5b):

(A5a) selecting one or more symbols 501 to be displayed in the display window 150 out of the plurality of symbols 501 through random determination (the symbol random determination process in S14 of FIG. 7A); and
(A5b) when a predetermined trigger condition is satisfied in the step (A5a) (symbol random determination), starting the step (1a) (wheel random determination) (YES in S18 of FIG. 7A).

In the above arrangement, the following game effect is provided: a symbol random determination is performed, and a result of the symbol random determination may cause satisfaction of the condition for starting the wheel random determination (trigger condition). As compared with the case where such a game effect is not provided, the game effect regarding the start of the wheel random determination is diversified. For example, as compared with the game effect where the wheel random determination is started without satisfaction of the trigger condition, the game effect is diversified.

In the present embodiment, the roulette is the mechanical wheel 201 which is rotatable about a rotation axis (see FIG. 3). The RAM 73 stores the scenario (see FIG. 6D). The scenario is the data sheet in which the rotational direction and the rotational speed of the wheel 201 are defined in chronological order. The main CPU 71 executes the process of controlling the rotational operation of the wheel 201 in accordance with the description in the scenario.

In the above arrangement, the rotational operation of the wheel 201 is controlled by the main CPU 71 in accordance with the scenario which is the data sheet in which the rotational direction and the rotational speed of the wheel 201 are defined in chronological order. Therefore, as compared with the case where such a scenario is not used, control and adjustment of the rotational operation of the wheel 201 are easier. For example, suppose the case where the descriptions of the rotational direction and the rotational speed of the wheel 201 are combined in a complicated manner. In this case, by describing the complex combination in the data sheet (by editing the datasheet), the control and adjustment of the rotational operation of the wheel 201 is facilitated.

The scenario is the data sheet in which the rotational direction and the rotational speed of the wheel 201 are defined in chronological order. This makes it easier for a developer and the like of the gaming machine 1 to check the flow of the rotational operation of the wheel 201. This facilitates the adjustment of the rotational operation of the wheel 201. As a result, the period of time required for this adjustment is shortened. This consequently shortens the development cycle of the gaming machine 1, and hence, the productivity and development efficiency of the gaming machine 1 is improved.

Because the flow of the rotational operation of the wheel 201 is thus easily checked, a bug in the data sheet is easily found. This consequently shortens the development cycle of the gaming machine 1.

Because a bug in the data sheet is easily found, determination regarding the causes for an error in the rotational operation of the wheel 201 is easier. Specifically, for example, determination whether the error in the rotational operation of the wheel 201 results from a bug in the datasheet or a defect in its peripheral hardware (i.e., the wheel device M2) is easier.

If such a scenario is arranged to be readable in different type of machines, a scenario used in the machines of one type can be used in the machines of the other type. If the scenario is executed in an execution program on the machine of one type and debugged, there is no need to perform debugging on the machines of the other type (the scenario is reliable).

For example, there is a case where software such as an OS (operating system) of hardware (such as the motherboard 70) of the gaming machine 1 is changed because of version upgrade of the gaming machine 1. Also in this case, only required is to modify and debug a program for executing the scenario to compatible with the new software or new hardware. There is no need to modify and debug the scenario.

### Second Embodiment

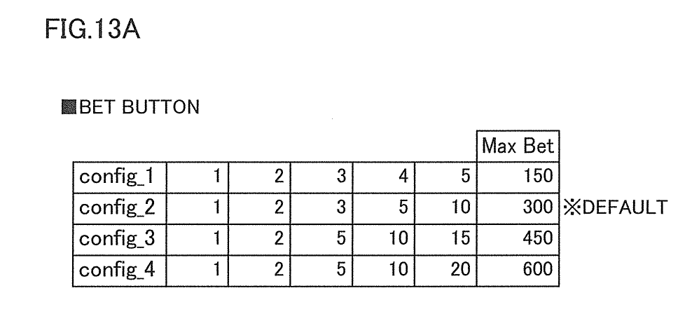

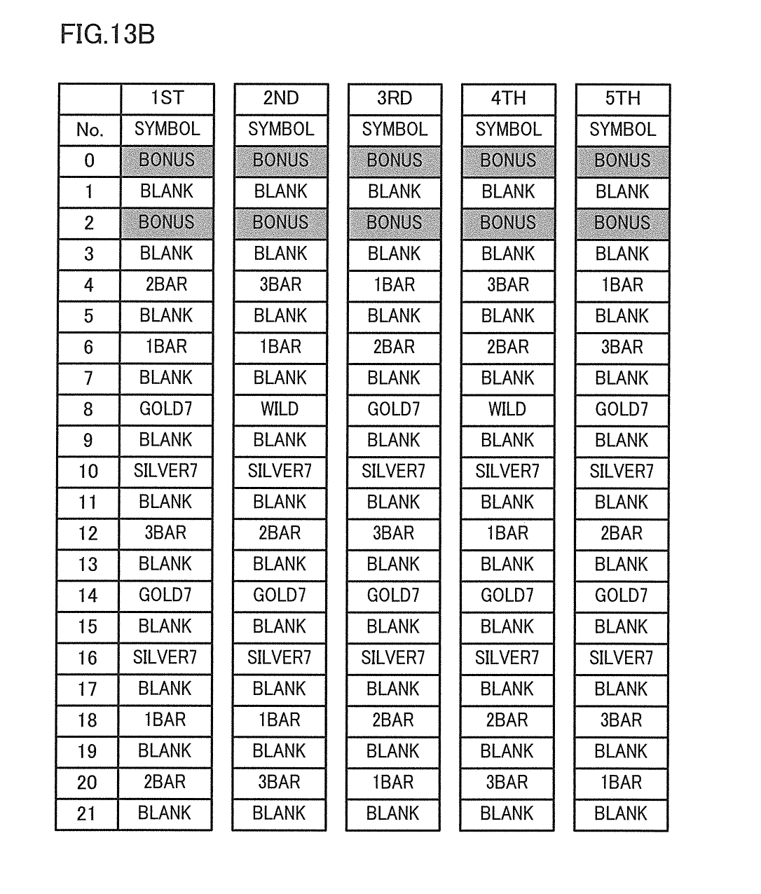

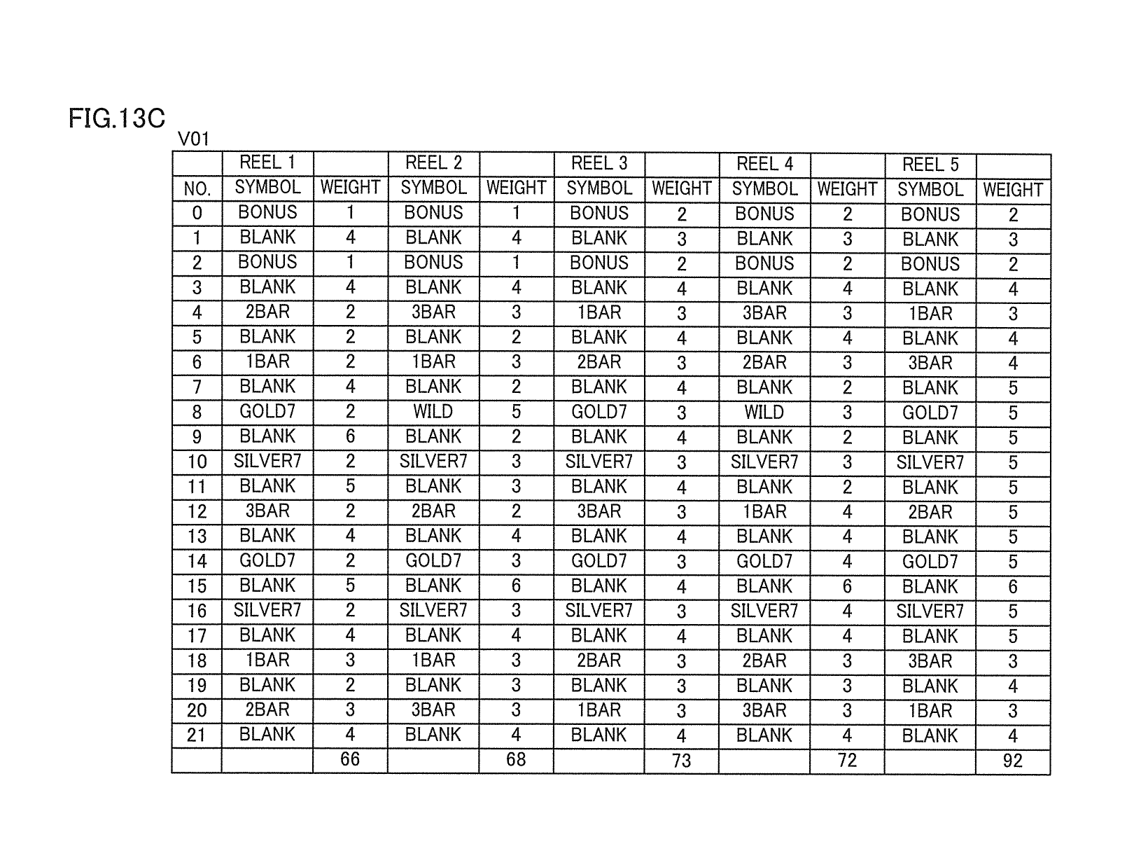

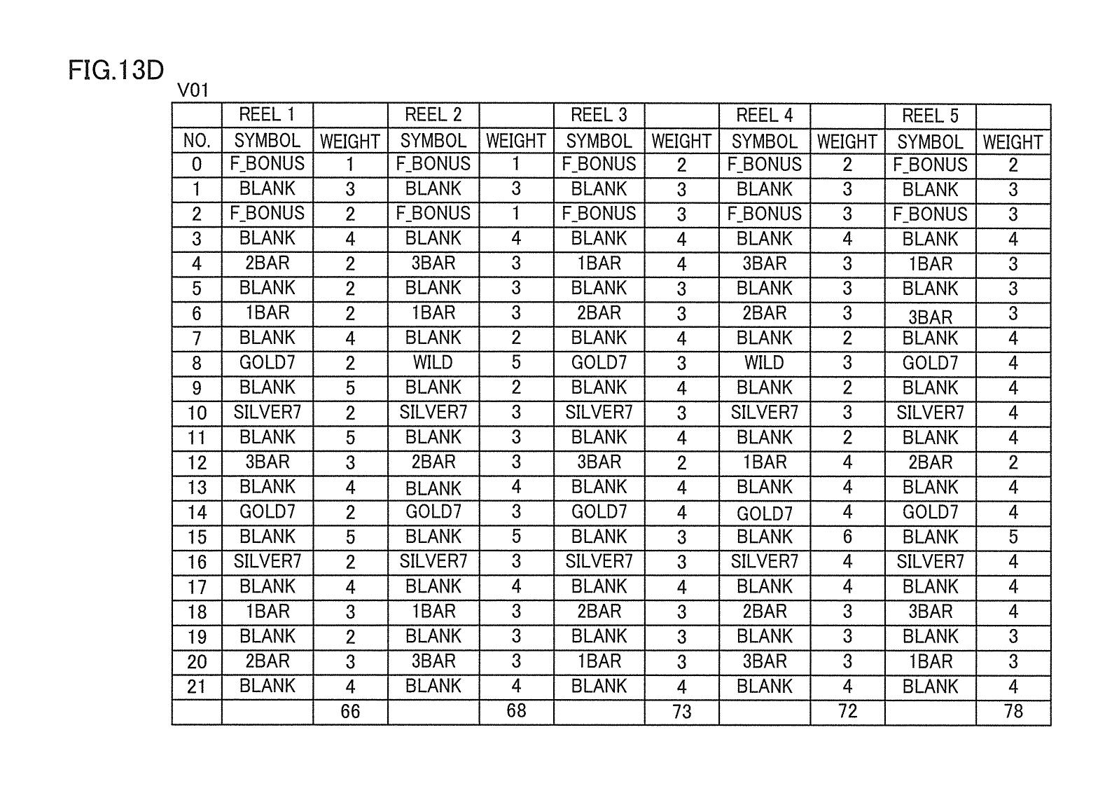

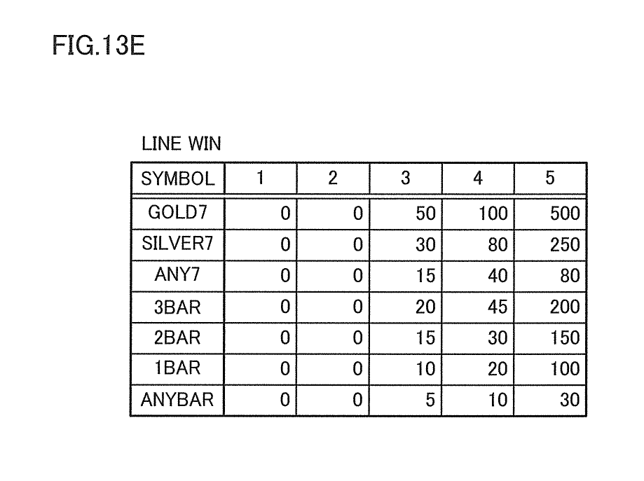

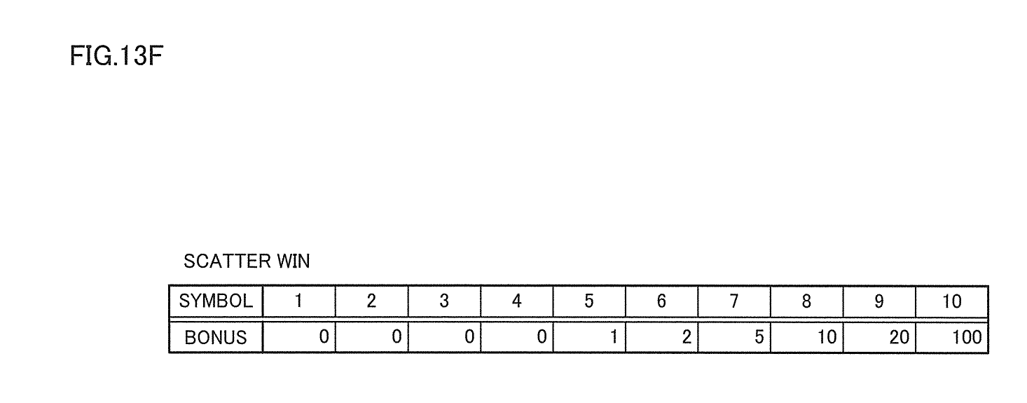

The following will describe a gaming machine 2 of the second embodiment with reference to FIG. 13A to FIG. 18L. Specifically, differences between the gaming machines of the first and second embodiments are described. Descriptions for the features common between the first and second embodiments are omitted.

<Outline of Differences>

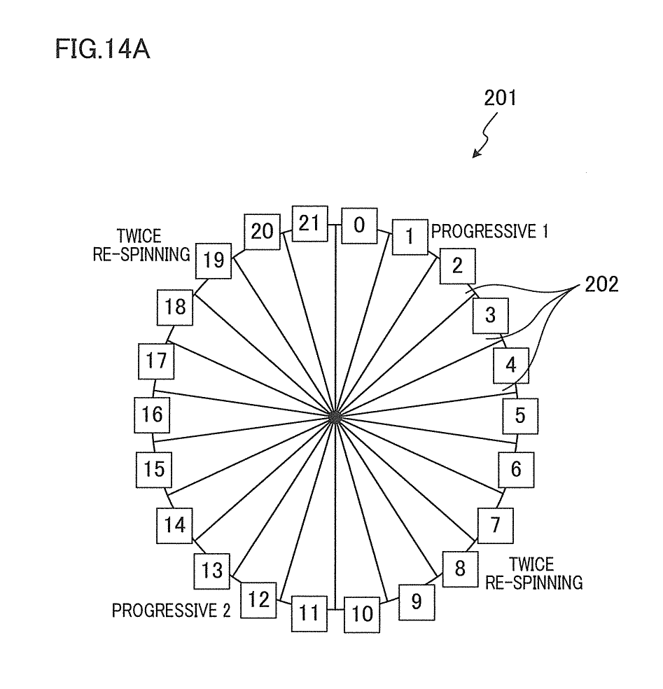

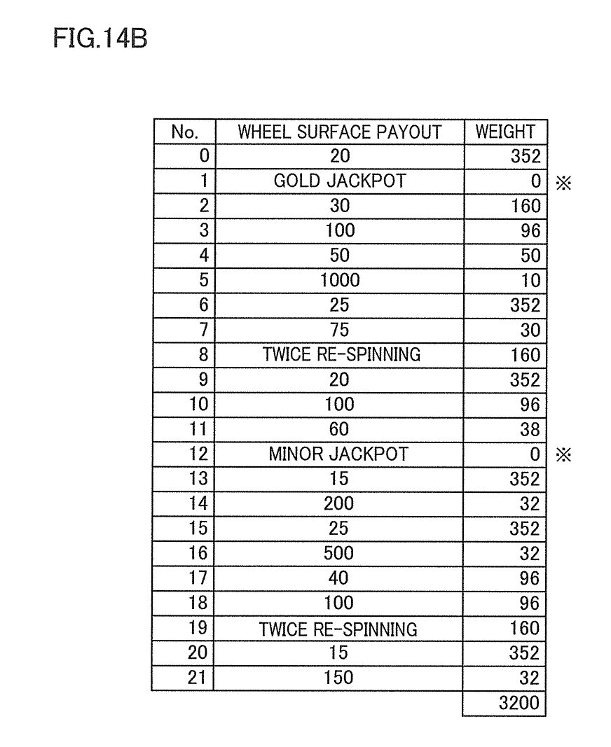

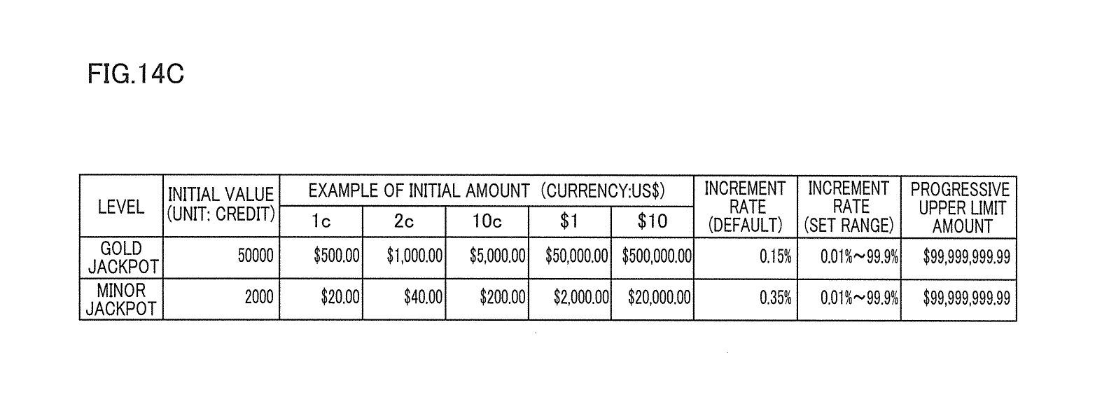

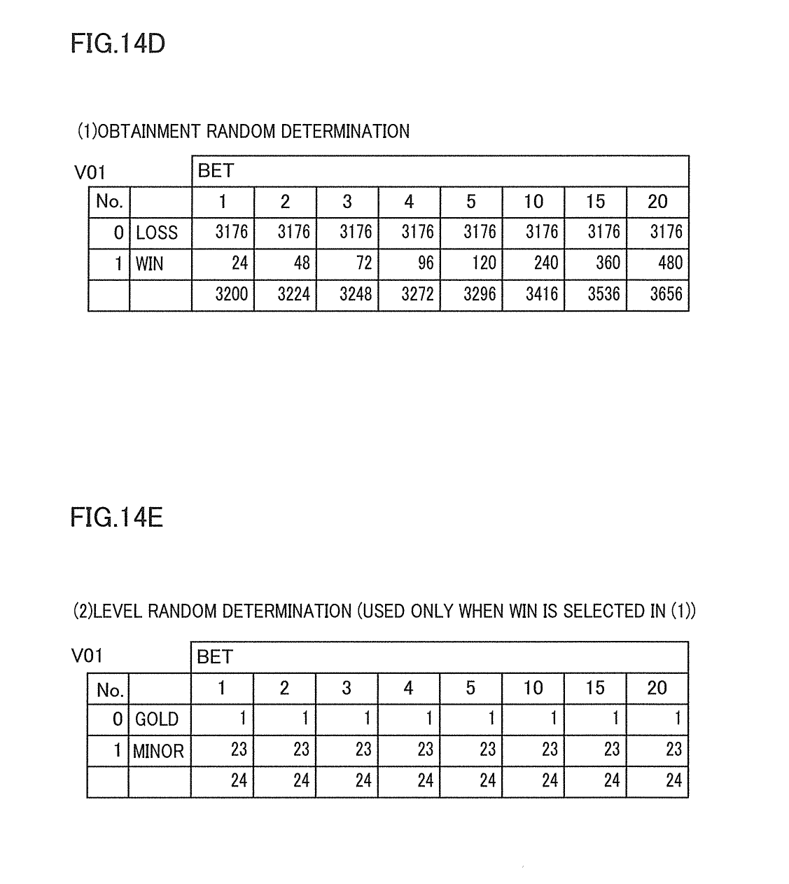

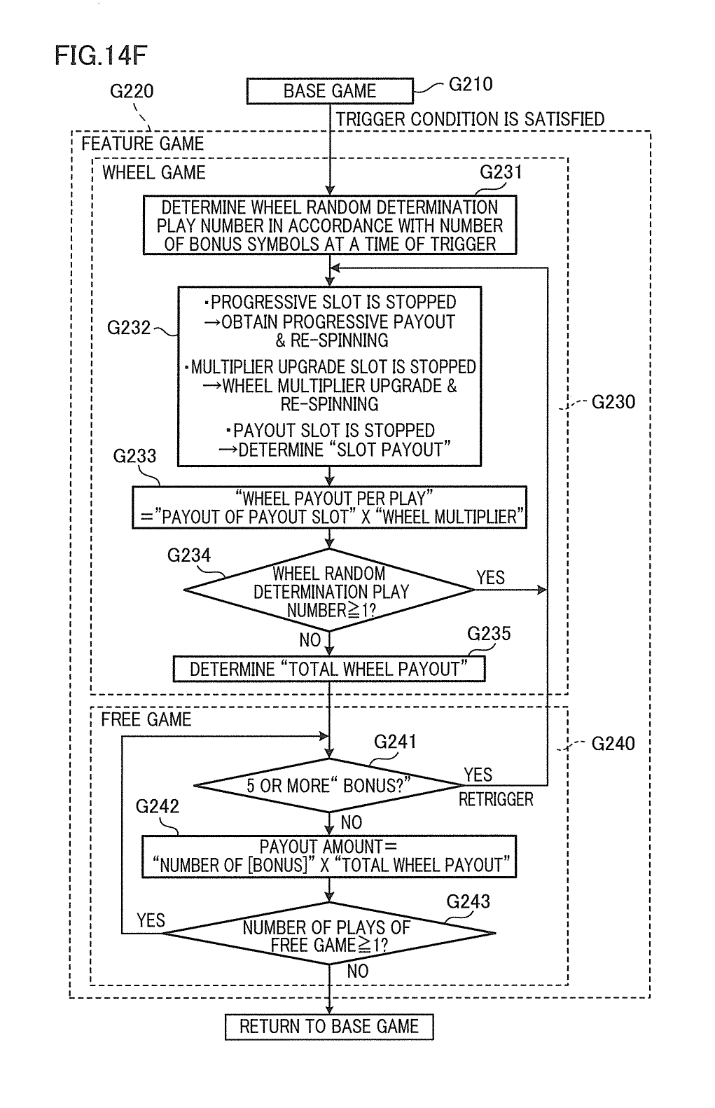

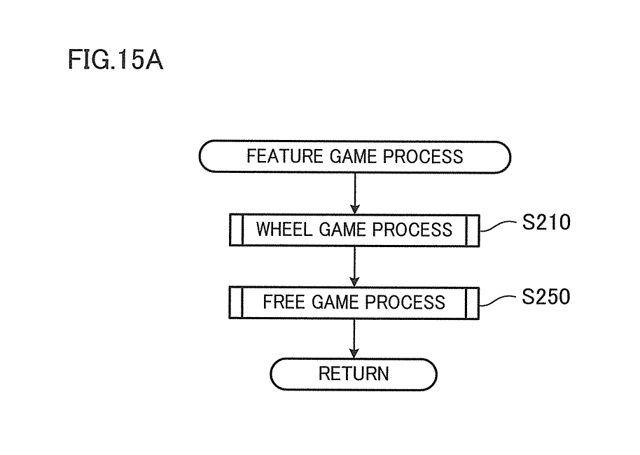

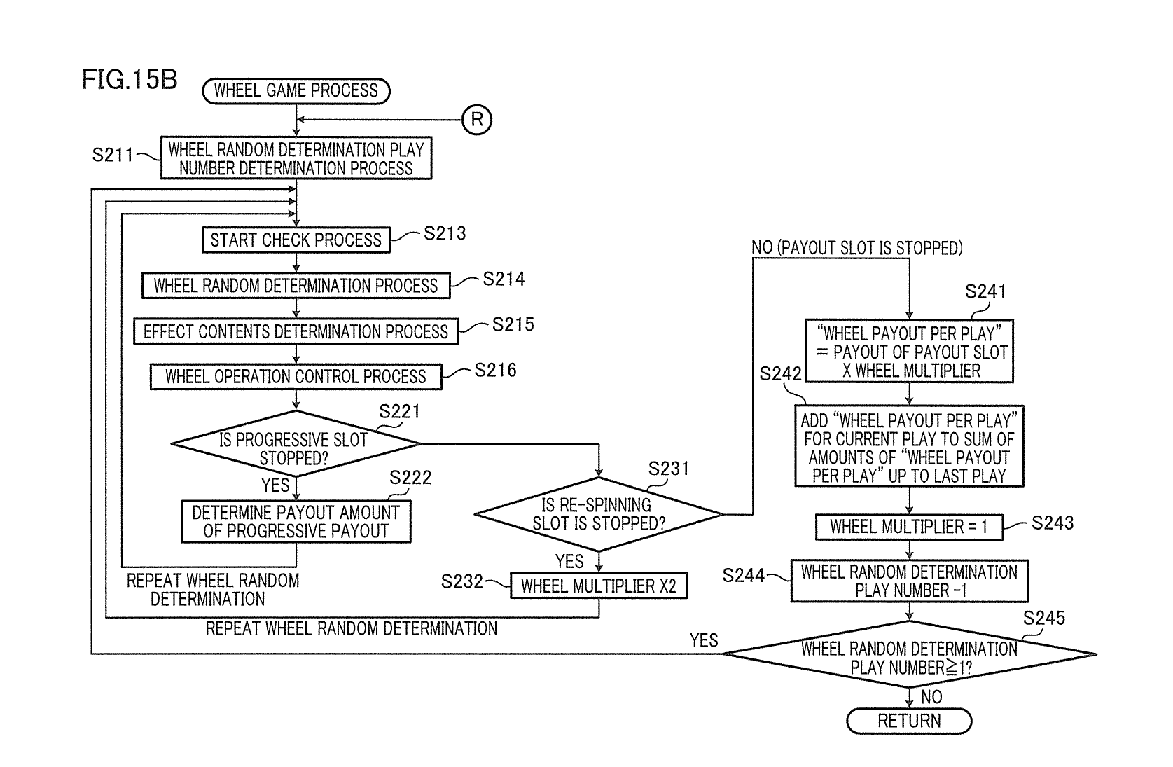

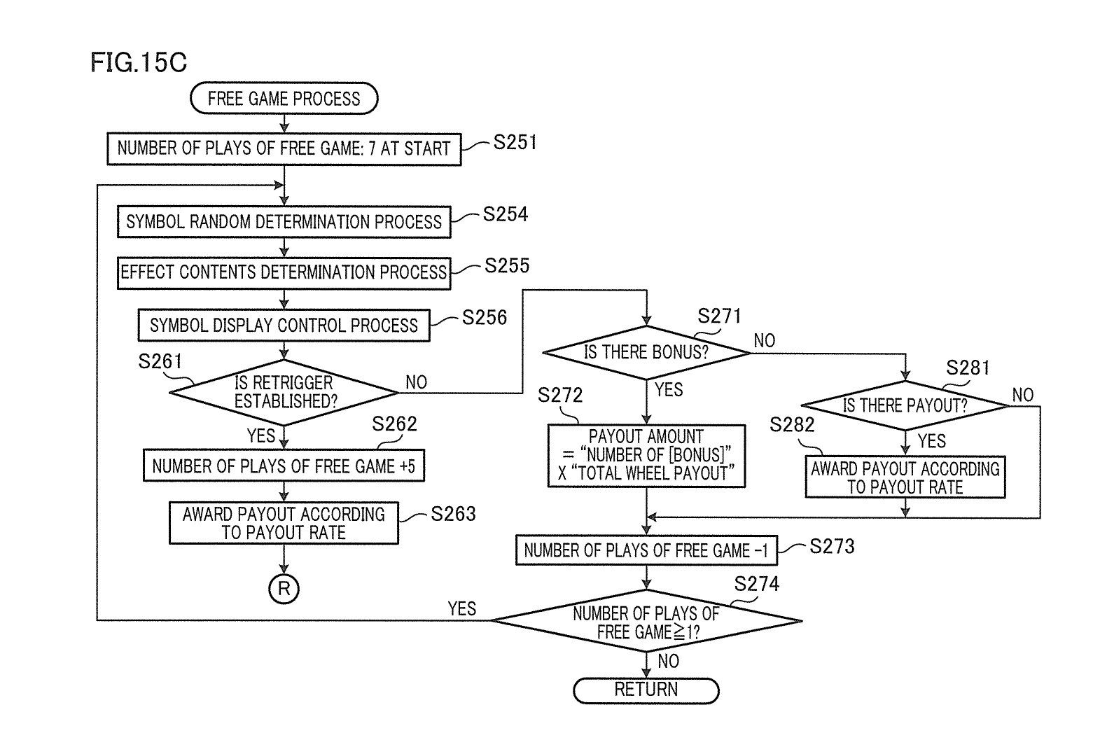

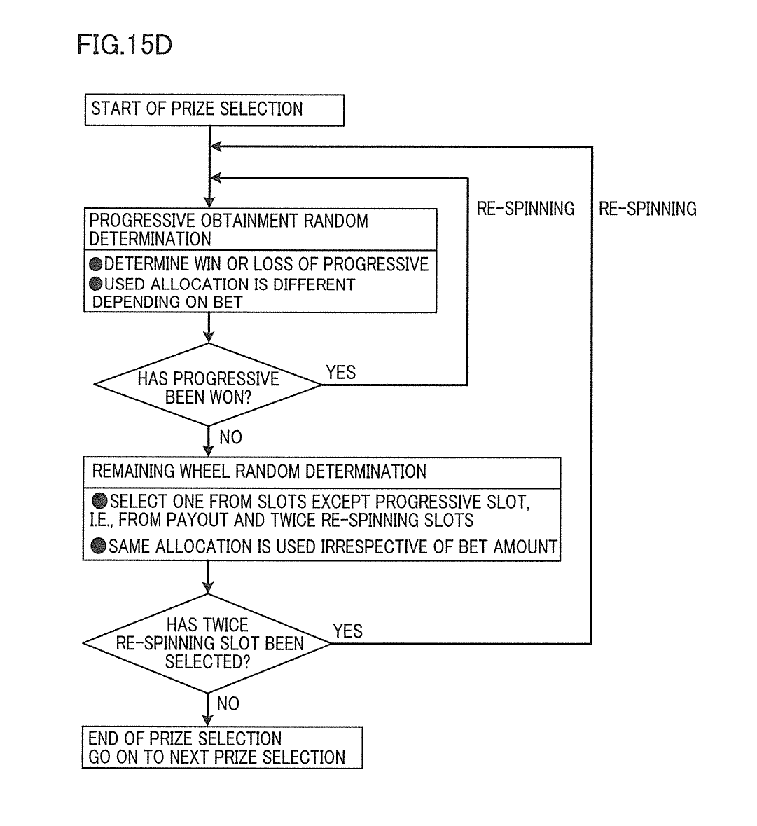

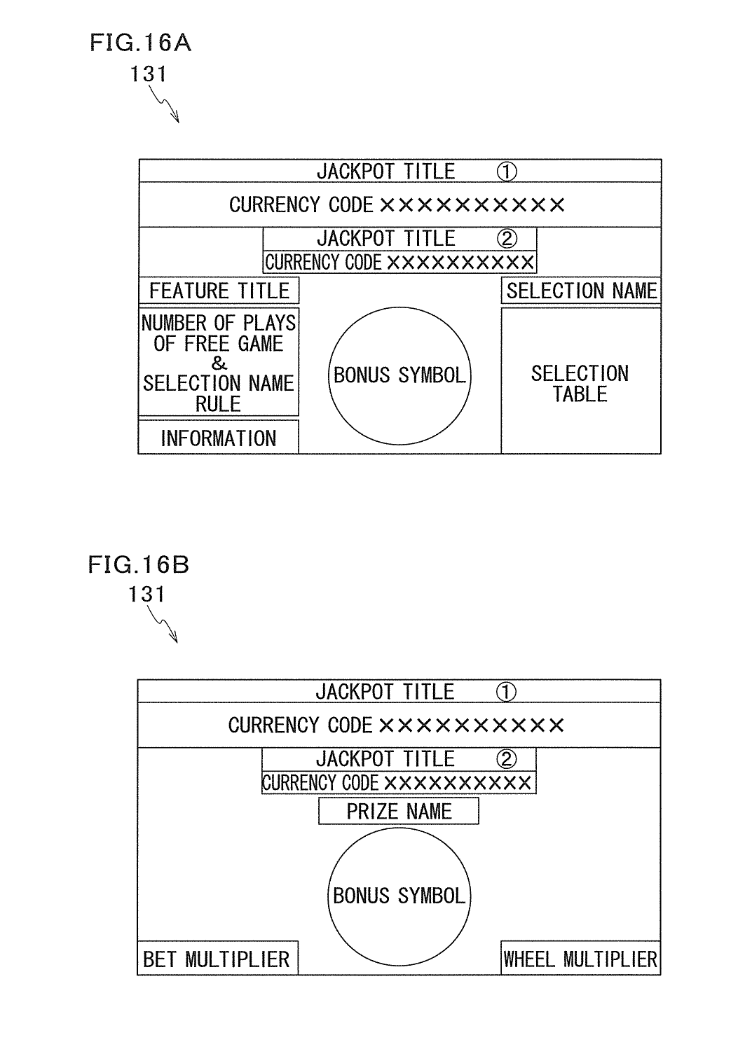

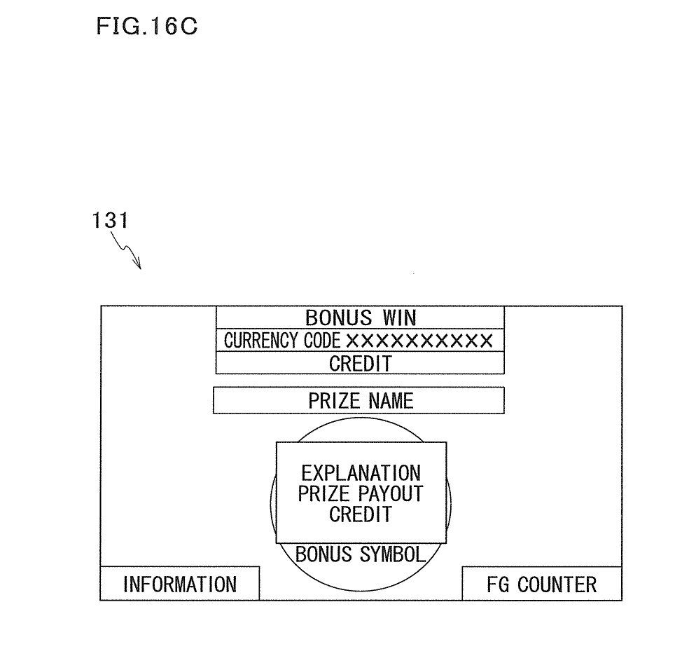

The basic structure of the display on the upper image display panel 131 of the gaming machine 2 (see FIG. 16A to FIG. 16C) is different from that in the first embodiment. Further, the gaming machine 2 is different from the gaming machine of the first embodiment in: settings of the bet buttons 34 to 38 (see FIG. 13A); the symbol arrangement (see FIG. 13B) on each of the reels 101 to 105; and the slot arrangement of the slots 202 of the wheel 201 (see FIG. 14A and FIG. 14B). Out of several types of games executed by the gaming machine 2, the base game is basically similar to that in the first embodiment; however, the feature game is totally different from that in the first embodiment (see FIG. 15A to FIG. 15C).

(Outline of Game)

FIG. 14F illustrates the outline of the flow of the game executed by the gaming machine 2. The game is implemented by hardware which is included in the gaming machine 2 and executes programs which will be described later. The game includes: the base game (G210) which is substantially similar to that in the first embodiment; and the feature game (G220) which is different from that in the first embodiment.

<Bet Amount>

FIG. 13A shows the relationship (relative relationship) between the bet buttons 34 to 38 and bet amounts. For example, in Configuration 2 (config 2), relative bet amounts of 1, 2, 3, 5, and 10 are respectively assigned to the bet buttons 34 to 38. In this embodiment, the minimum bet amount is 30. Thus, in Configuration 2, the bet amounts bet in response to the operations of the bet buttons 34 to 38 are respectively 30, 60, 90, 150, and 300. The maximum bet amount (Max Bet) is 300.

<Type of Symbols and the Like>

FIG. 13B illustrates the arrangement of the symbols 501 on each of the reels 101 to 105. The types of the symbols 501 are: “WILD”, “GOLD7”, “SILVER7”, “3BAR”, “2BAR”, “1BAR”, “BONUS”, and “BLANK”. The “WILD” symbol only exists in the second reel 102 and the fourth reel 104. The WILD symbol can be used as a substitute for any type of the symbol, except the BONUS symbol. When one “WILD” symbol exists on a payline, a payout for a line win (line payout) is twice as large as the basic payout for the case where no “WILD” symbol exists on a payline. When two “WILD” symbols exist on a payline, the line payout is four times as large as the basic payout. Winning determination for “GOLD 7” and “SILVER 7” symbols is made in the “Mixed” manner. Winning determination for “1BAR”, “2BAR”, and “3BAR” symbols is made in the “Mixed” manner. Each of the reels 101 to 105 has two BONUS symbols. There are 10 BONUS symbols in total. Maximum 10 BONUS symbols are displayed in the display window 150. The symbols other than the BONUS symbols are included in each of the reels 101 to 105.

The symbols 501 displayed in the display window 150 are randomly determined based on a base game reel weight table shown in FIG. 13C. This will be described later.

<Winning>

There are two winning types in the base game: line wins; and scattered wins, in the same manner as in the first embodiment. Whether the line win is achieved is determined in accordance with “LEFT TO RIGHT” based on the 30 paylines (see FIG. 5D), similarly to the winning determination in the first embodiment. The relationship between the types and number of arranged symbols and payouts are defined in a line payout table shown in FIG. 13E. The scattered win is achieved when five or more BONUS symbols are stopped. The payout provided by the scattered win is defined in the scatter payout table shown in FIG. 13F. To be more specific, in the scatter payout table, there are defined the relationship between the number of the BONUS symbols and the payout amount.

(Outline of Feature Game)

As shown in FIG. 14F, when the trigger condition is satisfied during the base game (G210), the feature game (G220) is awarded. The trigger condition for the feature game is satisfied when five or more BONUS symbols (specific symbols) are stopped (displayed in the display window 150). The feature game includes a wheel game (G230) and a free game (G240). In the wheel game (G230), a “payout amount per BONUS symbol” is determined. Then, the payout amount per BONUS symbol is paid out for each of the BONUS symbols selected in the free game (G240).

(Outline of Wheel Game)

The wheel game is executed on the wheel device M2, similar to the feature game in the first embodiment. In the wheel game, there is provided the wheel random determination, the number of plays of which corresponds to the number of the BONUS symbols displayed in the display window 150 (hereinafter, the number of plays of the wheel random determination is referred to as a “wheel random determination play number”) when the trigger condition is satisfied (G231 in FIG. 14F). A game result in the wheel game is obtained in accordance with a slot 202 selected in the wheel random determination (G232 in FIG. 14F). In the wheel random determination, one of the slots 202 is selected through random determination on the basis of the tables respectively shown in FIG. 14B, FIG. 14D, and FIG. 14E.

<Slot Arrangement>

FIG. 14A and FIG. 14B each shows slot arrangement. The slot arrangement is constituted by 22 slots 202 respectively corresponding to code numbers “0” to “21”. There are plural types of slots 202: payout slots (corresponding to the payout slots 202b in FIG. 1); progressive slots; and re-spinning slots (repeat random determination slots) (corresponding to the multiplier upgrade slots 202a in FIG. 1). The number of the payout slots (CREDIT) is 18. There payout slots are of plural types: “15”, “20”, “25”, “30”, “40”, “50”, “60”, “75”, “100”, “150”, “200”, “500”, and “1000”, for example. Note that there are two slots of “15”, two slots of “20”, and three slots of “100”. The number of the progressive slots is 2. The types of the progressive slots are: “GOLD JACKPOT” and “MINOR JACKPOT”. There are two “Twice Re-spinning” slots, which are the multiplier upgrade slots. The payout slots, the progressive slots and the multiplier upgrade slots have the same width in the radial direction of the wheel 201.

<Re-Spinning Slot>

As shown in FIG. 14F, when any of the re-spinning slots is selected in the wheel random determination (when a re-spinning slot is stopped), the “wheel multiplier” (initial value: 1) is increased. Specifically, the value of the wheel multiplier is multiplied by 2. When the re-spinning slot is stopped, the wheel random determination is performed again (repeat wheel random determination is performed). If the re-spinning is selected again and again, each time the re-spinning slot is selected, the wheel multiplier is increased from 1 to 2, 4, 8, 16, and so on. Note that the wheel multiplier is a multiplying factor by which the slot payout is multiplied. The below-described progressive payout is not multiplied by the wheel multiplier.

<Progressive Slot>

When any of the progressive slots is selected in the wheel random determination, the progressive payout is paid out, and the repeat wheel random determination is performed. However, the wheel multiplier is not increased.

<Payout Slot>

When any of the payout slots is selected in the wheel random determination, a “wheel payout per play” is determined (G233 in FIG. 14F), and the wheel random determination play number is decreased by 1. When the wheel random determination play number is equal to or larger than 1 (G234: YES); the next play of the wheel random determination is performed. When the wheel random determination play number becomes 0 (zero), a “total wheel payout” obtained by summing up the amounts of the “wheel payout per play” in all the plays (G235). The total wheel payout is equivalent to the payout amount per BONUS symbol.

(Outline of Free Game)

The free game (G240 of FIG. 14F) is a game played on the reel device M1, similarly to the base game (G210). When the free game is started (the first time the free game is played after the start of the feature game), seven plays of the free game (the number of plays of the free game: 7) are provided. In the free game, the symbols 501 displayed in the display window 150 are randomly determined based on a free game reel weight table shown in FIG. 13D. This will be described later.

<Explanation of Terms of Free Game>

The free game is a game runnable with a bet of fewer amounts of gaming values than in the base game. Note that the “bet of fewer amounts of gaming values” encompasses a bet of 0 gaming value. In other words, the free game may be a game which starts without consumption of a gaming value. To be more specific, the free game may be a game runnable without a bet of a gaming value, which free game awards an amount of gaming values based on symbols rearranged. The free game in this embodiment is a game run with a bet amount of 0. In contrast to the free game, the base game (normal game) is a game which starts on the premise that a gaming value is consumed. To be more specific, the “base game” is a game runnable on condition that a gaming value is bet, which base game awards an amount of gaming value based on the symbols rearranged.

<Payout, Retrigger>

As shown in FIG. 14F, when 5 or more BONUS symbols are stopped in the free game (G240), a retrigger is established (G241: YES). When the retrigger is established, 5 is added to the number of plays of the free game, and the wheel game is executed again. Further, the “payout per BONUS symbol” determined in the wheel game after the retrigger is added to the “payout per BONUS symbol” determined in the wheel game before the retrigger. When 1 to 4 BONUS symbols are stopped in the free game, the amount corresponding to the “total wheel payout” (“payout amount per BONUS symbol”) determined in the wheel game is paid out for each BONUS symbol (a second specific symbol) stopped (G242). When the number of plays of the free game is equal to or more than 1, the next play of the free game is started (G243: YES). When the number of plays of the free game is 0 (zero) (G243: NO), the feature game ends, and the game returns to the base game (G210).

(Basic Structure of Screen Display)

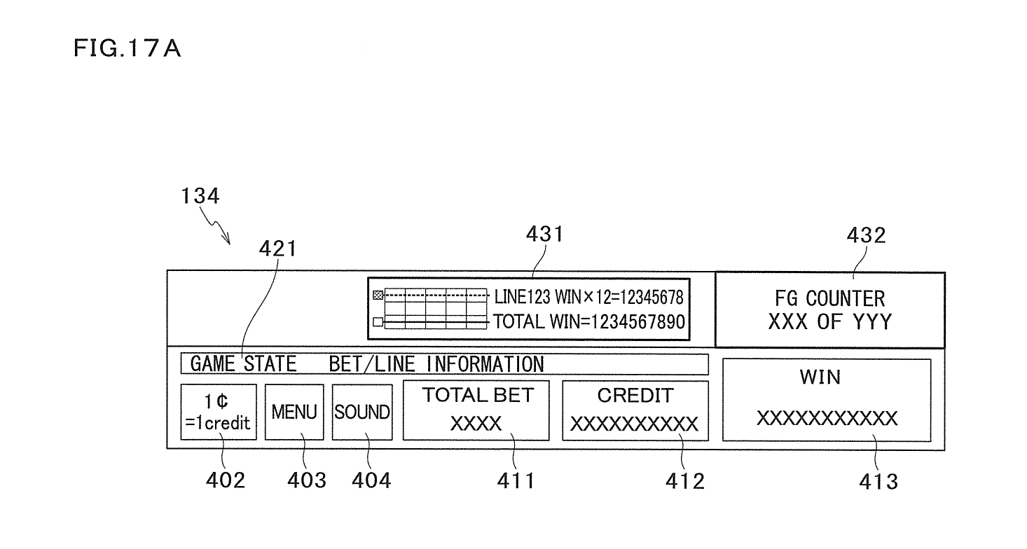

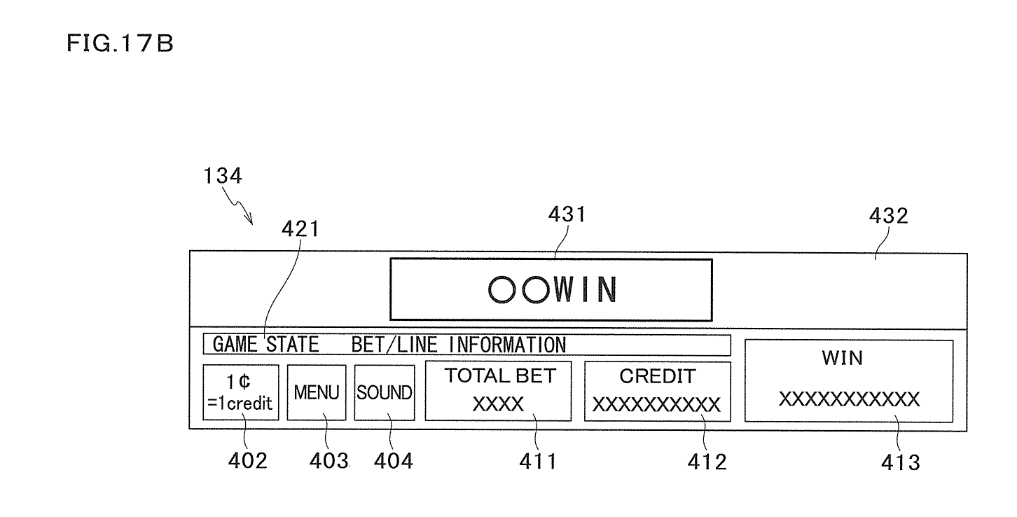

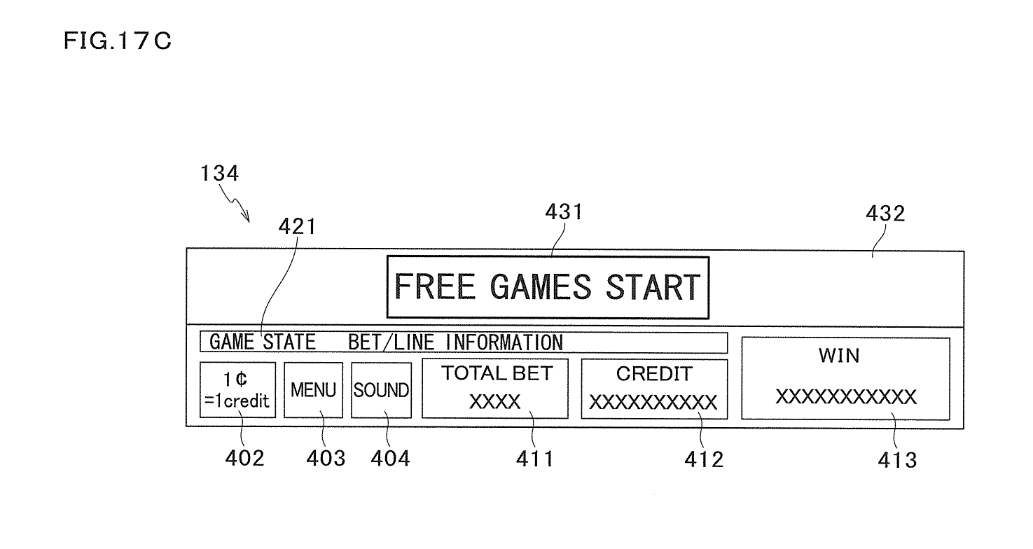

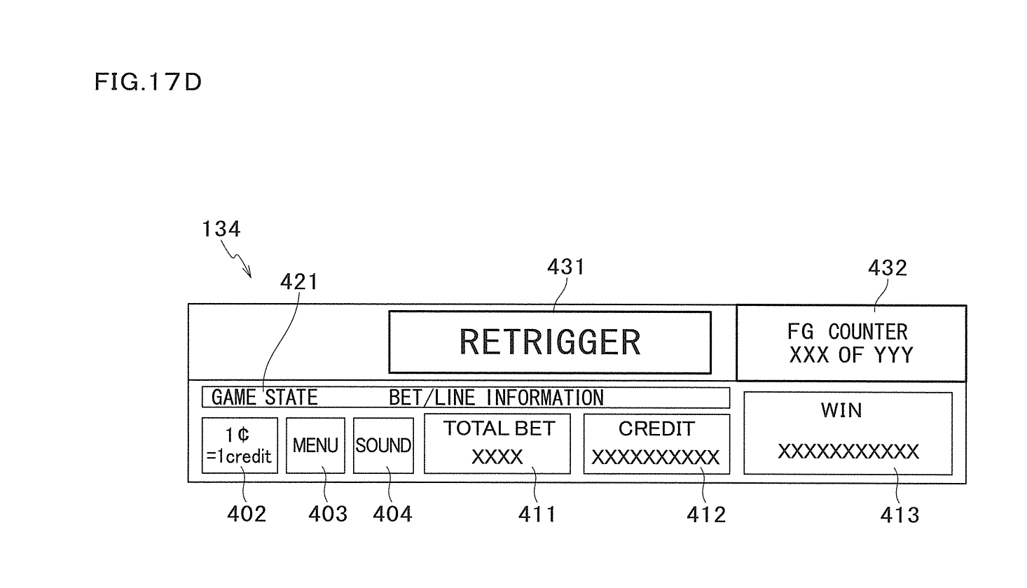

The basic structure of the screen display on the liquid crystal display device 134 (see FIG. 10A) is similar to that in the first embodiment. In the upper middle display region 431, texts different from the those displayed in the first embodiment may be displayed (see FIG. 17B to FIG. 17D) (details thereof will be described later). In the upper right display region 432, an FG counter, which is not displayed in the first embodiment may be displayed (see FIG. 17A) (details thereof will be described later).

The basic structure of the screen display on the upper image display panel 131 (see FIG. 16A) is different from that in the first embodiment. Displays for the base game, for the wheel game in the feature game, and for the free game in the feature game, which are provided on the upper image display panel 131, are different from one another.

<2nd Screen for Normal Situation>

FIG. 16A shows the display on the upper image display panel 131 while the base game is executed (display during the base game). During the base game, the upper image display panel 131 displays, in an upper area of the screen, titles (jackpot titles in FIG. 16A) and payout amounts (e.g., 3-letter currency code and maximum 10-digit number) of the two types of progressive payout. The displayed titles are “GOLD JACKPOT”, and “MINOR JACKPOT”, in this order from the top. At the same time, the upper image display panel 131 displays, in a central to central lower area on the screen, the BONUS symbol (e.g., an image).

In the base game, the upper image display panel 131 displays, in a left area on the screen, the title of the feature game (FEATURE TITLE). Specifically, the upper image display panel 131 displays the text of “GOLD WHEEL BONUS”. At this time, the upper image display panel 131 displays, in the left area of the screen (below the title of the feature game), the number of plays of the free game, a selection name, and rules. Specifically, the following texts are displayed: “7 FREE GAMES” (when the number of plays of the free game is 7); “GOLD PRIZE SELECTION”; and “GOLD PRIZE will be selected before free games.”, in this order from the top.

In the base game, the upper image display panel 131 displays information (INFORMATION) in the lower left area on the screen. The information will be detailed later. To put it simply, it is information related to the number of BONUS symbols displayed in the display window 150, and information related to the wheel random determination play number. Specifically, the displayed information is, for example, “5 or more [BONUS] trigger GOLD WHEEL BONUS.”, “GOLD PRIZE selection occurs on the wheel.”, “2 more [BONUS] for the BONUS.”, “1 more [BONUS] for the BONUS.”, “GOLD WHEEL BONUS”, and the like. The upper image display panel 131 displays these texts in a loop manner (i.e., repeatedly one after another).

In the base game, the upper image display panel 131 displays, in the right area on the screen, the selection name. Specifically, the upper image display panel 131 displays the text of “GOLD PRIZE SELECTION”. At this time, the upper image display panel 131 displays a selection table in a lower right area on the screen. The selection table shows the relationship between the number of BONUS symbols displayed in the display window 150 and the wheel random determination play number. Specifically, the selection table includes, for example, the following texts: “10 [BONUS] 7 SELECTIONS”, “9 [BONUS] 5 SELECTIONS”, “8 [BONUS] 4 SELECTIONS”, “7 [BONUS] 3 SELECTIONS”, “6 [BONUS] 2 SELECTIONS”, and “5 [BONUS] 1 SELECTION”, in this order from the top.

<2nd Screen for Wheel Game>

FIG. 16B shows the screen display on the upper image display panel 131 at the time when the wheel game of the feature game is executed (screen display in the wheel game of the feature game). In the wheel game, the upper image display panel 131 displays, in the same manner as in the base game, the titles and payout amounts of the 2 types of progressive payout in the upper area on the screen. At this time, the upper image display panel 131 displays, in the central area on the screen, a prize name (e.g., the name of the wheel game which is a prize). Specifically, the upper image display panel 131 displays the text of “GOLD PRIZE”. At this time, the upper image display panel 131 displays, in the central to central lower area on the screen, the BONUS symbol (e.g., an image). At this time, the upper image display panel 131 displays a bet multiplier (e.g. a maximum 2-digit number) in the lower left area on the screen. At this time, the upper image display panel 131 displays, in the lower right area on the screen, a wheel multiplier (WHEEL MULTIPLIER) (e.g., a maximum 2-digit number).

<2nd Screen for Free Game>

FIG. 16C shows the screen display on the upper image display panel 131 at the time when the free game of the feature game is executed (screen display in the free game of the feature game). At this time, the upper image display panel 131 displays, in the upper area on the screen, “BONUS WIN”, a payout amount provided by the free game (a maximum 10-digit numerical value), and credits (e.g. “CREDITS”), in this order from the top. At this time, the upper image display panel 131 displays, in the central area on the screen, the prize name. Specifically, the upper image display panel 131 displays the text of “GOLD PRIZE”. At this time, the upper image display panel 131 displays, in the central (below the prize name) to the central lower area on the screen, the BONUS symbol and an “explanation”. The explanation is about a payout amount per BONUS symbol. Specifically, the explanation includes: “Award for one [BONUS]”; the payout amount per BONUS symbol (maximum 6-digit number) (“PRIZE PAYOUT” in the figure); and “CREDITS” (“CREDITS” in the figure), in this order from the top.

In the free game, the upper image display panel 131 displays information in the lower left area on the screen. The information is, for example, information in accordance with the number of the BONUS symbols displayed in the display window 150. Specifically, examples of the information include: “5 or more [BONUS] retrigger 5 free games.”, “Additional GOLD PRIZE SELECTION if retriggered.”, “2 more for the RETRIGGER.”, “1 more for the RETRIGGER.”, and “GOLD WHEEL BONUS RETRIGGERED.” The upper image display panel 131 displays these texts in a loop manner (repeatedly one after another).

In the free game, the upper image display panel 131 displays, in the lower right area on the screen, the free game counter (FG counter) which indicates the remaining number of plays of the free game. Specifically, the upper image display panel 131 displays the text of “FREE GAME XX OF XX”.

(Contents of Program)

Now, the program to be executed by the gaming machine 2 and the like are described about the difference between the first and second embodiments, mainly with reference to FIG. 15A to FIG. 15C. The main CPU 71 executes the main control process (see FIG. 7A), which is substantially similar to that in the first embodiment. In the symbol random determination process (Step S14), the base game reel weight table shown in FIG. 13C is used. In the awarded credit amount determination process (Step S17), an amount of payout to be paid out is determined based on the payout tables shown in FIG. 13E and FIG. 13F. The amount of the payout awarded when 5 or more BONUS symbols are stopped is obtained by multiplying the corresponding numerical value shown in FIG. 13F by a bet amount (total bet). For example, when the bet amount is 50 credits and 6 BONUS symbols are stopped (the numerical value corresponding 6 BONUS symbols is 2 in the figure), the amount of the payout is 100 credits.

<Screen Display for Base Game>

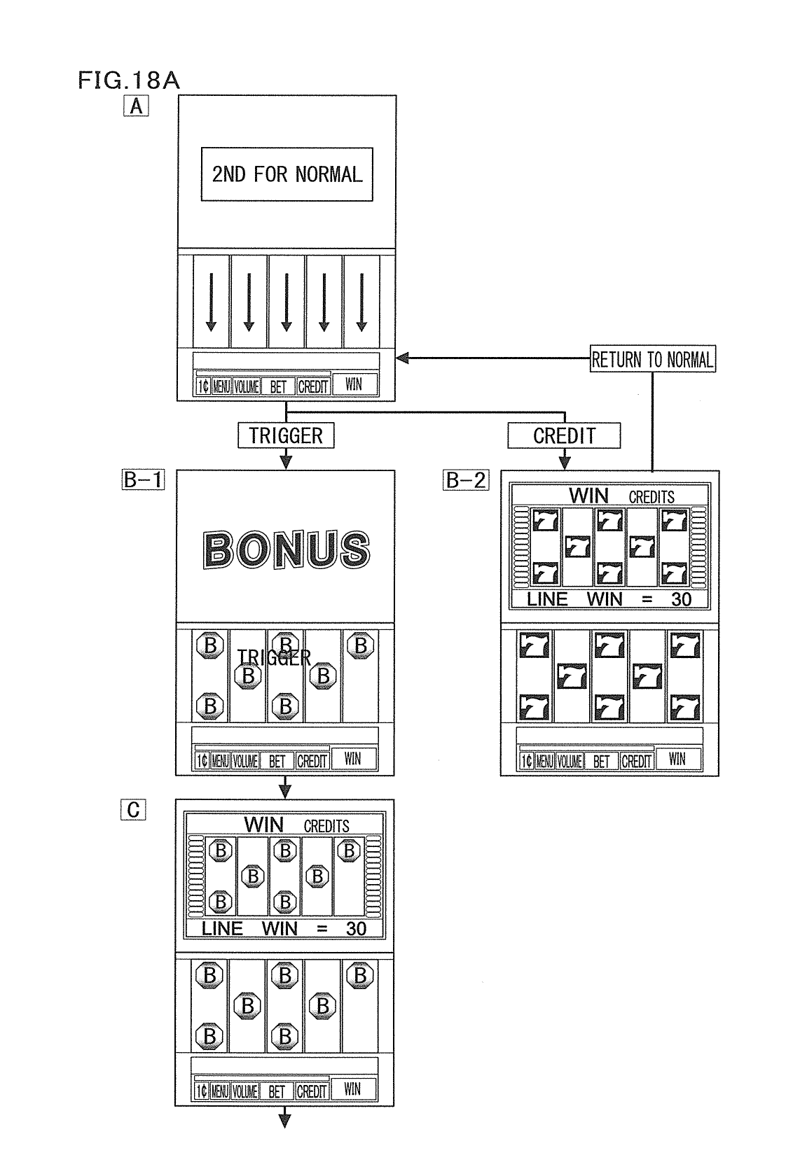

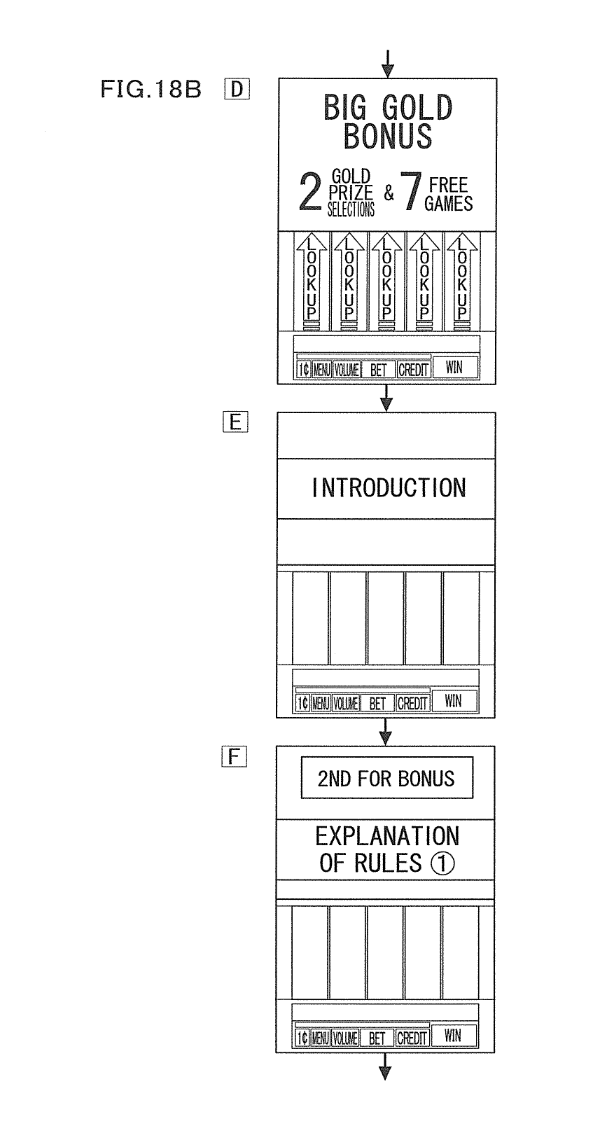

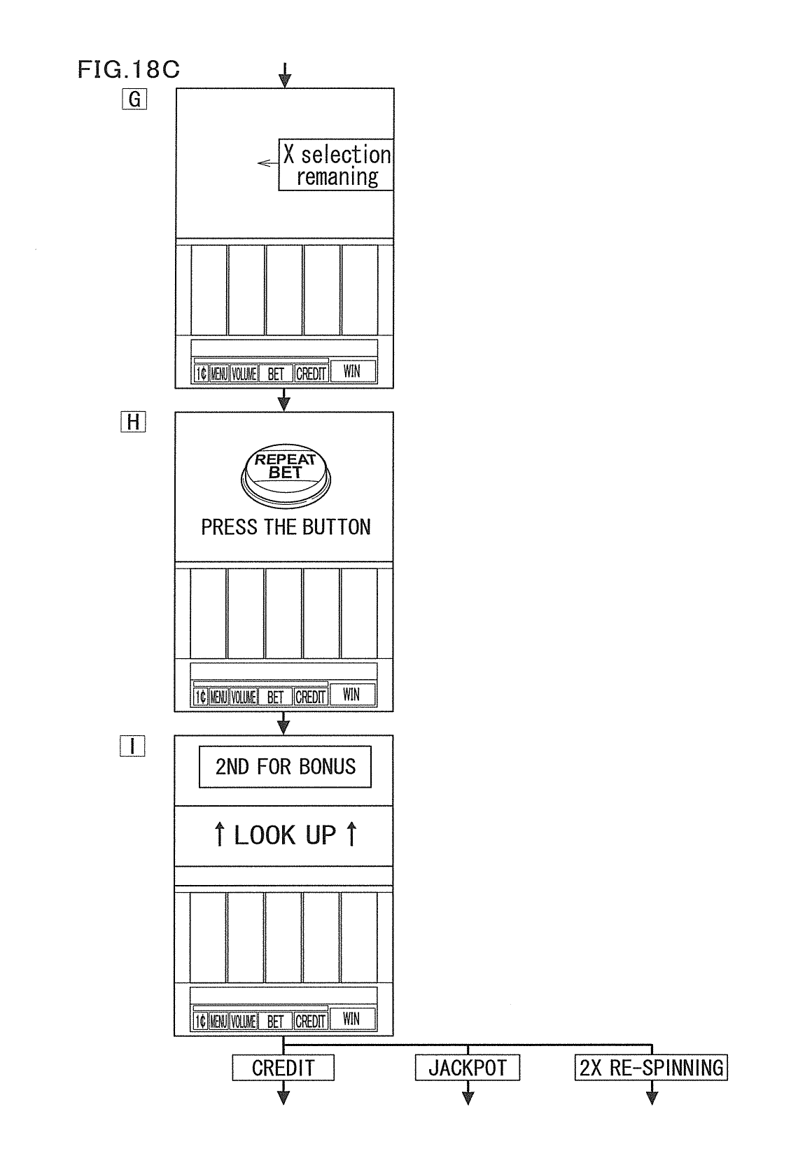

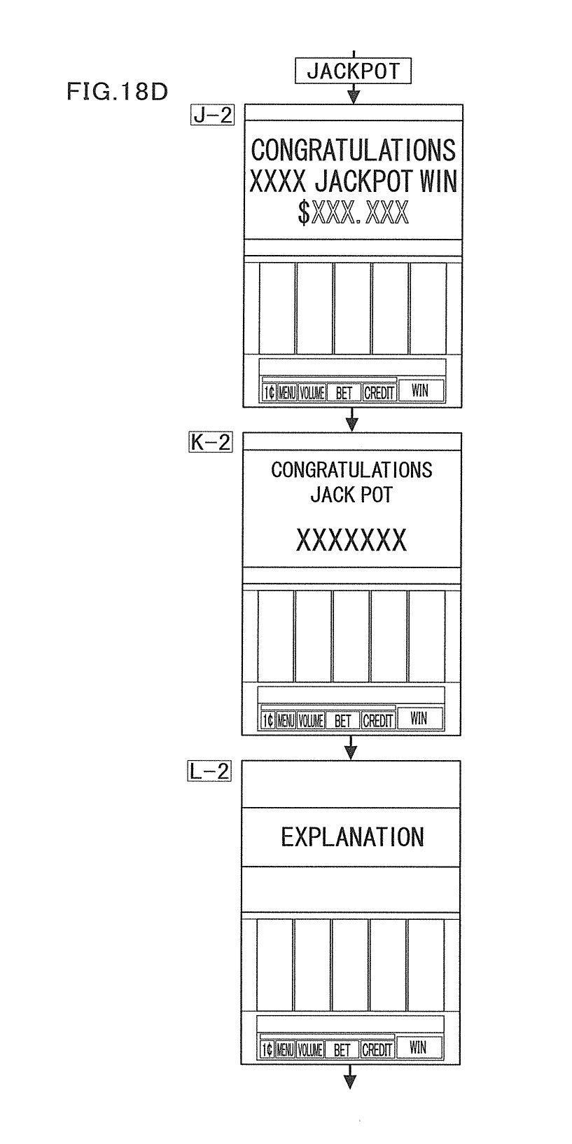

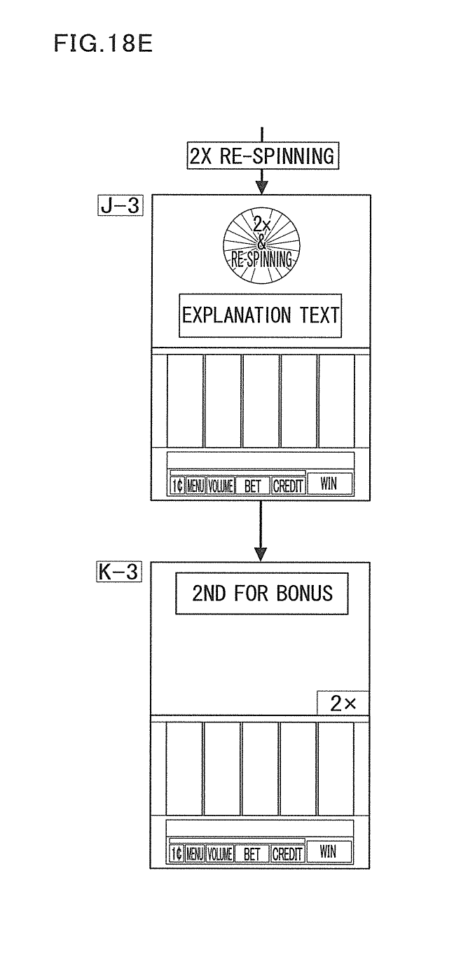

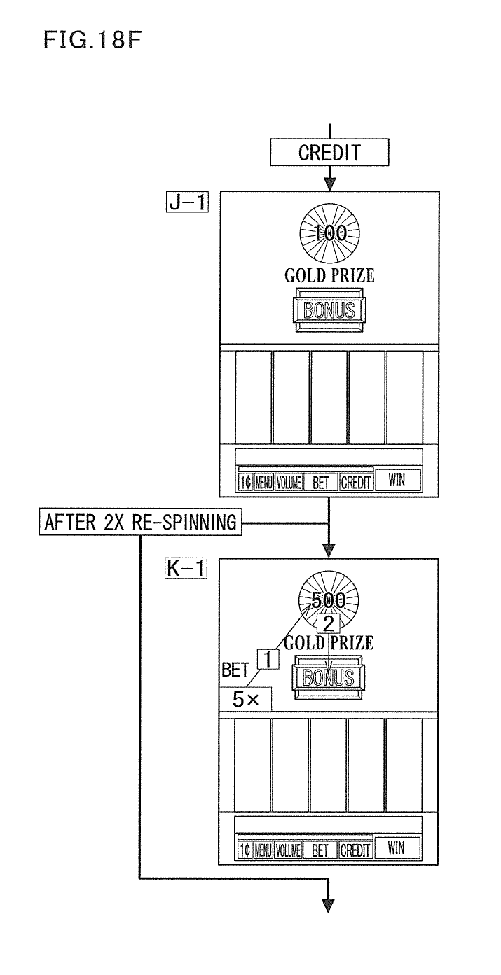

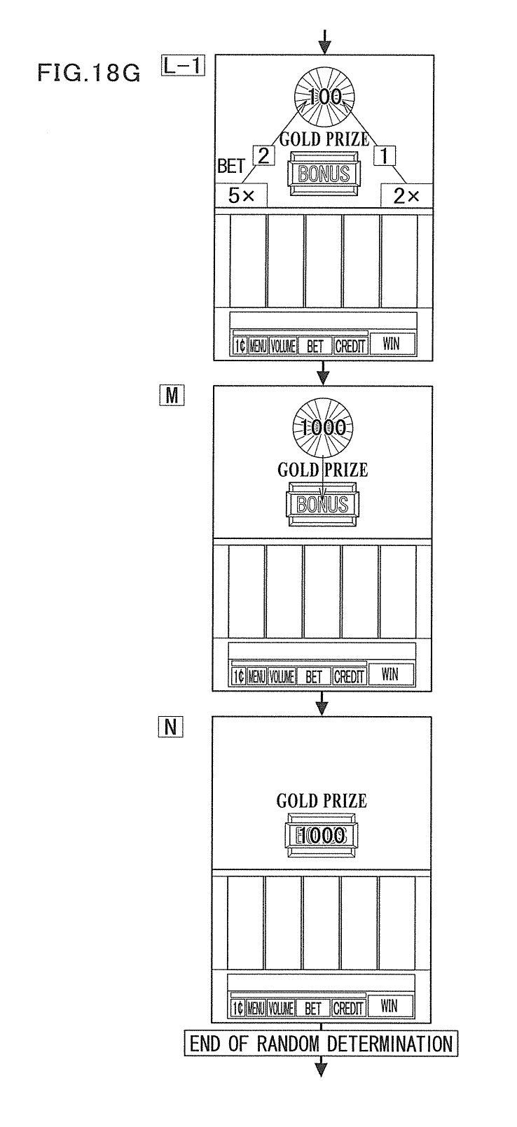

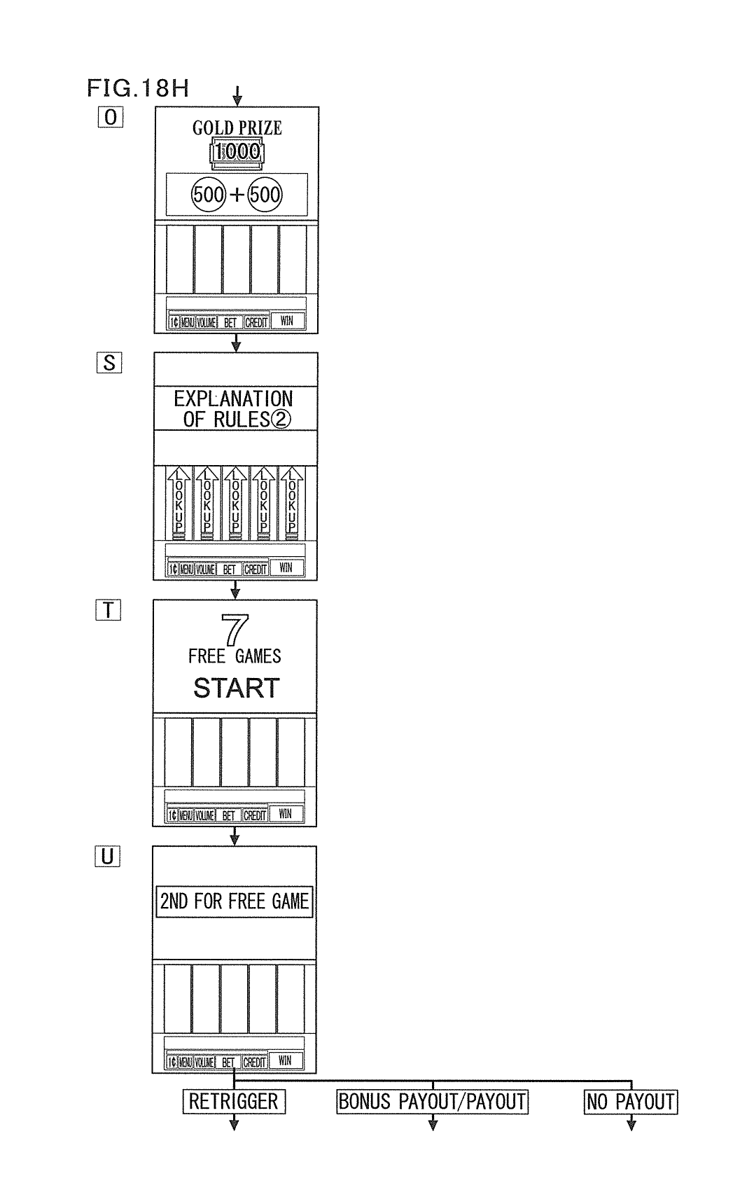

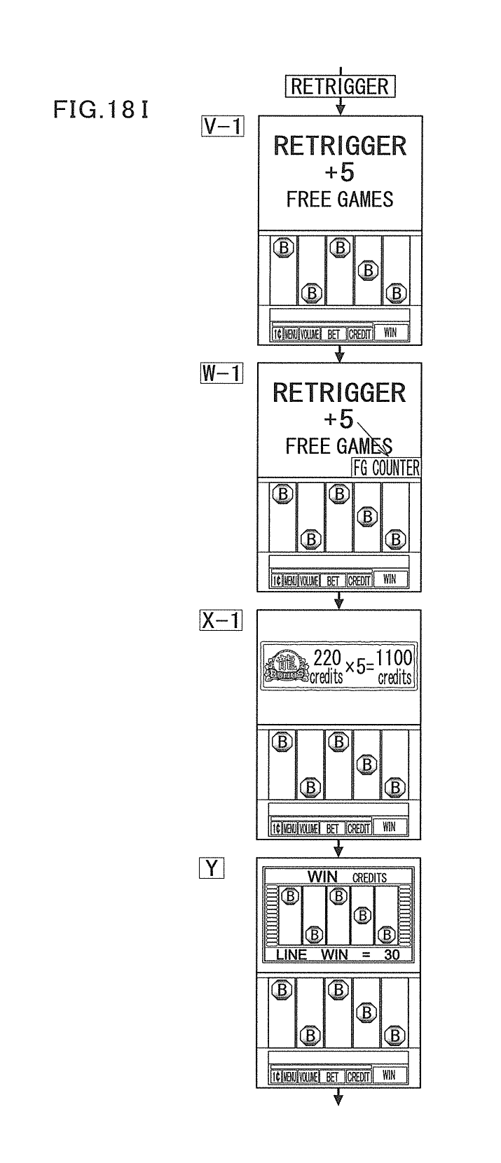

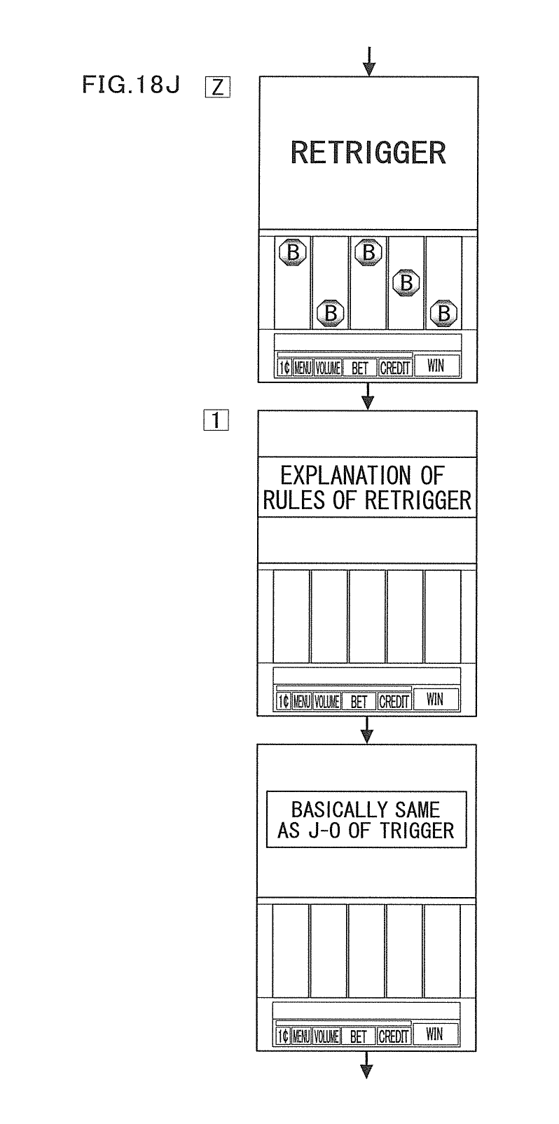

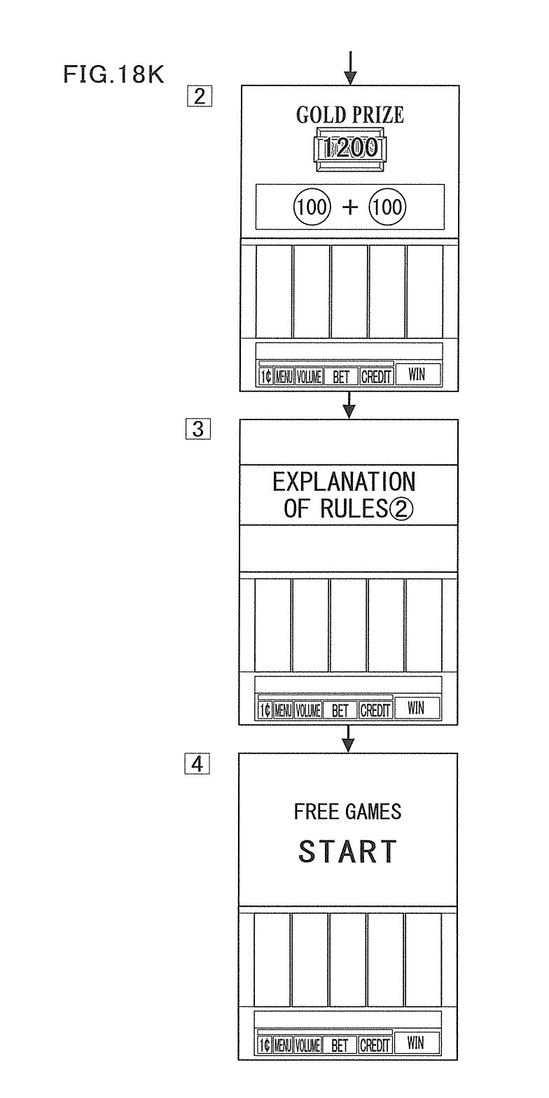

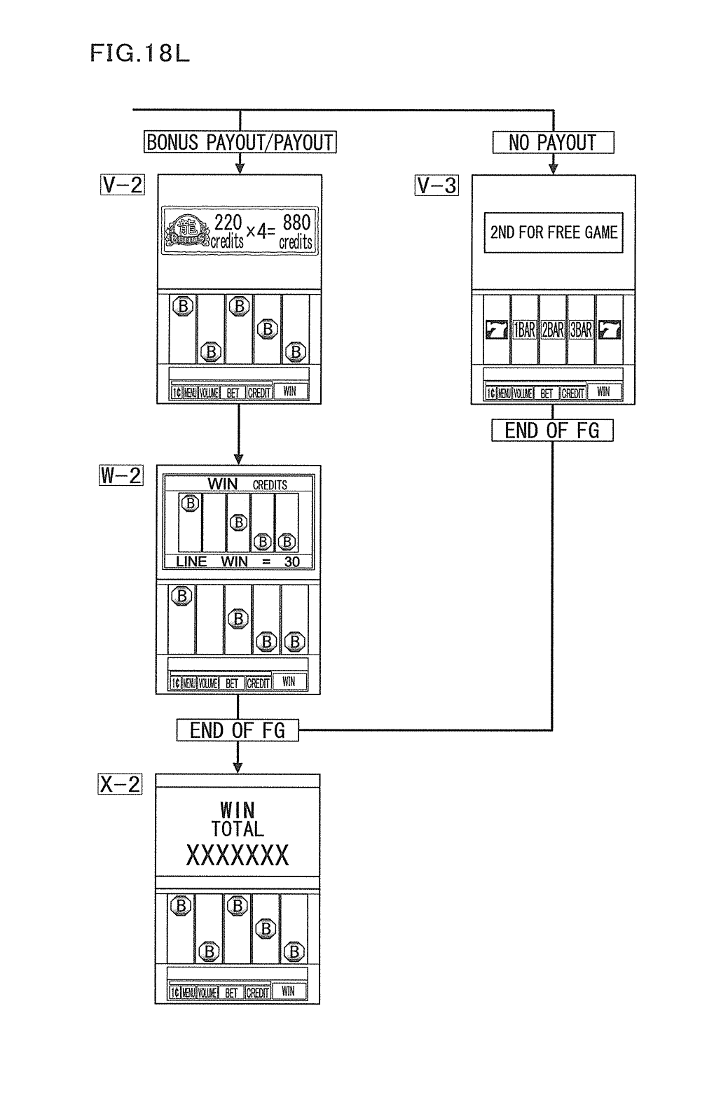

A in FIG. 18A shows the screen display for the normal situation in the base game. At this time, the upper image display panel 131 displays the 2nd screen for normal situation (see FIG. 16A). B-2 in FIG. 18A shows the screen display at the time when a win occurs in the base game (this is similar to that in the first embodiment).

<Screen Display when Trigger Occurs>

B-1 in FIG. 18A shows the screen display at the time when a feature game trigger condition is satisfied (when a trigger occurs) in the base game. At this time, the upper image display panel 131 displays: a background screen for the normal situation in the base game (2nd screen for normal situation); and the text of “BONUS”. The text of “BONUS” is displayed at the same time when the last reel (the reel which is stopped last among the reels 101 to 105) stops. At this time, the liquid crystal display device 134 (e.g. the upper middle display region 431) displays the text of “BONUS”.

Then, as shown in C in FIG. 18A, the upper image display panel 131 displays: the 2nd screen for normal situation as a background; and the win signboard (similarly to the first embodiment). The display of the win signboard can be skipped (for example, it is possible to skip the display of the win signboard in response to an operation by the player). At this time, the upper middle display region 431 of the liquid crystal display device 134 displays the line win signboard, the contents of which correspond to the payout amount at the time when the trigger occurs (see FIG. 10B).

Then, after displaying the screen shown in C in FIG. 18A (after displaying the win signboard), the upper image display panel 131 displays: the feature title; the wheel random determination play number (the number of selections); and the number of plays of the free game, as shown in D in FIG. 18B. The feature title is, for example, “BIG GOLD BONUS”. While the upper image display panel 131 displays the feature title, the upper middle display region 431 of the liquid crystal display device 134 also displays the feature title (for the same display time). After the feature title and the like are displayed on the upper image display panel 131, the main CPU 71 provides an effect using LEDs in the display window 150. Specifically, the main CPU 71 reproduces the effect only using the LEDs for the display of “LOOK UP!”. After turning on the LEDs, the main CPU 71 turns off the reels 101 to 105. After the upper middle display region 431 of the liquid crystal display device 134 displays the feature title, the upper middle display region 431 displays the text of “LOOK UP” (see FIG. 10E). The liquid crystal display device 134 keeps displaying the text of “LOOK UP” until this turns to the text of “SPIN THE WHEEL” as described below.

Subsequently, as shown in E in FIG. 18B, the upper image display panel 131 displays an introduction (reproduces video, images, or the like).

Then, as shown in F in FIG. 18B, the background on the upper image display panel 131 changes from the 2nd screen for normal situation to a 2nd screen for wheel game (“2nd for BONUS”). At this time, the upper image display panel 131 displays an explanation for rules (1) of the feature game (this can be skipped).

After displaying the explanation for the rules (1), the upper image display panel 131 displays “X selection remaining” (X is a numerical value) with animation so that the text slides from a right portion of the screen toward the left, as shown in G in FIG. 18C.

After displaying “X selection remaining”, the upper image display panel 131 displays an image of a button in the central portion on the screen, as shown in H in FIG. 18C. At this time, the upper image display panel 131 displays the text of “PRESS THE BUTTON TO SPIN THE WHEEL” below the image of the button (at a position lower than the image). While this text is displayed, the upper middle display region 431 of the liquid crystal display device 134 displays the text of “SPIN THE WHEEL”.

(Feature Game Process)

As shown in FIG. 15A, the main CPU 71 executes the feature game process which is different from that in the first embodiment. When the feature game process is executed, the main CPU 71 first executes a wheel game process (Step S210), and then executes a free game process (Step S250). Then, the main CPU 71 terminates the feature game process.

(Wheel Game Process)

Referring to FIG. 15B, the wheel game process will be described. To begin with, when the wheel game process is executed, the main CPU 71 executes a wheel random determination play number determination process to determine the wheel random determination play number (Step S211). The wheel random determination play number is determined depending on the number of the BONUS symbols displayed in the display window 150 when the trigger condition is satisfied in the base game (and is awarded to the player). Specifically, if the number of BONUS symbols displayed in the display window 150 when the trigger condition is satisfied is 10, the awarded wheel random determination play number is 7. In the same manner, the wheel random determination play number for 9 BONUS symbols is 5, the number for 8 BONUS symbols is 4, the number for 7 BONUS symbols is 3, the number for 6 BONUS symbols is 2, and the number for 5 BONUS symbols is 1.

The main CPU 71 executes the check-process (Step S213) similarly to Step S113 (see FIG. 7D) in the first embodiment.

Subsequently, the main CPU 71 executes the wheel random determination (Step S214). As shown in FIG. 15D, similarly to the first embodiment, the wheel random determination (“PRIZE SELECTION” in the figure) is performed in two stages: the progressive obtainment random determination; and the remaining wheel random determination. Similarly to the first embodiment, the progressive obtainment random determination is performed in two stages: the obtainment random determination (see FIG. 14D) and the level random determination (see FIG. 14E). In the obtainment random determination, win or loss is randomly determined on the basis of an obtainment random determination table shown in FIG. 14D. The obtainment random determination table is different from that of the first embodiment (see FIG. 6F), and is set so that the larger (higher) the bet amount is, the higher the probability that the win is selected. For example, when the bet amount is the minimum bet amount (“1” in this figure, the probability that the win is selected is 24/3200. When the bet amount is twice the minimum bet amount (“2” in this figure), the probability that the win is selected is 48/3224. The level random determination is performed when the win is selected in the obtainment random determination. In the level random determination, the level of the progressive payout is selected based on a level random determination table shown in FIG. 14E. Specifically, one of the levels of “GOLD” and “MINOR” is selected. Note that FIG. 14D and FIG. 14E each is the table for the minor setting V01. Illustration of the tables for the other minor settings is omitted.

Similarly to the first embodiment, in the remaining wheel random determination shown in FIG. 15D, one slot is selected from a group constituted by the payout slots and the re-spinning slots. The remaining wheel random determination is performed based on a wheel random determination table shown in FIG. 14B.

Then, the main CPU 71 determines contents of the effect in the effect contents determination process (Step S215), as shown in FIG. 15B (similarly to Step S115 in the first embodiment). Then, the main CPU 71 executes the wheel operation control process (Step S216) to control the operation of the wheel 201 (similarly to Step 116 in the first embodiment).

<Screen Display during Spin of Wheel>

I in FIG. 18C shows the screen display during the spin of the wheel 201. At this time, the upper image display panel 131 displays: the 2nd screen for wheel game (“2nd for BONUS”); and the text of “LOOK UP”. While the upper image display panel 131 displays the text of “LOOK UP”, the upper middle display region 431 of the liquid crystal display device 134 displays the text of “LOOK UP”.

<When Progressive Slot is Stopped>

Then, the main CPU 71 determines whether any of the progressive slots is selected in the wheel random determination (Step S214), as shown in FIG. 15B (Step S221). When any of the progressive slots is selected in the wheel random determination (S221: YES), the main CPU 71 pays out the progressive payout, the amount of which corresponds to the level selected in the level random determination (Step S222). The amount of the progressive payout to be paid out (progressive winning amount) is the sum of a jackpot amount (fixed payout) and an increment amount. The jackpot amount (fixed payout) is defined in the column of “initial value (in credits)” in FIG. 14C. In the first embodiment, the increment amount is the sum of the accumulation amount and the progressive initial amount. However, in the present embodiment, the increment amount is equal to the accumulation amount. The amount to be accumulated in each play is determined based on the bet amount, taking into consideration the increment rate and the set denomination. The increment rate is set in FIG. 14C.

<Screen Display when Progressive Slot is Stopped>

J-2 in FIG. 18D shows the screen display at the time when a progressive slot is selected in the wheel random determination and the progressive slot is stopped at the wheel predetermined position. At this time, the upper image display panel 131 displays an indication of the winning of the progressive payout. To be more specific, the upper image display panel 131 displays the text of “GOLD JACKPOT” or “MINOR JACKPOT”, which is the title of the progressive payout selected in the level random determination (“GOLD” or “MINOR”). Further, the upper image display panel 131 displays the amount of the progressive payout obtained by the player (to be paid out to the player). At this time, the liquid crystal display device 134 displays the title of the won progressive payout, as shown in FIG. 17B. Note that two circles in FIG. 17B represent the title of the progressive payout. At this time, the liquid crystal display device 134 does not have to display the credit amount (or amount) of the progressive payout.

Subsequently, as shown in K-2 in FIG. 18D, the upper image display panel 131 displays the congratulation signboard (similarly to the first embodiment). At this time, the liquid crystal display device 134 displays the title of the won progressive payout.

<Repeat Wheel Random Determination>

Subsequently, the main CPU 71 performs a repeat wheel random determination, as shown in FIG. 15B. To be more specific, after executing the start-check process (returning to Step S213), the main CPU 71 executes the wheel random determination process (Step S214). At this time, as shown in L-2 in FIG. 18D, the upper image display panel 131 displays an explanation text indicating that “random determination is made again”. At this time, the liquid crystal display device 134 displays the text of “LOOK UP”. Then, the screen display is returned to the display shown in H in FIG. 18C.

<When Re-Spinning Slot is Stopped>

As shown in FIG. 15B, when none of the progressive slots is selected in the wheel random determination (Step S214) (S221: NO), the main CPU 71 determines whether any of the re-spinning slots is selected in the wheel random determination (Step S231). When any of the re-spinning slots is selected in the wheel random determination (S231: YES), the wheel multiplier is multiplied by a predetermined multiplying value (Step S232). The value of the wheel multiplier (initial value) at the start of the feature game is 1. The predetermined multiplying value is 2. In a modification, the predetermined multiplying value may be a value which is not 2. Subsequently, the main CPU 71 executes the repeat wheel random determination. To be more specific, after executing the start-check process (returning to Step S213), the main CPU 71 executes the wheel random determination process (Step S214).

<Screen Display when Re-Spinning Slot is Stopped>

J-3 in FIG. 18E shows the screen display at the time when a re-spinning slot is selected in the wheel random determination and the selected re-spinning slot is stopped at the wheel predetermined position. At this time, the upper image display panel 131 displays: an image of the surface of the wheel; and an explanation text displayed below the image, as shown in J-3 in FIG. 18E. At this time, the upper image display panel 131 indicates: re-spinning of the wheel 201; and doubling of the wheel multiplier. Specifically, the upper image display panel 131 displays the text of “2× & RE-SPINNING”. While the upper image display panel 131 displays the image of the surface of the wheel (while the upper image display panel 131 displays the text of “MULTIPLIER UP”), the upper middle display region 431 of the liquid crystal display device 134 displays the text of “MULTIPLIER UP” (for the same display time) (see FIG. 10F).

Then, after displaying the image of the surface of the wheel and the explanation text, the upper image display panel 131 displays, in the lower right portion on the screen, the wheel multiplier (WHEEL PRIZE MULTIPLIER), as shown in K-3 in FIG. 18E. Specifically, the upper image display panel 131 displays “2×” (the multiplying factor is stored). At this time, the upper image display panel 131 displays the 2nd screen for wheel game (“2nd for BONUS”) as a background. At this time, the upper middle display region 431 of the liquid crystal display device 134 displays the text of “MULTIPLIER UP” (see FIG. 10F). Then, the screen display is returned to the display shown in H in FIG. 18C.

<When Payout Slot is Stopped>

As shown in FIG. 15B, when any of the payout slots is selected in the wheel random determination (Step S214) (S221: NO, S231: NO), the main CPU 71 determines a “wheel payout per play” (Step S241). The wheel payout per play is the product of: the amount of the slot payout (the value corresponding to the selected payout slot); and the wheel multiplier. Then, the main CPU 71 adds the amount of the wheel payout per play for the current play to the sum of the amounts of the wheel payout per play up to the last play. The value obtained by the above addition becomes a new value for the sum of the amounts of the wheel payout per play up to the last play (i.e., the value is updated). During the period from the start of the feature game to the first-time execution of Step S241, the value of the sum of the amounts of the wheel payout per play up to the last play is 0 (zero).

Subsequently, the main CPU 71 changes (returns) the value of the wheel multiplier to 1 (Step S243). Subsequently, the main CPU 71 subtracts 1 from the wheel random determination play number (Step S245). Then, the main CPU 71 determines whether the wheel random determination play number is equal to or more than 1 (whether the wheel random determination play number is zero or not) (Step S245). When the wheel random determination play number is equal to or more than 1 (S245: YES), the main CPU 71 starts the next play of the wheel random determination (the processing returns to Step S213 and Step 214). When the wheel random determination play number is 0 (zero) (S245: NO), the main CPU 71 ends the wheel game process. The total sum of the amounts of “wheel payout per play” obtained in the processes of S241 up to the above timing is the “total wheel payout”. If another wheel random determination is performed because the below-described retrigger is established, the “total wheel payout” after the establishment of retrigger is added to the “total wheel payout” before the establishment of retrigger, and the thus obtained amount is regarded as the “total wheel payout” (the value of the total wheel payout is updated).

<Screen Display when Payout Slot is Stopped>

J-1 in FIG. 18F shows the screen display at the time when a payout slot is selected in the wheel random determination and the selected payout slot is stopped at the wheel predetermined position. At this time, the upper image display panel 131 displays: an image of the surface of the wheel as a background; and an image of a number representing the credit amount (hereinafter, the number representing the credit amount may be simply referred to as a “value”). The value of the credits is displayed to overlap the image of the surface of the wheel. In this embodiment, the number representing the credit amount is the value of the slot payout (100 in the figure). At this time, the upper image display panel 131 displays “GOLD PRIZE” below the image of the surface of the wheel. The “GOLD PRIZE” includes: the text (characters) of “GOLD PRIZE”; and a bonus image (an image of a BONUS symbol) provided below the text. At this time, the upper middle display region 431 of the liquid crystal display device 134 displays the text of “LOOK UP”. When the wheel multiplier is 1, the screen display is changed to K-1 in FIG. 18F. When the wheel multiplier is more than 1, the screen display is changed to L-1 in FIG. 18G.

<Screen Display when Payout Slot is Stopped: No Re-Spinning>

K-1 in FIG. 18F shows the screen display at the time when a payout slot is stopped at the wheel predetermined position in the situation where the wheel multiplier is 1. At this time, the upper image display panel 131 displays, in the lower left area on the screen, the bet multiplier (“5×” in the figure). Then, the upper image display panel 131 displays animation in which the number representing the credit amount of the slot payout and provided in the upper portion on the screen (“100” in J-1 in FIG. 18F) is multiplied by the bet multiplier (5×). Then, the number representing the credit amount on the upper image display panel 131 is changed from the credit amount of the slot payout (“100”) to the value obtained by the multiplication (“500” in the figure). Subsequently, the upper image display panel 131 displays animation in which the value obtained by the multiplication (“500”) is put into “GOLD PRIZE” from the position where the value overlaps the surface of the wheel. If “the sum of the amounts of the wheel payout per play up to the last play” (described above) is not zero (if there are credits already), the upper image display panel 131 displays animation in which the value of the “wheel payout per play” for the current play is added to the value of “the sum of the amounts of the wheel payout per play up to the last play”. At this time, the upper middle display region 431 of the liquid crystal display device 134 displays the text of “LOOK UP”. When the wheel random determination play number is 1 or more (see FIG. 15B, S245: YES), the screen display is returned to the display shown in H in FIG. 18C. When the wheel random determination play number is zero (see FIG. 15B, S245: NO), the screen display proceeds to the display shown in O in FIG. 18H (which will be described later).

<Screen Display when Payout Slot is Stopped: With Re-Spinning>

L-1 in FIG. 18G shows the screen display at the time when a payout slot is stopped at the wheel predetermined position in the situation where the wheel multiplier is more than 1. At this time, the upper image display panel 131 displays the bet multiplier in the lower left area on the screen (“5×” in the figure), and displays the wheel multiplier in the lower right area on the screen (“2×” in the figure). Then, the upper image display panel 131 displays animation in which the credit amount of the slot payout which is provided in the upper portion on the screen (“100”) is multiplied by the wheel multiplier (2×). Then, the credit amount on the upper image display panel 131 is changed from the credit amount of the slot payout (“100”) to the value obtained by the multiplication (“200”). Then, the upper image display panel 131 displays animation in which the value of the credits after the first multiplication (“200”) is multiplied by the bet multiplier (5×). Then, the credit amount on the upper image display panel 131 is changed from the value before the multiplication by the bet multiplier (“200”) to the value obtained by the above multiplication (“1000”). At this time, the upper middle display region 431 of the liquid crystal display device 134 displays the text of “LOOK UP”.

Then, as shown in M in FIG. 18G, the upper image display panel 131 displays animation in which the value of the credits after the multiplications (after the multiplication by the wheel multiplier and the bet multiplier) is put into the “GOLD PRIZE”. At this time, the upper middle display region 431 of the liquid crystal display device 134 displays the text of “LOOK UP”.

Then, as shown in N in FIG. 18G, the image of the surface of the wheel disappears from the upper image display panel 131. If “the sum of the amounts of the wheel payout per play up to the last play” (described above) is not zero (if there are credits already), the upper image display panel 131 displays animation in which the value of the “wheel payout per play” for the current play is added to the value of “the sum of the amounts of the wheel payout per play up to the last play” (summing-up display). Then, when the wheel random determination play number is 1 or more (see FIG. 15B, S245: YES), the screen display is returned to the display shown in H in FIG. 18C. When the wheel random determination play number is zero (see FIG. 15B, S245: NO), the screen display proceeds to the display shown in O in FIG. 18H.

Subsequently, as shown in O in FIG. 18H, the upper image display panel 131 displays the calculation result (calculation result of PRIZE) of the “total wheel payout” (“payout amount per BONUS symbol”). At this time, the upper middle display region 431 of the liquid crystal display device 134 displays the text of “LOOK UP”.

After displaying the calculation result of PRIZE, the upper image display panel 131 displays an explanation for the rules (2), which is the explanation for the rules of the free game, as shown in S in FIG. 18H (this can be skipped). At this time, the upper middle display region 431 of the liquid crystal display device 134 displays “LOOK UP”.

Subsequently, as shown in T in FIG. 18H, the upper image display panel 131 displays: the number of plays of the free game; and the text of “START”. Specifically, the upper image display panel 131 displays the text of “7 FREE GAMES START”. While the upper image display panel 131 displays the above text, the upper middle display region 431 of the liquid crystal display device 134 displays the text of “FREE GAMES START” (for the same display time), as shown in FIG. 17C.

(Free Game Process)

The following describes the free game process with reference to FIG. 15C. To begin with, when the free game process is executed, the main CPU 71 sets the number of plays of the free game (initial value) to 7. However, when the free game process is executed after the retrigger, the number of plays of the free game is not updated (the details thereof will be described later).

Subsequently, the main CPU 71 performs a symbol random determination in the symbol random determination process (Step S254). The symbol random determination process is executed in the substantially same manner as the symbol random determination process in the base game (Step S14, see FIG. 7A). The relationship between each symbol and its weight in the free game is set in the free game reel weight table shown in FIG. 13D (this table is different from the table for the base game). The above-mentioned figure shows the free game reel weight table for the minor setting of V01. There are free game reel weight tables for the remaining minor settings though they are not illustrated. Note that “F_BONUS” in this figure means the BONUS symbol.

Then, the main CPU 71 executes an effect contents determination process (Step S255) to determine the contents of the effect. Thereafter, the main CPU 71 executes a symbol display control process (Step S256) to control the operation of the reels 101 to 105.

<Screen Display at Start of Free Game>

U in FIG. 18H shows the screen display at the start of the free game (after the upper image display panel 131 displays the number of plays of the free game in T in FIG. 18H). At this time, the display on the upper image display panel 131 is changed to the 2nd screen for free game (“2nd for FREE GAME”). At this time, the main CPU 71 starts spin of the reels 101 to 105. At this time, the upper middle display region 431 of the liquid crystal display device 134 displays the feature title. In the free game, the upper right display region 432 of the liquid crystal display device 134 displays the free game counter (FG counter) (see FIG. 17A). The FG counter shows the text of “FREE GAME XXX OF YYY”, where “XXX” represents the remaining number of plays of the free game, and “YYY” represents the number of plays of the free game awarded.

<When Retrigger Occurs>

Subsequently, as shown in FIG. 15C, the main CPU 71 determines whether a retrigger has been established in the symbol random determination (Step S261). The retrigger is established when 5 BONUS symbols (specific symbols) are rearranged in the display window 150. When the retrigger is established (S261: YES), the main CPU 71 increases the number of plays of the free game by 5 (Step S262).

Subsequently, the main CPU 71 determines the payout (awarded credit amount, payout amount) in accordance with the number of BONUS symbols stopped, on the basis of the payout table shown in FIG. 13F (Step S263). Then, the main CPU 71 determines the wheel random determination play number (the processing returns back to Step S211), and the main CPU 71 starts the wheel random determination (Step S214). When the retrigger starts the wheel random determination process, the start-check process (Step S213) is not performed before the wheel random determination process, but may be performed.

<Screen Display when Retrigger Occurs>

V-1 in FIG. 18I shows the screen display at the time when the retrigger condition is satisfied (when the retrigger occurs) during the free game. At this time, the upper image display panel 131 displays: the 2nd screen for free game as a background; the text of “RETRIGGER”; and the text indicating the number of plays of the free game to be added, that is, “+5 FREE GAMES”. These are displayed at the same time when the last reel (the reel which is stopped last among the reels 101 to 105) stops. When the last reel is stopped, as shown in FIG. 17D, the upper middle display region 431 of the liquid crystal display device 134 displays the text of “RETRIGGER”.

After displaying the screen of V-1 in the above figure (after displaying the text of “RETRIGGER” and the like), the upper image display panel 131 displays the followings, as shown in W-1 in FIG. 18I. At this time, in the lower right area on the screen, the upper image display panel 131 displays the free game counter (FG counter in the figure) indicating the number of plays of the free game. Further, the upper image display panel 131 displays animation in which the increment value for the number of plays of the free game in the middle of the screen (“+5”) is added to the value displayed in the free game counter. At this time, the upper middle display region 431 of the liquid crystal display device 134 displays the text of “RETRIGGER” (see FIG. 17D).

As shown in X-1 in FIG. 18I, the upper image display panel 131 displays, in the central area on the screen, the result of the payout obtained in accordance with the number of BONUS symbols displayed in the display window 150 at the time of occurrence of the retrigger (the payout amount determined in Step S263). At this time, the upper image display panel 131 displays the 2nd screen for free game as a background.

Then, as shown in Y in FIG. 18I, the upper image display panel 131 displays: the 2nd screen for free game as a background; and the win signboard (see the first embodiment) (this can be skipped). At this time, the liquid crystal display device 134 displays contents in accordance with the payout amount.

Subsequently, as shown in Z in FIG. 18J, the upper image display panel 131 displays the text of “RETRIGGER”. At this time, the upper middle display region 431 of the liquid crystal display device 134 displays the text of “RETRIGGER” (see FIG. 17D).

1 in FIG. 18J shows the screen display after the display of Z in FIG. 18J (after the display of the text of “RETRIGGER”). At this time, the upper image display panel 131 displays the 2nd screen for wheel game (the display on the upper image display panel 131 is switched to the 2nd screen for wheel game). At this time, the main CPU 71 turns off the reels 101 to 105. At this time, the upper image display panel 131 displays an explanation for rules of retrigger (this can be skipped). At this time, the upper middle display region 431 of the liquid crystal display device 134 displays the text of “LOOK UP”. The screen display during the wheel game executed as a result of the retrigger is similar to the screen display during the wheel game executed as a result of the trigger (FIG. 18D to FIG. 18G, and O in FIG. 18H).

As shown in 2 in FIG. 18K, after the wheel game executed as a result of the retrigger ends, the upper image display panel 131 displays a computation expression. In this expression, the value of the “total wheel payout” after the establishment of the retrigger is added to the value of the “total wheel payout” before the establishment of the retrigger. At this time, the upper middle display region 431 of the liquid crystal display device 134 displays the text of “LOOK UP”.

Then, as shown in 3 in FIG. 18K, the upper image display panel 131 displays the explanation for the rules (2), which is the explanation for the rules of the free game (this can be skipped). At this time, the upper middle display region 431 of the liquid crystal display device 134 displays the text of “LOOK UP”.

Subsequently, as shown in 4 in FIG. 18K, the upper image display panel 131 displays the text of “FREE GAMES START” which indicates that the free game is about to start. At this time, as shown in FIG. 17C, the upper middle display region 431 of the liquid crystal display device 134 displays the text of “FREE GAMES START”. The period of time during which the text of “FREE GAMES START” is displayed on the upper image display panel 131 is the same as the period of time during which the text of “FREE GAMES START” is displayed on the liquid crystal display device 134. Thereafter, the screen display is returned to the display shown in T in FIG. 18H.

<When BONUS is Stopped>

As shown in FIG. 15C, when the retrigger is not established in the symbol random determination (S261: NO), the main CPU 71 determines whether one to four (1 to 4) BONUS symbols are displayed in the display window 150 (Step S271). When one to four BONUS symbols are displayed in the display window 150 (S271: YES), the main CPU 71 determines the payout amount (Step S272). The payout amount determined here is the product of: the number of the BONUS symbols displayed in the display window 150; and the “total wheel payout” (“payout amount per BONUS symbol”). Then, the main CPU 71 executes the process of Step S273 (which will be described later).

<Screen Display when BONUS is Stopped>

When the one to four BONUS symbols are displayed in the display window 150, which does not cause the retrigger, the upper image display panel 131 displays a calculation equation (result of payout) at the center of the screen, as shown in V-2 in FIG. 18L. This calculation equation shows the calculation performed in Step S272. Specifically, the equation shows that the payout amount is calculated by multiplying the “total wheel payout” by the number of the BONUS symbols.

After displaying the calculation equation (see V-2 in the above figure), the upper image display panel 131 displays the win signboard (see the first embodiment) as shown in W-2 in FIG. 18L.

<When No BONUS is Stopped>

As shown in FIG. 15C, when no BONUS symbols is displayed in the display window 150 in the symbol random determination (S261: NO, S271: NO), the main CPU 71 determines whether there is a payout to be awarded (Step S281). Whether there is a payout or not is determined in the same manner as in the base game described above. When there is a payout (S281: YES), the main CPU 71 determines the payout amount in accordance with the payout multiplying factor (Step S282), and executes the process of Step S273 (which will be described later). The payout amount is determined on the basis of the payout table shown in FIG. 13F, in the same manner as in the base game. In this case, the upper image display panel 131 displays the win signboard (similar to that in the first embodiment) as shown in W-2 in FIG. 18L.

When it is determined that there is no payout in Step S281 (S281: NO), the main CPU 71 executes the process of Step S273 (which will be described later), as shown in FIG. 15C. In this case, as shown in V-3 in FIG. 18L, the upper image display panel 131 displays the 2nd screen for free game, and the upper middle display region 431 of the liquid crystal display device 134 displays the feature title (see FIG. 10C).

<Number of Plays of Free Game:—1>

As shown in FIG. 15C, when the retrigger is not established (S261: NO), the main CPU 71 decreases the number of plays of the free game by 1 (Step S273). Then, the main CPU 71 determines whether the number of plays of the free game is 1 or more (whether the number of plays is zero or not) (Step S274). When the number of plays of the free game is 1 or more (S274: YES), the main CPU 71 executes the symbol random determination process again (the processing returns to Step S254). At this time, the screen display is returned to the display shown in O in FIG. 18H. When the number of plays of the free game is 0 (zero) (S274: NO), the main CPU 71 ends the free game process. At this time, the screen display proceeds to X-2 in FIG. 18L.

<Screen Display at End of Free Game>

As shown in X-2 in FIG. 18L, the upper image display panel 131 displays the total win signboard at the end of the free game. On the total win signboard, for example, the text of “WIN TOTAL XXXXXXXXXX CREDITS” is displayed. On the total win signboard, there is displayed the total sum of payout amounts paid out in the feature game (total payout amount). The type of the signboard displayed on the upper image display panel 131 differs depending on the ratio of the total payout amount to the bet amount. When the total payout amount is less than 25 times the bet amount, a normal signboard is displayed. When the total payout amount is not less than 25 times and less than 50 times the bet amount, a signboard which is gorgeous as compared with the normal signboard is displayed. When the total payout amount is not less than 25 times and less than 50 times the bet amount, there are displayed: the signboard which is gorgeous as compared with the normal signboard; and a background which is gorgeous as compared to the 2nd screen for free game. Further, the text of “Congratulations!” is displayed instead of the text of “WIN”. Then, the screen display is returned to the normal display for the base game (A in FIG. 18A).

(Functions and Effects)

The functions and effects of the gaming machine 2 of the present embodiment are as follows. In the present embodiment, the main CPU 71 (corresponding to the controller 220 in FIG. 1) sets the initial value of the wheel multiplier (roulette multiplier) to 1. In the step (A1c), when the wheel random determination is executed repeatedly and the re-spinning slot is selected repeatedly, the wheel multiplier is multiplied by a predetermined multiplying value each time the re-spinning slot is selected repeatedly (see S232 of FIG. 15B).

In the above arrangement, the following game effect is provided: each time the re-spinning slot is selected repeatedly, the wheel multiplier, the initial value of which is 1, is multiplied by the predetermined multiplying value and increased in geometric progression (for example, 1, 2, 4, 8, 16, and so on). As compared with the case where such a game effect is not provided, the game effect regarding the way to increase the wheel multiplier is diversified.

In the above arrangement in which each time the re-spinning slot is selected repeatedly, the wheel multiplier is increased in the manner of 1, 2, 4, 8, 16, and so on), it is easier for the player to understand how the wheel multiplier increases.

In the present embodiment, the plurality of symbols 501 includes a plurality of BONUS symbols (specific symbols). The RAM 73 (corresponding to the storage device 210 in FIG. 1) stores the wheel random determination play number (roulette random determination play number) which is a numerical value indicating the number of plays of the wheel random determination. The main CPU 71 is configured to execute the following steps of (A6a) to (A6c):

(A6a) when the trigger condition is satisfied, determining the wheel random determination play number in accordance with the number of the BONUS symbols displayed in the display window 150 (Step S211 of FIG. 15B);
(A6b) when the payout slot is selected in the step (A1a) (wheel random determination), decreasing the wheel random determination play number by 1 (Step S244 in FIG. 15B); and
(A6c) when the wheel random determination play number after decreasing in the step (A6b) is 1 or larger, starting the step (A1a) (YES in S245 of FIG. 15B).

In the above arrangement, the steps (A6a) to (A6c) are executed. There is provided the following game effect: the wheel random determination play number is determined in accordance with the number of the BONUS symbols displayed in the display window 150 when the trigger condition is satisfied; and the wheel random determination is repeated until the wheel random determination play number becomes less than 1. As compared with the case where such a game effect is not provided, the game effect regarding the number of plays of the roulette random determination is diversified. For example, the game effect is diversified as compared with the case where the wheel random determination play number is predetermined irrespective of the result of the symbol random determination.

In the present embodiment, when the step (A1d) is executed multiple times, the main CPU 71 executes a process of updating the value of the payout to the sum of amounts of the payout (“total wheel payout”) determined multiple times (accumulation of the “wheel payout per play”) (Step S242 in FIG. 15B).

In the above arrangement, the following game effect is provided: when the step (A1d) is executed multiple times, the value of the payout is updated to the sum of the amounts of the payout (“total wheel payout”) determined multiple times (accumulation of the “wheel payout per play”). As compared with the case where such a game effect is not provided, the game effect regarding how to determine the payout is diversified. For example, the game effect is diversified, as compared with the case where the “wheel payout per play” is simply determined as the payout.

In the present embodiment, the gaming machine 2 includes the reels 101 to 105 and the display window 150. The reels 101 to 105 include a plurality of symbols 501 and are provided separately from the wheel 201 (see FIG. 3). The display window 150 is configured to display one or more symbols 501 out of the plurality of symbols 501. The plurality of symbols 501 includes a plurality of BONUS symbols (second specific symbols). The main CPU 71 is configured to execute the following steps of (A8a) and (A8b):

(A8a) after the step (A1d), selecting one or more symbols 501 to be displayed in the display window 150 out of the plurality of symbols 501 through random determination (the symbol random determination process in S254 of FIG. 15C); and
(A8b) determining a product of the “total wheel payout” (payout) and the number of the BONUS symbols selected in the step (A8a) as a second payout (Step S272 in FIG. 15C).

In the above arrangement, the random determination in the step (A8a) (symbol random determination) is performed. In the step (A8b), the product of the “total wheel payout” and the number of the BONUS symbols selected to be displayed in the display window 150 in the symbol random determination is determined as the second payout. As compared with the case where such a game effect is not provided, the game effect regarding the payout is diversified. For example, the game effect is diversified, as compared with the case where the “total wheel payout” is simply determined as the second payout.

(Other Structures)

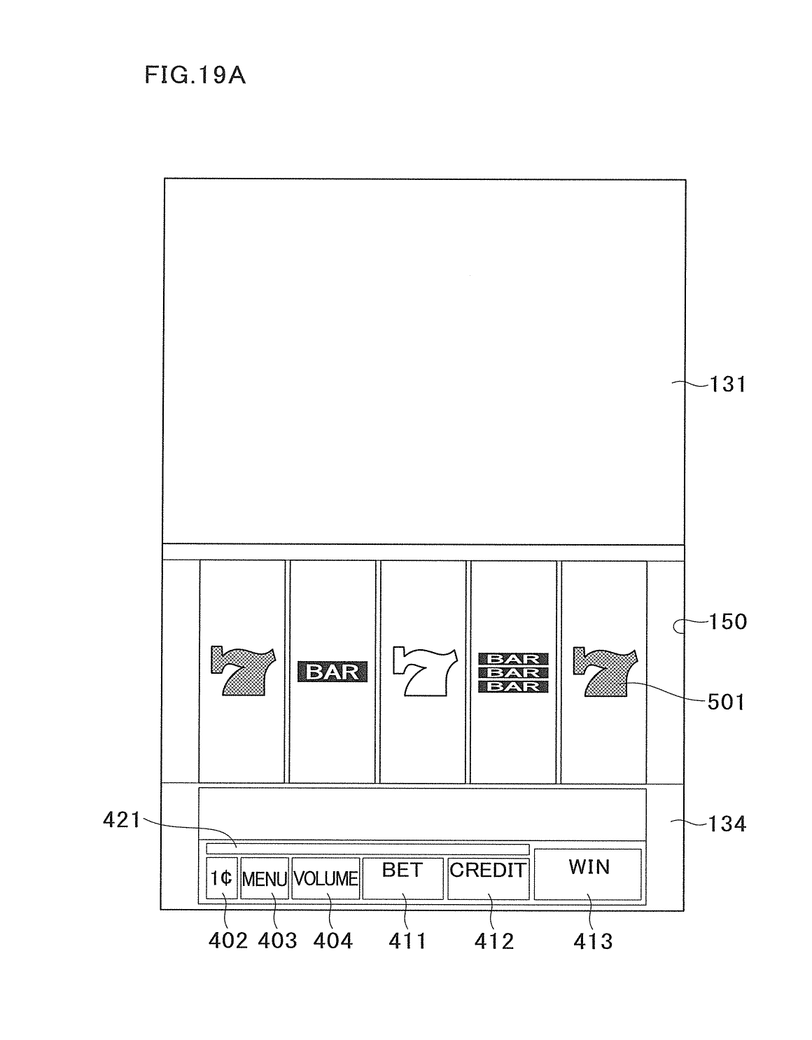

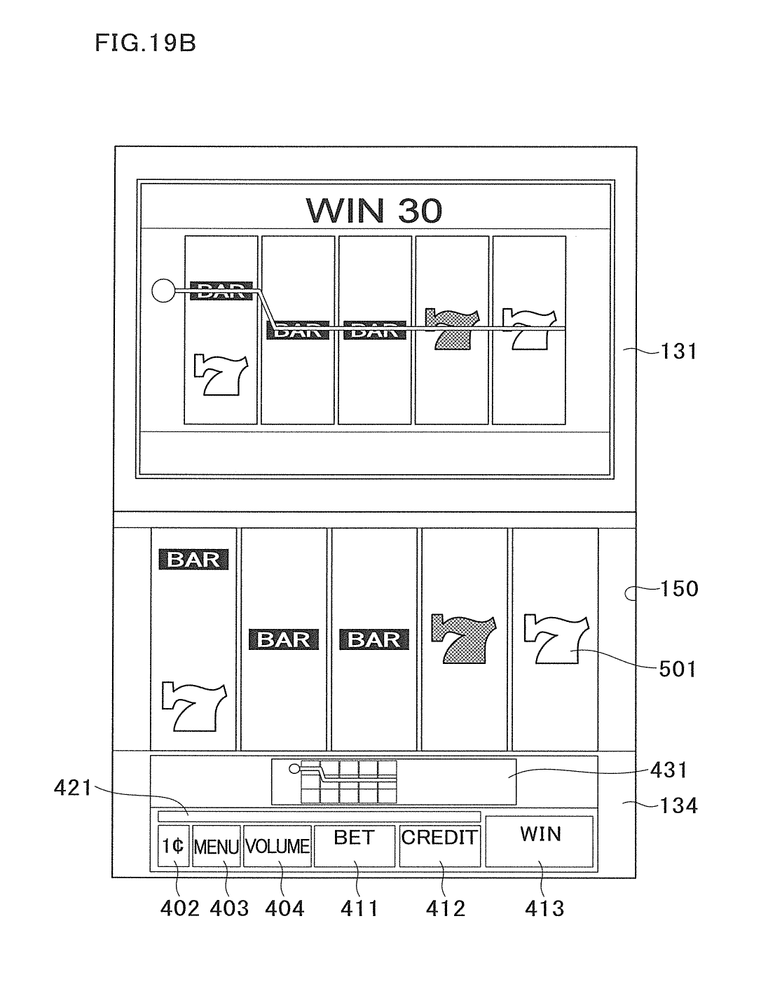

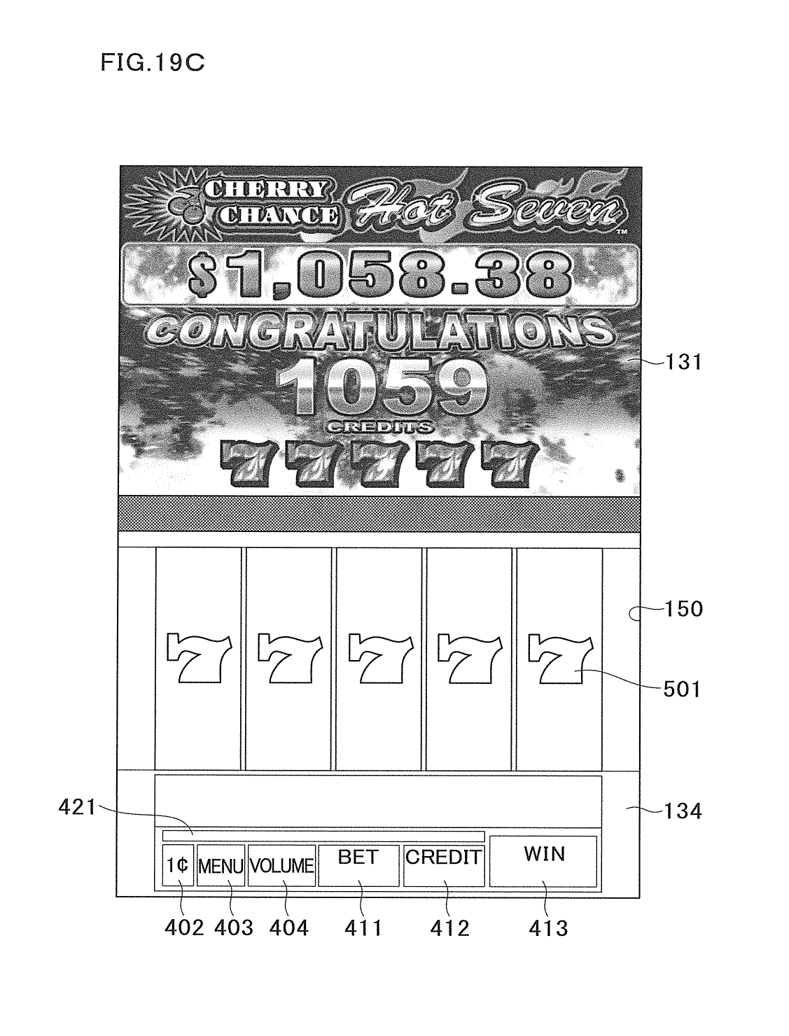

Now, referring to FIG. 19A to FIG. 32, other structures of the gaming machine will be described. The below-described structures are applicable to the gaming machine 1 in the first embodiment and also to the gaming machine 2 in the second embodiment.

(Flow of Basic Operations of Gaming Machine)

Now, referring to FIG. 19A to FIG. 19C, the basic operations of the gaming machine will be described.

<RAM Clear->Idle>

The operation of the gaming machine after the RAM 73 is cleared (after the clearance of the RAM 73) is as follows.

<<Immediately after Clearance of RAM>>

The operation of the gaming machine immediately after the clearance of the RAM 73 is as follows. The upper image display panel 131 shown in FIG. 19A displays GAME INFO. (game information, information of the game). The amounts of the progressive payout displayed on the upper image display panel 131 are initial values (see FIG. 6E). The reels 101 to 105 in the display window 150 are stopped at reel stop positions exclusive for the clearance of the RAM 73 (no-win position). Illumination LEDs for the reels 101 to 105 and the LEDs inside the reels 101 to 105 are turned on. The liquid crystal display device 134 displays a SYSTEM TILT log. Touch buttons on the liquid crystal display device 134 are turned on to activate the touch buttons. In the above embodiments, the lines are fixed as described above. When the lines are variable in a modification, the display on the liquid crystal display device 134 regarding the selection of lines and selection of bet is the same as the display at the time when a win occurs. The bet meter 411, the credit meter 412, and the win meter 413 of the liquid crystal display device 134 each indicates “0”. The game state indicator 421 of the liquid crystal display device 134 displays the text of “GAME OVER”.

<<Selection of Bet and Line>>

The operation at the time of selection of a bet and a line is as follows. The upper image display panel 131 displays the game information. The reels 101 to 105 in the display window 150 are stopped at reel stop positions exclusive for the clearance of the RAM 73 (no-win position). The illumination LEDs for the reels 101 to 105 and the LEDs inside the reels 101 to 105 are turned on. Touch buttons on the liquid crystal display device 134 are turned on to activate the touch buttons. When a bet button is pressed down, the button is turned on and a sound is produced. In response to pressing down of the bet button, the liquid crystal display device 134 displays the bet multiplier (BET x). The display of the bet on the liquid crystal display device 134 (BET in the figure) is not updated, until the game is started.

<Idle->Cash in->Win or Loss>

The operations of the gaming machine at the times of idle, cash-in, win or loss (no winning is achieved) are as follows. When a progressive payout is won and awarded (when the amount of a progressive win is added to credits), the following win process is performed after rounding up the fraction of the payout amount.

<<Idle>>

During the idle time, the game state indicator 421 of the liquid crystal display device 134 displays the text of “GAME OVER”.

<<Cash in>>

The operation of the gaming machine at the time when credits (gaming values) are input (inserted) to the gaming machine (at the time of “cash in”) is as follows. When the “cash in” occurs, “CASH IN $100.00” or the like cuts in on the display provided on the liquid crystal display device 134 before the cash in. After this is displayed for 3 seconds, this display is cleared. In the present embodiments, no spin button is provided. In a modification in which a spin button is provided, the spin button may be turned on when credits, the amount of which enables a play of the game, are input to the gaming machine.

<<Spin>>

The operation of the gaming machine during the spin of the reels 101 to 105 is as follows. The upper image display panel 131 keeps displaying the game information in a game information area (area for displaying the game information). The reels 101 to 105 spin in the display window 150. The SYSTEM TILT log is cleared from the liquid crystal display device 134. The touch button of “MENU” (described below) of the liquid crystal display device 134 is disabled and the touch button of “VOLUME” is enabled. The text of “GAME OVER” on the game state indicator 421 of the liquid crystal display device 134 is changed to the text of “GOOD LUCK!”. The bet meter 411 displays a consumed credit amount. The credit meter 412 displays a value obtained by subtracting the consumed credit amount from the value displayed before the spin. The selected bet amount and the display regarding the line which are displayed on the liquid crystal display device 134 are left as they are before the spin.

<<Loss>>

The operation of the gaming machine at the time of loss is as follows. The upper image display panel 131 keeps displaying the game information in the game information area. The text of “GOOD LUCK” on the game state indicator 421 of the liquid crystal display device 134 is changed to the text of “GAME OVER”. The values of the meters are maintained until the next spin is started. The display of the selected bet amount on the liquid crystal display device 134 is changed in response to pressing down of a bet button. If the selection of the line(s) is possible, line information on the liquid crystal display device 134 is changed by pressing down of a select line button.

<<1 Line Wing>>

The operation of the gaming machine at the time when a 1-line win occurs is as follows. As shown in FIG. 19B, the upper image display panel 131 displays the win signboard (win effect screen), the type of which corresponds to the payout amount, and symbol frames related to the win are emphasized (e.g., blinked). In the display window 150, the LEDs in the reels 101 to 105 which respectively correspond to the symbols achieving the winning combination blink (the details thereof will be described later). The status of the LEDs in the reels 101 to 105 and the like are maintained until the next spin is started. The liquid crystal display device 134 displays the win effect screen the type of which corresponds to the payout amount, and the symbol frames related to the win occurs are emphasized (e.g., blinked). The win meter 413 performs incremental display (increment). In the setting of GAMBLE OFF, after the increment of the win meter 413 is finished, the amount of paid out credits is added to the value of the credit meter 412. In the setting of GAMBLE ON, after the increment of the win meter 413 is finished, the machine enters into a gamble waiting state. The values of the meters are maintained until the next spin is started.

<<Multiple Line Wing>>

The operation of the gaming machine at the time when wins occur on multiple lines as follows. The upper image display panel 131 displays the win signboard (win effect screen), the type of which corresponds to the payout amount, and the symbol frames related to the win are emphasized (e.g., blinked). In the display window 150, the LEDs in the reels 101 to 105 which correspond to the symbols achieving each winning combination blink, and then the combinations are blinked in turn (the details thereof will be described later). At this time, the line win display for each line is performed in an ascending order of the numbers of the lines (the numbers are respectively set for the lines) (the details of the line win indication will be described later). The status of the LEDs in the reels 101 to 105 and the like is maintained until the next spin is started. The liquid crystal display device 134 displays the win effect screen the type of which corresponds to the payout amount, and the symbol frames related to the win occurs are emphasized (e.g., blinked). The win meter 413 performs the incremental display. In the setting of GAMBLE OFF, after the increment of the win meter 413 is finished, the amount of paid out credits is added to the value of the credit meter 412. In the setting of GAMBLE ON, after the increment of the win meter 413 is finished, the machine enters into a gamble waiting state. The values of the meters are maintained until the next spin is started.

<Cash Out>

The operation of the gaming machine at the time when the cash out button 31 (see FIG. 3) is pressed down is as follows.

<<Idle>>

The operation of the gaming machine before the cash out button 31 is pressed down is as follows. The upper image display panel 131, the reels 101 to 105 in the display window 150, and the liquid crystal display device 134 each maintains the state in the last play of the game.

<<Cash Out—Ticket>>

The operation of the gaming machine at the time when the cash out button 31 is pressed down is as follows. From the upper image display panel 131, the win signboard is cleared. From the upper middle display region 431 of the liquid crystal display device 134, the win signboard is cleared. The upper middle display region 431 of the liquid crystal display device 134 displays the text of “Please take your ticket or receipt.”, for example, which is a ticket out signboard (the details thereof will be described later). The credit meter 412 displays 0 (zero). The value of the bet meter 411 and the value of the win meter 413 are unchanged (these meters keep displaying their respective last values). The liquid crystal display device 134 displays a payment log (system message).

<Cash Out->Attendant Pay>

The operation of the gaming machine at the time when the cash out button 31 is pressed down and “attendant pay” (payment by an attendant) is performed is as follows.

<<Idle>>

The operation of the gaming machine before the cash out button 31 is pressed down is as follows. The upper image display panel 131, the reels 101 to 105 in the display window 150, and the liquid crystal display device 134 each maintains the state in the last play of the game.

<<Cash Out—Hand Pay>>

The operation of the gaming machine at the time when the cash out button 31 is pressed down and the machine enters into a call attendant state (state in which an attendant is called) is as follows. In the call attendant state, the upper image display panel 131 stops video operation. The reels 101 to 105 in the display window 150 maintain the state in the last play of the game. If displaying the win signboard, the upper middle display region 431 of the liquid crystal display device 134 displays a call attendant sign over the win signboard (so that the call attendant display overlaps the win signboard). The call attendant sign is the text of “CALL ATTENDANT, ATTENDANT PAY $200”, for example. At this time, the gaming machine (machine) is locked (e.g., normal operations are locked). Further, a call attendant sound is produced. Then, the value of the credit meter 412 is maintained until the gaming machine is reset by a key (until “key reset” is performed). After the key reset, the call attendant sign and the win signboard on the liquid crystal display device 134 is cleared, and the value of the credit meter 412 is reset to 0 (zero). The value of the bet meter 411 and the value of the win meter 413 are unchanged (these meters keep displaying their respective last values). The liquid crystal display device 134 displays a message indicating that the attendant pay has been performed. For example, the liquid crystal display device 134 displays this message and the payment log (system message) alternately.

<Win->Attendant Pay>

The operation of the gaming machine at the time when the attendant pay is performed after a win is as follows.

<<Win>>

As shown in FIG. 19C, when a win occurs, the upper image display panel 131 displays the win signboard or the like (see the first embodiment).

<<Win—Attendant Pay>>

The operation of the gaming machine at the time when the machine enters into the call attendant state after a win occurs is as follows. If displaying the win signboard, the upper middle display region 431 of the liquid crystal display device 134 displays a call attendant sign (signboard) over the win signboard (so that the call attendant sign overlaps the win signboard). The call attendant sign is, for example, the text of “CALL ATTENDANT OVER JACKPOT LIMIT ATTENDANT PAY $20,000.00”. At this time, the gaming machine (machine) is locked (e.g., normal operations are locked), and only the win amount (payout amount resulting from the win) is paid through “hand payment”. Further, the call attendant sound is produced. On the upper middle display region 431 of the liquid crystal display device 134, the line win display of the win signboard is temporarily stopped. The values of the bet meter 411, the credit meter 412, and the win meter 413 are unchanged (these meters keep displaying their respective last values (i.e., values at the time of the win)). After the key reset, the call attendant sign on the liquid crystal display device 134 is cleared. The liquid crystal display device 134 displays a message indicating that the attendant pay has been performed. For example, the liquid crystal display device 134 displays this message and the payment log (system message) alternately. While the gaming machine is locked (during locking up), the line win display of the win signboard on the upper image display panel 131 is temporarily stopped.

<Tilt>

The operation of the gaming machine at the time when tilt occurs is as follows. The upper image display panel 131 keeps the display state in the last play of the game. In the display window 150, after recovering from an error (after reset or automatic recovering), the reels 101 to 105 spin again to search their to-be-stopped positions again. When tilt occurs in the middle of the game, the game is restarted. For example, when a reel error occurs during the spin of the reels 101 to 105, the reels 101 to 105 spin slowly (at a rotational speed sufficiently slower than that during the game) until the main door 13 is opened. When the main door 13 is opened, the reels 101 to 105 stop. The liquid crystal display device 134 does not display the SYSTEM TILT log during the game. The upper middle display region 431 of the liquid crystal display device 134 displays the call attendant sign (signboard). The call attendant sign is the text of “CALL ATTENDANT MAIN DOOR OPEN (MECHANICAL SWITCH)”. When the reels recover from the tilt automatically, the call attendant sign on the liquid crystal display device 134 disappears at the time when the error is overcome. When the tilt needs reset, the key reset is performed, and then the call attendant sign on the liquid crystal display device 134 disappears.

(Details of Liquid Crystal Display Device 134)

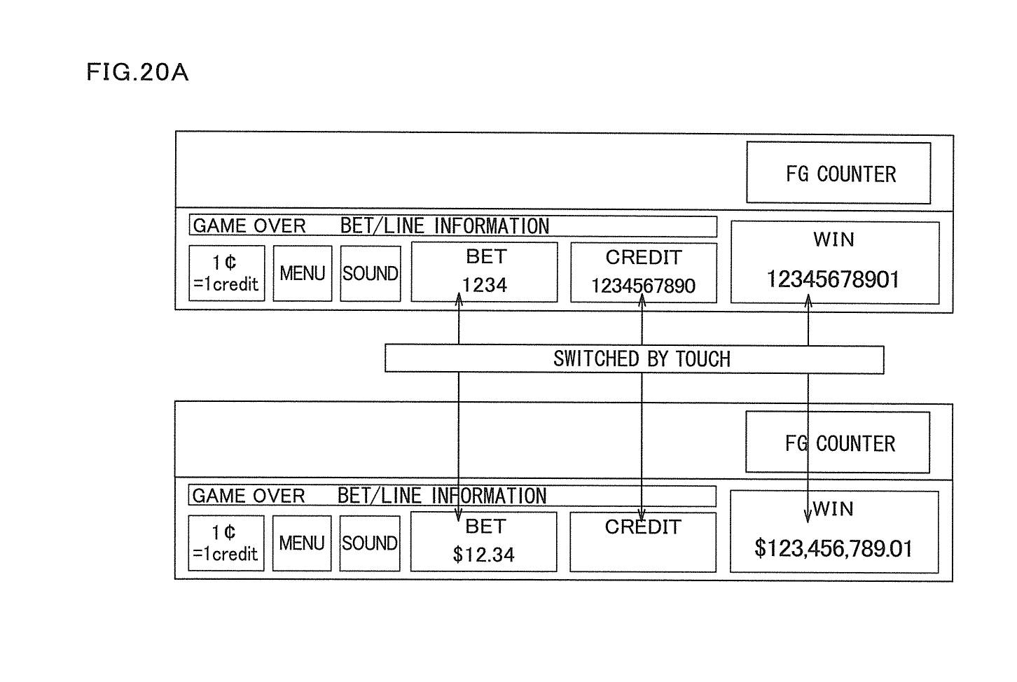

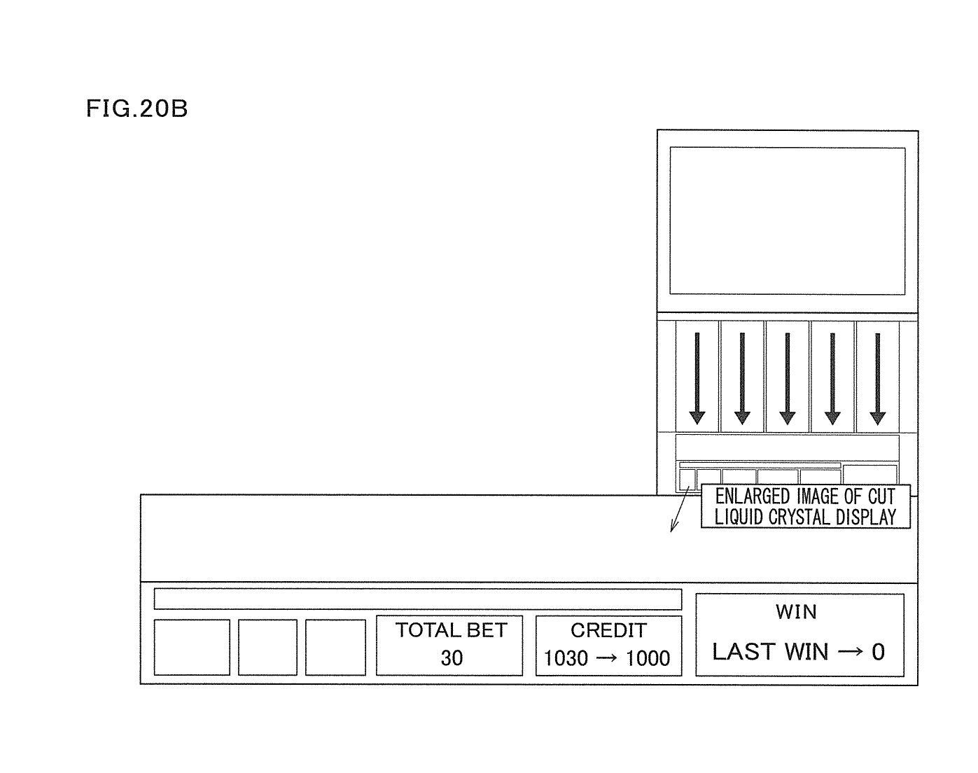

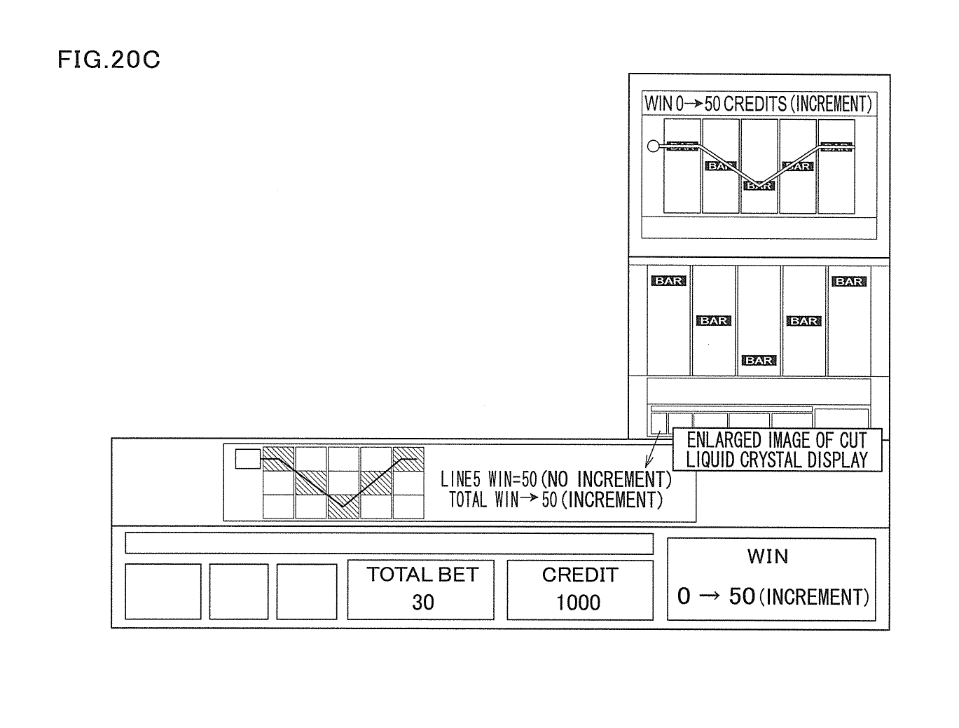

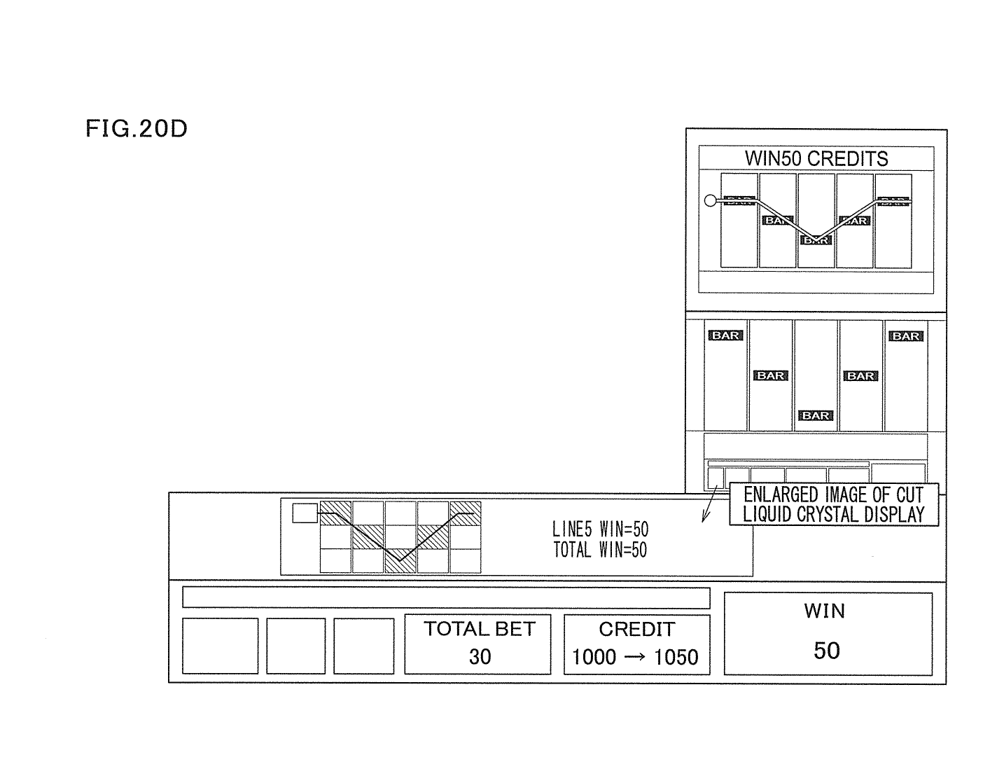

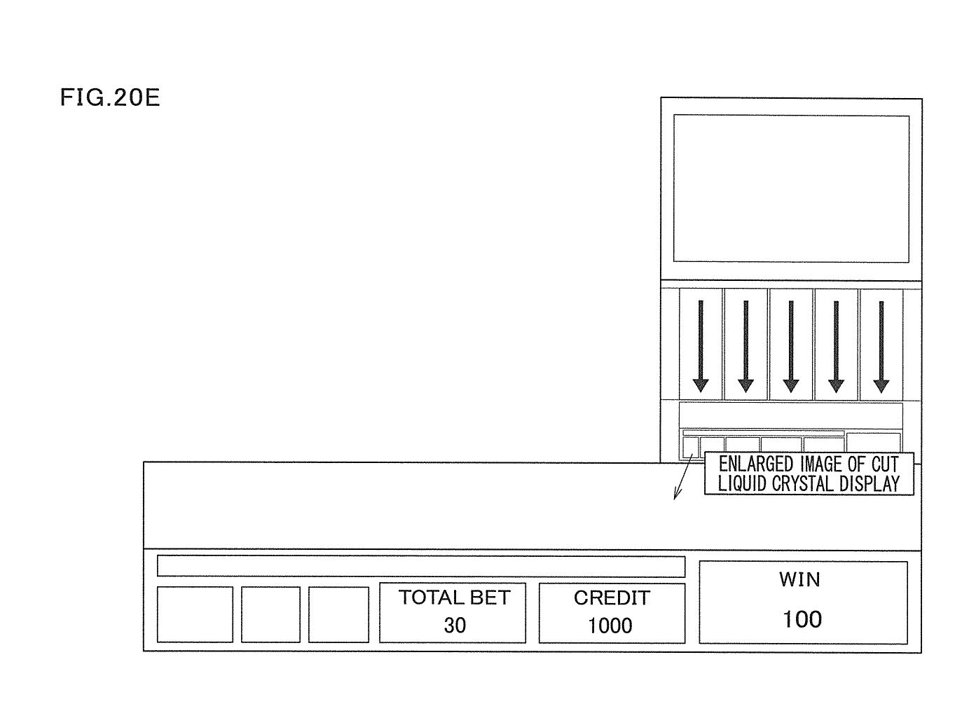

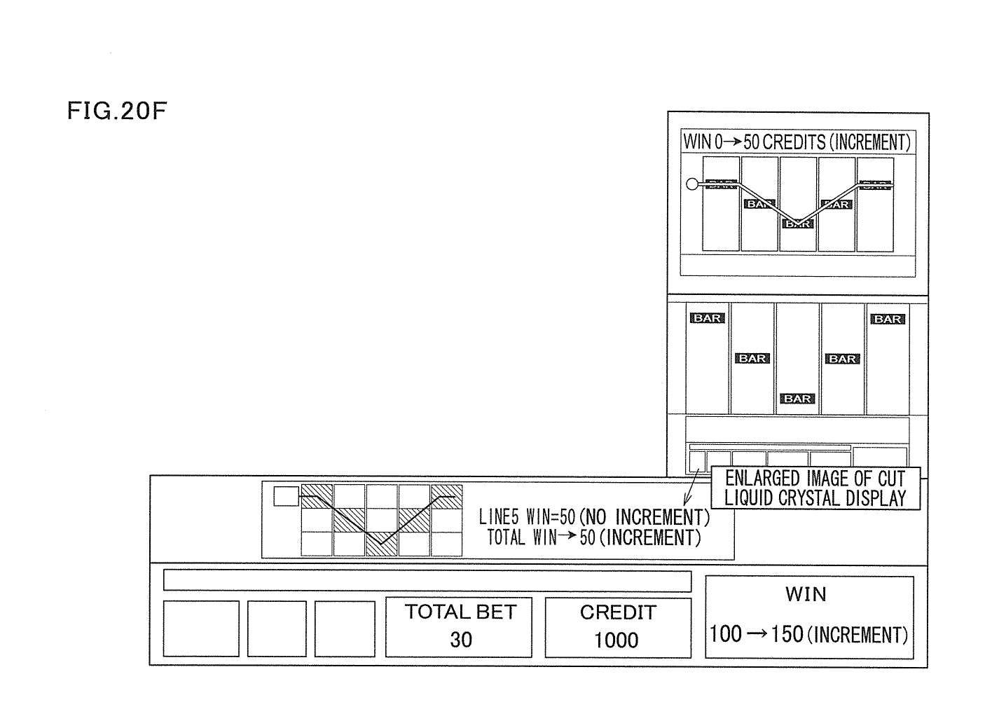

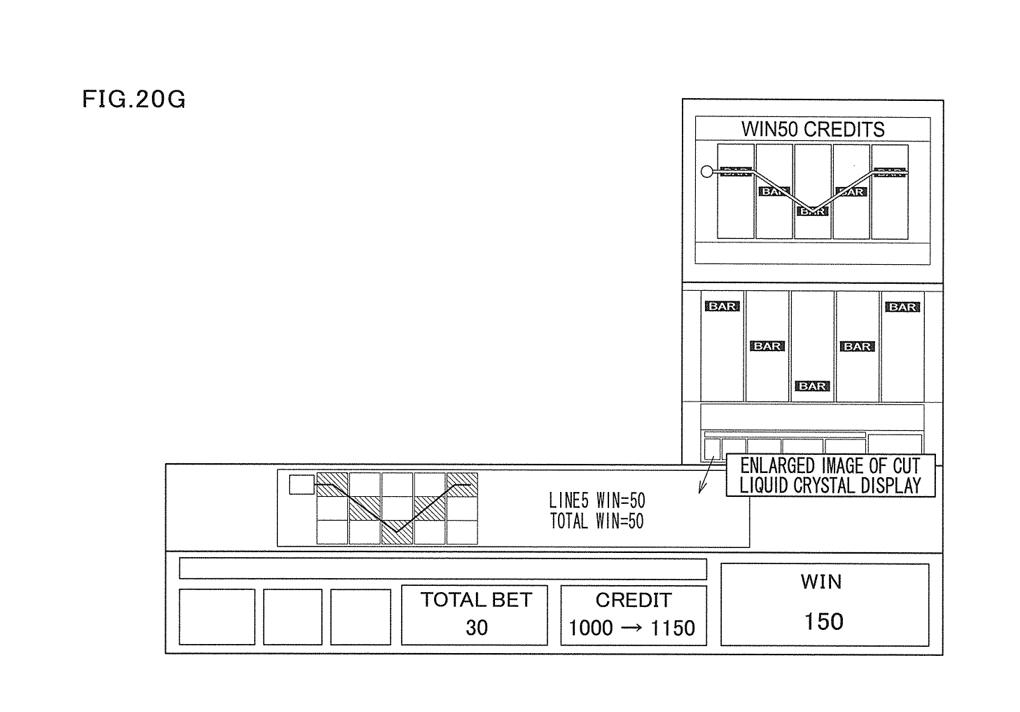

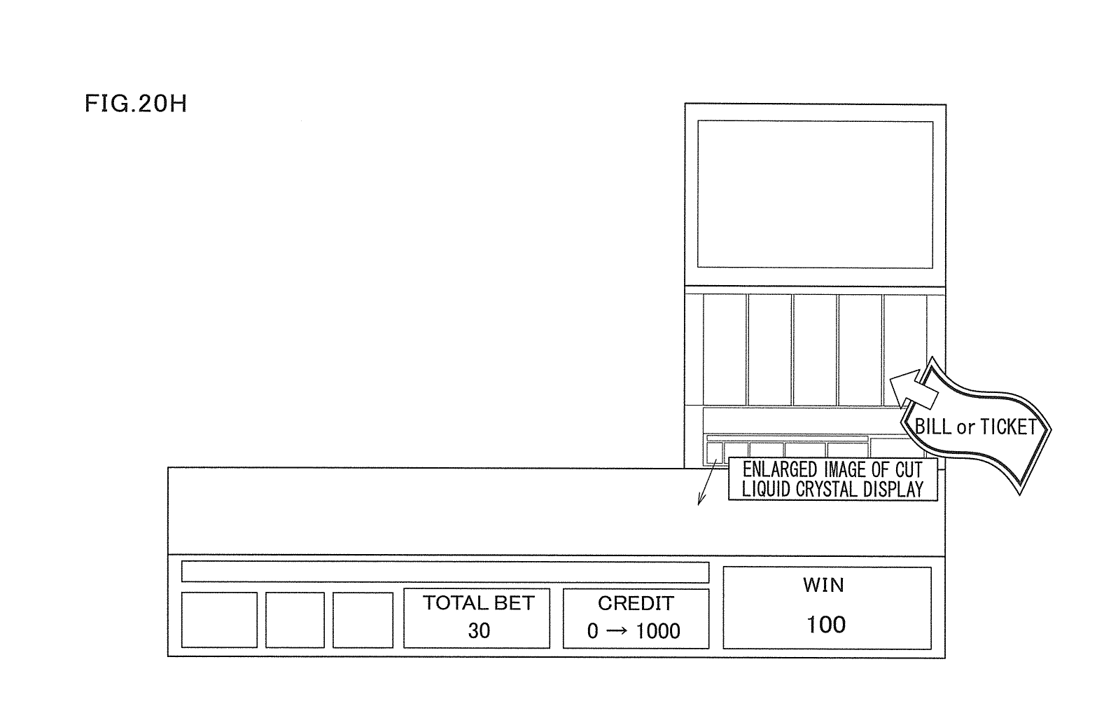

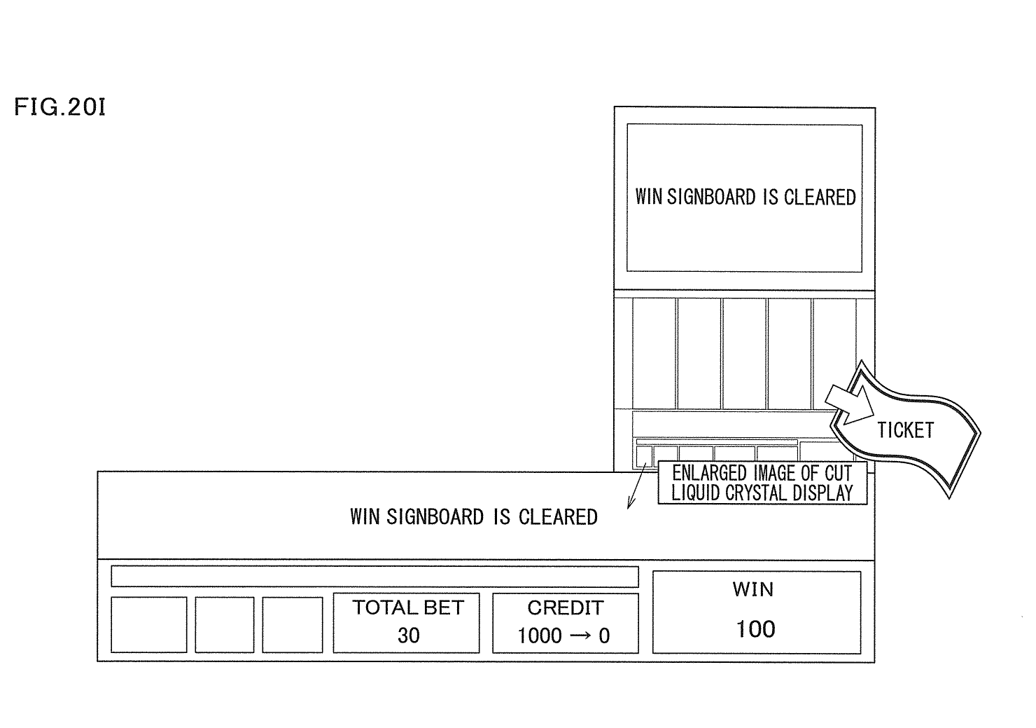

The details of the liquid crystal display device 134 (display on the meters) will be described with reference to FIG. 10A and FIG. 20A to FIG. 20I. In the following description, as for the reference sings for the components of the liquid crystal display device 134, FIG. 10A and the like are mainly referred to.

<Each Area of Liquid Crystal Display Device 134>

The game state indicator 421 is an area where a game message such as “GAME OVER” is displayed (see the first embodiment).

On the denomination button 402, a denomination is indicated. Specifically, a currency code is shown in an upper stage of the button. In a lower stage of the button, there are shown “=”, a number, and “credit(s)”. In FIG. 10A, the denomination button 402 indicates that 1cent is equivalent to 1 credit. When the gaming machine is a multi-denomination type, the denomination button 402 may be a touch icon.

The menu button 403 (“MENU”), and the sound volume switch button 404 (“SOUND”) each is a touch icon. The button is turned on while touch of the button is effective, and the button is turned off (displayed in gray) while touch of the button is not effective.

The bet meter 411 (bet display) is an area where the bet amount is displayed. As shown in FIG. 20A, the display on the bet meter 411 is switched between the display in credits and the display in currency in response to touch by the player. The bet meter 411 may display the bet amount in credits and the bet amount in currency in 2 stages at the same time, and does not have to switch the display. The amount displayed on the bet meter 411 is always the product of LINE and BET, and the displayed amount is synchronized with the selection state by the buttons on the control panel 30.

The credit meter 412 (credit indicator) displays the credit amount and the like. As shown in FIG. 20A, the display on the credit meter 412 is switched between the display in credits and the display in currency in response to touch by the player. The credit meter 412 may display the amount in credits and the amount in currency in 2 stages at the same time, and does not have to switch the display. When there is a remaining amount while the credit is 0 (zero), the display on the credit meter 412 is automatically switched to the display in currency. Switching from this state to the display in credits is impossible.

The win meter 413 (win indicator) displays a payout amount resulting from a win. The display on the win meter 413 is switched between the display in credits and the display in currency in response to touch by the player. The win meter 413 may display the amount in credits and the amount in currency in 2 stages at the same time, and does not have to switch the display.

In the upper right display region 432, the free game counter (FG counter) is displayed (see FIG. 17A). The free game counter displays “current play number of the game” of “total number of plays of the game” (each of “current play number of the game” of “total number of plays of the game” is a numerical value). If the free game counter is displayed before the first spin, 0 (zero) is displayed as the “current play number of the game”.

In an area to the right of the game state indicator 421 and to the left of the win meter 413, bet/line information is displayed. The bet/line information is information on the bet amount and the number of lines.

In an upper left end area of the liquid crystal display device 134, an error log is displayed.

In an upper right end area of the liquid crystal display device 134, a system message (SYS message) is displayed. Specifically, there are displayed: information on payment; information on a ticket (log); communication information; and the like. In the upper right end area of the liquid crystal display device 134, a clock may be displayed. Other than the above-described areas of the liquid crystal display device 134, there may be provided an area in which a message and the like are displayed.

<Operation of Liquid Crystal Display Device 134>

The operation of the liquid crystal display device 134 (cut liquid crystal display) at the time when a normal win occurs in the base game and at the time when a win occurs in the free game is as follows.

<Normal Win>

The operation of the liquid crystal display device 134 when a normal win occurs is as follows.

<<Start of Spin>>

As shown in FIG. 20B, at the start of spin, the value of the win meter 413 (see FIG. 10A) is reset to 0 (zero) (if a win occurs in the last play). At this time, the credit meter 412 displays a value obtained by subtracting the bet amount (BET amount) from the credit amount before the start of the spin.

<<Stop of 5th Reel->Win Increment>>

As shown in FIG. 20C, after the last reel (e.g., the fifth reel 105) is stopped, a payout amount resulting from a win (win amount) is displayed on the win meter 413. The win amount is displayed in the incremental manner (such that a number appears digit by digit) (incrementally posted). Simultaneously with the incremental posting on the win meter 413, the win amount displayed on each of the upper image display panel 131 (Top Screen) and the upper middle display region 431 of the liquid crystal display device 134 (cut liquid crystal display) is also incrementally posted.

<<After Increment by Win>> (after Take Win in Gamble Setting)

As shown in FIG. 20D, after the incremental posting described above, the win amount is added (posted), in a lump sum, to the value of the credit meter 412. When, for example, wins occurs on 2 lines, the sum of the win amounts of the 2 lines is added to the value of the credit meter 412.

<Win in Free Game Etc.>

The operation of the liquid crystal display device 134 when a win occurs during the free game is as follows.

<<Start of Spin in Free Game>>

As shown in FIG. 20E, at the start of spin in the free game, the win meter 413 displays the credit amount at the start of the free game (in the present embodiment, the credit amount when the trigger condition for the feature game is satisfied).

<<Stop of 5th Reel->Win Increment>>

As shown in FIG. 20F, after the last reel (e.g., the fifth reel 105) is stopped, the win meter 413 displays the value obtained by adding the win amount in the current play to the sum the win amounts in the previous plays (the current win amount is posted through addition). The addition of the current win amount is displayed in the incremental manner (incrementally posted). Simultaneously, the win amounts respectively displayed on the upper image display panel 131 (Top Screen) and the upper middle display region 431 of the liquid crystal display device 134 (cut liquid crystal display) are also incrementally posted.

<<After Free Game>> (after Take Win in Gamble Setting)

As shown in FIG. 20G, when the free game is finished, the win amount is added (posted), in a lump sum, to the value displayed on the credit meter 412.

<Others> <<Cash in>>

As shown in FIG. 20H, when a gaming value is inserted into the gaming machine, the credit amount corresponding to the amount of the inserted gaming value (e.g., amount of money) is added to the credit amount displayed on the credit meter 412 (posted in a lump sum through addition). At this time, the display on the win meter 413 is not updated (if a win occurs in the last play, the value at that time remains there).

<<Cash Out>>

As shown in FIG. 20I, when the cash out button 31 (see FIG. 3) is pressed down, the value displayed on the credit meter 412 is updated to 0 (zero). At this time, the display on the win meter 413 is not updated (if a win occurs in the last play, the value at that time remains there).

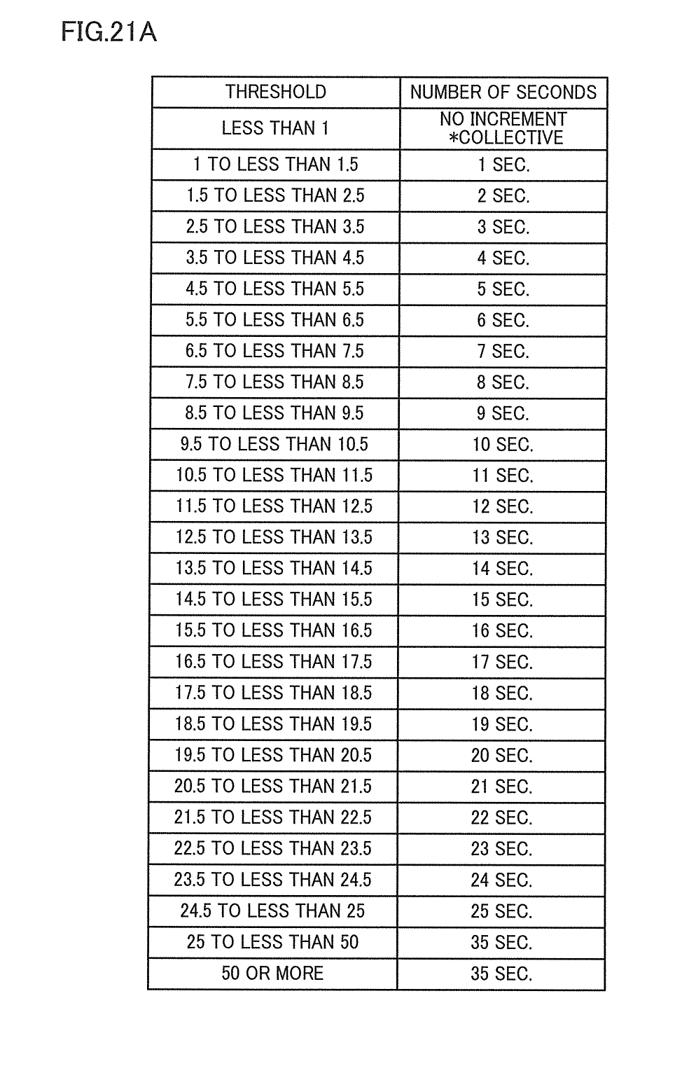

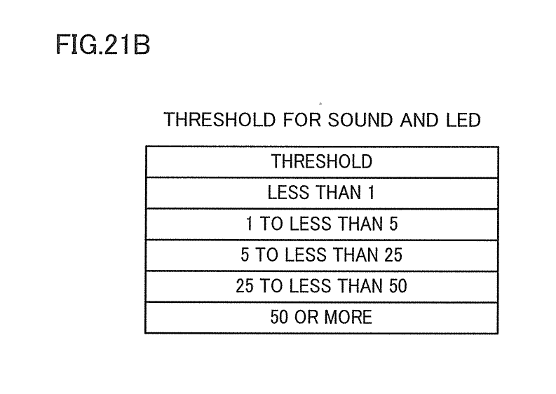

(FIG. 21A, FIG. 21B: Win Increment Speed and the Like)

The speed of the increment (the display manner in which a number appears digit by digit) is managed based on the ratio of the win amount to the bet amount. FIG. 21A shows the relationship between: the range of the ratio of the win amount to the bet amount (“threshold value” in the figure); and the number of seconds during which the increment is performed. For example, when the ratio of the win amount to the bet amount is 2.7, the number of seconds during which the increment is performed is 2 seconds. Further, in accordance with the ratio of the win amount to the bet amount, the type of the effect of sounds and LEDs changes. FIG. 21B shows the ranges of the ratio (“threshold value” in the figure) within each of which the effect of the same type is provided. For example, the effect of sounds and LEDs provided when the above ratio is 1 or more and less than 5 is different, in type, from the effect of sounds and LEDs provided when the above ratio is 5 or more and less than 25.

(Win Effect Flow)

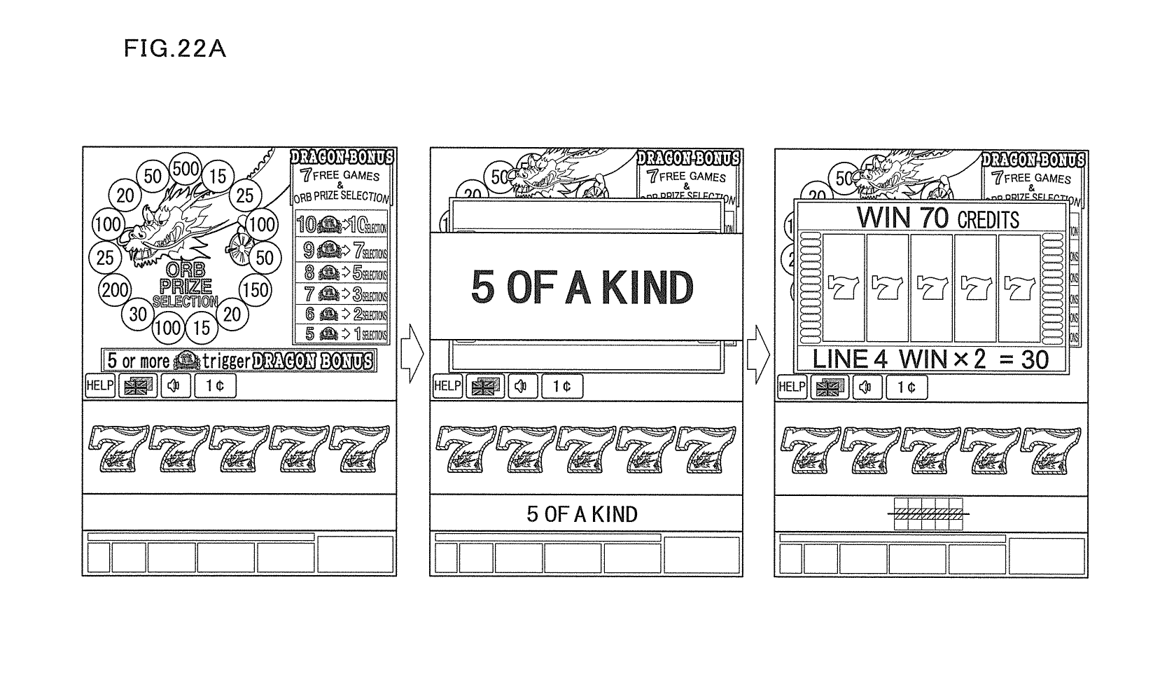

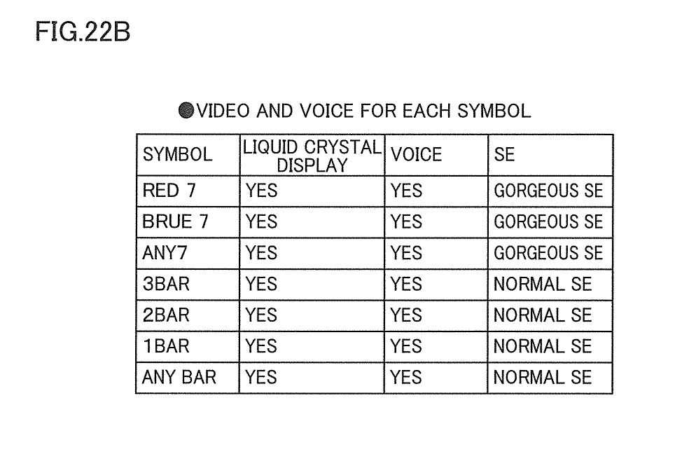

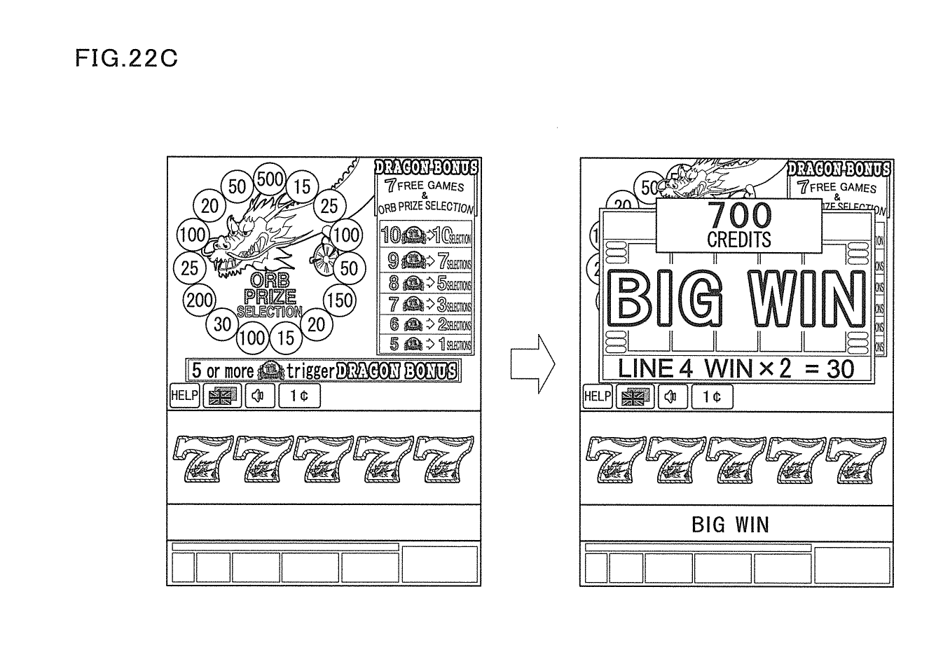

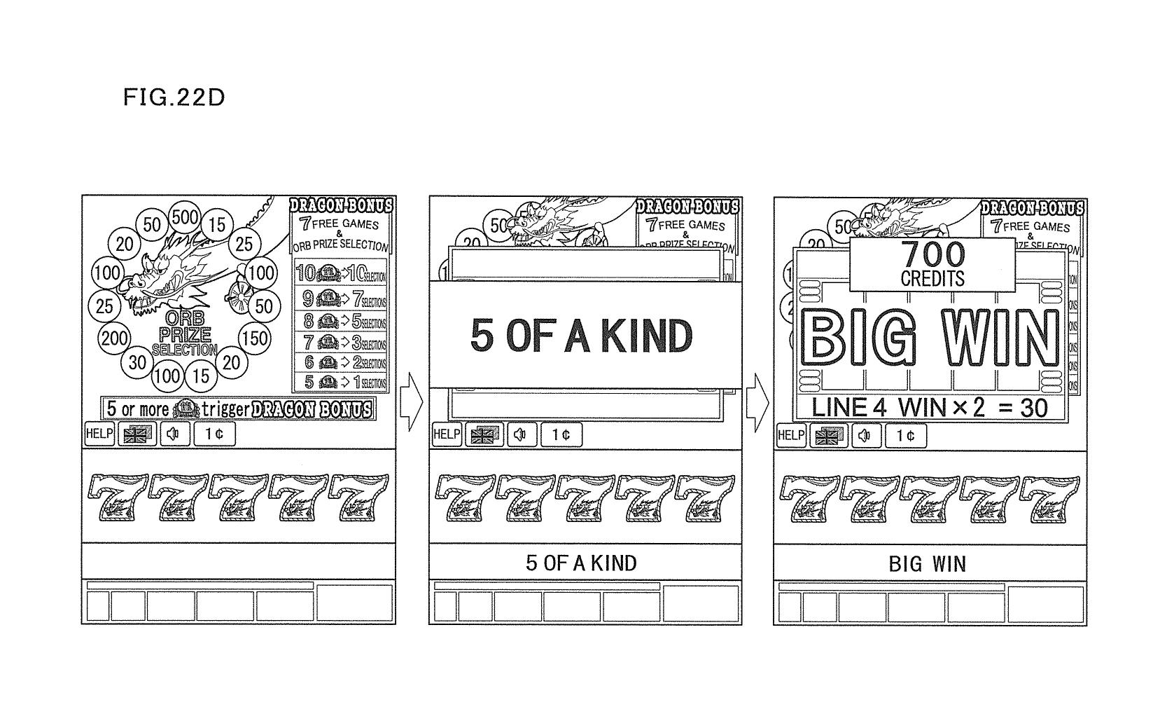

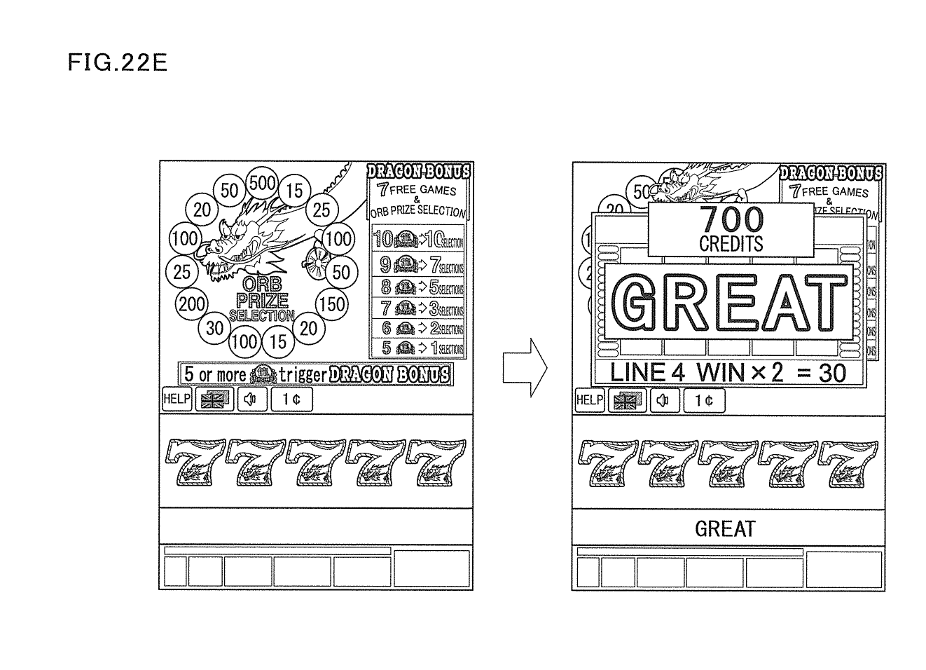

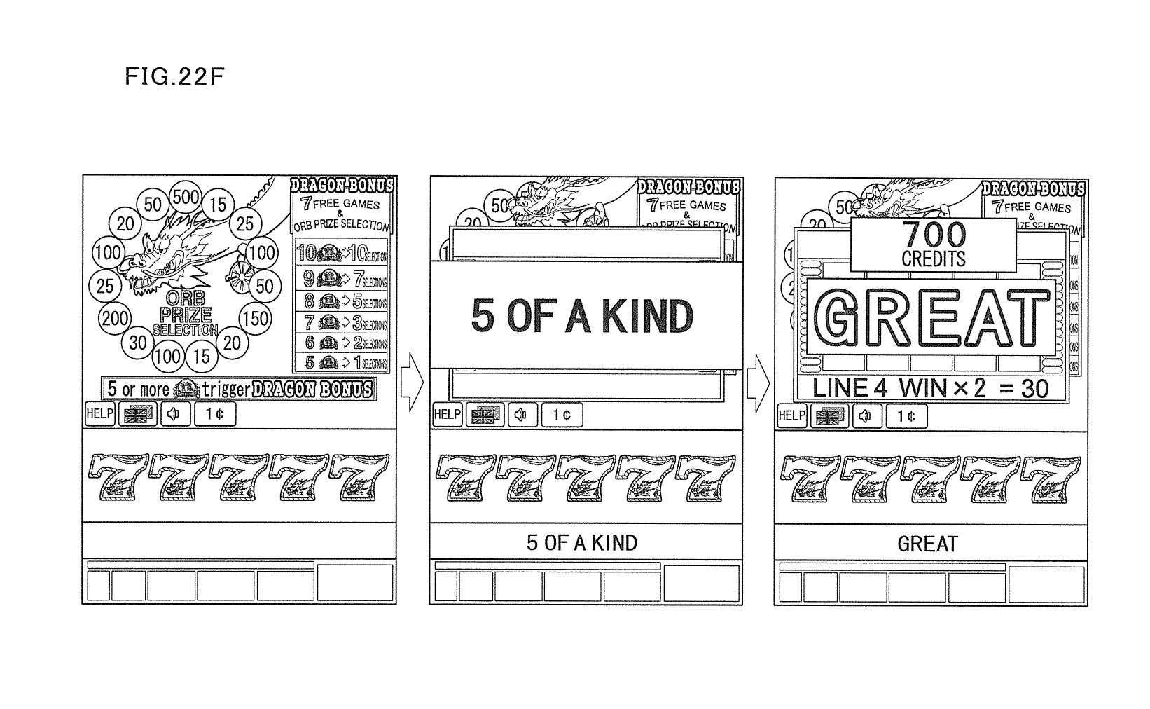

The following describes a win effect flow in the base game with reference to FIG. 22A to FIG. 22F. The win effect is provided on the upper image display panel 131 and the liquid crystal display device 134 (particularly in the upper middle display region 431). The win effect includes: a normal win effect; an effect of “5 OF A KIND”; an effect of “BIG WIN”; and an effect of “GREAT”.

<<5 of a Kind>>

FIG. 22A shows the flow of the effect when a 5-of-a-kind symbol combination occurs. The 5-of-a-kind symbol combination occurs, for example, when 5 symbols 501 (see FIG. 8, the same shall apply hereafter) of the same kind are arranged on a payline. When the 5-of-a-kind symbol combination occurs, an effect using video and sound is provided on the gaming machine, irrespective of the strength of the combination. The flow of this effect is as follows.

A left portion of FIG. 22A shows the state where the reels 101 to 105 are stopped and the 5-of-a-kind combination occurs. As shown in a central portion of FIG. 22A, after the reels 101 to 105 are stopped, the upper image display panel 131 displays “5 OF A KIND” for 2 seconds, for example. At this time, a sound (voice and a sound effect) is reproduced from the speaker 112. Different sounds are reproduced depending on the strength of the combination (strength of the symbols 501). For example, as shown in FIG. 22B, when the 5-of-a-kind combination occurs for any of “RED7”, “BLUE7”, and “ANY7”, the reproduced sound is more gorgeous than the sound reproduced when the 5-of-a-kind combination occurs for any of “3BAR”, “2BAR”, “1BAR”, and “ANY BAR”. At this timing, the increment of the payout is not started. As shown in a right portion of FIG. 22A, when a payout occurs, the increment of the payout and the display of the line win are performed on the upper image display panel 131 and the liquid crystal display device 134. At this time, the symbols 501 blink.

<<Big Win (No 5-of-a-Kind Combination>>

FIG. 22C shows the flow of the effect provided when a “big win” occurs without the 5-of-a-kind symbol combination. A left portion of FIG. 22C shows the state where the reels 101 to 105 are stopped. At this time, a win the amount of which is not less than 5 times and less than 25 times the bet amount occurs, that is, the big win occurs.

As shown in a right portion of FIG. 22C, after the reels 101 to 105 are stopped, the upper image display panel 131 and the liquid crystal display device 134 each displays the text of “BIG WIN”. This text is cleared, for example, 5 seconds after the start of the display of the text. Simultaneously with the display of the text of “BIG WIN”, the upper image display panel 131 displays the win line (WIN LINE). The upper image display panel 131 displays the text of “BIG WIN” over the win line display (so that the text overlaps of the win line display). At the timing when the upper image display panel 131 starts the display of the text of “BIG WIN”, the upper image display panel 131 starts the increment on a big meter exclusive to the big win. This exclusive meter is not displayed on the liquid crystal display device 134. The text of “BIG WIN” disappears when the next spin is started or when the cash out button 31 is pressed down. The display of the “BIG WIN” and the increment can be skipped immediately.

<<Big Win (with 5-of-a-Kind Combination)>>

FIG. 22D shows the flow of the effect provided when the big win occurs with the 5-of-a-kind combination. A left portion of FIG. 22D shows the state where the reels 101 to 105 are stopped. At this time, a win the amount of which is not less than 5 times and less than 25 times the bet amount occurs, that is, the big win occurs.

As shown in a central portion of FIG. 22D, after the reels 101 to 105 are stopped, the upper image display panel 131 and the liquid crystal display device 134 each displays “5 OF A KIND” for the time length of 2 seconds, for example. At this time, a sound is reproduced from the speaker 112. Different sounds are reproduced depending on the strength of the combination (strength of the symbols 501). At this timing, the increment of the payout and the like are not started.

As shown in a right portion of FIG. 22D, after displaying the text of “5 OF A KIND”, the upper image display panel 131 and the liquid crystal display device 134 each displays the text of “BIG WIN”. The text of “BIG WIN” disappears, for example, 5 seconds after the start of the display of the text. At the timing when the upper image display panel 131 starts the display of the text of “BIG WIN”, the upper image display panel 131 starts the increment on the big meter exclusive to the big win. The text of “BIG WIN” disappears when the next spin is started or when the cash out button 31 is pressed down. Simultaneously with the display of the text of “BIG WIN”, the upper image display panel 131 displays the win line (similarly to the above flow).

<<Great Win (No 5-of-a-Kind Combination>>

FIG. 22E shows the flow of the effect provided when a great win occurs without the 5-of-a-kind symbol combination. A left portion of FIG. 22E shows the state where the reels 101 to 105 are stopped. At this time, a win the amount of which is not less than 25 times the bet amount occurs, that is, the great win occurs.

As shown in a right portion of FIG. 22E, after the reels 101 to 105 are stopped, the upper image display panel 131 and the liquid crystal display device 134 each displays the text of “GREAT”. This text disappears, for example, 10 seconds after the start of the display of the text. Simultaneously with the display of the text of “GREAT”, the upper image display panel 131 starts the win line display. The upper image display panel 131 displays the text of “GREAT” over the win line display (so that the text overlaps the win line display). At the timing when the upper image display panel 131 starts the display of the text of “GREAT”, the upper image display panel 131 starts the increment on a big meter exclusive to the great win. This exclusive meter is not displayed on the liquid crystal display device 134. The text of “GREAT” disappears when the next spin is started or when the cash out button 31 is pressed down. The display of the “GREAT” and the increment can be skipped immediately.

<<Great Win (with 5-of-a-Kind Combination)>>

FIG. 22F shows the flow of the effect provided when the great win occurs with the 5-of-a-kind combination. A left portion of FIG. 22F shows the state where the reels 101 to 105 are stopped. At this time, a win the amount of which is not less than 25 times the bet amount occurs, that is, the great win occurs.

As shown in a central portion of FIG. 22F, after the reels 101 to 105 are stopped, the upper image display panel 131 and the liquid crystal display device 134 each displays “5 OF A KIND” for the time length of 2 seconds, for example. At this time, a sound is reproduced from the speaker 112. Different sounds are reproduced depending on the strength of the combination (strength of the symbols 501). At this timing, the increment of the payout and the like are not started.

As shown in a right portion of FIG. 22F, after displaying the text of “5 OF A KIND”, the upper image display panel 131 and the liquid crystal display device 134 each displays the text of “GREAT”. The text of “GREAT” disappears, for example, 10 seconds after the start of the display of the text. At the timing when the upper image display panel 131 starts the display of the text of “GREAT”, the upper image display panel 131 starts the increment on the big meter exclusive to the great win. The text of “GREAT” disappears when the next spin is started or when the cash out button 31 is pressed down. Simultaneously with the display of the text of “GREAT”, the upper image display panel 131 displays the win line.

(LED Illumination Provided when Win Occurs)

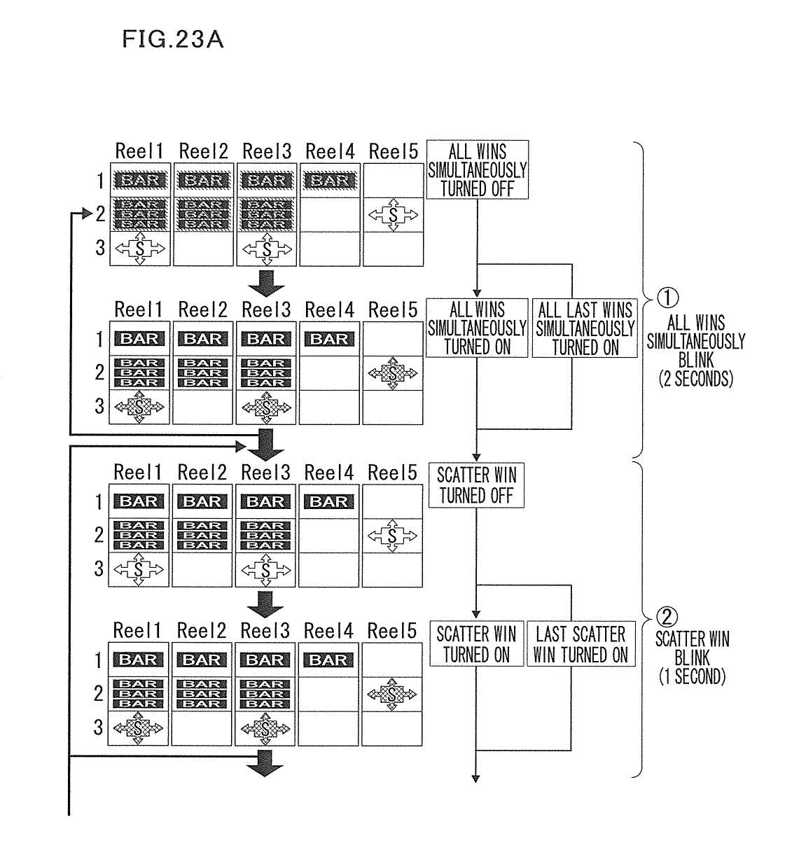

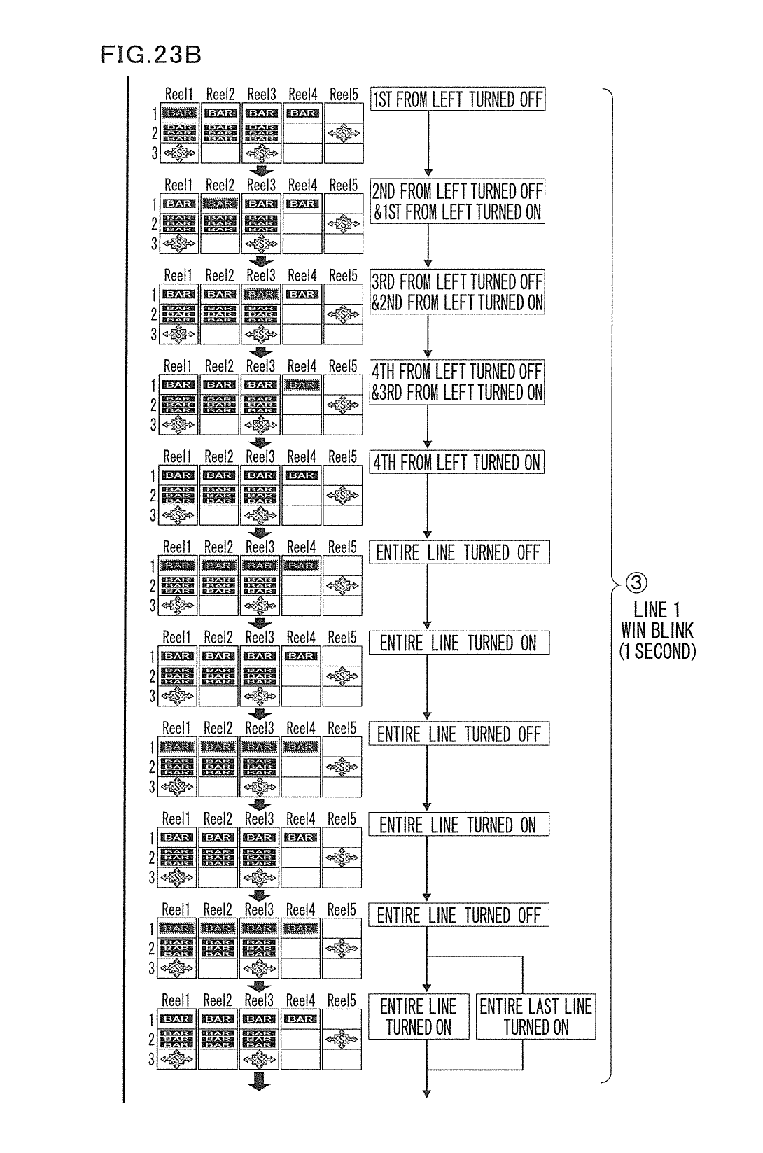

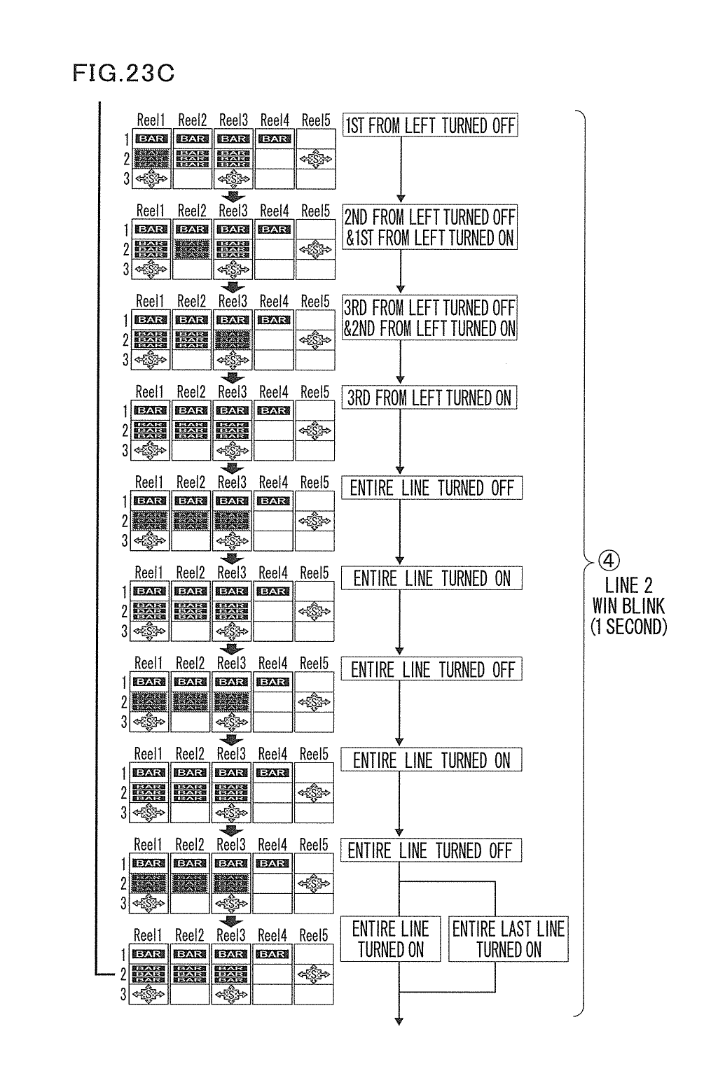

The following describes the effect of LED illumination on the reels 101 to 105, with reference to FIG. 23A to FIG. 23C. The effect of the LED illumination is performed in accordance with the flow shown in FIG. 23A to FIG. 23C. For example, reference is made to a case where the following wins occur in a 3-line game: a scatter win; a first line win (LINE 1) (4-of-a-kind symbol combination for “1BAR”); and a second line win (line 2) (3-of-a-kind symbol combination for “3BAR”. In this case, the following processes (1) to (4) are executed. In the above-described embodiments, only the 30-line game is executed. However, in a modification, the 3-line game may be executed.

(1) As shown in FIG. 23A, the symbols 501 associated with all the wins (the scatter win, and the line wins) blink (for 2 seconds in total). Because the symbols are in an on state at the time when the reels 101 to 105 are stopped, the blink starts with turning off (OFF state) of the symbols, and ends with a normal state (turning on, ON state) of the symbols (the same shall apply hereafter).

(2) Then, the symbols (scatter symbols) associated with the scatter win blink concurrently (for 1 second in total).

Then, as shown in FIG. 23B and FIG. 23C, the symbols 501 associated with the line wins blink. When a plurality of line wins occur, the blink is performed for each line win (for 1 second per line win). The details are as follows.

(3) First, the symbols associated with the 1st line (e.g., the 4-of-a-kind symbol combination for “1BAR”) blink in such a manner that light passes from the left (“symbol LED stream”). Then, the whole line blinks (for 1 second in total). The symbol LED stream is specifically provided as follows. First, the leftmost symbol is turned off. Then, the second symbol from the left end is turned off and the leftmost symbols is turned on. Then, the third symbol from the left end is turned off and the second symbol from the left end is turned on. Then, the fourth symbol from the left end is turned off and the third symbol from the left end is turned on. Then, the fourth symbol from the left end is turned on.

(4) Subsequently, the symbols associated with the 2nd line (e.g., the 3-of-a-kind symbol combination for “3BAR”) blink in such a manner that light passes from the left. Then, the whole line blinks (for 1 second in total).

The above-described effect of LED illumination is used, for example, in the following situations (A) to (E). In the above-described embodiments, the situations (C) and (D) do not occur. However, in a modification, one of the situations (C) and (D) may occur. (A) During the base game (normal game). (B) During the free game. (C) Base game after obtainment of the free game (occurrence of the trigger). (D) Base game after of obtainment of mystery bonus (non-occurrence of trigger, NON TRIGGER). (E) When the retrigger is obtained.

The priority of the above-described effect of the LED illumination (order of displaying the wins) is as follows: scatter wins are displayed first, and then line wins are displayed in an ascending order according to the numbers of the line wins (for example, according to the numbers assigned to the lines on which the line wins occur).

In the base game, the effect of LED illumination continues until the next play of the game is started. In the free game, the above-described effect of LED illumination is provided at least once, for example. After the effect of LED illumination is completed, it is determined (checked) whether the win increment is completed, and whether a standby time (5 seconds) has elapsed. When these conditions are both satisfied, transition to the next game occurs. If the player executes one of the following operations of: skip; and cancel of the win increment, during the blink of the symbols 501 (during the win increment), the executed operation is accepted (if these functions are incorporated in the gaming machine).

(Win Signboard Etc. (Line Win Display))

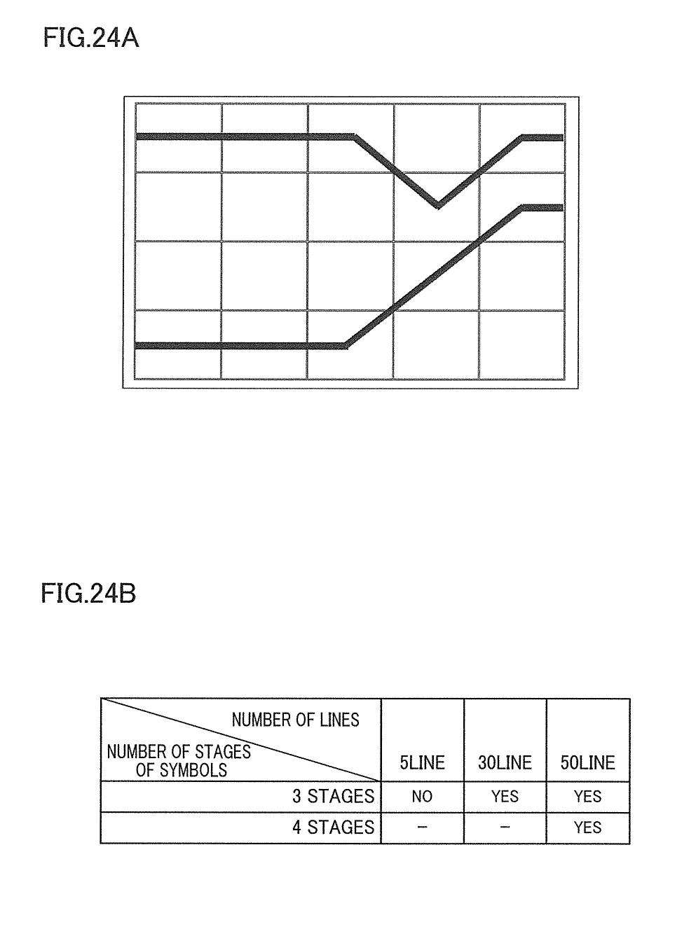

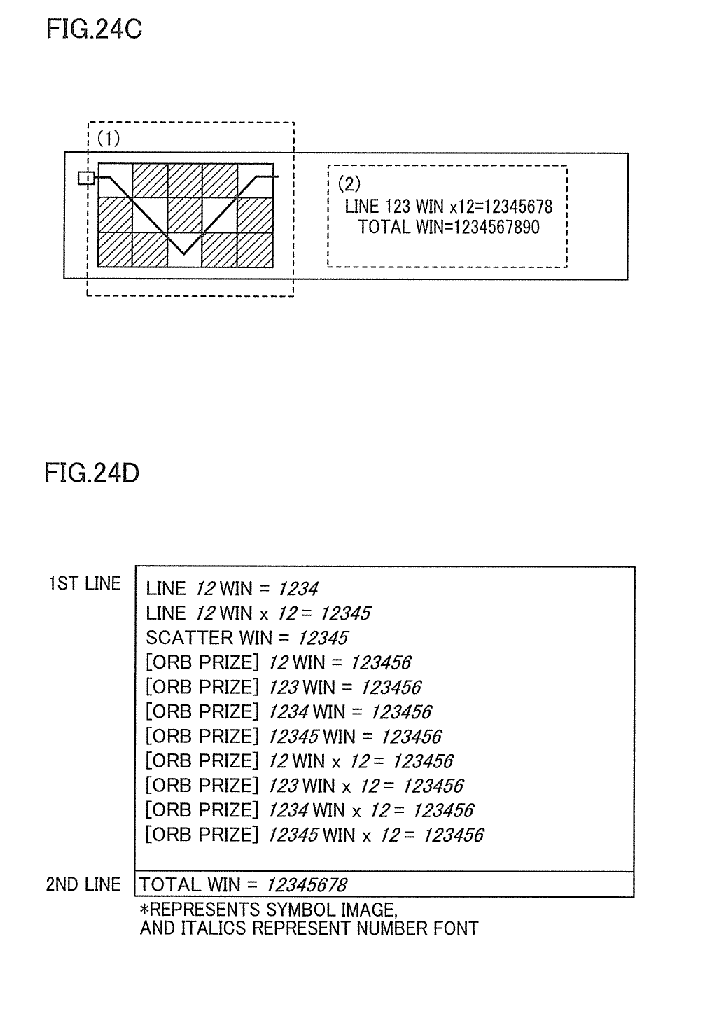

The following describes the line win display (“LINE WIN display”) on the win signboard, with reference to FIG. 24A to FIG. 24B. As shown in FIG. 8, when line wins occur, the upper image display panel 131 (2nd screen) and the liquid crystal display device 134 (cut liquid crystal display) each displays the win signboard, and displays the lines on each of which a win occurs (win lines). As shown in FIG. 8 and FIG. 24A, each win line displayed there passes through the centers of the symbols, and the number of each line is not displayed. When line wins occur on a plurality of lines at the same time, the upper image display panel 131 and the liquid crystal display device 134 each displays the win lines concurrently (performs “concurrent display of win lines”). This makes an appeal, and facilitates recognition of the fact that the line wins occur on the plurality of lines at the same time.

FIG. 24B shows the relationship between the number of the lines, the number of stages of the symbols, and execution or non-execution of the concurrent display of win lines. When the number of the lines is 30 (30 LINE in the figure) or 50, the concurrent display of win lines is executed. When the number of the line is 5 and the number of the stages of the symbols is 3, the above-described effect (making an appeal and facilitating the recognition of concurrent occurrence of line wins on a plurality of lines) is not brought about. Therefore, the concurrent display of win lines is not executed. In the above-described embodiments, the number of the lines is fixed to 30, and the number of the stages of the symbols is 3. However, the number of the lines and the number of the stages of the symbols may be changed.

The win signboard displayed on the upper image display panel 131 shown in FIG. 8 is cleared when any of the following conditions (1) to (3) is satisfied. Note that the win signboard displayed on the liquid crystal display device 134 is not cleared even when any of the following conditions (1) to (3) is satisfied. (1) When the cash out button 31 is pressed down (for example, not at the time of TAKE WIN, but the time of CASH OUT). (2) When any of the bet buttons 34 to 38 (a play button, if provided) or the repeat bet button 46 is pressed. (3) When the machine recovers from an error state.

(Win Signboard on Liquid Crystal Display Device 134)

The following describes the win signboard on the liquid crystal display device 134, with reference to FIG. 24C. The win signboard (information about a win) displayed on the liquid crystal display device 134 enables the player to understand the details of the win without the upper image display panel 131. The win signboard on the liquid crystal display device 134 is constituted by: the display of the win line etc. (Area (1) in the figure); and the display of the win amount (Area (2) in the figure).

<Display of Win Line Etc.>

The liquid crystal display device 134 displays, in Area (1) in FIG. 24C, the win line on which the line win occurs, or symbols forming the scatter win. On the liquid crystal display device 134, symbol positions (areas corresponding to the positions of the symbols) associated with a win blink. Differently from the win signboard on the upper image display panel 131, the liquid crystal display device 134 does not display symbol pictures. In a modification in which the gaming machine is configured so that a progressive payout can be awarded corresponding to a combination of the symbols 501 displayed in the display window 150, an effect corresponding to the winning (blink of symbols associated with the winning of the progressive payout, for example) is provided at the time of winning.

<Display of Win Amount>

The liquid crystal display device 134 displays the win amount in Area (2) in FIG. 24C. The win amount is displayed in 2 lines. The displayed win amount includes: a win amount for the win displayed in the above “display of win line etc.” (1st line); and a “total win amount in the concerned spin result” (2nd line). The “total win amount in the concerned spin result” is, for example, the sum of: the win amount for the win displayed in the “display of win line etc.”; and the win amount(s) provided by one or more wins occurring simultaneously with this win. The total win amount is displayed after the win increment on the win meter 413 is completed.

Example 1 and Example 2 described below each shows how the win amount is displayed.

Example 1: LINE 123 win×12=12345678

### TOTAL WIN=12345678

### Example 2: PROGRESSIVE WIN=1234567890

### TOTAL WIN=1234567890

The details of each line are as follows. In the 1st line, one of “LINE”, “SCATTER”, “XX PRIZE WIN” (only in the free game), and “PROGRESSIVE WIN” is displayed by switching the display. To be more specific, these texts are displayed in the following manner. When a line win occurs, “LINE” is displayed. When a scatter win occurs, “SCATTER” is displayed. When some prize win (this is not set in the above-described embodiments) occurs, “-PRIZE WIN” is displayed. When a progressive win occurs (a progressive payout is won), “PROGRESSIVE WIN” is displayed. Next to each text, its win amount is displayed.

In the 2nd line, the total win is displayed. To be more specific, there is displayed the text of “TOTAL WIN” and the total win amount. FIG. 24D shows a list of contents of display for the win amount.

<Other Display Manner of Win Signboard on Liquid Crystal Display Device 134>

The timing of starting the display, the timing of clearing the display, and switching of display on the win signboard of the liquid crystal display device 134 are basically the same as those on the win signboard of the upper image display panel 131. The difference between the win signboard of the liquid crystal display device 134 and the win signboard of the upper image display panel 131 is as follows: while symbol pictures are displayed on the upper image display panel 131, the symbol pictures are not displayed on the liquid crystal display device 134.

<Flow of Win Signboard>

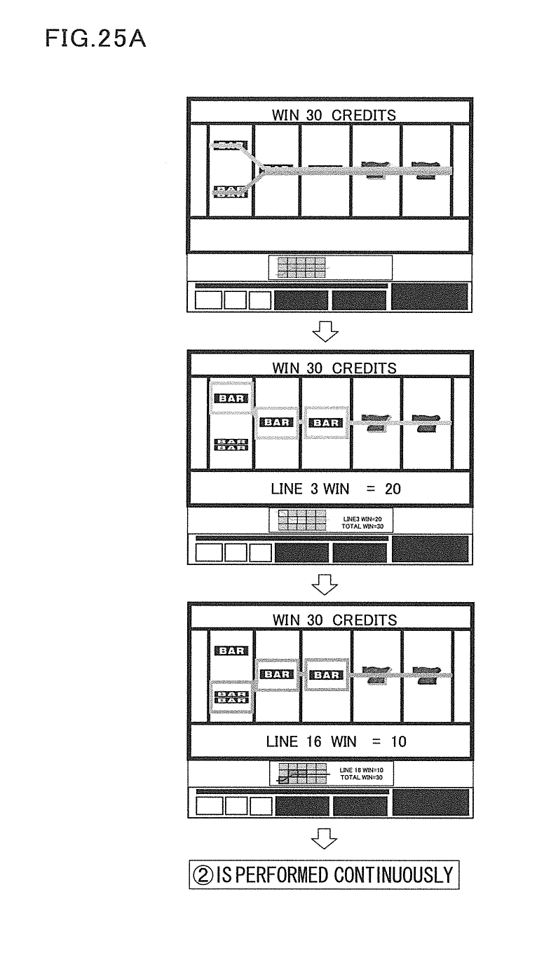

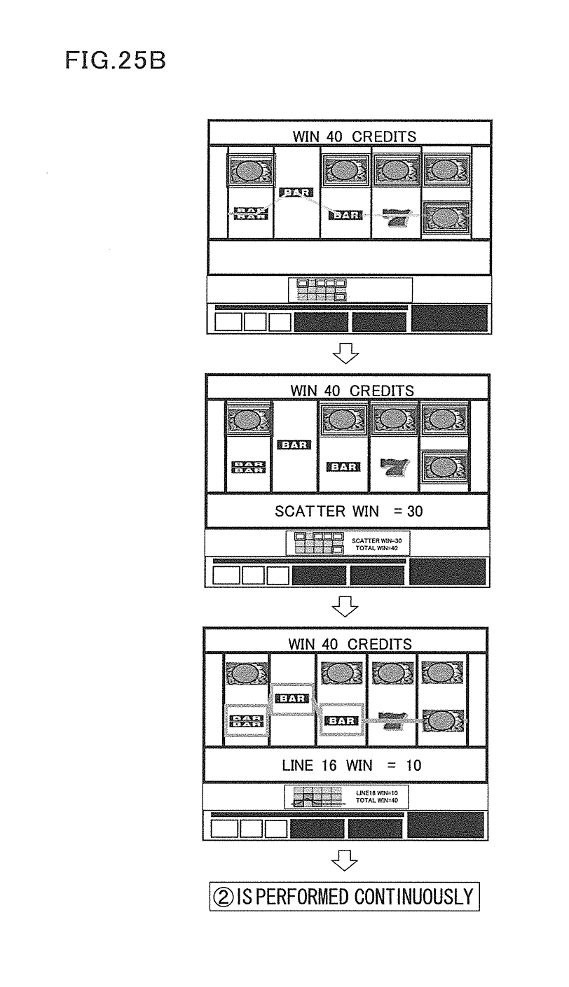

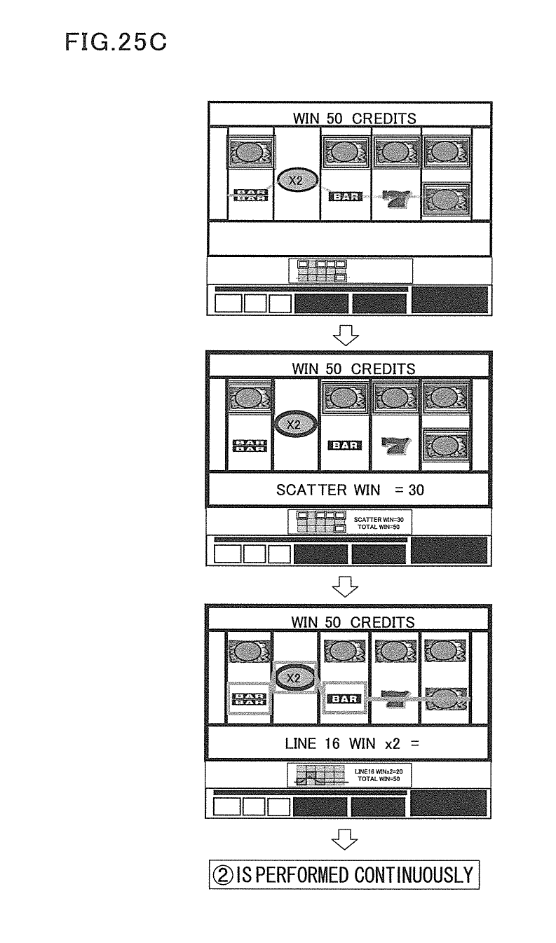

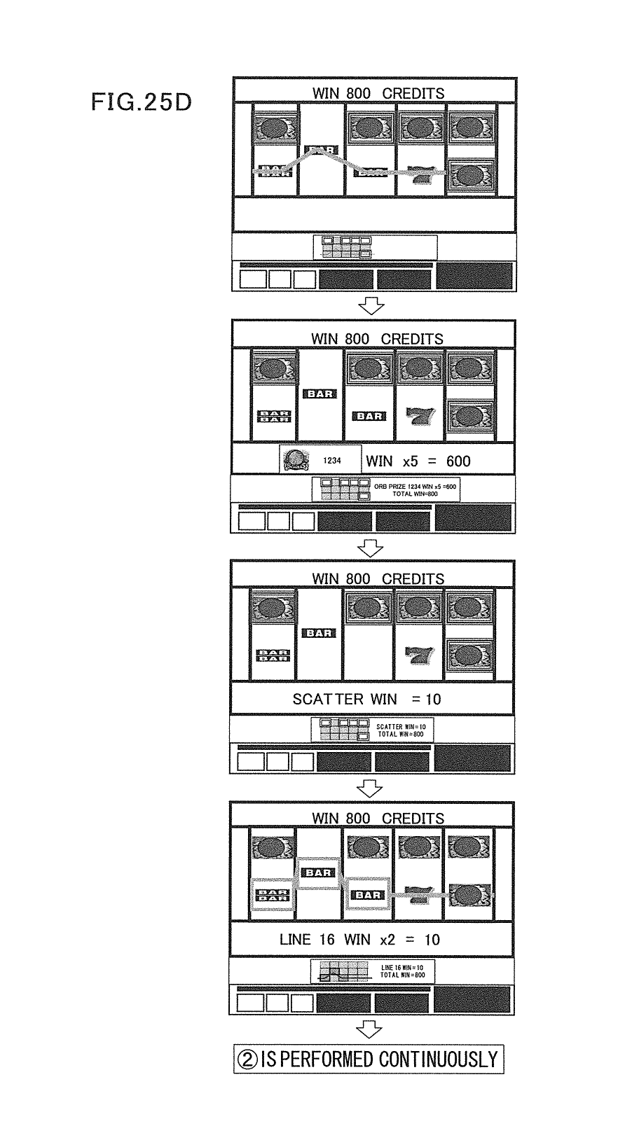

With reference to FIG. 25A to FIG. 25D, the following describes the flow of the display of the win signboard (particularly the line win signboard). FIG. 25A to FIG. 25D each illustrates the upper image display panel 131 and the liquid crystal display device 134. The display window 150 is not illustrated.

<Display of Win in Base Game (No Scatter Win)>

FIG. 25A shows the flow of displaying the win signboard when a line win occurs in the base game without a scatter win.

An upper portion of FIG. 25A is the screen display at the time of “all wins concurrently blink (for 2 seconds)” (LED blink time (concurrent display of win lines)) in FIG. 23A. At this time, the upper image display panel 131 performs increment display (see “WIN 30 CREDITS” in the figure) in sync with (simultaneously with) the win meter 413 of the liquid crystal display device 134. The upper image display panel 131 and the liquid crystal display device 134 each performs the concurrent display of win lines for 2 seconds, correspondingly to the time length during which the symbols on the reels 101 to 105 blink (symbol blink). The symbols displayed on the upper image display panel 131 and the liquid crystal display device 134 blink (the blink continues after this). As described above, the liquid crystal display device 134 does not display the total win amount until the increment of the win meter 413 is finished. Note that in the 5-line game, this phase (such as the display shown in FIG. 25A) is not performed.

Middle and lower parts of FIG. 25A each shows the screen display at the time when the symbol LED stream is performed on the reels 101 to 105 (symbol LED stream time, at the time of individual win line display, see FIG. 23B). As shown in a middle part of FIG. 25A, the upper image display panel 131 and the liquid crystal display device 134 each performs the “individual display of win lines” at 1-second rate, correspondingly to the time length of symbol LED stream. The “individual display of win lines” is display of win lines (line, frame, and the like) respectively corresponding to a plurality of line wins. In the individual display of win lines, each of the win symbols (symbols forming each line win) on each line is surrounded by a frame, on each of the upper image display panel 131 and the liquid crystal display device 134. As shown in middle and lower parts of FIG. 25A, when there are the plurality of win lines, the win line to be displayed is switched per second. The win lines are displayed in an ascending order according to the numbers of the lines. Thereafter, the screen display shown in the middle and lower parts of FIG. 25A is continued.

<Display of Win in Base Game (with Scatter Win)>

FIG. 25B shows the flow of displaying the win signboard in the case where a scatter win occurs and a line win occurs in the base game.

An upper part of FIG. 25B shows the screen display at the time of “all wins concurrently blink (for 2 seconds)” (LED blink time (concurrent display of win lines)) in FIG. 23A. At this time, the upper image display panel 131 performs increment display (see “WIN 40 CREDITS” in the figure) in sync with (simultaneously with) the win meter 413 of the liquid crystal display device 134. The upper image display panel 131 and the liquid crystal display device 134 each performs the concurrent display of the symbols forming the scatter win and the win lines for 2 seconds, so as to correspond to the time length during which the symbols on the reels 101 to 105 blink (symbol blink). The symbols displayed on the upper image display panel 131 and the liquid crystal display device 134 blink (the blink continues after this). On each of the upper image display panel 131 and the liquid crystal display device 134, each of the symbols forming the scatter win is surrounded by a frame. As described above, the liquid crystal display device 134 does not display the total win amount until the increment of the win meter 413 is finished. Note than in a 5-line game, this phase (such as the display shown in FIG. 25A) is not performed.

Middle and lower parts of FIG. 25B each show the screen display at the time when symbols associated with each win blink on the reels 101 to 105. As shown in the middle part of FIG. 25B, on each of the upper image display panel 131 and the liquid crystal display device 134, each of the symbols forming the scatter win is surrounded by a frame (display of scatter). The display of scatter is performed correspondingly to the time length (for 1 second) of blink of symbols forming the scatter win on the reels 101 to 105 (see “SCATTER WIN BLINK” in FIG. 23A). Then, the upper image display panel 131 and the liquid crystal display device 134 each performs “individual display of win lines” at 1-second rate (in the same manner as above), correspondingly to the time length of the symbol LED stream. As shown in middle and lower parts of FIG. 25B, when there are the plurality of win lines, the win line to be displayed is switched per second. Thereafter, the screen display shown in the middle and lower parts of FIG. 25B is continued.

<Display of Win in Base Game (with “DOUBLE”)>

FIG. 25C shows the flow of displaying the win signboard in the case where a line win including a “DOUBLE” symbol occurs in the base game. In the above-described embodiments, the “DOUBLE” symbol is not used. However, in a modification, the “DOUBLE” symbols may be used. Also in this case, the display similar to that shown in FIG. 25B is produced.

<Display of Win in Free Game (with Scatter (Bonus) Win)>

FIG. 25D shows the flow of displaying the win signboard in the case where a scatter win occurs and a line win occurs in the free game. As shown in an upper screen of FIG. 25D, concurrent display of the symbols forming the scatter win and the win line is performed, in the same manner as the upper part in FIG. 25B. Then, as shown in upper middle and lower middle parts in FIG. 25D, each of the symbols forming the scatter win is surrounded by a symbol frame. At this time, as shown in the upper middle part in FIG. 25D, display regarding “ORB PRIZE WIN” is produced, and thereafter, display regarding the scatter win is produced. In the above-described embodiments, the “ORB PRIZE WIN” is not set. However, in a modification, the “ORB PRIZE WIN” may be set. Then, the upper image display panel 131 and the liquid crystal display device 134 each performs “individual display of win lines” at 1-second rate (in the same manner as above), correspondingly to the time length of the symbol LED stream. Thereafter, the display shown in the upper middle, lower middle, and lower parts in FIG. 25D is continued.

The display of the win signboard in the free game is continued until the following condition is satisfied. When the win increment is performed for the period not more than 5 seconds, the win signboard in the free game is kept displayed for 5 seconds. When the win increment is performed for the period more than 5 seconds, the win signboard in the free game is kept displayed until the win increment is completed. When the win increment is skipped (an operation of increment skip is performed), the win signboard in the free game is cleared, and then the next play of the game is started.

(Game Progress and Screen Display)

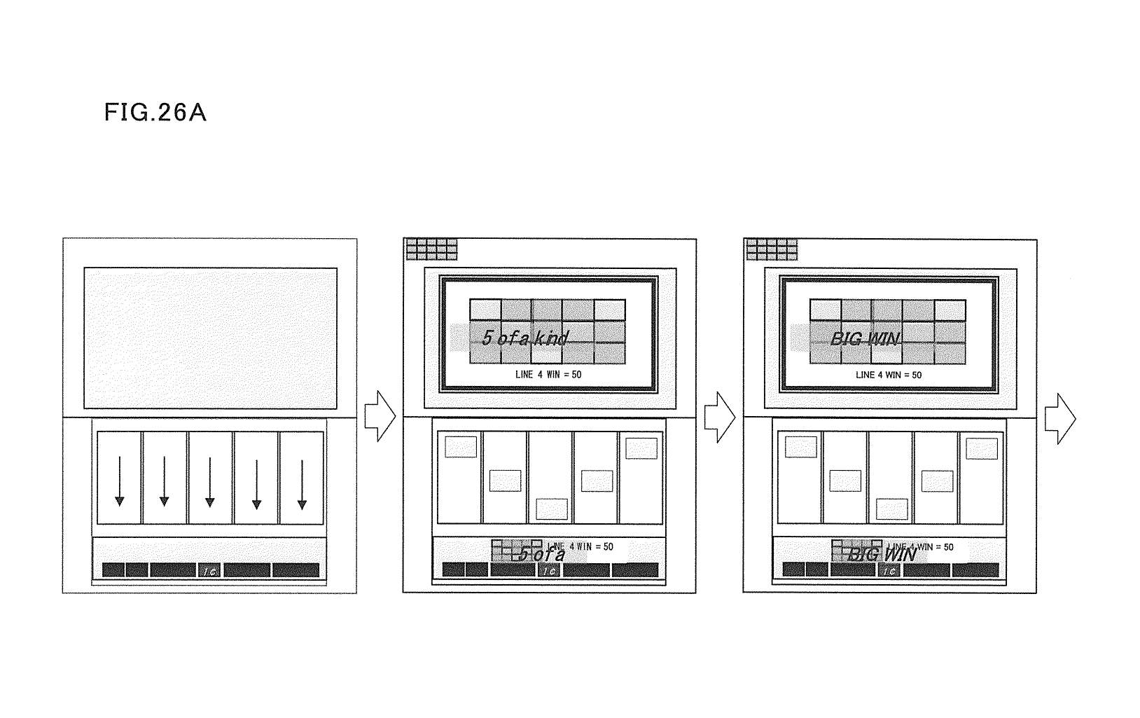

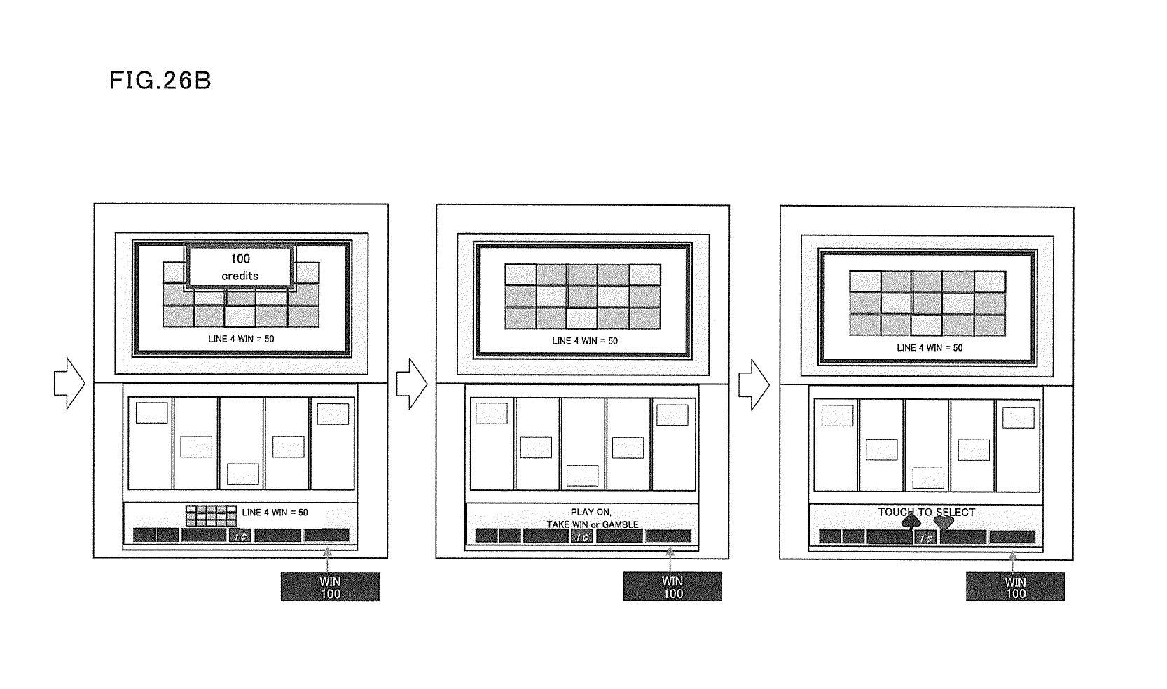

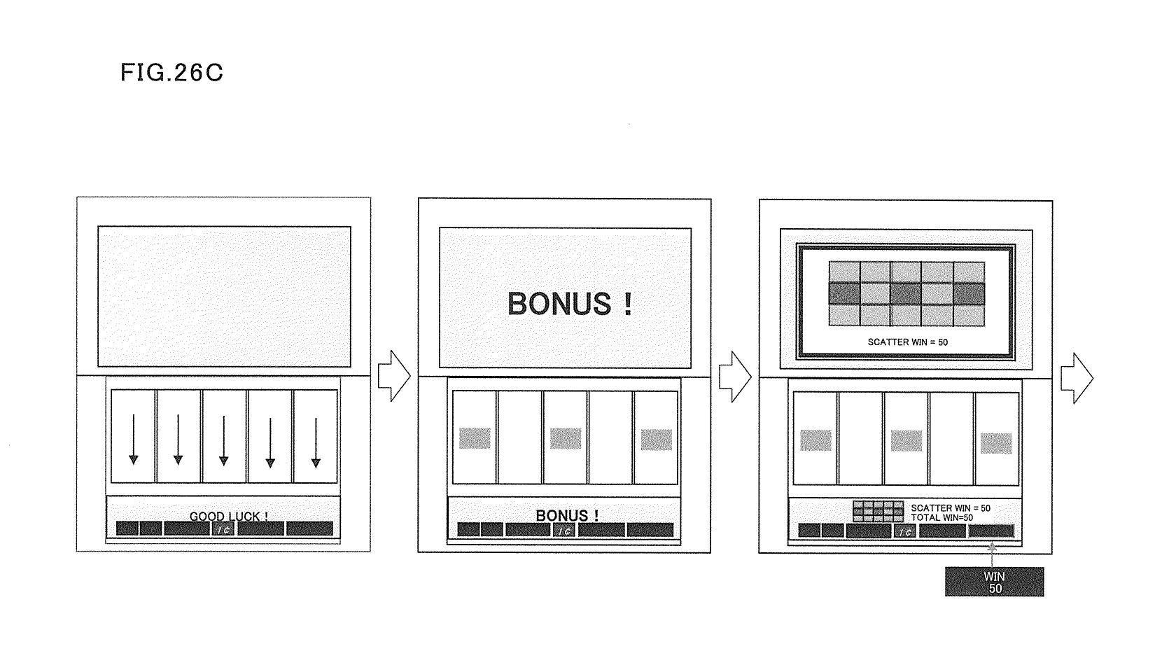

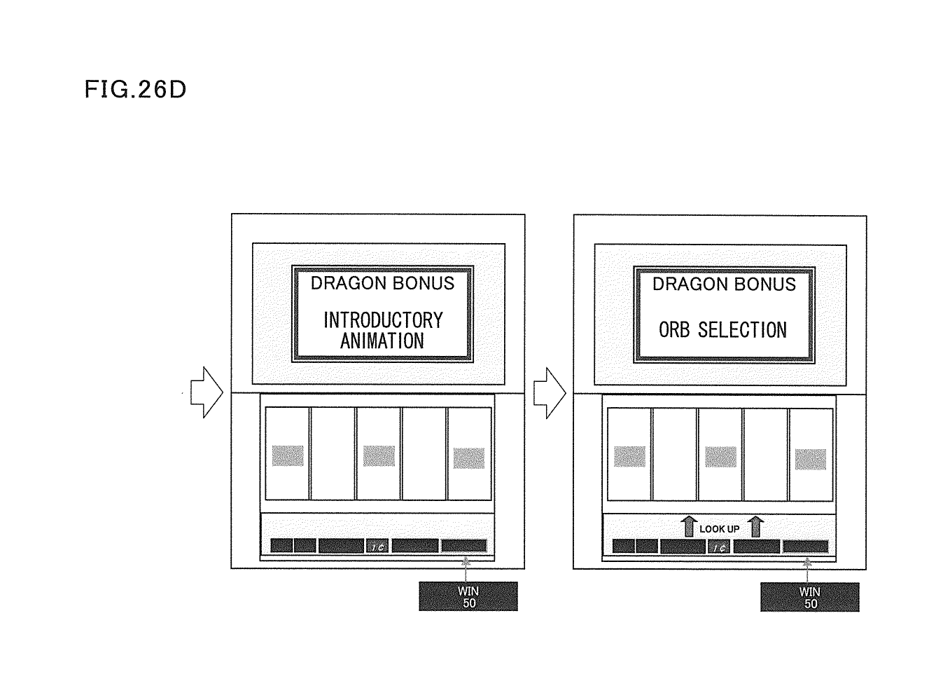

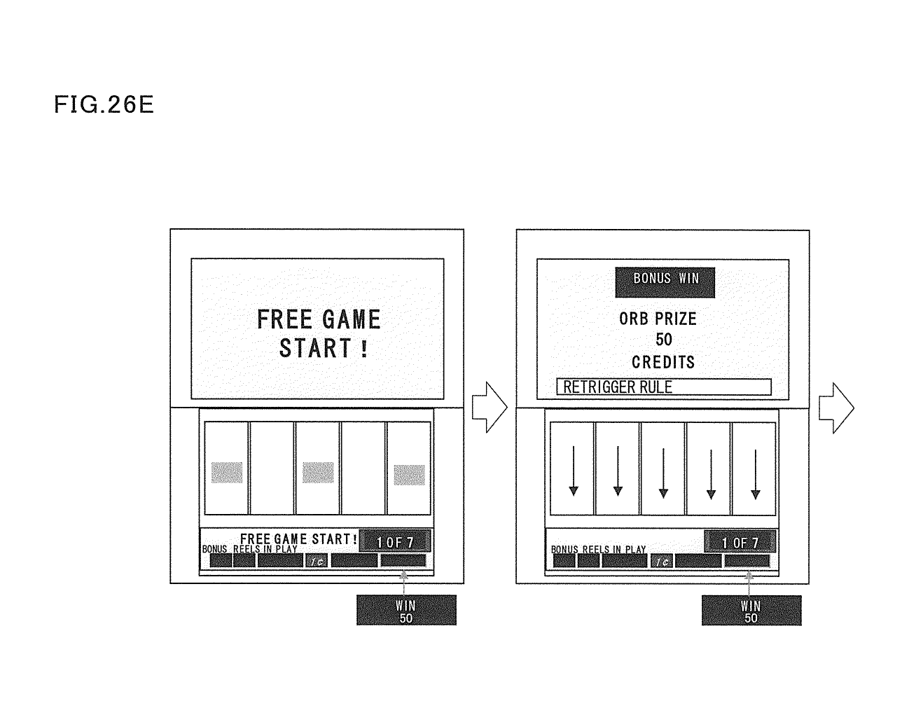

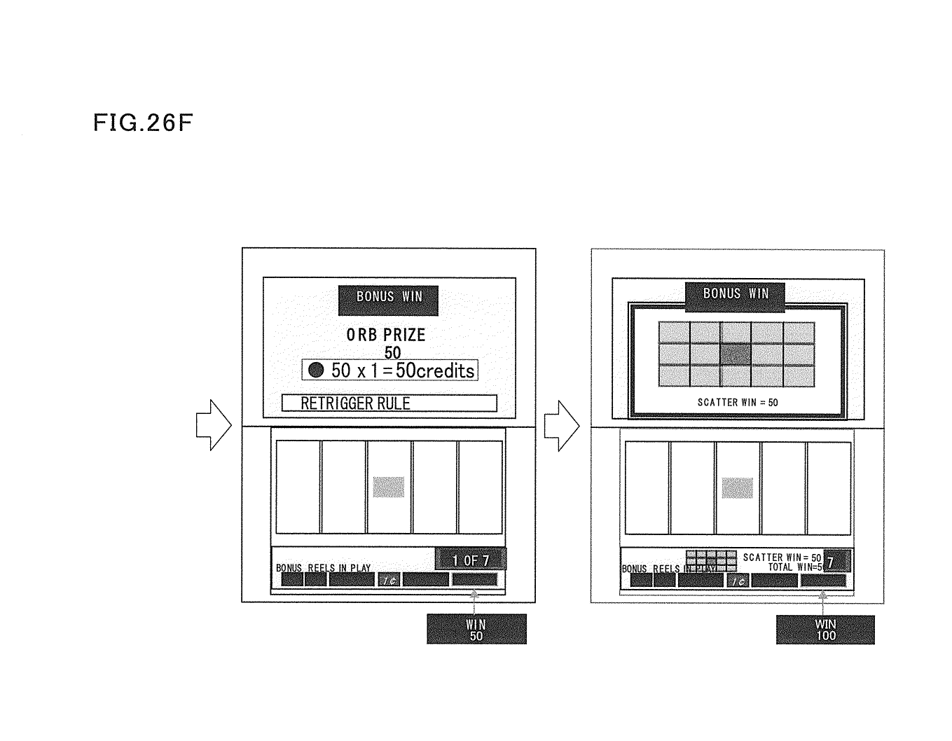

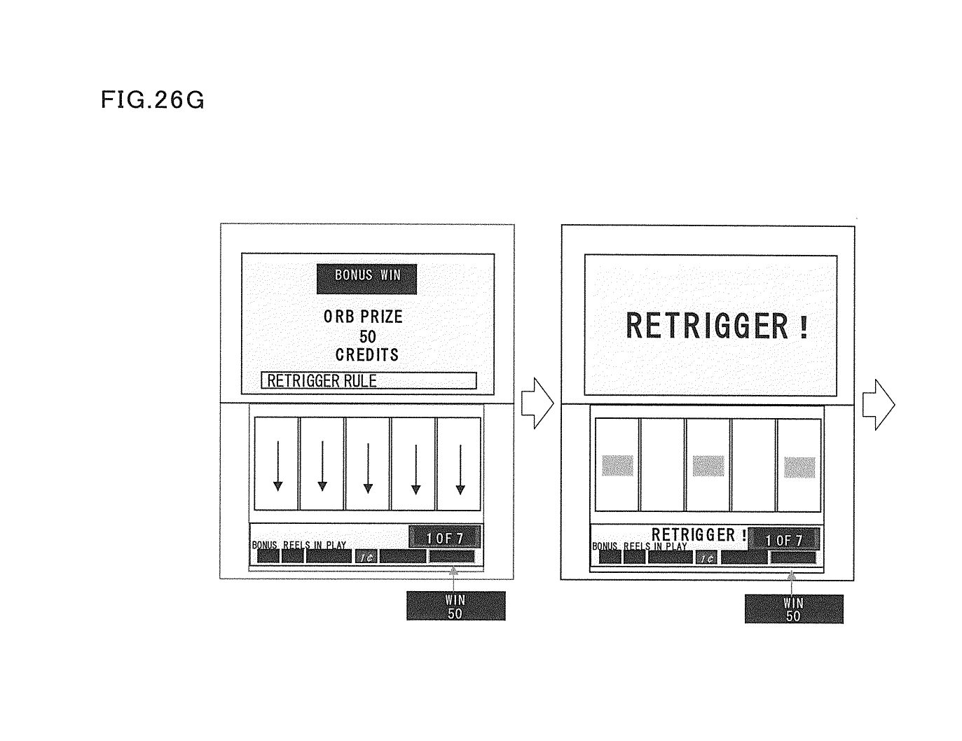

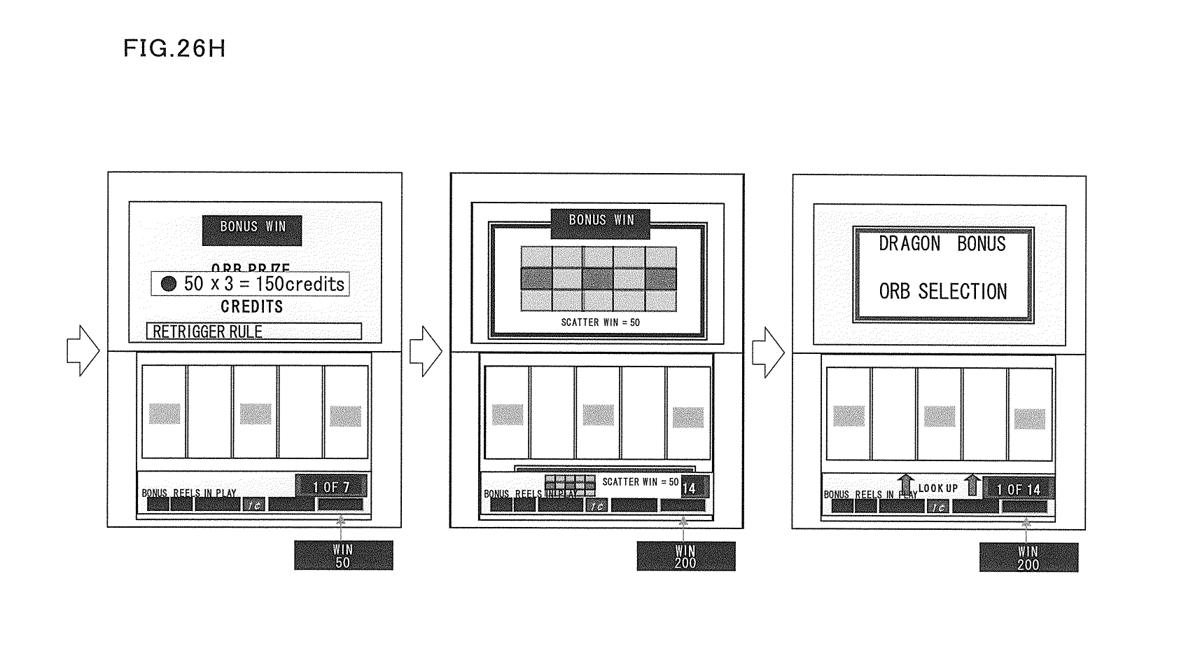

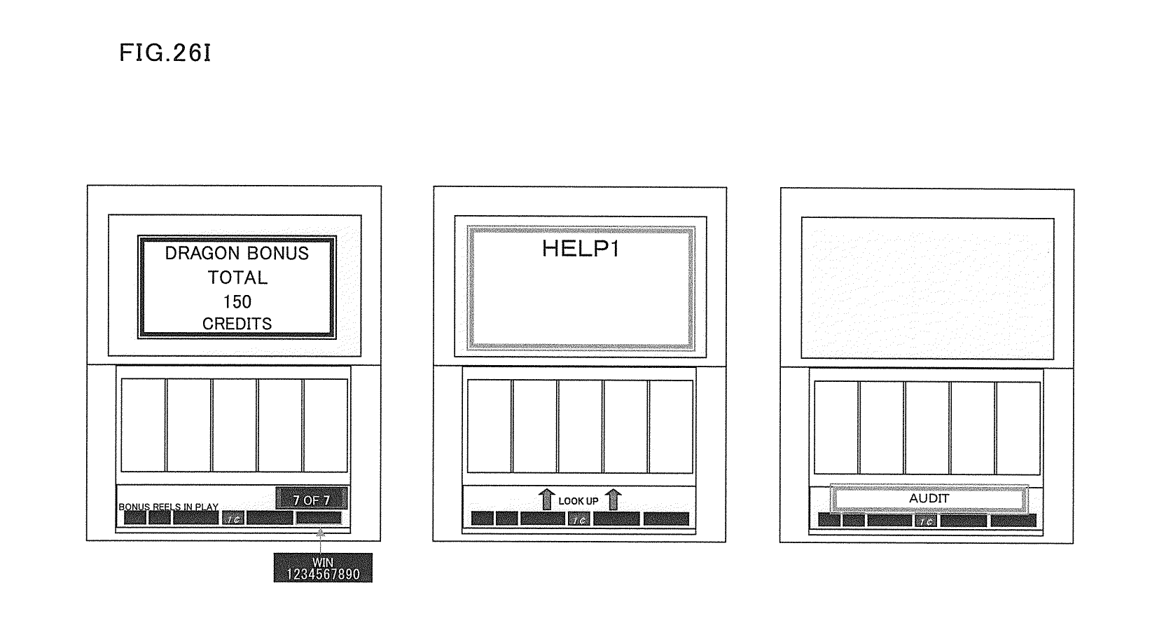

FIG. 26A to FIG. 26I illustrate the progress of the game and the flow of the screen display. Note that, description on some of the contents illustrated in FIG. 26A to FIG. 26I which have already described above may be omitted.

<<Base Game—Occurrence of Win>>

FIG. 26A and FIG. 26B show the flow of the screen display etc. at the time when a win occurs in the base game. A left part of FIG. 26A shows the state where the reels 101 to 105 spin. A central part of FIG. 26A shows the state where the reels 101 to 105 are stopped and a win (5-of-a-kind combination) occurs. At this time, the upper image display panel 131 displays the text of “5 of a kind”, and the liquid crystal display device 134 also displays the same text. A right portion of FIG. 25A shows the state where a big win occurs. At this time, the upper image display panel 131 displays the text of “BIG WIN”, and the liquid crystal display device 134 also displays the same text. When a great win occurs, as described above, the upper image display panel 131 displays the text of “GREAT”, and the liquid crystal display device 134 also displays the same text. At this time, the upper image display panel 131 displays the big meter (described above), but the liquid crystal display device 134 does not display the big meter.

A left part of FIG. 26B shows the state after the text of “BIG WIN” is cleared from the upper image display panel 131. A central part of FIG. 26B shows the state where the display of the win increment on the upper image display panel 131 and the liquid crystal display device 134 is finished. In the case where a gamble setting is provided in the gaming machine, the machine enters into a gamble standby state, and a gamble screen shown in a right part of FIG. 26B is displayed. In the case where the gamble setting is not provided in the gaming machine, the game is over in the state shown in the central part of FIG. 26B.

<<Base Game—when Bonus Occurs>>

FIG. 26C and FIG. 26D show the flow of the screen display etc. at the time when a bonus occurs in the base game. The occurrence of the bonus described here means the satisfaction of the trigger condition for the free game. Such an occurrence of the bonus is not set in the gaming machines of the above embodiments; however, such an occurrence of the bonus may be set in a modification. A left part of FIG. 26C shows the state where the reels 101 to 105 spin. A central part of FIG. 26C shows the state where the reels 101 to 105 are stopped and the bonus occurs. At this time, the upper image display panel 131 and the liquid crystal display device 134 each displays the text of “BONUS!”. Then, as shown in a right part of FIG. 26C, the upper image display panel 131 and the liquid crystal display device 134 each displays the win signboard.

Then, as shown in a left part of FIG. 26D, an introductory animation of the free game is reproduced on the upper image display panel 131. Then, as shown in a right part of FIG. 26D, the machine enters into a state of “orb selection”. In the above-described embodiments, the “orb selection” is not set. However, in a modification, the “orb selection” may be set.

<<Free Game—when Win (Scatter Win) Occurs>>

FIG. 26E and FIG. 26F show the flow of the screen display etc. at the time when a scatter win occurs in the free game. The free game described here may be of a type different from that of the free game of the above-described embodiments, i.e., a free game in a modification. A left part of FIG. 26E shows the state at the start of the free game. The upper image display panel 131 and the liquid crystal display device 134 each displays the text of “FREE GAME START!” Then, as shown in a right part of FIG. 26E, the reels 101 to 105 spin. Then, as shown in a left part of FIG. 26F, the reels 101 to 105 stop, and the upper image display panel 131 displays information on a scatter win. Then, as shown in a right part of FIG. 26G, the upper image display panel 131 and the liquid crystal display device 134 each displays the win signboard. In the right part of FIG. 26G, the free game counter of the upper right display region 432 and the display of the win amount overlap each other, for the sake of convenience. However, in actual display, these do not overlap each other.

<<Free Game—when Bonus Retrigger Occurs>>

FIG. 26G and FIG. 26H show the flow of the screen display etc. at the time when a retrigger occurs in the free game. The retrigger described here is a retrigger in a modification, which is at least partially different from the retrigger of the above-described embodiments. A left part of FIG. 26G shows the state where the reels 101 to 105 spin. Then, as shown in a right part of FIG. 26G, the reels 101 to 105 stop, and the retrigger occurs. At this time, the upper image display panel 131 and the liquid crystal display device 134 each displays the text of “RETRIGGER!”. Then, as shown in a left part of FIG. 26H, the upper image display panel 131 displays information on a scatter win. Then, as shown in a central part of FIG. 26H, the upper image display panel 131 and the liquid crystal display device 134 each displays the win signboard. Then, as shown in a right part of FIG. 26H, the machine enters into the state of “orb selection”.

<<Others>>

As shown in a left part of FIG. 26I, the total win amount in the free game is displayed. Then, as shown in a central part of FIG. 26I, the liquid crystal display device 134 displays the text of “LOOK UP” while the upper image display panel 131 displays a help screen. As shown in a right portion of FIG. 26J, AUDIT is displayed on the liquid crystal display device 134.

(Texts Displayed on Liquid Crystal Display Device 134)

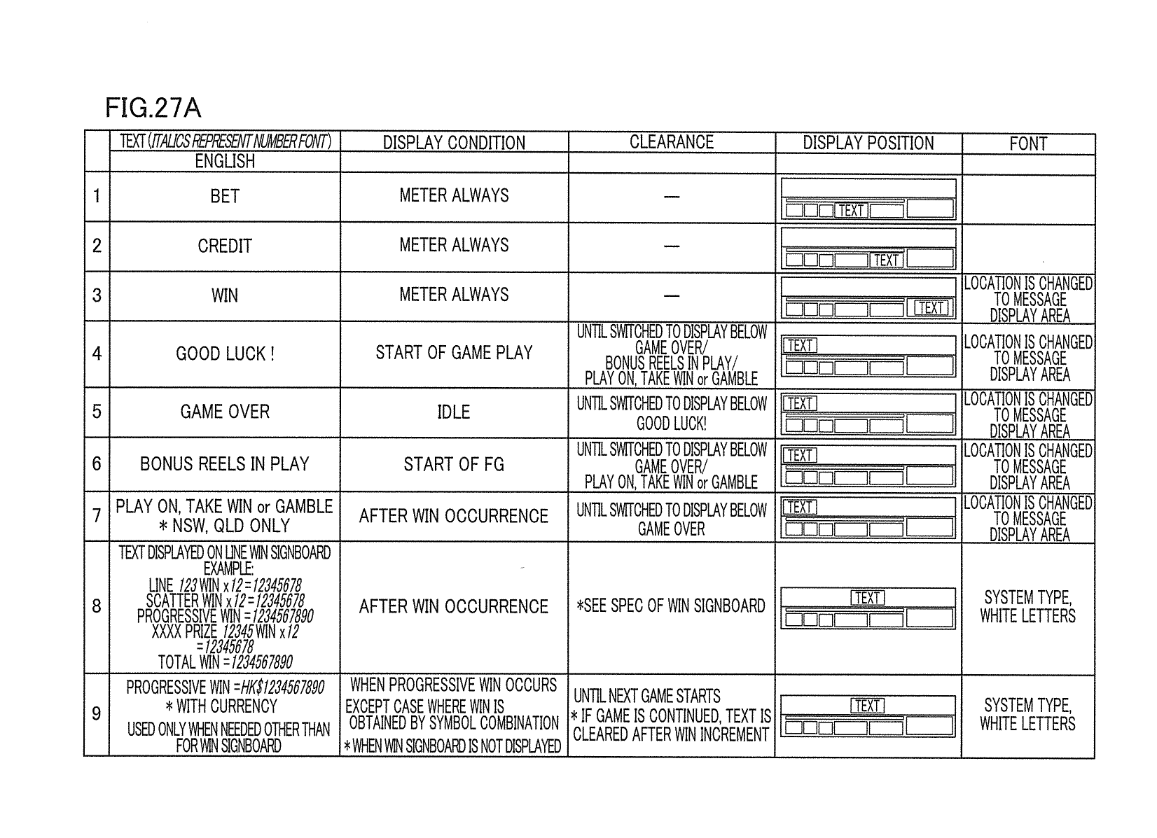

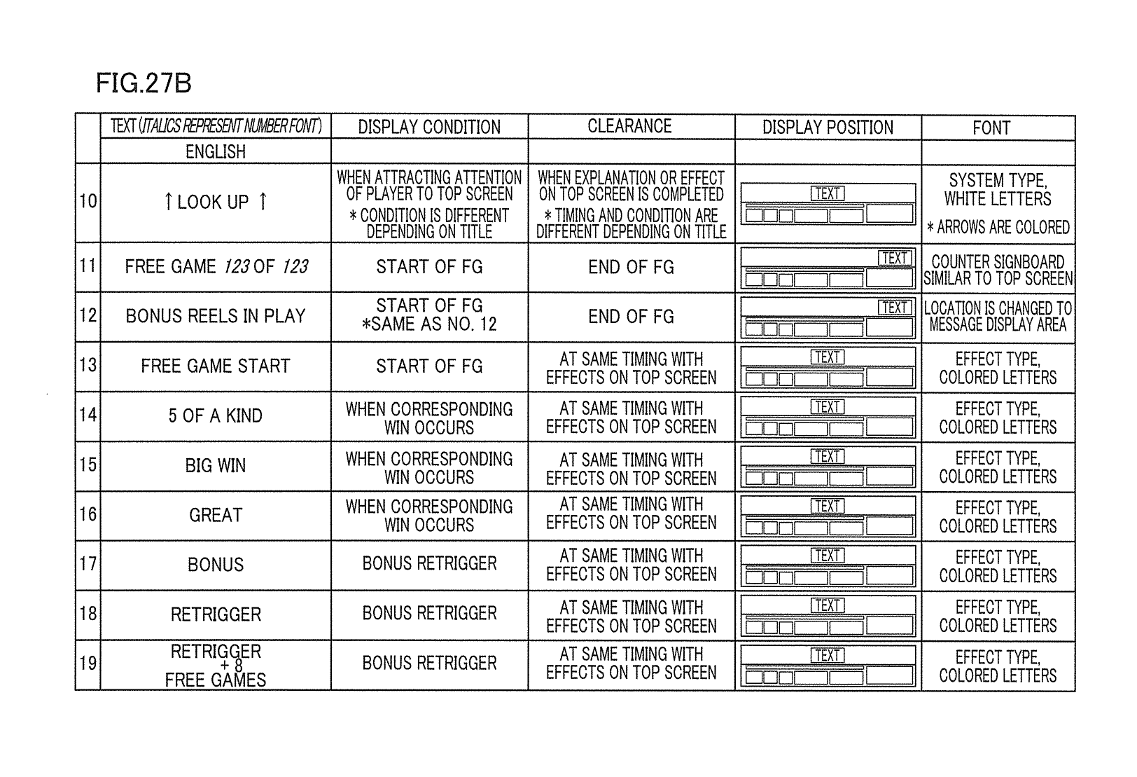

FIG. 27A and FIG. 27B show the details of the texts displayed on the liquid crystal display device 134. Each text in the column of “text” in the table of FIG. 27A is displayed at a position of “TEXT” illustrated in the corresponding cell of the column of “display position” in the table. Each text is displayed when the condition defined in the corresponding cell of the column of “display condition” in the table is satisfied. Each text is cleared at the timing defined in the corresponding cell of the column of “clear”. Each text is displayed in the font defined in the corresponding cell of the column of “font”. For example, the text of “BET” is always displayed at the position of the bet meter 411 (see FIG. 10A). For example, in the idle state (“IDLE” in the table), the text of “GAME OVER” is displayed at the position of the game state indicator 421 (see FIG. 10A), until the text is switched to “GOOD LUCK!”.

(Display of Help Screen)<Condition for Displaying Help Screen>

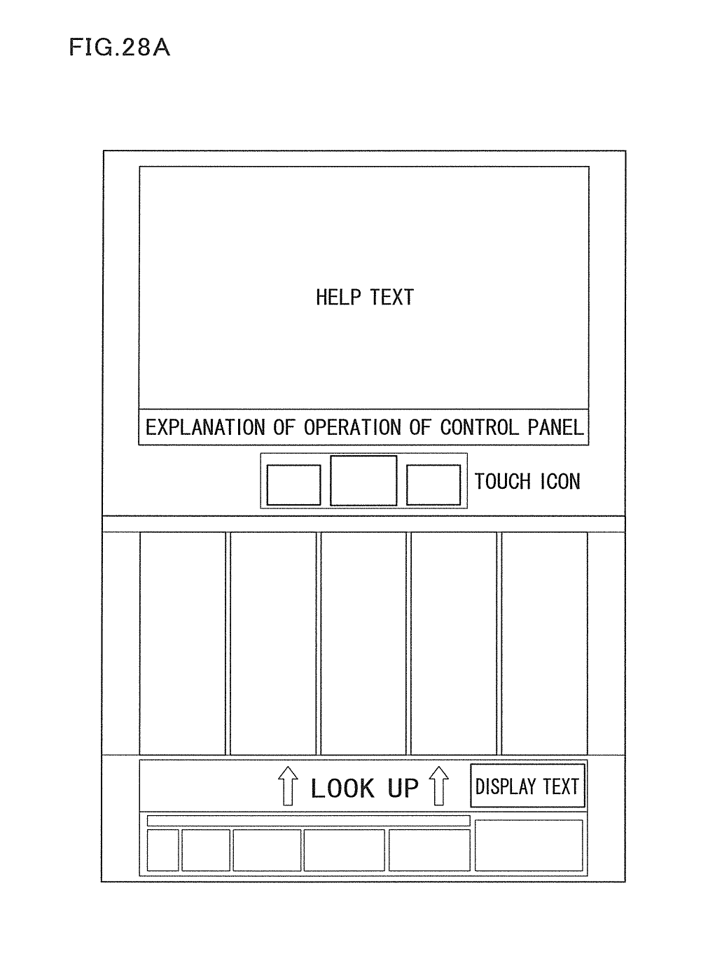

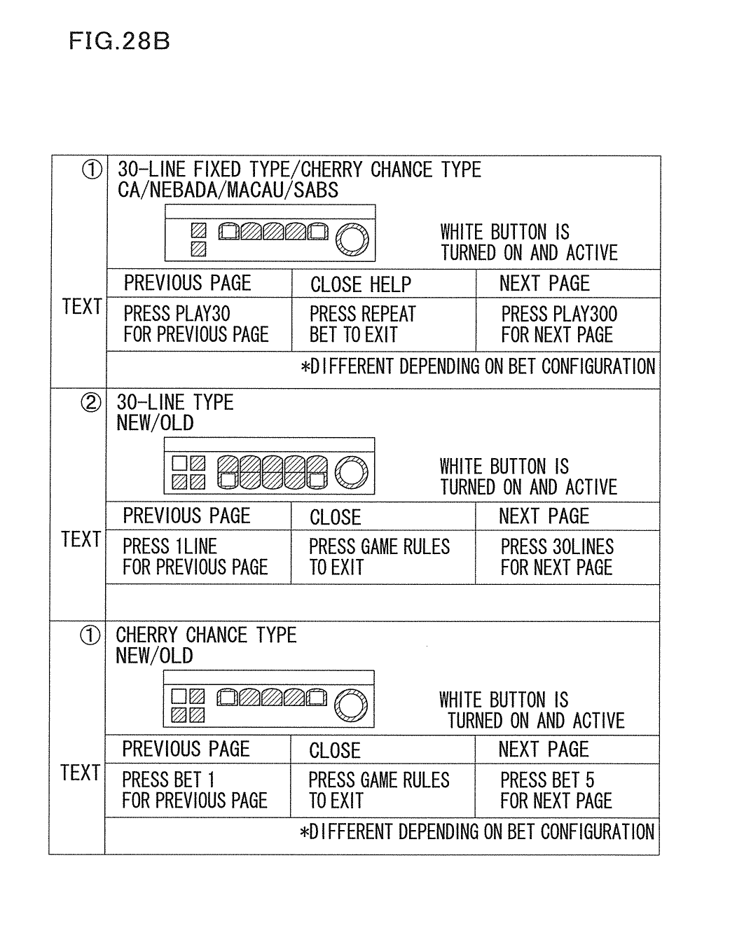

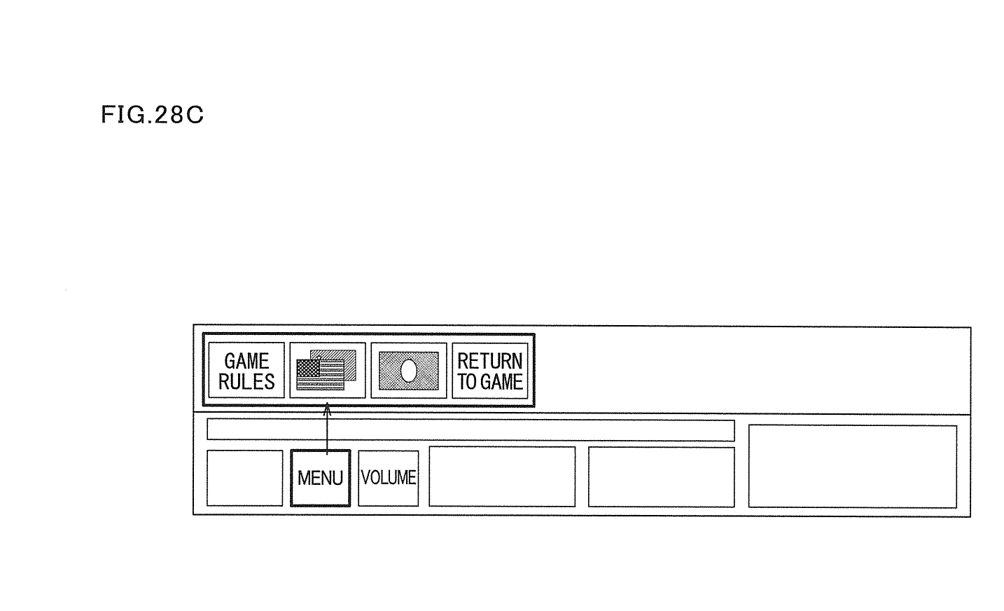

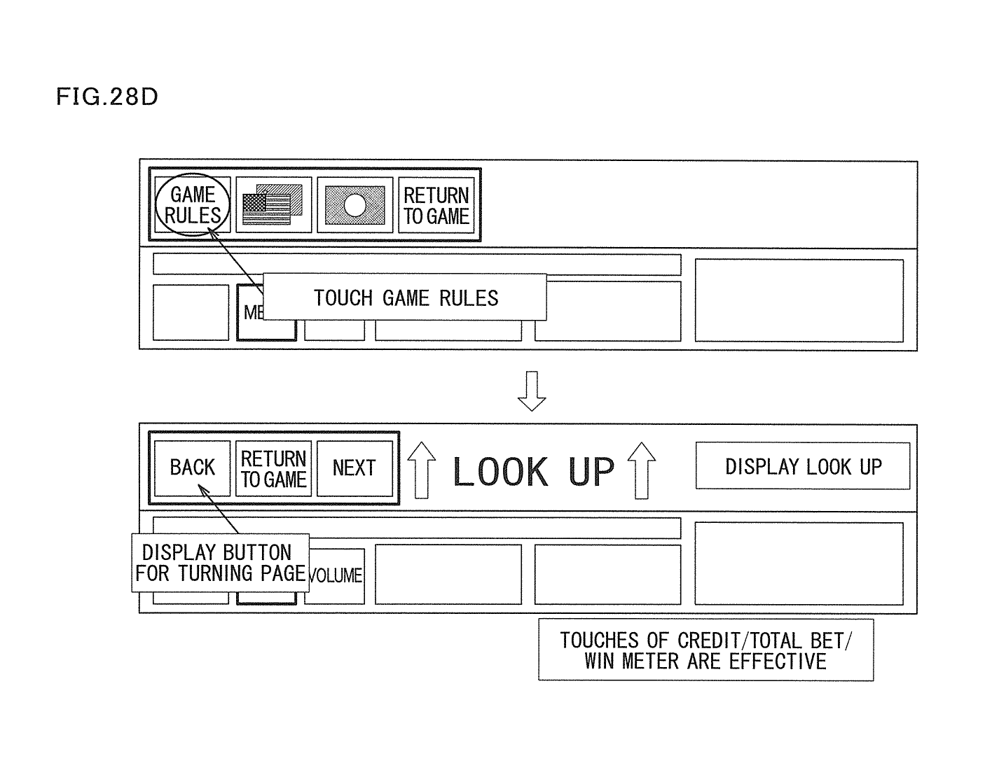

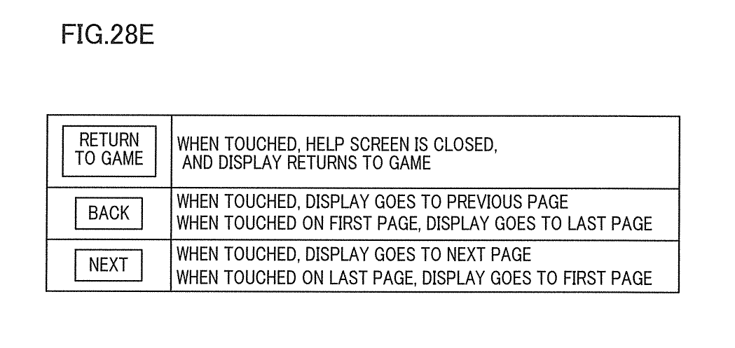

The following describes the help screen (HELP screen) and the like with reference to FIG. 28A to FIG. 28E. As shown in FIG. 28A, the upper image display panel 131 displays the help screen in predetermined coordinates. The help screen is displayed if the following situation (1) or (2) is satisfied.

(1) If a button for displaying the help screen (e.g., a game rules button which is not illustrated) is provided on the control panel 30 (see FIG. 3, the same shall apply hereafter), the upper image display panel 131 displays the help screen when this button is pressed.
(2) The upper image display panel 131 displays the help screen when the corresponding touch icon displayed on the liquid crystal display device 134 is pressed, as shown in FIG. 28C (the details thereof will be described later). Note that such a touch icon may be provided on the upper image display panel 131, as shown in FIG. 28A.

<Operation of Help Screen Using Buttons of Control Panel 30>

The following describes, for example, the operation of the help screen using the buttons of the control panel 30, with reference to FIG. 28A and FIG. 28B. The operation for the help screen may be performed using the buttons of the control panel 30. In this case, the types of the operation for the help screen and the buttons of the control panel 30 associated therewith are displayed, for example, on the help screen (these are referred to as “displayed explanation”). In the displayed explanation, 3 items are included: “Clear HELP” (clearing of the help screen from the upper image display panel 131); “previous page” (“PREVIOUS PAGE” in the figure); and “next page” (“NEXT PAGE” in the figure). The displayed explanation differ depending on the destinations of shipment of the gaming machine, game type, or the like, for example. For example, in a machine of a 30-line-fixed cherry chance type, the bet button 34 (see FIG. 3) with the note of “PLAY30” is allocated to “previous page”. While the help screen is displayed, “PRESS PLAY30 FOR PREVIOUS PAGE” is displayed as the displayed explanation.

<Operation of Help Screen Using Touch Icon of Liquid Crystal Display Device 134, Etc.>

The following describes the operation of the help screen using the touch icon of the liquid crystal display device 134, etc., with reference to FIG. 28C to FIG. 28E.

If there is a game rule touch icon (or button) (not illustrated) in an initial state, the help screen is displayed on the upper image display panel 131 when the icon is touched. If, as shown in FIG. 28C, the touch icons on the liquid crystal display device 134 do not include the game rule icon in the initial state but include a menu icon, a menu screen (a pop-up window) is displayed when the menu icon is touched. The game rule icon is provided on the menu screen, and the help screen is displayed on the upper image display panel 131 when the game rule icon is touched.

While the upper image display panel 131 displays the help screen, the liquid crystal display device 134 displays the text of “LOOK UP”, as shown in FIG. 28D. At this time, the icon within the pop-up window changes to an icon for turning a page. FIG. 28E shows the relationship between each icon (touch icon) in the pop-up window and its function. At this time, touches of the bet meter 411, the credit meter 412, and the win meter 413 are still effective. Further a touch of the sound volume switch button 404 (VOLUME) is also still effective.

(Touch Icon, Normal Screen)

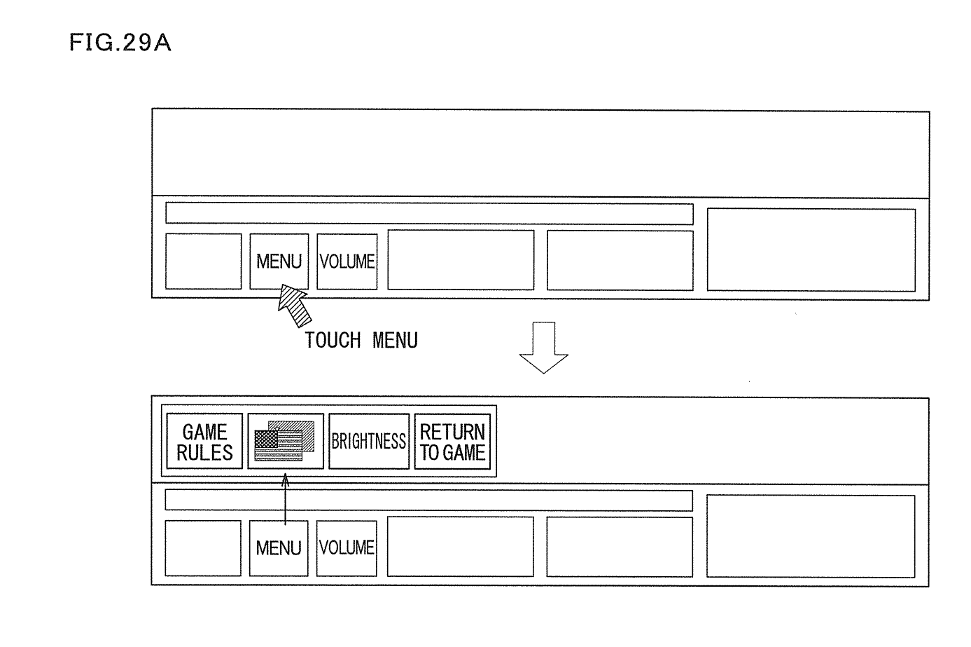

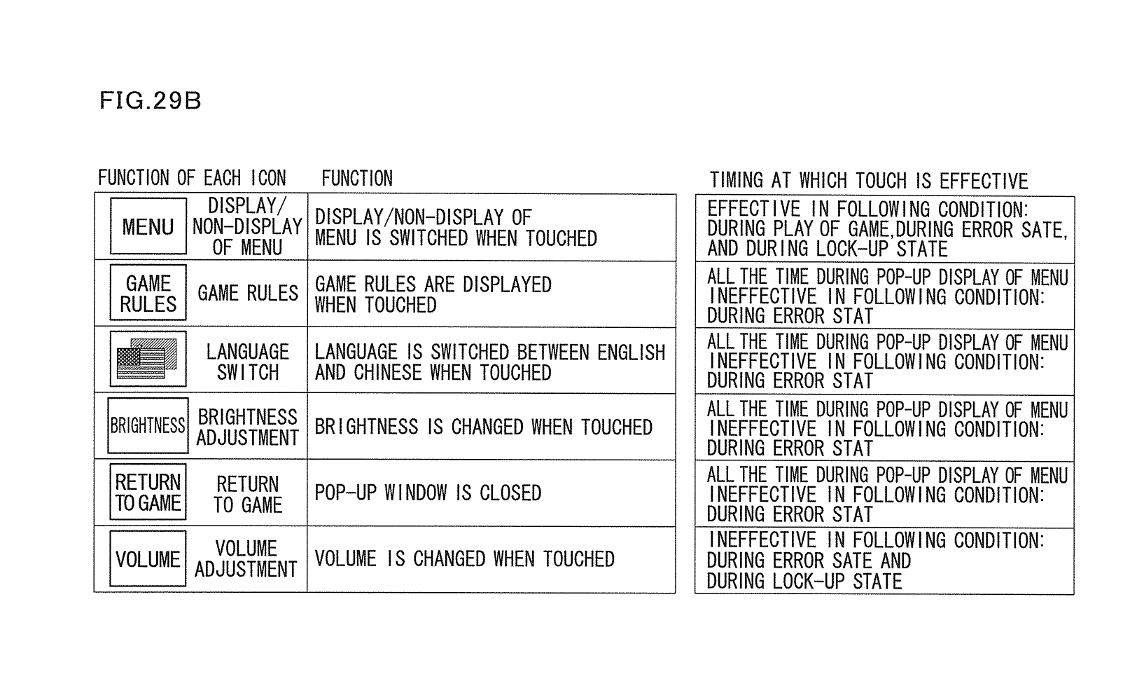

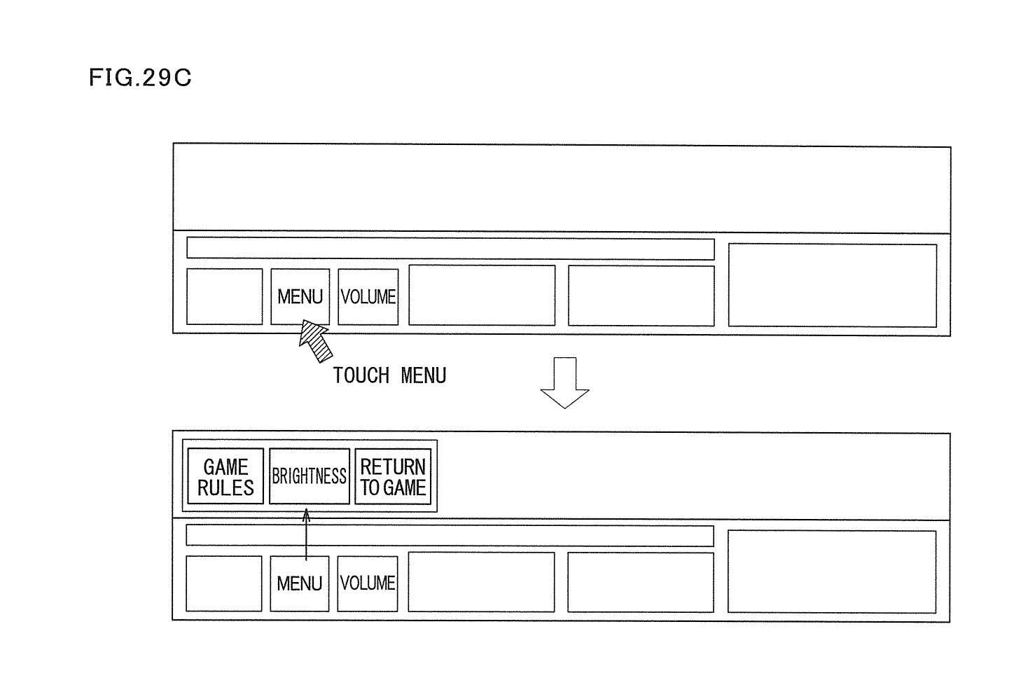

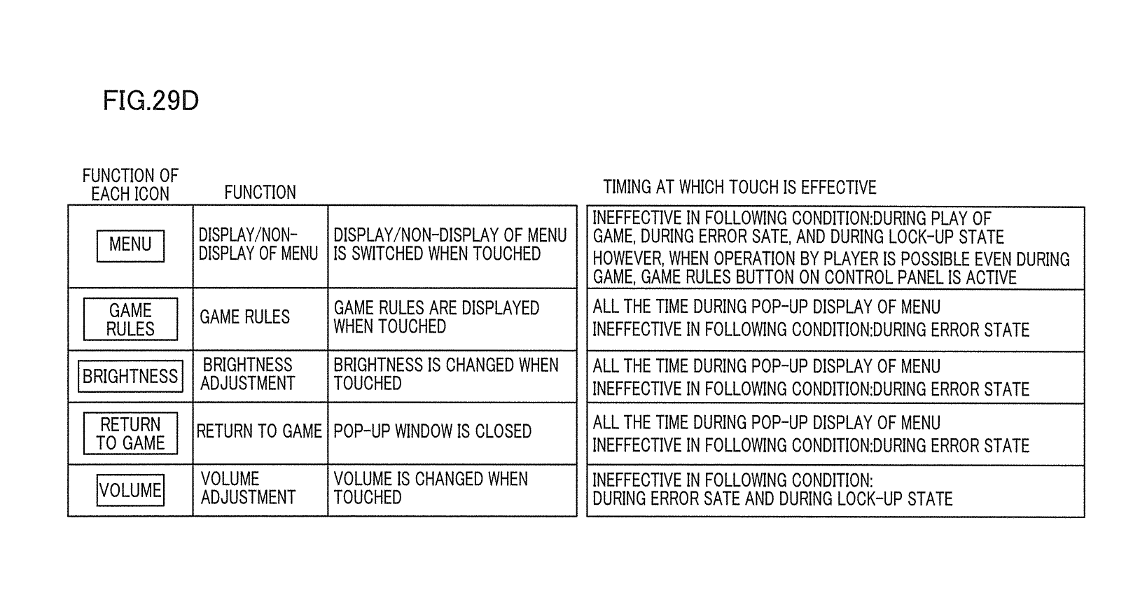

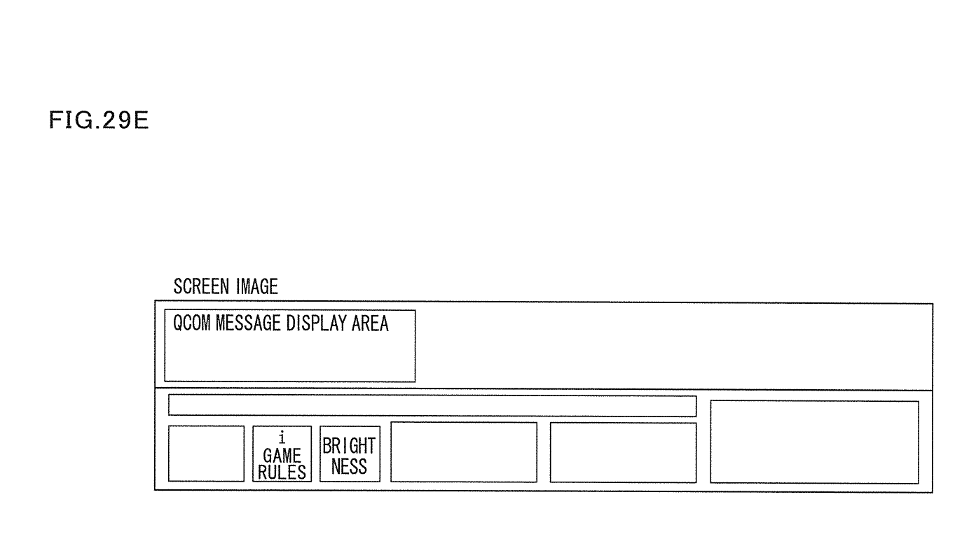

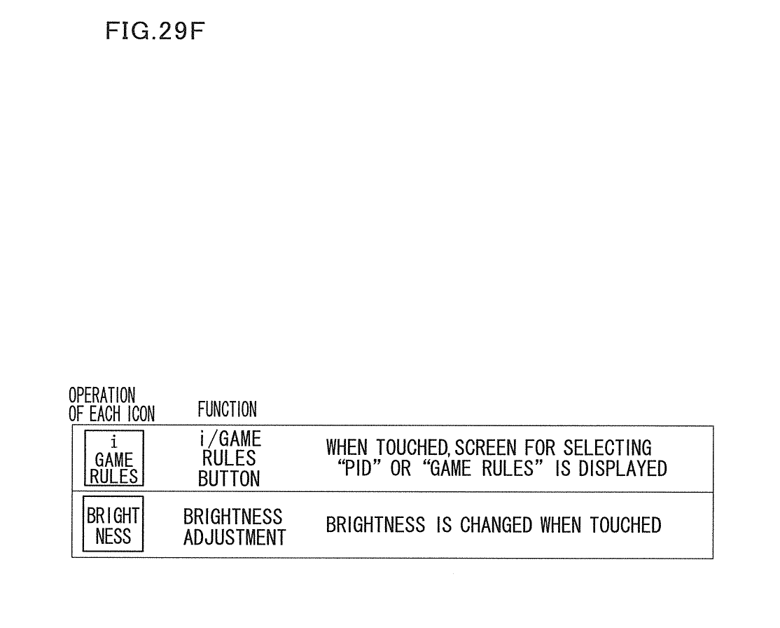

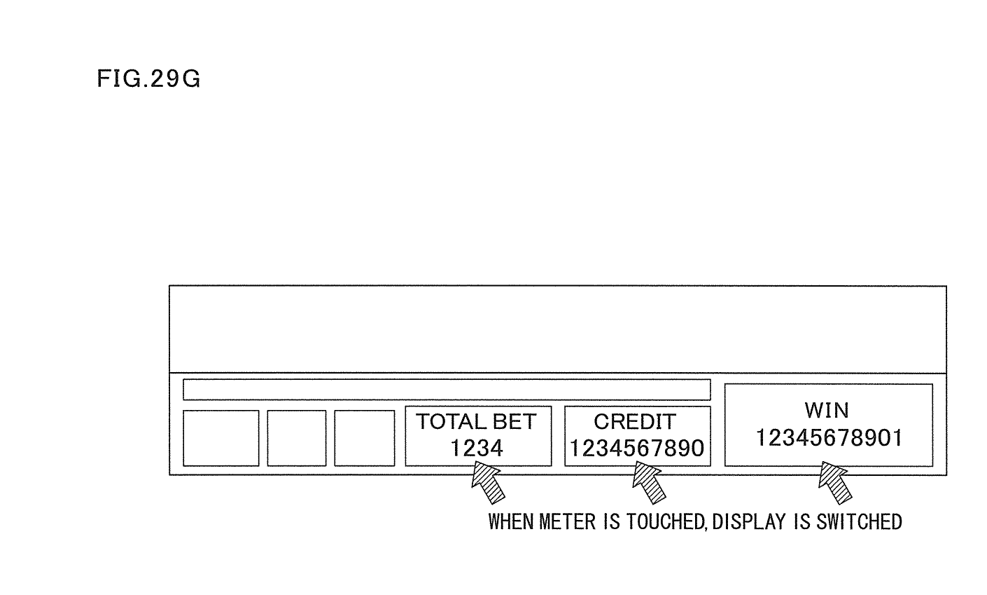

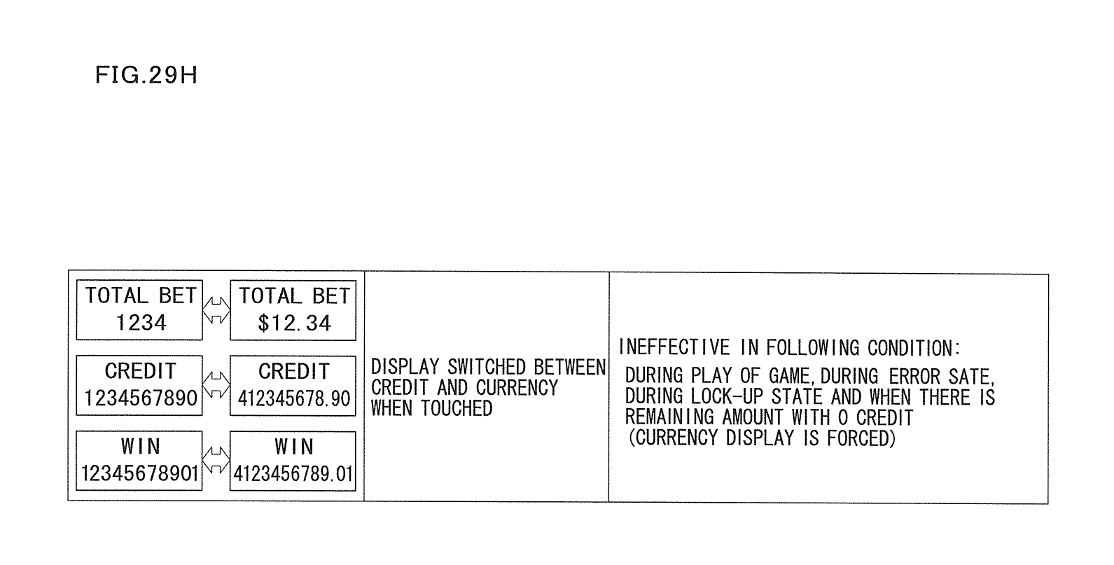

The following describes the details of the touch icons provided on the liquid crystal display device 134, with reference to FIG. 29A to FIG. 29H.

<Menu Icon>

When the menu icon is touched, as shown in FIG. 29A, a menu screen (a pop-up window) emerges from the menu icon, and touches of 4 icons (pop-up icons) are enabled. The menu screen is closed when any of the following operations (A) to (D) is done. (A) When operation through the control panel 30 (operation of a button) is performed. (B) When no operation is performed for 30 seconds. (C) When an area outside the menu screen is touched. (D) When the gaming machine enters into an advertise mode (demonstration mode).

FIG. 29B shows the function of each icon and the state in which the touch of each icon is effective. For example, each time the menu icon is touched, display and non-display of the menu (menu screen) is switched. The touch of the menu icon is ineffective during the play of the game, during the error sate, and during a lock-up state. Each time the language switch icon is touched, the language is switched. The touch of the language switch icon is always effective while the menu screen is displayed (“MENU POP-UP” in the figure). The touch of the language switch icon is ineffective during the error state.

<Language Switching Disabled Setting>

FIG. 29C shows examples of other touch icons. The touch icons may be arranged as follows depending on the destination of shipment of the gaming machine, for example. When the menu icon is touched, the menu screen (pop-up window) emerges from the menu icon, and touches of 3 icons (pop-up icons) are enabled. In the example shown in FIG. 29B, the function of language switching is provided. However, in the example shown in FIG. 29C, the function of language switching is not provided. The menu screen is closed when any of the operations (A) to (D) described in the example shown in FIG. 29A is performed. FIG. 29D shows the function of each icon and the state in which the touch of each icon is effective (as for how to read the table, see the explanation for FIG. 29B).

<Message Display Area Etc.>

FIG. 29E shows another example of touch icons and the like. On the liquid crystal display device 134, a message display area (e.g. “QCOM message display area”) may be provided. In this case, when the menu screen (pop-up window) is displayed in the same manner as above, the menu screen overlaps the message display area. For this reason, the menu icon is not provided. FIG. 29F shows the function of each icon and the state in which the touch of each icon is effective (the explanation of the table is similar to that for FIG. 29B).

<Credit Meter/Bet Meter/Win Meter>

As shown in FIG. 29G, each time the meter (the credit meter 411, the bet meter 412, the win meter 413) is touched, the display on the meter is switched. Specifically, the display is switched between the display in credits and the display in currency. As shown in FIG. 29H, a touch of each meter (icon) is ineffective during the play of the game, for example.

(Example of Control Panel 30)

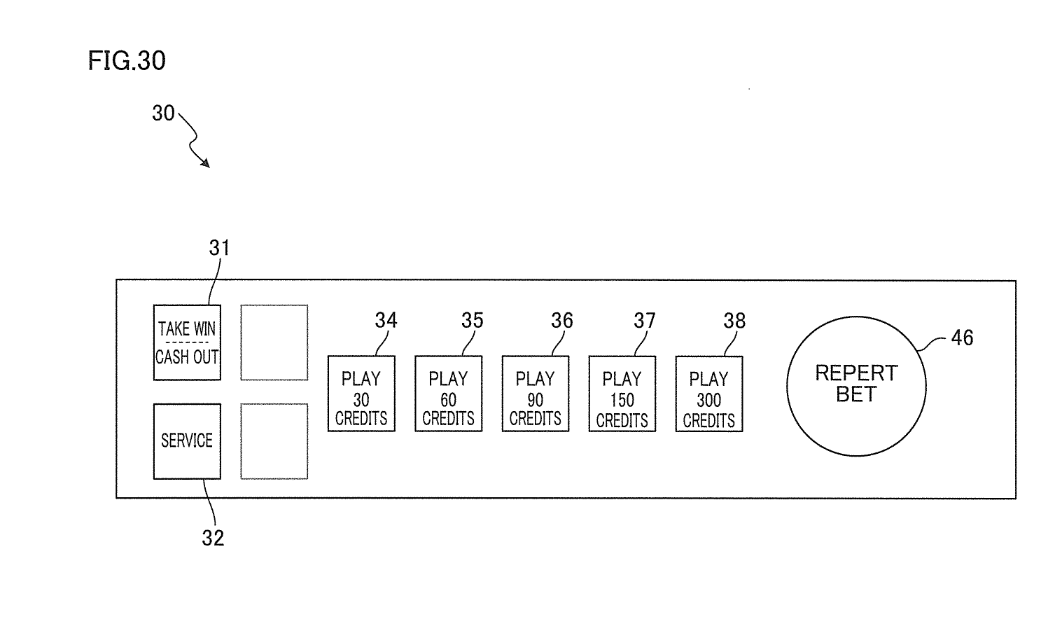

FIG. 30 shows an example of the control panel 30. Each button has a text shown in FIG. 30. For example, the bet button 34 (the button used to play the game with a bet amount of 30) has the text of “PLAY 30 credits”.

(Operation of Buttons)

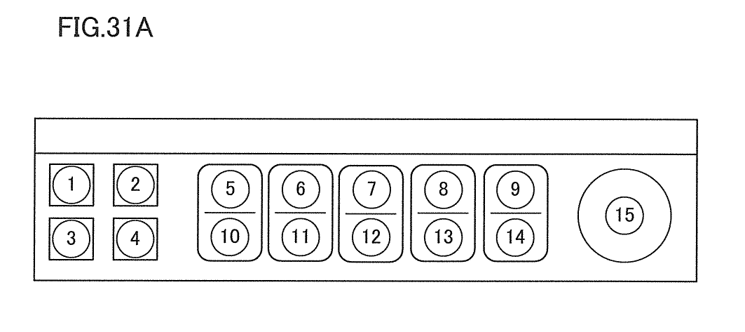

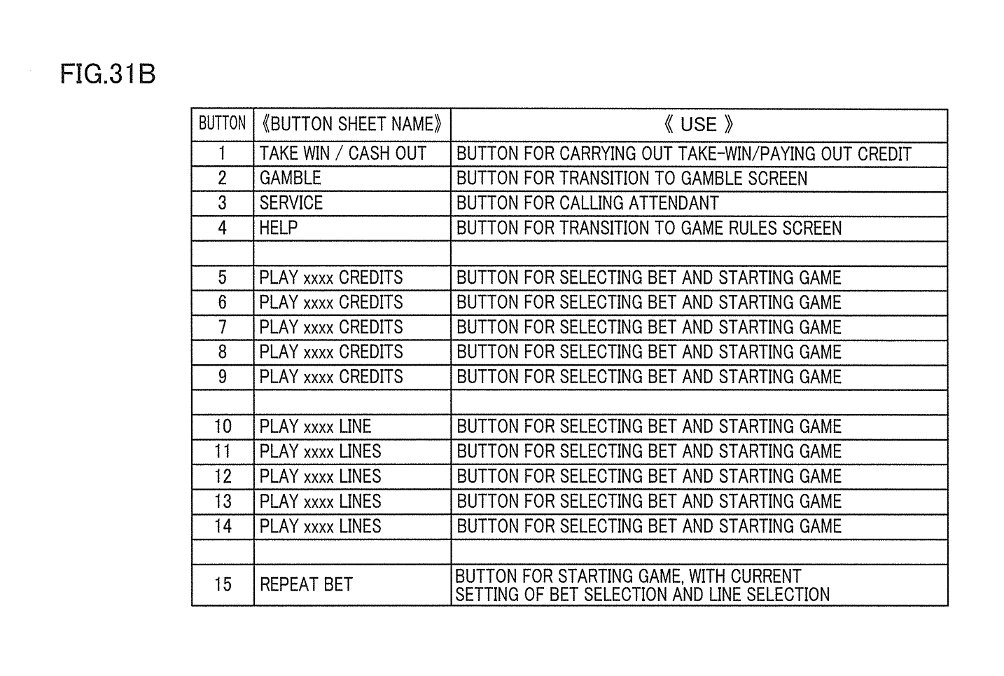

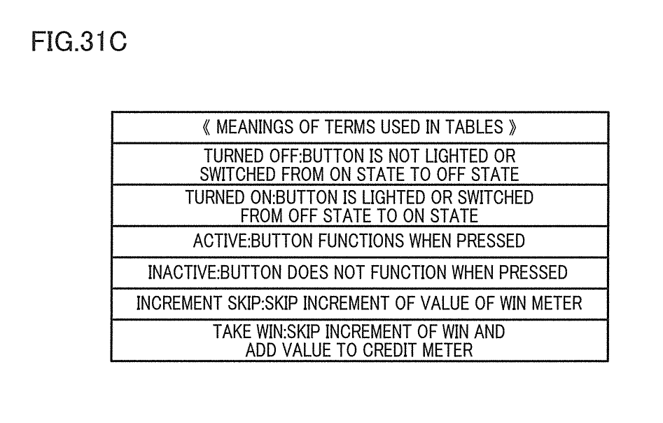

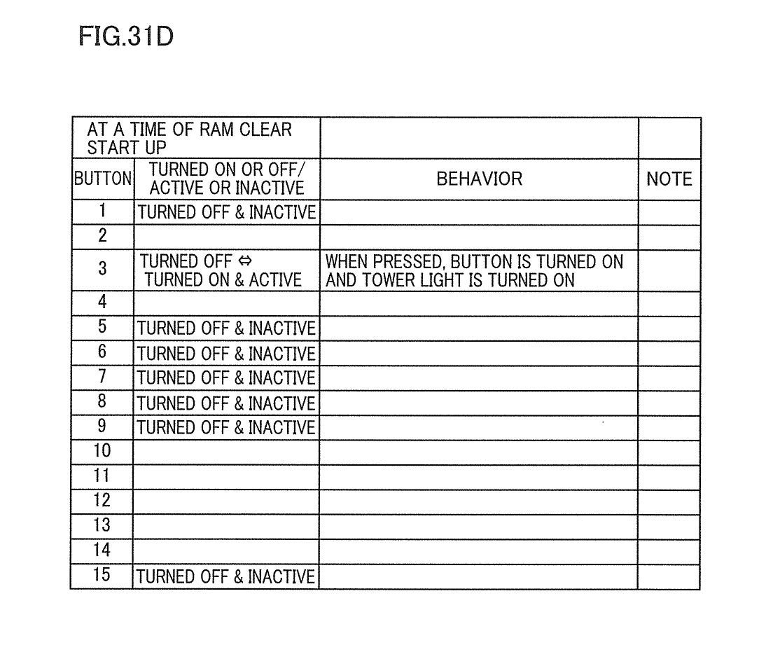

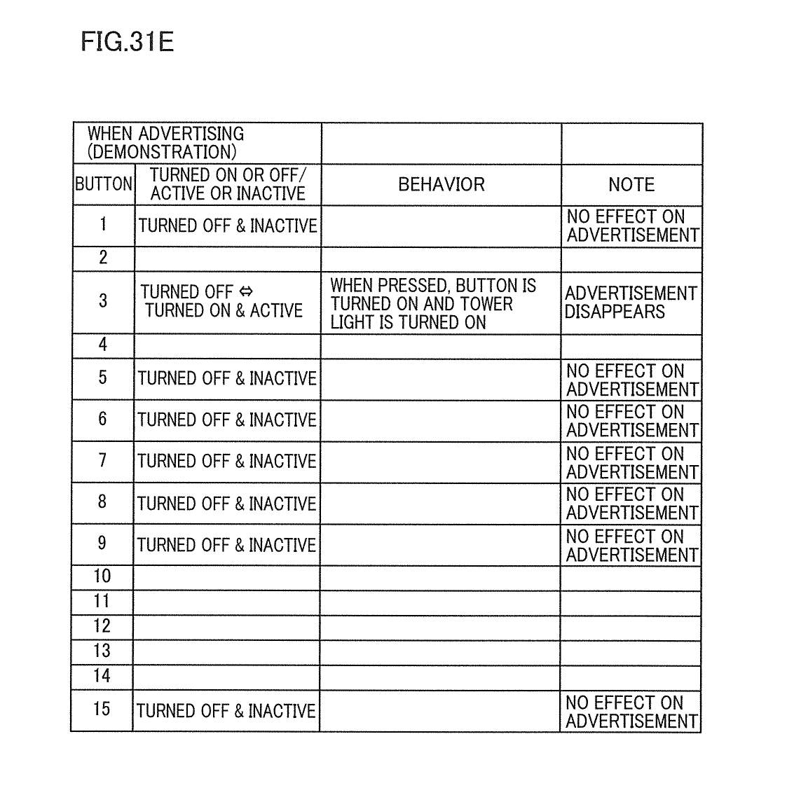

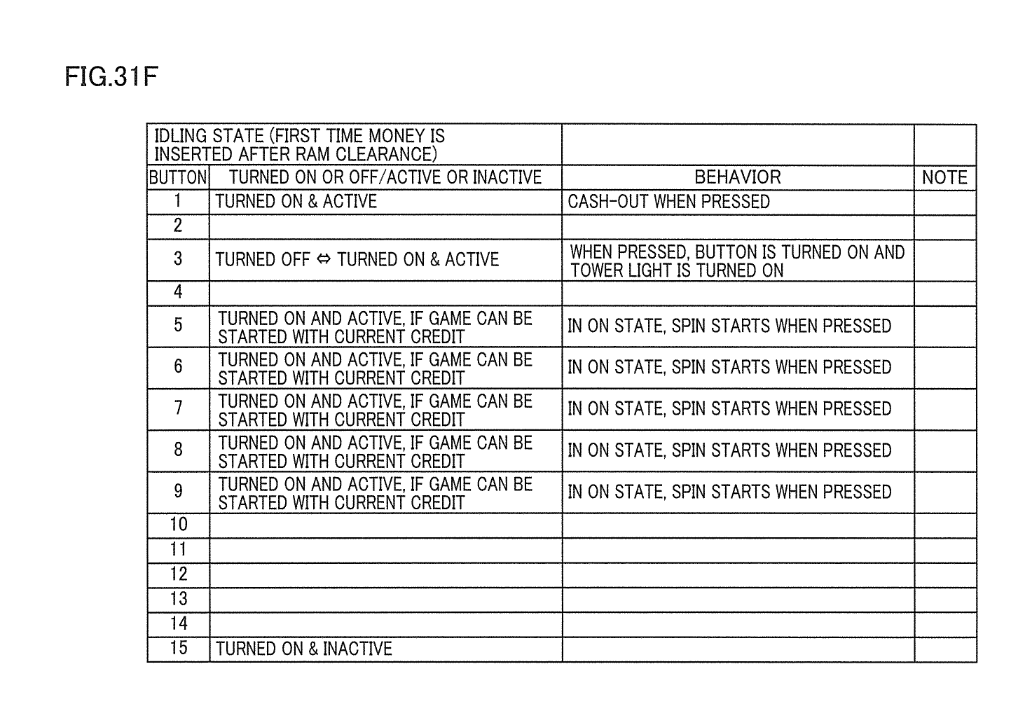

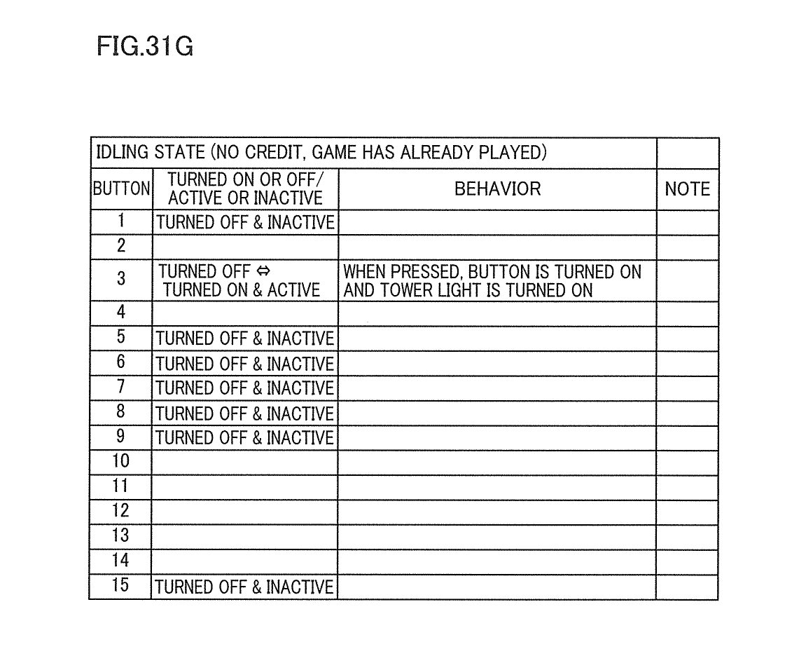

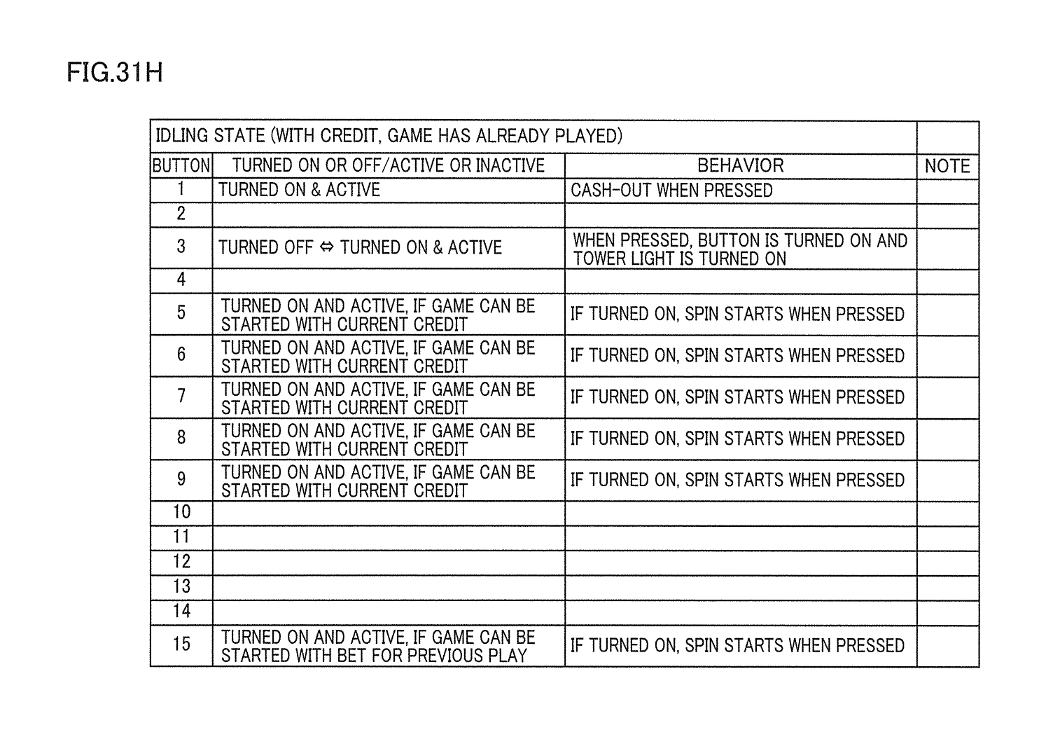

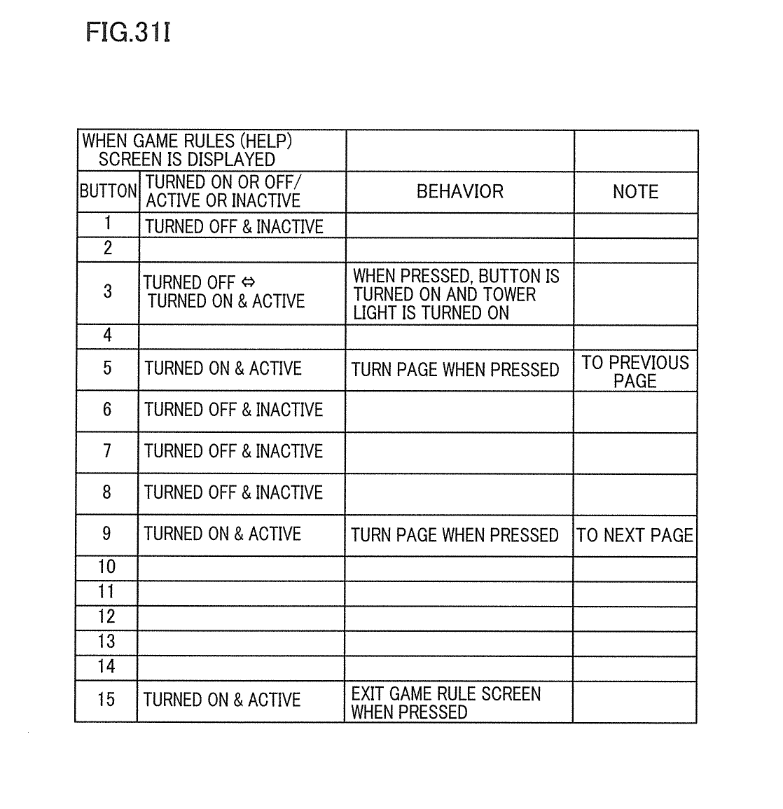

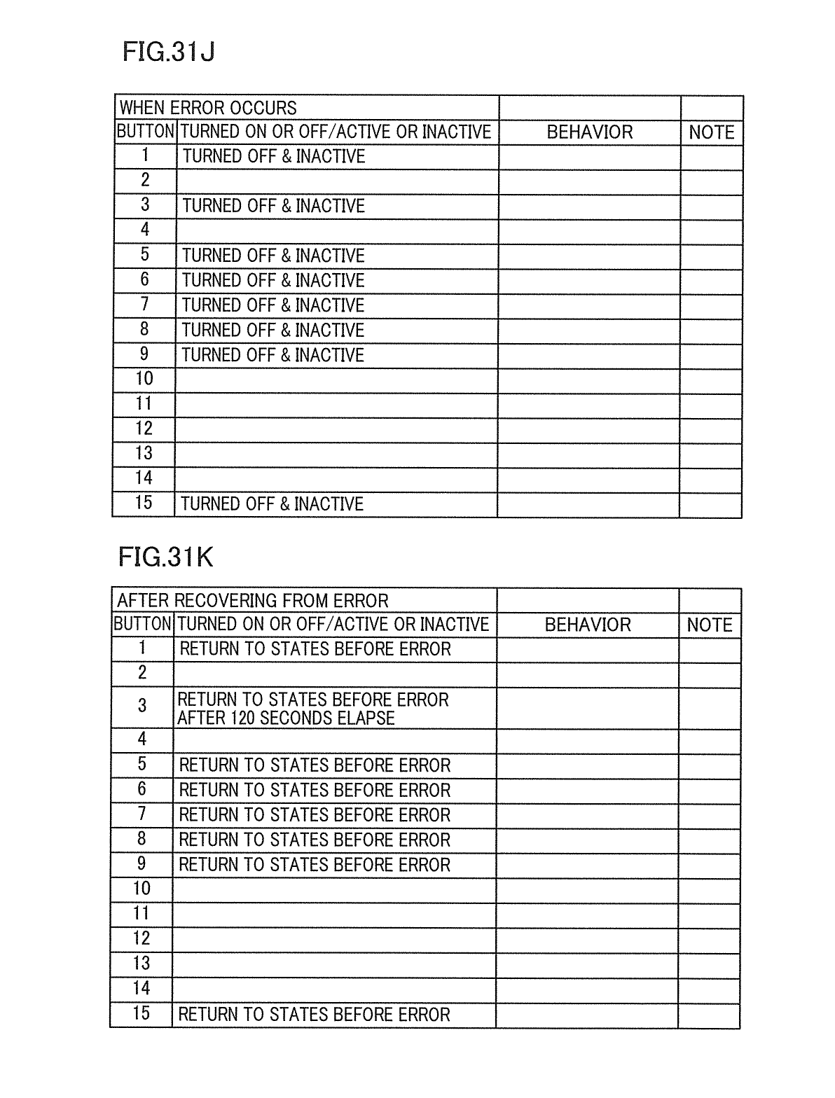

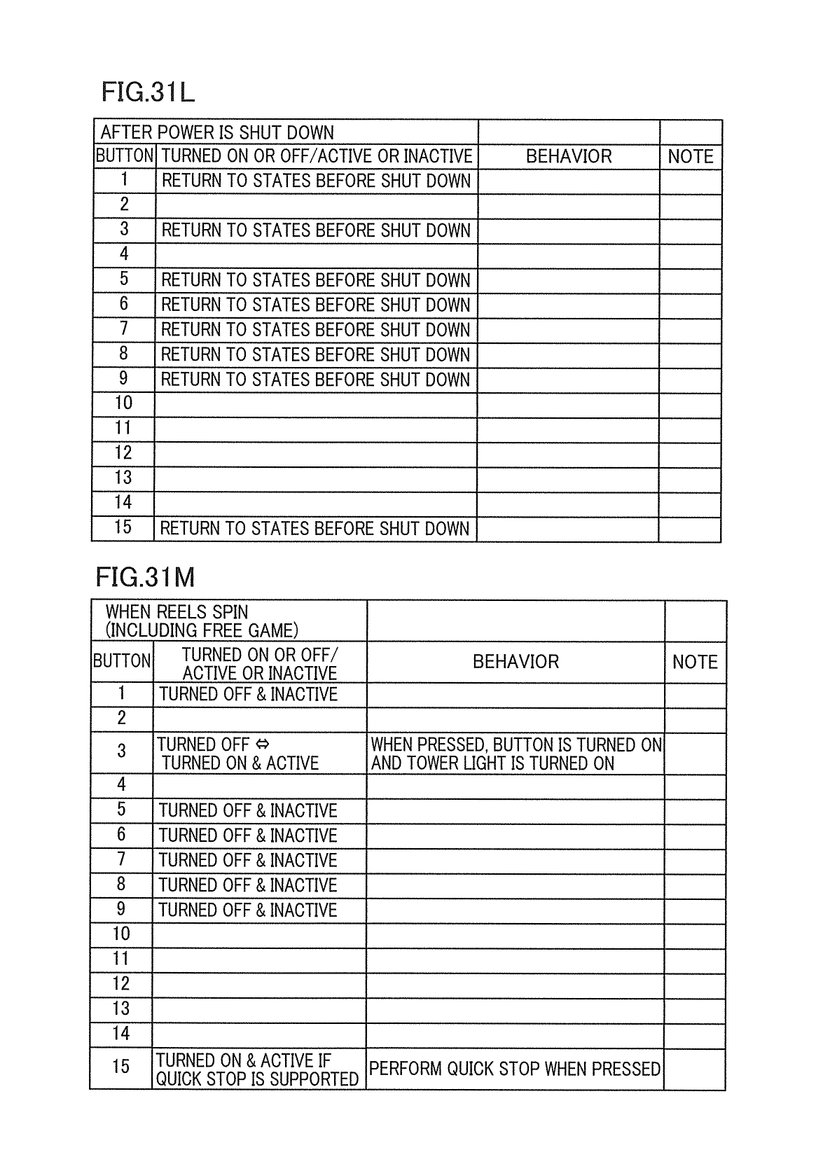

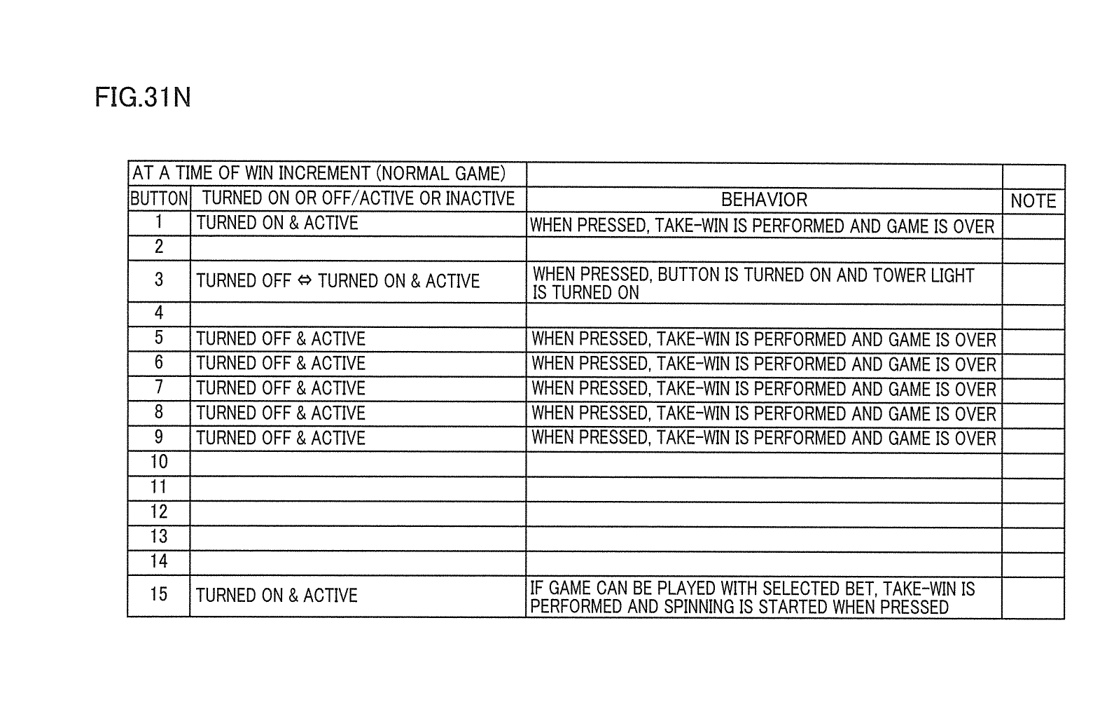

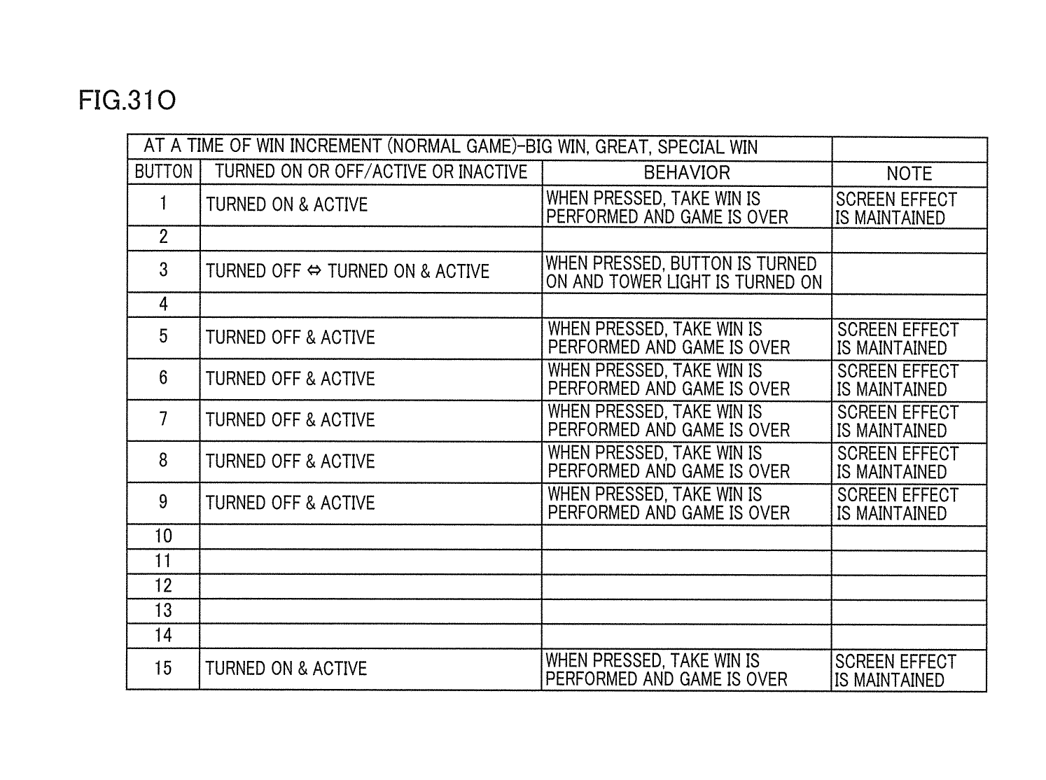

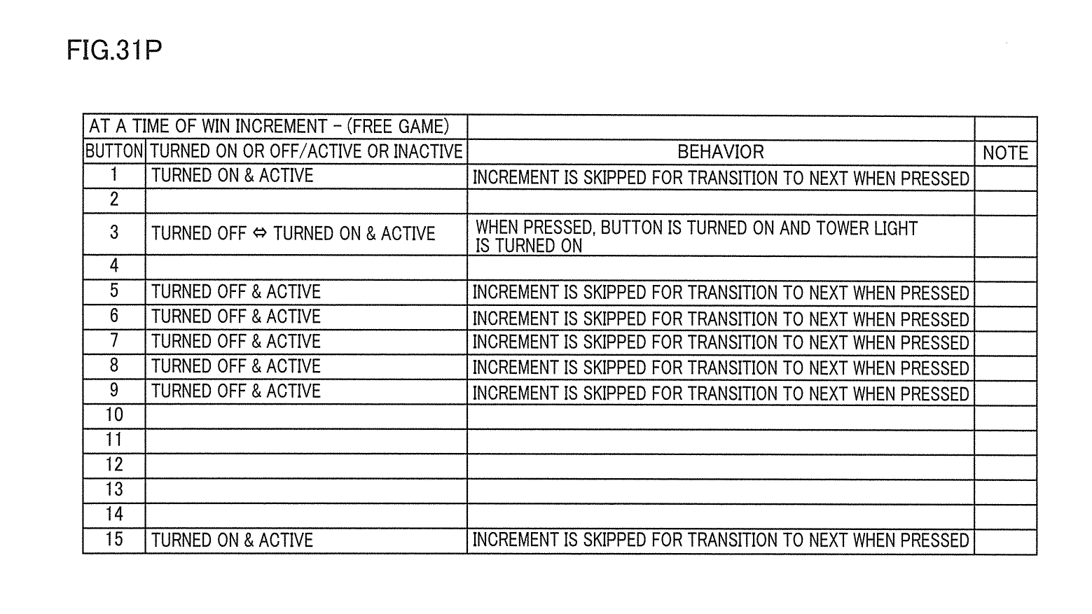

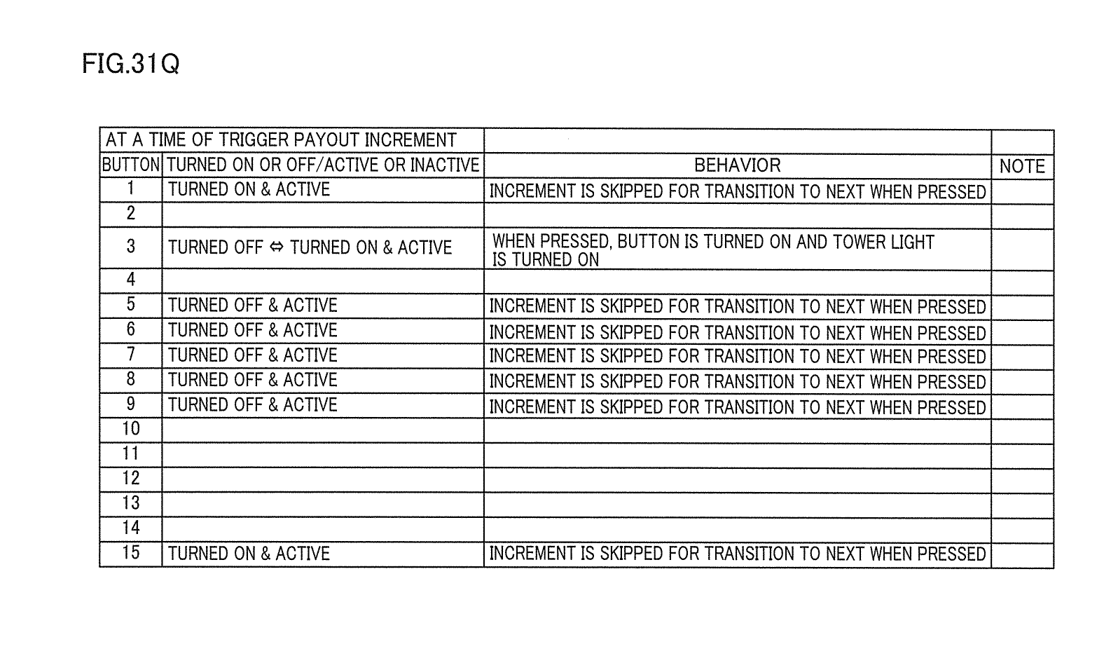

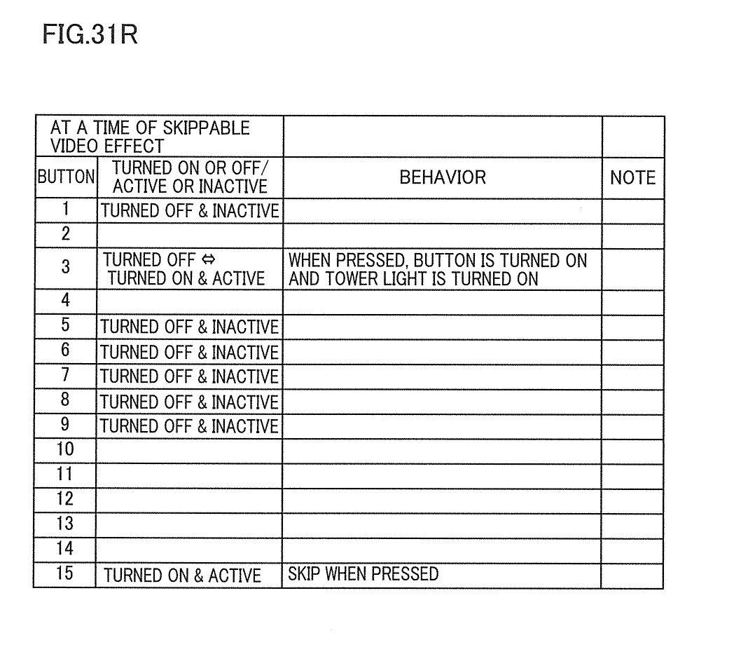

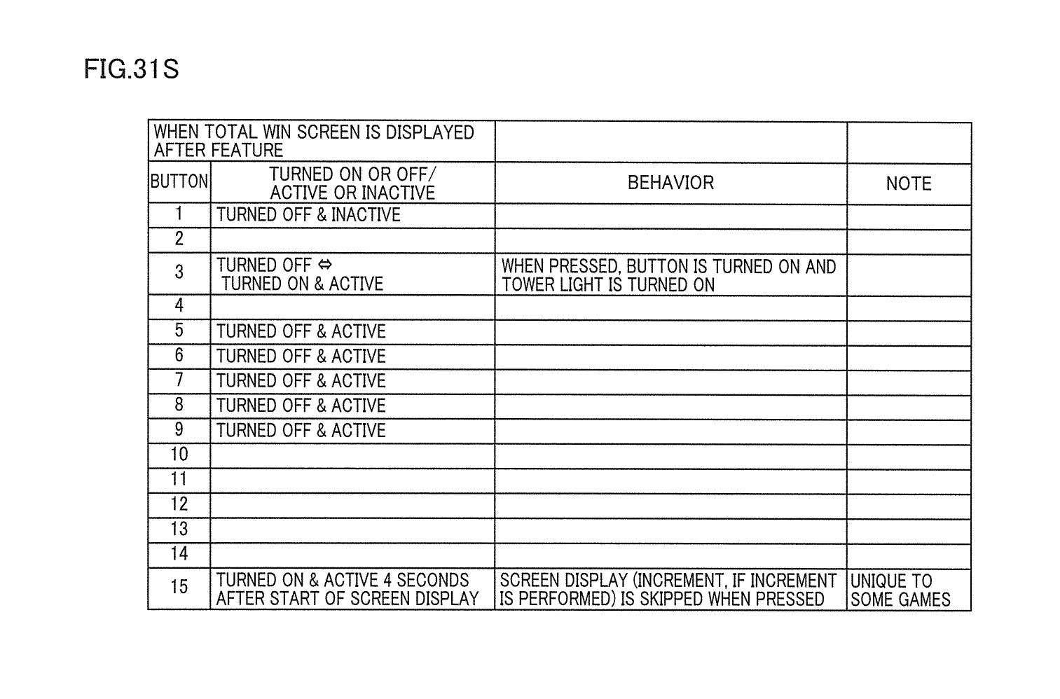

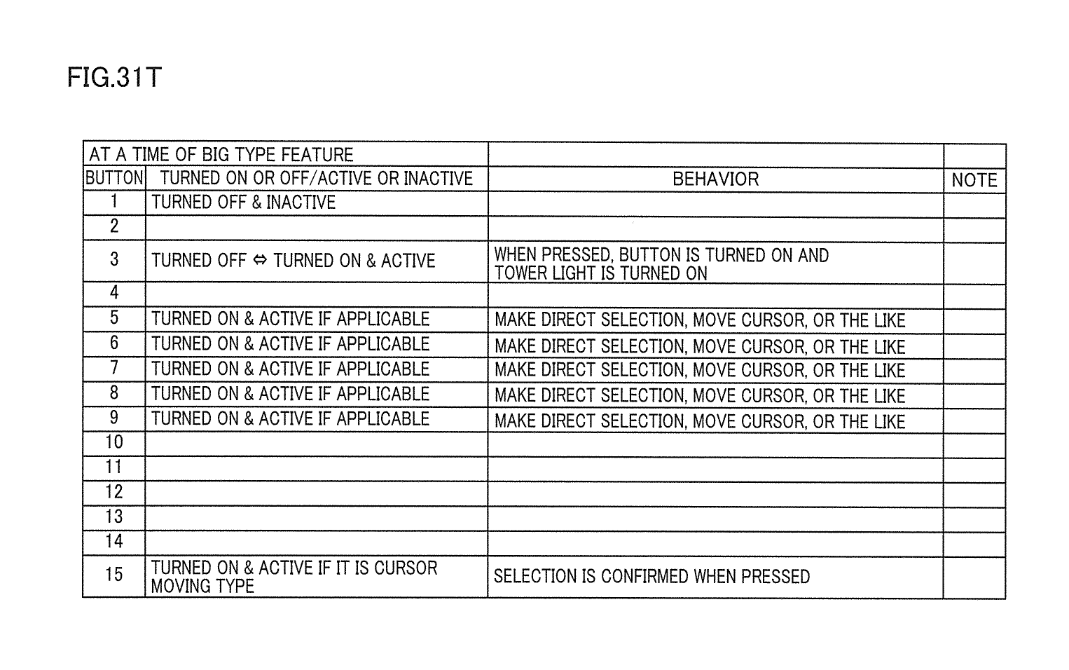

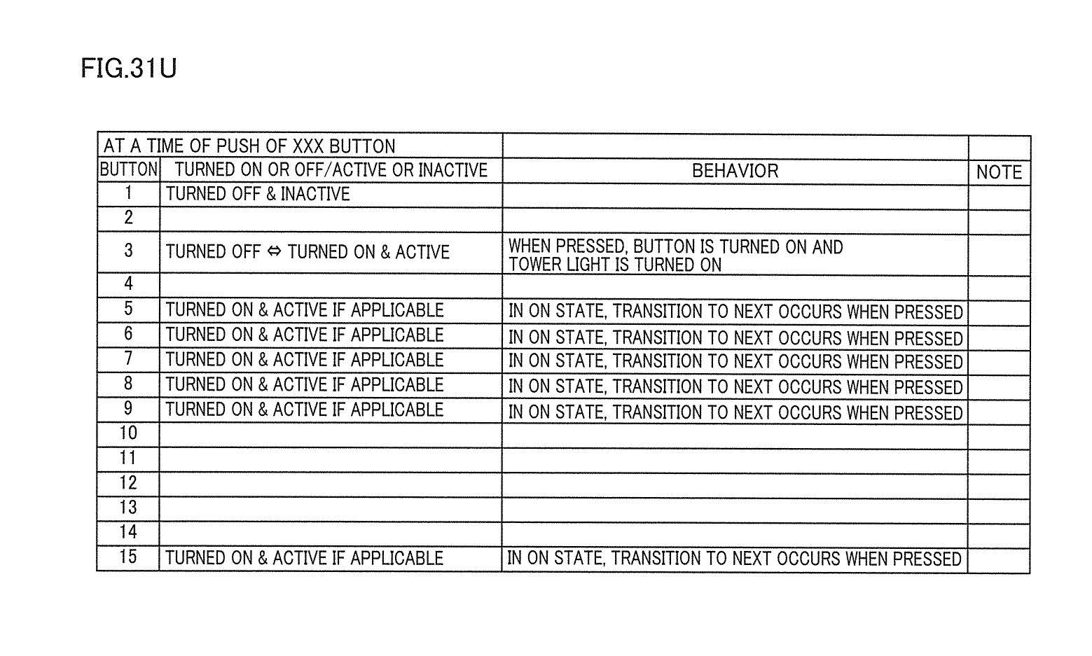

The following describes the behavior of each button of the control panel 30 (see FIG. 30, the same shall apply hereafter), with reference to FIG. 31A to FIG. 31U. As shown in FIG. 31A, button numbers 1 to 15 are allocated to the respective buttons. The button numbers respectively correspond to the numbers in the column of “button” in each of FIG. 31B and FIG. 31D to FIG. 31U. Note that buttons to which the button numbers 2, 4, and 10 to 14 are allocated (shown in FIG. 31A) are not provided in the example shown in FIG. 30. However, in a modification, these buttons may be provided. FIG. 31B shows the relationship between each button and its use. For example, the button having the button number of 5 is used for starting the game after selecting a bet amount. For example, the button having the button number of 15 is used for starting the game under the condition of the bet amount and lines (30 lines in the above embodiments) currently selected. Each of the buttons respectively having the button numbers 5 to 9 may be a button used for selecting the bet amount only. The button having the button number 15 may be a button (spin button) used for starting the spin of the reels 101 to 105.

FIG. 31C shows the meanings of terms used in tables shown in FIG. 31D to FIG. 31U. Specifically, this figure shows the meanings of the terms of “turned off”, “turned on”, “active”, “inactive”, “increment skip”, and “take win”. FIG. 31D to FIG. 31U each shows the relationship between each button and its lighting state (turned on or turned off), operation state (active or inactive), and behavior, for the specified situation (in the upper left cell). For example, FIG. 31 shows the behavior of each button in the situation of RAM clear start up (situation where the RAM 73 is cleared immediately after the start-up of the gaming machine). In this situation (RAM clear start up), the button having the button number of 1 (the cash out button 31) is turned off and inactive. Further, in this situation, the button having the button number of 3 (service button 32) is turned off, and active. When the button having the button number of 3 is pressed, the lighting state is changed from “turned off” to “turned on”, and a tower light (not illustrated, a light configured to be turned on when an attendant is called) is turned on. The setting for the operation of the buttons may be changed depending on the destination of shipment of the gaming machine, for example.

(Payout Message Etc.)

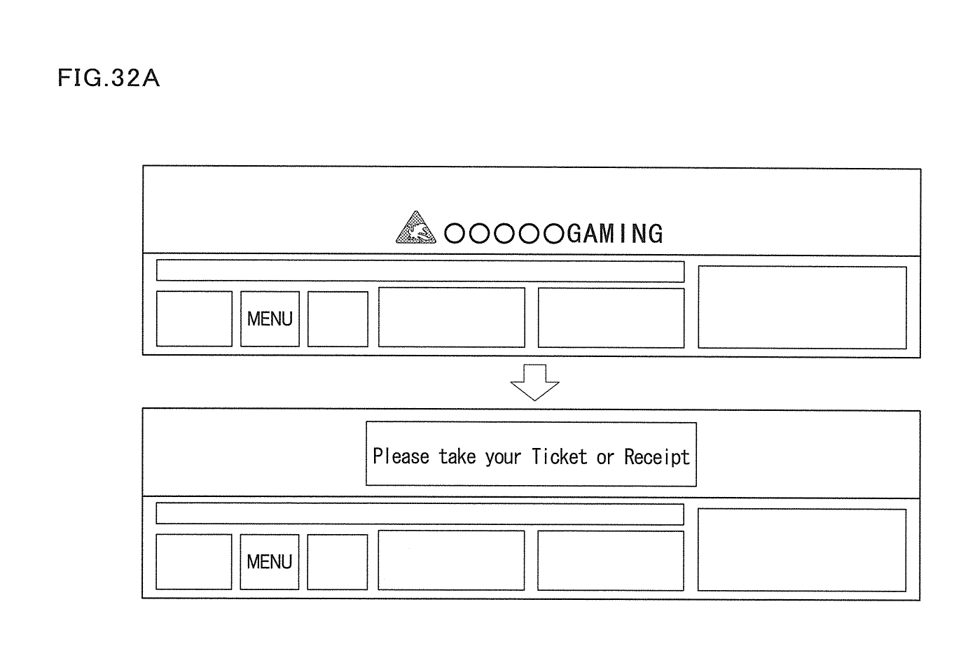

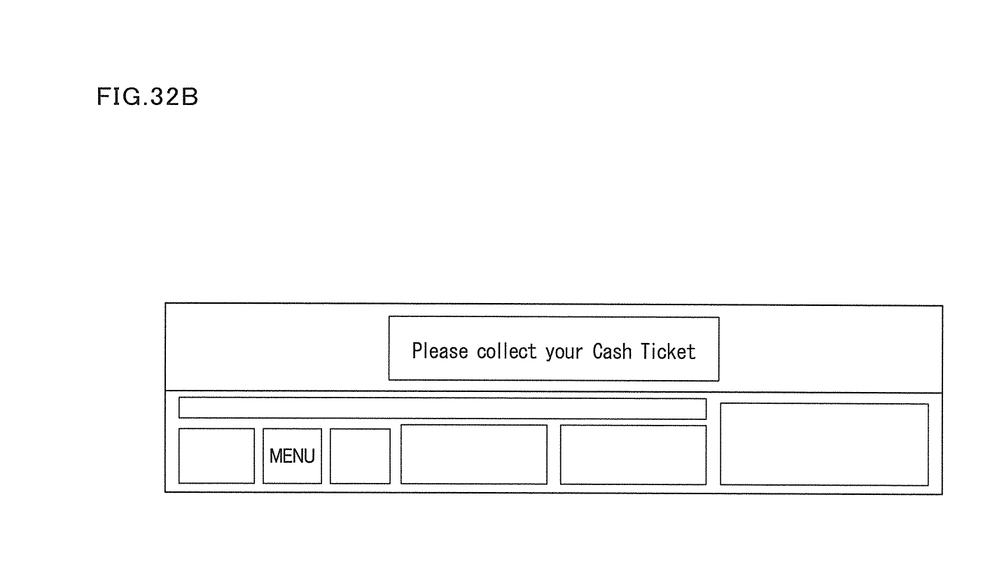

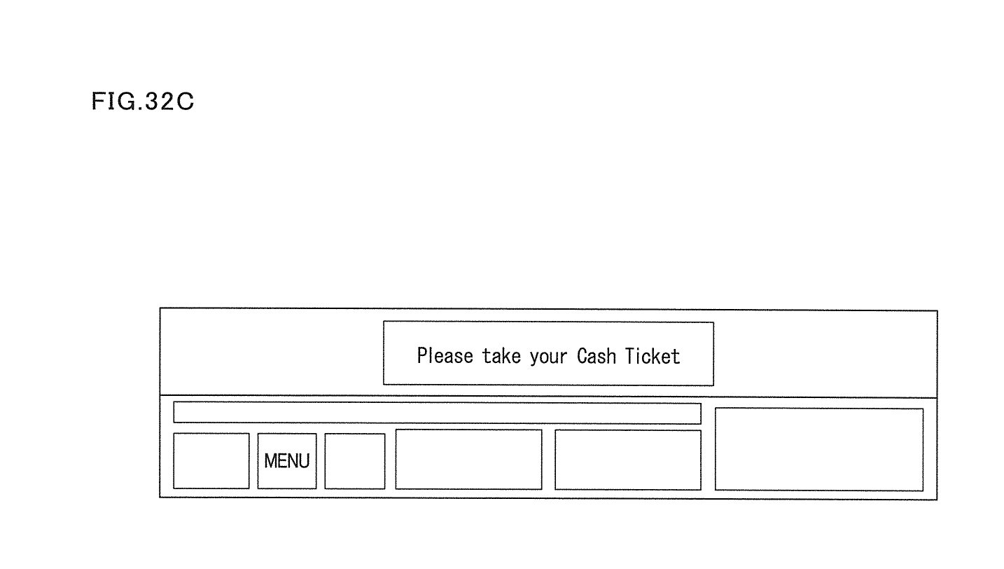

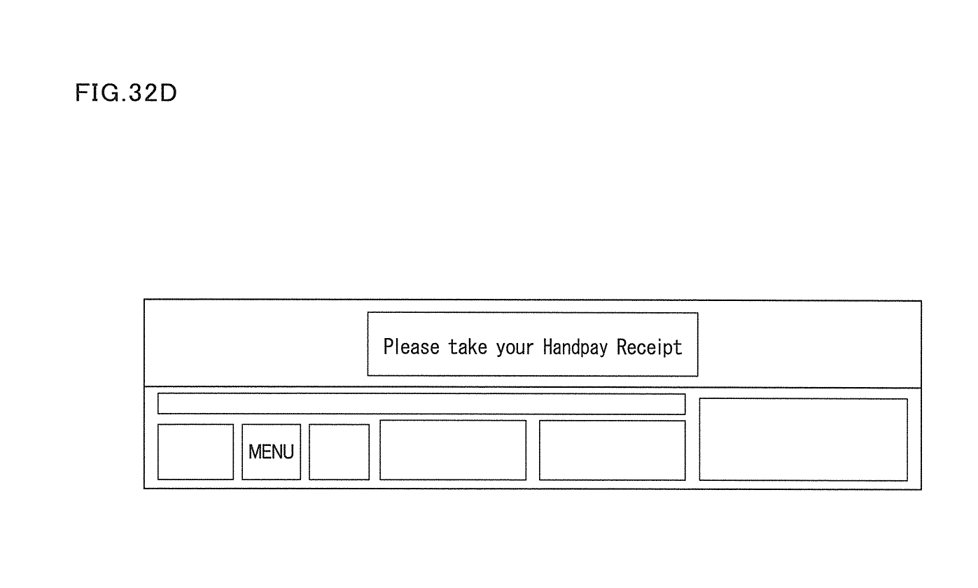

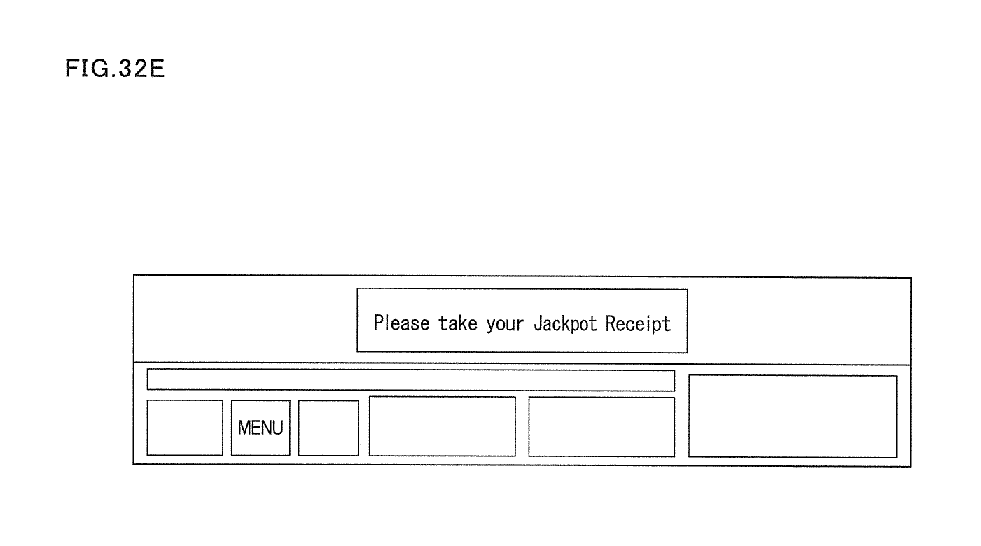

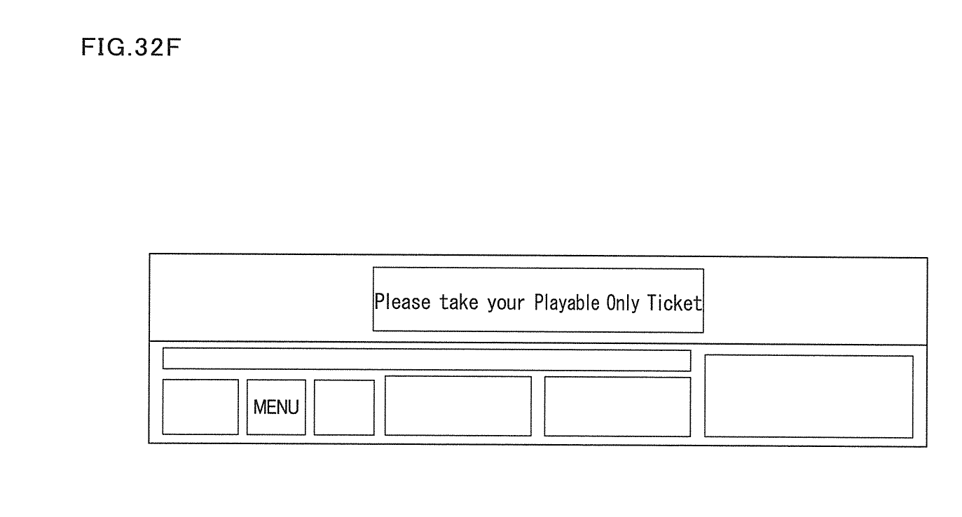

The following describes payout messages displayed on the liquid crystal display device 134, with reference to FIG. 32A to FIG. 32F. When the cash out button 31 (see FIG. 30) of the control panel 30 (or a collect button) is pressed, a payout process (e.g. a ticket payout) is performed, and a payout message is displayed on the liquid crystal display device 134. The payout message is displayed at a position (e.g. a vertical position) where the message is not hidden by a pop-up system message (message displayed at the time of cash in or cash out).

(Contents of Payout Message)

As shown in FIG. 32A, after the cash out button 31 is pressed, the upper middle display region 431 of the liquid crystal display device 134 displays a logo animation for approximately 2 seconds, and then displays the text exclusive to the payout message (display text). The contents of the payout message are changed, as needed, depending on the destination of shipment of the gaming machine.

<<Cash Ticket>>

When the cash out button 31 is pressed in a normal situation (situation other than the below-described “hand-pay receipt” or the like), the payout process is performed, and the liquid crystal display device 134 displays the payout message. The payout message at this time is “Please collect your Cash Ticket” (see FIG. 32B) or “Please take your Cash Ticket” (see FIG. 32C).

<Hand-Pay Receipt>

The operation for the case where the payout amount exceeds a payout upper limit set in the gaming machine when the cash out button 31 is pressed is as follows. In this case, the function of the gaming machine to call an attendant (staff) is activated, and the screen display is turned to a call attendant screen. After the attendant resets this situation (clears the state reporting an excess of the payout upper limit), the payout process is performed, and the liquid crystal display device 134 displays the payout message. The payout message at this time is “Please take your Hand-pay Receipt” (see FIG. 32D).

<Jackpot Receipt>

When a payout exceeding an upper limit defined in regulations is to be awarded, the function of the gaming machine to call an attendant is activated, and the screen display is turned to the call attendant screen. After the attendant resets this situation, the liquid crystal display device 134 displays the payout message, and the payout process is performed. The payout message at this time is “Please take your Jackpot Receipt” (see FIG. 32E).

<Playable Only Ticket>

Examples of tickets include a “playable only ticket”. This ticket enables playing of the game after read by the gaming machine. The playable only ticket is only for playing the game, and is not exchangeable with money. For example, when a player applies for a membership in a casino, the casino provides the playable only ticket to the player in a show of gratitude. The payout message at this time of providing the playable only ticket is “Please take your Playable Only Ticket” (see FIG. 32F).

<Ticket or Receipt>

The payout message displayed on the liquid crystal display device 134 when a ticket is about to be inserted to a printer is “Please take your Ticket or Receipt” (see FIG. 32A).

(Other Modification)

While the gaming machines in the present embodiments each includes the reels 101 to 105 and the roulette (e.g. the wheel 201), each gaming machine may include the roulette only out of these.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

The components in the first embodiment may be combined with the components in the second embodiment.

What is claimed is:

1. A gaming machine comprising:
a roulette including a plurality of slots including a repeat random determination slot and a payout slot;
a storage device storing a roulette multiplier which is a numerical value indicating a multiplying factor; and
a controller configured to execute the following steps of (1a) to (1d):
(1a) selecting one slot out of the plurality of slots through random determination;
(1b) when the repeat random determination slot is selected in the step (1a), executing the step (1a) again;
(1c) when the repeat random determination slot is selected in the step (1a), increasing the roulette multiplier, and when the step (1a) is executed repeatedly and the repeat random determination slot is selected repeatedly, increasing the roulette multiplier each time the repeat random determination slot is selected; and
(1d) when the payout slot is selected in the step (1a), determining a payout accordance with the roulette multiplier.

2. The gaming machine according to claim 1, wherein:
the storage device stores a slot payout which is a value associated with the payout slot; and
in the step (1d), when the payout slot is selected in the step (1a), a product of the slot payout associated with the selected payout slot and the roulette multiplier is determined as the payout.

3. The gaming machine according to claim 1, wherein:
the controller sets an initial value of the roulette multiplier to 1; and
in the step (1c), when the step (1a) is executed repeatedly and the repeat random determination slot is selected repeatedly, the roulette multiplier is incremented by a predetermined increment value each time the repeat random determination slot is selected repeatedly.

4. The gaming machine according to claim 1, wherein:
the controller sets an initial value of the roulette multiplier to 1; and
in the step (1c), when the step (1a) is executed repeatedly and the repeat random determination slot is selected repeatedly, the roulette multiplier is multiplied by a predetermined multiplying value each time the repeat random determination slot is selected repeatedly.

5. The gaming machine according to claim 1, further comprising:
a reel including a plurality of symbols and provided separately from the roulette; and
a display window configured to display one or more symbols out of the plurality of symbols, wherein
the controller is configured to execute the following steps of (5a) and (5b):
(5a) selecting one or more symbols to be displayed in the display window out of the plurality of symbols through random determination; and
(5b) when a predetermined trigger condition is satisfied in the step (5a), starting the step (1a).

6. The gaming machine according to claim 5, wherein:
the plurality of symbols include a plurality of specific symbols;
the storage device stores a roulette random determination play number which is a numerical value indicating the number of plays of the roulette random determination; and
the controller is configured to execute the following steps of (6a) to (6c):
(6a) when the trigger condition is satisfied, determining the roulette random determination play number in accordance with the number of the specific symbols displayed in the display window;
(6b) when the payout slot is selected in the step (1a), decreasing the roulette random determination play number by 1; and
(6c) when the roulette random determination play number after decreasing in the step (6b) is 1 or larger, starting the step (1a).

7. The gaming machine according to claim 1, wherein
when the step (1d) is executed multiple times, the controller executes a process of updating a value of the payout to a sum of amounts of the payout determined multiple times.

8. The gaming machine according to claim 1, further comprising:
a reel including a plurality of symbols and provided separately from the roulette; and
a display window configured to display one or more symbols out of the plurality of symbols, wherein
the plurality of symbols include a plurality of second specific symbols, and
the controller is configured to execute the following steps of (8a) and (8b):
(8a) after the step (1d), selecting one or more symbols to be displayed in the display window out of the plurality of symbols through random determination; and
(8b) determining a product of the payout and the number of the second specific symbols selected in the step (8a) as a second payout.

9. The gaming machine according to claim 1, wherein:
the roulette includes a mechanical wheel which is rotatable about a rotation axis;
the storage device stores a scenario which is a data sheet in which a rotational direction and a rotational speed of the wheel are defined in chronological order; and
the controller executes a process of controlling rotational operation of the wheel in accordance with description in the scenario.
